(19) United States
(12) Patent Application Publication
(10) Pub. No.: US 2004/0107368 A1
(43) Pub. Date: Jun. 3, 2004

(54) METHOD FOR DIGITAL RIGHTS MANAGEMENT INCLUDING SELF ACTIVATING/SELF AUTHENTICATION SOFTWARE

(75) Inventor: David S. Colvin, Commerce Township, MI (US)

Correspondence Address: BIR LAW, PLC, 45094 MIDDLEBURY CT., CANTON, MI, 48188-3215, US

(73) Assignee: Z4 TECHNOLOGIES, INC., Commerce Township, MI (US)

(21) Appl. No.: 10/605,060

(22) Filed: Sep. 5, 2003

Related U.S. Application Data
(63) Continuation-in-part of application No. 10/180,616, filed on Jun. 26, 2002.
Application No. 10/180,616 is a continuation of application No. 09/535,321, filed on Mar. 27, 2000, now Pat. No. 6,460,142.
Application No. 09/535,321 is a continuation of application No. 09/090,620, filed on Jun. 4, 1998, now Pat. No. 6,044,471.

(51) Int. Cl. H04L 9/00

(52) U.S. Cl. 713/202

(57) ABSTRACT

A system and method for digital rights management include designating software for protection via a corresponding code or identifier within the software. The identifier is detected by an authorized representative entity that may be resident on a user computer, network, or device, remotely located relative to the user, or both. Software/digital content being self-activating/self-authenticating when used in conjunction with a resident authorized administrator. During the first use or transfer of the content designated for protection, the authorized representative generates a password or authentication code at least partially based on user system information and links the code to the content. Subsequent use or access to the content requires that the current system information at least partially match the system information of the authorized system. Registration information associated with the user/device remaining within a trusted network associated with the user providing optimal user privacy.

### CROSS REFERENCE TO RELATED APPLICATIONS.

This application is a continuation-in-part of copending U.S. patent application Ser. No. 10/180,616, filed Jun. 26, 2002, which is a continuation of U.S. patent application Ser. No. 09/535,321, filed Mar. 27, 2000, now U.S. Pat. No. 6,460,142, which is a continuation of U.S. patent application Ser. No. 09/090,620 filed Jun. 4, 1998, now U.S. Pat. No. 6,044,471, the disclosures of which are incorporated by reference in their entirety.

### BACKGROUND OF INVENTION

1.Field of the Invention

The present invention relates to systems and methods for securing software/digital content to reduce unauthorized use.

2. Background Art

Developers of software, which is used in its broadest sense to mean anything that can be stored electronically and processed by computer, are often victims of illicit copying and unauthorized use in violation of contractual obligations imposed by licensing agreements. While violators may be subject to civil and criminal penalties under various domestic and foreign laws, this is often an insufficient deterrent to unauthorized use. A wide variety of unauthorized uses and unauthorized entities exist ranging from a relatively small percentage of the total users to an overwhelming majority of users. Unauthorized use of digital content collectively amounts to a multibillion dollar theft of intellectual property and may reduce the variety of digital content available to subsequent legitimate purchasers.

Ever-changing technology has contributed to a variety of methods, both legal and illegal, for exchanging digital content. The relative ease of use of the Internet has contributed to the proliferation of illegal or unauthorized distribution and copying of software/digital content, often referred to as piracy. Various Internet sites and peer-to-peer networks trafficking in illegal or unauthorized digital content, known as “warez”, are but one form of piracy.

One of the industries that suffers from very significant and unauthorized use of software is the music industry. While historical copyright infringement and piracy of music was manifested in the unauthorized duplication of magnetic tapes or, more recently, CDs, the more common form of music piracy currently plaguing software developers is illegal file sharing between computing devices, including computers as well as secondary devices such as personal audio players. While illicit web sites having stores of unauthorized music files can sometimes be identified and shut down, software that facilitates distributed file sharing, such as used in the Napster, Kazaa, and/or Grokster models, makes identification of individual computers and enforcement of licensing terms significantly more difficult.

An even more prevalent form of unauthorized use may be referred to as “softlifting” or casual piracy. This may include legally purchasing a copy of software, such as a computer program, digital music, an electronic book, a movie or video, etc. and using the purchase in violation of any accompanying license agreement, such as by installing the software on more devices than provided in the licensing terms, for example. This may also include sharing the software/digital content with friends, co-workers, family members, and others, contrary to the terms of any licensing agreement. As described above, unauthorized use may also include Internet piracy, which encompasses unlawfully transmitting software or providing infringing digital content that enables users to violate copy protection mechanisms in software (such as serial numbers and cracker utilities) over one or more of the Internet's components.

Another form of piracy that is more often acknowledged as a criminal enterprise includes software counterfeiting. These enterprises range from the very simple to more complex and elaborate strategies for illegally duplicating, distributing, and selling copyrighted digital content that may appear to be legitimate to often unsuspecting consumers. Of course, many consumers know or should know that the digital content has been misappropriated due to its substantially discounted price, distribution channel, early release, or other factors surrounding the illegal sale/purchase.

Yet another form of piracy includes loading unauthorized copies of software onto hard disks of personal computers sold by a computer dealer or reseller, often as an incentive for the end-user to buy the hardware from that particular dealer. Similarly, unbundling software—selling stand-alone software that was intended to be sold packaged with specific accompanying hardware and/or other software may violate the licensing terms and reduce the ultimate profitability of the product. Likewise, renting software for temporary use and then making a copy for subsequent use or distribution, such as renting and illegally copying a videotape, DVD, CD, or computer game, for example, contributes to the lost profits of artists, actors, writers, producers, directors, programmers, and all those involved with the development and distribution of various types of software. In addition, prior art encryption schemes which seek to protect CDs and DVDs from illegal copying are being cracked in ever increasing numbers by various “ripping”and decompiling techniques.

These and other forms of piracy will likely continue to proliferate, largely due to consumer demand and acceptance of a wide variety of digital devices including desktop, laptop, and hand-held computers; cell phones; CD and DVD players; MP3 and personal audio players; game consoles and set-top boxes; and home and mobile audio/video electronics, for example. Likewise, the numerous forms of distribution of many kinds of software/digital content contribute to the proliferation of illicit use due to the ease of acquisition. Distribution modes including traditional shrink-wrap purchases from brick-and-mortar outlets as well as e-commerce and mail order providers, point-of-sale (POS) software/digital content selection and purchase, and direct download of software over the internet or other local and wide area networks via computing devices and set-top boxes are making both legal and illegal use easier for typical consumers as well as committed pirates. As such, the need for piracy countermeasures has never been more urgent. A fractional reduction in the rate of even a small number of the manifestations of piracy means billions of dollars in additional revenues to digital content providers.

Because licensing terms for various types of software/digital content often limit use to a particular person or group, machine or device, or to a particular location and/or time, anti-piracy measures have attempted to associate the licensed party, device, location, or time, with the digital content. Various types of information relative to the user, location, machine, or time of use may be transferred to a retailer, publisher, or third-party to monitor compliance, for example. While this may be advantageous to the publisher in terms of providing additional marketing opportunities and assuring compliance with licensing terms, any type of software/digital content that requires the transfer of personal information to a remote location for the software to be operable may be highly objectionable to some users as evidenced by both voluntary and government mandated adoption of privacy policies applicable to various types of information collection entities. In ever increasing numbers and with ever increasing intensity, consumers have tremendous resentment and hostility to any program or application that transfers information from the user or user's machine to any remote location or entity. Such concerns have resulted in user boycotts, users purchasing alternative applications or content files from other sources, calls to Congress for legal remedies, etc. This user backlash cannot be underestimated or understated. Virtually all previous strategies to reduce unauthorized use of software fall into this category. In many cases, publishers have suffered significant loss of market share and had even been forced into bankruptcy due to this apparent or perceived invasion of user privacy.

While digital content developers may benefit from repeated contact with authorized users and the reduction of piracy through various license compliance measures, depending on the particular type of software/digital content and the particular developer or publisher, the additional cost or responsibility associated with long-term involvement with license compliance may be undesirable.

Various other prior art strategies have been developed to protect digital information, most of which are ineffective, burdensome to the user, or create significant privacy concerns for various users. For example, a hardware key that is typically installed in the parallel port of the computer may be used to provide a software interlock. The software cannot be used to the hardware key is not detected. While this method may reduce the unauthorized use of the software, this method is relatively expensive for the developer and cumbersome for authorized users. In addition, this method does not protect against the unauthorized use by users within close proximity who could exchange the hardware key as needed. Another approach requires a serial number or other customer identification to be entered during installation of the software. Missing or invalid registration information prevents installation of the software. Similarly, the user may be required to register the software with the manufacturer or distributor to obtain a software key, operational code, or password to install the software/digital content. These approaches may be easily defeated by transferring the necessary serial number, software key, or other registration information whether obtained manually with the software products, electronically, or via telephone from the manufacturer or distributor along with the pirated copy of the software.

In addition to being ineffective and easily defeated, these prior art solutions may be proprietary and instituted by a single publisher/developer acting only to protect their own content or information and therefore have little impact on the overall problem of unauthorized use.

### SUMMARY OF INVENTION

The present invention includes methods and systems for securing software, which includes various types of digital content and/or information, to reduce unauthorized use. Various implementations include one or more authentication or authorization codes associated with the software/digital content as well as a particular user or device used to access the digital content during registration and/or acquisition of the digital content. An authorized administrator may monitor and/or enforce compliance with licensing terms as desired by requiring subsequent authorization codes and/or requiring an appropriate authorization or authentication code to access the digital content. According to the present invention, the authorized administrator functions may also optionally include transferring information to a user or user device that may include marketing, promotional, or other information. The authorized administrator functions may be performed remotely over a wireless or wired local or wide area public or proprietary network, or locally on the user's device or a trusted local or wide area network connected to the user device. This feature of the present invention provides for authentication of any type of software at the user's system or closely related trusted network either independently or in conjunction with a remote authorized representative. Authentication performed soley within the user system requires that little or no authentication information be transferred from the user's machine to any remote representative. All authentication functions may be resident in the user's machine with additional functionality selectively applied utilizing a remote authorized representative or authorized representative module as a particular publisher or user may desire. The administrator or authorized representative functions may be performed by the content publisher or provider, a third-party service, or by a computer module or program attached to or separate from the digital content. The authorized administrator or representative may be an individual entity or module associated with each computer readable storage medium having stored software that may include digital content, for a group of individual computer readable storage media containing digital content, one authorized representative for all computer readable storage media, or any combination thereof.

Embodiments of the present invention provide a self-activating and self-authenticating turn-key solution for developers and publishers of software including various types of digital content by installing a user resident authorized representative upon initial use or transfer of protected content, or by installing an authorized representative on an OEM basis, and performing authentication functions on or within the user system or device for the initial and/or any subsequent software/digital content transferred to the user system which has been designated for protection. The user resident authorized representative may be provided with the protected content on a computer readable storage medium or via electronic distribution over a local or wide area public or private network, or provided upon first use or transfer of the protected content on a separate medium or downloaded separately depending upon the particular application.

Administrator or authorized representative functions may also include locking, disabling, partially disabling, or otherwise reducing functionality of the digital content. Similarly, authorized representative functions may also include disabling authorization or authentication code information to prevent tampering.

The invention includes a general authentication process applicable to a wide variety of software/digital content distribution modes and use modes. In addition, the invention includes various embodiments of an authentication process particularly suited for electronically distributed software/digital content stored on various types of computer readable storage media including rewritable media and non-writable media. The invention also includes authentication processes for use with primary computing devices, such as computers for example, in addition to secondary use devices that may include digital content players, for example.

The present invention provides a number of advantages. For example, the present invention provides an authentication process that is independently capable of performing license compliance functions locally, independent from a remote authorized representative or authorized representative module(s). As such, the present invention addresses various privacy concerns by providing the capability for any or all authentication activities to take place either at a remote, secure authorized representative site, or within an authorized representative module residing within a trusted computer or trusted computer network. The use of such a user resident authorized software/digital content administrator may be preferable to facilitate protection of varying content types and/or for various developers/providers that do not want long term involvement since associated revenue is generated without future administrative costs while assuring compliance. In many embodiments of the present invention, information collected during registration from the user or the user's machine required for digital content to be transferred to the user or the user's machine is kept within the trusted environment, but remains effective in preventing unauthorized use. This feature of the present invention allows developers/publishers the option of protecting their investment in the software/digital content by paying one price per activation to a licensing compliance entity with no additional follow-on costs to assure license compliance and increase overall revenue from additional content sales.

Various embodiments of the present invention allow the publisher the option of providing extensive secondary services to end-users, which may include marketing, advertising, promotion, update/upgrade services, quality assurance and error log reporting and monitoring, etc. while also assuring license compliance and/or without requiring transmission of any personal information outside of the trusted computer or trusted network.

The present invention includes various countermeasures effective to reduce or eliminate a wide variety of piracy and/or other unauthorized use of software including various types of digital content. Although deterring experienced hackers or those with a high-level of technical expertise in circumventing anti-piracy measures may be more difficult and require additional safeguards, the present invention includes various features intended to hinder and impede these more determined or committed scofflaws without impacting the ease of use or invading user privacy for authorized users. Digital content protection and rights management is provided and applicable to all types of software individually or in combination including operating system software, application programs, middleware, music files, text files, graphics files, games, and the like. In addition, the present invention is applicable to all forms of use and distribution. These forms include OEM sales, user purchases, software or digital content rental, update or upgrade models, network licenses, network management, and the like.

The present invention provides the ability if desired or applicable to alter authentication codes for each piece of software/digital content. While authentication codes may be at least partially associated with the user registration information, each may be altered relative to the next to further inhibit unauthorized use. Likewise, encryption algorithms and/or keys may be modified for each primary and/or secondary user device to further deter unauthorized use. As such, even if the encryption is circumvented or cracked by an unauthorized user, decryption will not be possible in another unauthorized user's system.

The present invention also provides for transitioning, as necessary, to a fully integrated digital rights management or other authorization/authentication process to reduce or eliminate unauthorized use of protected software. As such, the present invention is backward compatible with various primary and secondary use devices that may not have the capability to implement all the features afforded by the present invention.

Various embodiments of the present invention provide authorization or authentication of digital content/software that may be adapted to any of a variety of computer readable storage media and various types of software.

While the present invention may provide a standard authorization or authentication system or method adaptable to all types of computer readable storage media and all types of digital content, particular processes for systems relative to a specific one or group of computer readable storage media may provide optional authorization or authentication depending upon the particular application.

The invention provides various steps or functions that can be used individually or collectively for a number of applications including “try before you buy” or trial use scenarios; software, video, music, or other content rental; fixed time licenses, and the like.

The ability to locally and/or remotely locate an authorized representative entity according to the present invention accommodates wireless and wired local and wide area public or private networks that may have an authorized representative entity resident on a server and/or on each device. Digital content may be locked or restricted for use for a particular device or client, the server, a group of devices, etc.

The above advantage and other advantages and features of the present invention will be readily apparent from the following detailed description of the preferred embodiments when taken in connection with the accompanying drawings.

### BRIEF DESCRIPTION OF DRAWINGS

FIG. 1 is a block diagram illustrating a general authentication process applicable to numerous types of software stored on computer readable storage media.

FIG. 2 is a block diagram illustrating one embodiment for an authorized representative to authenticate a user for a general authentication process according to the present invention.

FIG. 3 is a block diagram illustrating an alternative embodiment of a general authentication process including representative authentication or compliance functions that may be performed by an authorized representative.

FIG. 4 is a block diagram illustrating a general authentication process according to the present invention having a remote server or source to perform one or more of the authorized administrator functions.

FIG. 5 is a block diagram illustrating an authentication process for electronically distributed digital content stored on computer readable storage media.

FIG. 6 is a block diagram illustrating representative functions performed for authentication of electronically distributed digital content stored on computer readable storage media.

FIG. 7 is a block diagram illustrating an alternative embodiment for an authentication process for electronically distributed software stored on computer readable storage media with various optional administrator functions.

FIG. 8 is a block diagram of an authentication process for electronically distributed digital information stored on computer readable storage media with various authorized representative functions performed by a user resident authorized administrator.

FIG. 9 is a block diagram illustrating general authentication of software stored on a non-writable computer readable storage medium.

FIG. 10 illustrates an alternative embodiment for an authentication process for non-writable computer readable storage media.

FIG. 11 is a block diagram illustrating authentication of digital content stored on non-writable computer readable storage media with various optional administrator functions.

FIG. 12 illustrates an authentication process for digital content stored on non-writable computer readable storage media with authorized representative functions performed locally.

FIG. 13 illustrates a representative authentication process for writable computer readable storage media.

FIG. 14 illustrates the representative authentication process for software stored on writable computer readable storage media with various optional authorized representative or administrator functions.

FIG. 15 is a block diagram illustrating an alternative embodiment of a representative authentication process for digital content stored on writable computer readable storage media.

FIG. 16 illustrates authentication of digital content stored on a writable computer readable storage medium with repeated authentication by an authorized representative.

FIG. 17 illustrates an alternative embodiment of authentication of digital content stored on a writable computer readable storage medium with various optional functions performed by the authorized representative.

FIG. 18 illustrates an alternative embodiment of an authentication process for writable computer readable storage media having repeated authentication and optional compliance functions performed by an authorized administrator or representative.

FIG. 19 is a block diagram of an alternative embodiment for an authentication process for software stored on writable computer readable storage media illustrating a representative installation and registration function.

FIG. 20 is a block diagram of an alternative authentication process for software/digital content stored on writable computer readable storage media with all authentication and authorized representative functions performed locally.

FIG. 21 is a block diagram illustrating an authentication process for writable computer readable storage media having most authentication functions performed locally with optional functions performed remotely.

FIG. 22 is a block diagram illustrating possible locations and types of authorized representatives or administrators applicable to any or all embodiments of the present invention.

FIG. 23 is a block diagram illustrating an alternative implementation for performing authorized representative functions applicable to any or all embodiments of the present invention.

FIG. 24 is a block diagram illustrating another alternative implementation for performing authorized representative functions locally and/or remotely applicable to any or all embodiments of the present invention.

FIG. 25 illustrates another implementation of an authorized representative or administrator residing on the user system with an optional remote server backup for use with any of the embodiments for securing software according to the present invention.

FIG. 26 is a block diagram illustrating an authorized representative implemented using a local or remote network arrangement for use with any of the embodiments for securing software according to the present invention.

FIG. 27 is a block diagram illustrating additional variations for implementing authorized representative functions using a network and a remote server for use with any of the embodiments of the present invention.

FIG. 28 is a block diagram illustrating additional variations of implementations for authorized representative locations and types for use in securing software according to the present invention.

FIG. 29 illustrates another variation for an authorized representative implemented using a network and optional remote server for backup.

FIG. 30 is a block diagram illustrating use of an authorized administrator as a clearinghouse for all software/digital content applicable to any or all embodiments of the present invention.

FIG. 31 is a block diagram illustrating a content locking and reinstallation sequence that may be used alone or incorporated into any of the embodiments for securing software according to the present invention.

FIG. 32 is a block diagram illustrating a general authentication process for secondary use devices according to the present invention.

FIG. 33 is a block diagram illustrating administrator or authorized representative functions for an authentication process with secondary use devices according to the present invention.

FIG. 34 illustrates another embodiment of an authentication process for securing digital content for use with secondary devices requiring repeated authentication.

FIG. 35 illustrates a general authentication process for use with secondary devices having authorized representative functions performed locally on a user system in addition to optional functions being performed on a remote server.

FIG. 36 is a block diagram illustrating a system or method for adding one or more secondary device authentication codes to computer readable storage media according to the present invention.

FIG. 37 is a block diagram illustrating an alternative embodiment for adding secondary device authentication codes to computer readable storage media according to the present invention.

FIG. 38 is a block diagram illustrating another embodiment for adding secondary device authentication codes to computer readable storage media to reduce unauthorized use of digital content according to the present invention.

FIG. 39 illustrates a system or method for authentication of secondary devices utilizing authentication codes for secondary devices particularly suited for computer readable storage media having software in the form of music or video files.

FIG. 40 illustrates an alternative embodiment for authentication of secondary devices without corresponding authentication codes particularly suited for computer readable storage media having stored music or video information.

FIG. 41 is a block diagram illustrating authentication of secondary devices utilizing corresponding authentication codes including alternatively formatted computer readable storage media content, such as music or video content, for secondary devices.

FIG. 42 illustrates authentication of secondary devices without utilizing secondary device authentication codes including alternatively formatted computer readable storage media content such as music or video information.

FIG. 43 is a block diagram illustrating one embodiment of an authentication process for electronically distributed content for secondary use devices according to the present invention.

FIG. 44 is a block diagram illustrating an authentication process for electronically distributed content for secondary use devices showing authorized representative functions requiring repeated authentication according to one embodiment of the present invention.

FIG. 45 is a block diagram illustrating an alternative authentication process for electronically distributed software/content transferred by the user to a computer readable storage medium.

FIG. 46 is a block diagram illustrating an authentication process for electronically distributed content for secondary use devices with repeated authentications according to one embodiment of the present invention.

FIG. 47 illustrates an authentication process for electronically distributed software stored on computer readable storage media for secondary use devices with various administrator functions performed on a local user device or system according to the present invention.

FIG. 48 illustrates an authentication process for non-writable computer readable storage media for use with a secondary use device according to one embodiment of the present invention.

FIG. 49 is a block diagram illustrating an authentication process for non-writable computer readable storage media for use with secondary use devices illustrating various administrator or authorized representative functions including repeated authentication according to the present invention.

FIG. 50 is a block diagram illustrating an authentication process for non-writable computer readable storage media with optional authorized representative functions.

FIG. 51 is a block diagram illustrating an authentication process for non-writable computer readable storage media for use with secondary use devices with various authorized representative functions performed at a remote server or source.

FIG. 52 is a block diagram illustrating an authentication process for writable computer readable storage media and secondary use devices according to one embodiment of the present invention.

FIG. 53 illustrates an authentication process for writable computer readable storage media and secondary use devices with optional authorized representative functions according to the present invention.

FIG. 54 is a block diagram illustrating an alternative embodiment of an authentication process for writable computer readable storage media with secondary use devices.

FIG. 55 is a block diagram illustrating an authentication process for writable computer readable storage media with secondary use devices having additional authorized representative functions.

FIG. 56 illustrates an authentication process for writable computer readable storage media with secondary use devices with the user transferring and installing digital content according to one embodiment of the present invention.

FIG. 57 is a block diagram illustrating an authentication process for writable computer readable storage media and secondary use devices with optional authorized administrator functions according to the present invention.

FIG. 58 is a block diagram illustrating an authentication process for writable computer readable storage media with secondary use devices and repeated authentication according to one embodiment of the present invention.

FIG. 59 is a block diagram illustrating an authentication process for writable computer readable storage media with secondary use devices having authorized administrator or representative functions performed locally in conjunction with a user system according to one embodiment of the present invention.

FIG. 60 illustrates an authentication process for writable computer readable storage media with secondary use devices with various authorized representative functions performed using a local user system according to one embodiment of the present invention. and

FIG. 61 is a block diagram illustrating representative applications of an authentication system or process to reduce unauthorized use of various types of software in secondary use devices having a processor and memory according to the present invention.

FIG. 62 is a block diagram illustrating representative applications of an authentication system or process to reduce unauthorized use of digital content in secondary use devices via alternative file types according to the present invention.

FIG. 63 is a block diagram illustrating representative applications of an authentication system or process to reduce unauthorized use of digital content in obsolete or unidentifiable secondary devices according to the present invention.

FIG. 64 is a block diagram illustrating use of symmetric encryption for an authentication process according to one embodiment of the present invention.

FIG. 65 is a block diagram illustrating use of asymmetric encryption for an authentication process according to one embodiment of the present invention.

FIG. 66 is a block diagram illustrating an alternative embodiment using asymmetric encryption in an authentication process according to the present invention.

FIG. 67 is a block diagram illustrating a process for designating software for copy protection according to one embodiment of the present invention.

FIG. 68 is a block diagram illustrating a process for designating software for copy protection and providing protection using an authorized administrator according to the present invention.

FIG. 69 is a block diagram illustrating a process for determining current authorized representative status and applicable update procedures.

FIG. 70 is a block diagram illustrating a process for implementing authorized representatives in the form of a chip, chip set, authorized representative card, processor integral, etc.

### DETAILED DESCRIPTION

The various block diagrams/flow charts used to illustrate operation of various embodiments for systems/methods of the present invention may represent logic having various steps implemented manually, automatically, or in combination using computer programs or code and any one or more of a number of processing strategies such as event-driven, interrupt-driven, multi-tasking, multi-threading, and the like. As such, various steps or functions illustrated may be performed in the sequence illustrated, in parallel, in a different sequence, and in some cases repeated or omitted while providing the features and advantages of the present invention as will be appreciated by those of ordinary skill in the art. The depicted order of processing is not necessarily required to achieve the features and advantages of the invention, but is provided for ease of illustration and description. Although not explicitly illustrated, one of ordinary skill in the art will recognize that one or more of the illustrated steps or functions may be repeatedly performed alone or in combination with other steps or functions. Likewise, one or more of the steps or functions, or a portion of a particular step or function, may be stored and/or implemented by hardware and/or software of a general-purpose or specialized computing device having a microprocessor depending upon the particular application. When implemented in software code, an application program, operating system, or the like, the control logic may be provided in a computer-readable storage medium having stored data representing instructions executed by a microprocessor-based computer to perform the step(s) or function(s). The computer-readable storage medium or media may be any of a number of known physical devices which utilize electric, magnetic, optical, and/or combination devices to temporarily or persistently store executable instructions and associated information or content.

Throughout the description of the various embodiments of the present invention, software is used in its broadest sense to include computer instructions, data, or content. Generally, anything that can be stored electronically in any type of format is software. In contrast, the devices or systems that store, use, and/or display the software, may generally be referred to as hardware. As such, software includes different types of digital information that may be used to provide the code or instructions for a computer game, application, or operating system program, content such as text, audio, music, video, etc. While software encompasses a wide variety of electronically storable digital information or content used by hardware devices, in the description of various embodiments of the present invention, the term software may be used interchangeably with one or more types of digital information or content particularly applicable to the function, step, or embodiment being described. Those of ordinary skill in the art will appreciate that the use of a particular type of software in describing a step, function, or embodiment, does not necessarily limit that step, function, or embodiment to that particular type, sub-category, or classification of software, but is used for ease of description and illustration of the more common applications for that particular type of software. For example, description of a step or function related to digital content in the form of a music file may also apply to digital content in the form of a video file or any other type of file including application or system software whether or not explicitly stated or shown. As another example, the description of one embodiment may refer specifically to electronic software distribution (ESD) or other electronic distribution with the software stored by the user on writable computer readable storage media including floppy disks, memory cards, and the like, while that same embodiment may also be applied to non-writable computer readable storage media distributed via more conventional methods although not explicitly illustrated or described. Likewise, various types of computer readable storage media may be either writable or non-writable, such as CDs, DVDs, etc., depending upon the particular application.

Software may include a combination of various types of digital information in a multi-formatted file or files or in a composite file or files of the same or similar type of software or content. For example, a music or video file may be supplied in different formats or file types to accommodate different devices or hardware. Preferably, all files may enjoy the protection of the authentication process or processes of the present invention. However, not all of the types of software or digital information must be protected to be within the present invention. Information acquired in an unprotected format or mode may be utilized in older or selected devices or hardware that may not be suited for any one or more embodiments of authentication processes to provide backward compatibility or a transitioning period, for example.

While a variety of combinations of various features of the invention are illustrated and described, any or all of the individual steps, functions, or processes illustrated and described with respect to one or more embodiments of the present invention may be used individually, in the combinations illustrated, or various other combinations in any user environment depending upon the particular application and implementation. Representative user environments include a single user device or system, a group of related users, wired or wireless network environments including local area networks and wide area networks, etc. Specific process steps or functions may also be selectively applicable to other operational sequences and may be altered or changed as desired. Similarly, various steps, functions, processes or devices are illustrated, without limitation, as being optional in some embodiments by using dashed lines. As such, these steps, functions, or processes may be required to provide the features and advantages of the present invention depending upon the particular application and implementation. Likewise, steps, functions, processes, and devices that are not illustrated as being optional may, nonetheless be optional for some applications and implementations. The various illustrated embodiments are representative of the more common applications and implementations but do not limit the scope of the invention.

Various terms related to authorization, activation, authentication, and the like are used interchangeably throughout the description and illustrations. Likewise, authorization codes, passwords, activation codes, authentication codes, and the like are used interchangeably throughout the description and figures. The terms representative, authorized representative, administrator, authorized administrator, and the like are used interchangeably as well. As described in greater detail below, various functions performed by an authorized representative, administrator, or the like may be performed manually or automatically using a computer program module and/or special-purpose device alone or in various combinations, for example. Similarly, generation of any type of authorization, activation, authentication or other code, registration information, hardware identification, etc. may be performed manually or automatically with communication by or between any type of authorized representative and the software or user unencrypted, fully encrypted, or partially encrypted. While most operations that include contact with, by, or between a local or remote server or authorized representative and a user, user device, or system are intended to be in the form of electronic communication, the present invention may also include various conventional forms of communication including telephone, fax, and the like.

In general, any and all illustrations and references depicting a user or user's device may also include a group of machines or devices, a group of users, and/or users or devices connected by a network including local and wide area networks both public and private. Authentication and other compliance measures are generally illustrated as directed to one user or user device but may also be applicable to any group of users or devices either individually or collectively. Likewise, illustrations of, and references to any of the various authentication or compliance activities may include any one or more of a number of actions intended to reduce the unauthorized use of software including but not limited to inhibiting or preventing access to software/digital content, reducing functionality, preventing transfer, removing, disabling, erasing, or deleting previously stored electronic information or portions thereof, etc. Any illustrations of, or references to any scenarios depicting authentication or authentication activities which by example are using hardware identifiers, static or dynamic addresses, registration information, serial numbers, and the like are by example only to illustrate a representative process or processes. Any or all of the representative scenarios may include any or all forms of user and/or device identification as appropriate.

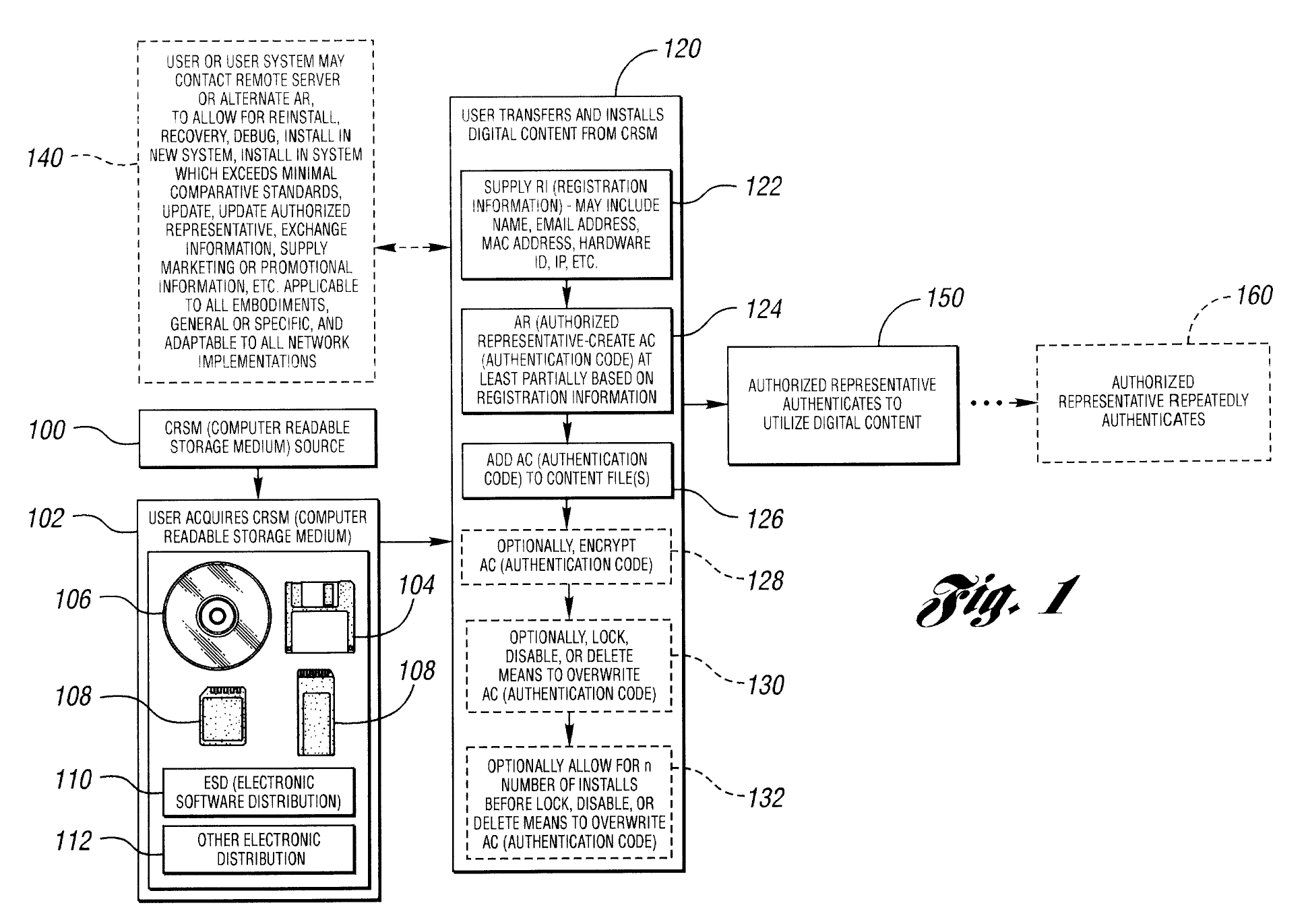

Referring now to FIG. 1, a block diagram illustrating a general authentication process according to one embodiment of the present invention is shown. A computer readable storage medium (CRSM) source 100 is acquired by a user as represented by block 102. As illustrated, computer readable storage medium or media 100 may include writable or recordable media in addition to non-writable media. Representative forms of computer readable storage media may include a floppy disk 104, CD or DVD 106, or any of a wide variety of separate or integrated solid-state electronic storage devices, such as portable memory cards 108 or integrated memory installed in a computer or other stationary or portable device including a digital audio player, for example. In general, computer readable storage media may include any media capable of storing digital information that is directly or indirectly readable by a device having a processor to present the digital information in a format useful to a user. Other examples of computer readable storage media may include hard drives, floptical disks, magnetic tape, and the like. Depending upon the particular application, computer readable storage media source 100 may or may not include protected software/digital content. Software/digital content may be obtained by the user using electronic software distribution (ESD) 110 or other electronic distribution 112, for example, and temporarily or permanently stored on computer readable storage medium 100. For illustration purposes in all embodiments, electronic software distribution, other electronic distribution, and wireless are referred to as computer readable storage media. In such cases, the actual computer readable storage medium is the underlying remote server or transmission site computer readable storage medium, but are best understood and appreciated in the context of their respective distribution means. Storage of the software/digital content on computer readable storage medium 100 may require explicit steps performed by the user, or may be performed transparently with or without the user's knowledge. For example, a user downloading digital content from a wide area public computer network such as the Internet may be unaware that the software is temporarily stored in a computer readable storage medium, such as the memory of a computer connected to the network. The transfer may take place without any intervention required by the user, or may require the user to initiate the download, specify a destination, etc. Additional activation steps may also be required such as entry of a first activation code, activation key, etc. The requirement of entry of additional activation or authentication codes may also follow the authentication process of the present invention. Requirements of entry of additional activation or authentication codes are adaptable to all embodiments of the present invention.

The user transfers and installs software/digital content from the computer readable storage medium to another hardware device as represented by block 120. Again, the steps of transferring and installing the software may be performed in response to specific user actions or may be performed transparently to the user depending upon the particular application and implementation. Similarly, transferring and installing the software may be performed in discrete steps or functions or in a single integrated, automated, or combined step. During the transfer and/or installation of digital content from the computer readable storage medium as represented by block 120, registration information may be collected or supplied as represented by block 122. Registration information may include traditional contact information, such as name, address, e-mail, phone number, fax number, etc., but preferably includes at least some information that can be obtained without intervention by the user to improve veracity of the registration information. In addition, some registration information is preferably associated with a hardware device that is currently or subsequently receiving the software/digital content. As such, registration information may also include hardware specific information associated with a computing device or other software/digital content access device. Hardware specific information such as an electronic serial number that uniquely identifies the device based on information stored in a non-volatile memory, a computer or operating system registry, a motherboard or network card serial number, hard disk number, or the like, may be obtained automatically or through manual user entry or selection. Other device specific information may include a dynamic or static hardware and/or software network address associated with a specific component such as a network adapter including a MAC address or IP address, for example. Device specific information may be combined with user information and coded to produce a unique identification code. Any codes generated may be converted to appropriate hash values to protect user information and assist in the code generation process. The identification code may be further encrypted or otherwise hidden to inhibit unauthorized duplication that would allow subsequent illegally “authorized” use of the software/digital content. As with the traditional user contact information, any hardware identification information may be obtained either manually or automatically as noted above. Manually entered information may be obtained by prompting the user to enter device specific information, such as the manufacturer, model, serial no. etc., or selecting from a list of possible devices or models, for example. Alternatively, or in combination, some or all of the hardware specific information may be electronically transferred automatically with little or no user intervention for appropriately equipped hardware devices. Provision of manual entry is one feature that provides for backward compatibility of older devices according to the present invention. Operating system software and secondary software, preferably application software, identification may also be utilized either independently or in conjunction with the other identification means described. Although various system identifiers are illustrated, it is also possible to generate non-associated authentication codes in the authorization processes described. Although perhaps less prolific, these other authentication code generation means are adaptable to any of the embodiments described.

As represented by block 124, an authorized representative (AR) for the software/digital content creates an authentication code (AC) as represented by block 126. The authentication code preferably is at least partially based on registration information, which, in turn preferably includes hardware or device specific information or identifiers as described above. Depending upon the particular application, the authorization code or codes may be generated and locked prior to downloading, unpacking, installing, etc. to prevent content from residing freely on the users system or device. Accordingly, if the content is transferred to an unauthorized system, the authorization or authentication code is also transferred to the unauthorized user's system. This will prevent use of the content on the unauthorized user's system when a comparison of the authentication code, which is based on registration information including hardware, user, or other device specific information of the original authorized user, will not be the same as that on the unauthorized user's system.

Generation of the authentication code or codes may take place at a remote authorized representative server or module, or may be generated by an authorized representative module downloaded and installed on the user's device, to authenticate and encode any future downloaded file or files, or may be attached to each individual file or group of files, for example. In addition, whether generated locally or remotely, alternate authorized device codes may be included to allow access or use of the digital content on one or more of these authorized devices. These codes may be reduced to one master code for all authorized devices, may require individual codes for each device, or may be grouped by manufacturer, model, etc. depending upon the particular application and implementation. Such authorization codes will allow use of the software including music, text, video, applications or systems programs, games, and the like on any one or more of the authorized devices. In any device that cannot be authenticated, such as may occur with older or incompatible devices, users may or may not be allowed to access the content depending upon the particular compliance actions or rules implemented by the authorized representative as described in greater detail below.

If the digital content file or files are provided in a physical medium, such as a CD or DVD for example, authentication and generation of authentication codes would generally, but not necessarily, take place at a remote authorized representative and be downloaded to the users device. Once the file or files are copied to a local computer readable storage medium, such as a hard drive or other writable device, they may only be utilized upon proper authentication of the corresponding codes as described below. Depending upon the particular application and implementation, limited use of the content may be provided rather than completely disabling access to the content if proper authentication does not take place. Access to the digital content may also be provided if the original physical media is in place at the user's machine or device with the presence of the original physical medium providing a presumption that the use is authorized.

All or any portion of information generated or exchanged by the authorized representative in any of the user systems or devices may be encrypted as represented by block 128. User devices may include a primary device such as a computer, set-top box, digital radio, or satellite radio and/or a secondary device such as a personal audio player or DVD player, for example, with the digital content being transferred first to the primary device and subsequently to the secondary device depending upon the particular application. Encryption and/or decryption algorithms may be interlocked to the authentication code and/or authorized representative module or modules during generation of the authentication code as represented by block 126. As an example, the generated authentication code or codes may be encrypted and interlocked to registration information that preferably includes hardware identification values. When the content is subsequently decrypted, the decryption keys are regenerated utilizing current values for the user device. An authorized decryption key based on the proper identification code will be operable to provide access to the content. Alternatively, if the content has been transferred to an unauthorized system, the decryption key will be invalid, i.e. will not include the proper values, and the content will not be accessible, will not be usable, or any of a number of actions may be performed by the authorized representative to inhibit unauthorized use as described in greater detail below.

As described above, the authentication code is encoded and interlocked as a lock code for the digital content file or files. The authorized representative module and/or the authorization or authentication code may be interlocked with, or embedded within any file or files associated with the software/digital content, any portion of the content which is needed to enable the content, any file or files external to the actual content which may enable the content, any application that may enable the content, etc. Alternatively, the authorized representative module and authorization or authentication code may be external to the software/digital content, similar to that of a digital wrapper or digital envelope, and linked to any file or files within the content, any portion of the content which is needed to partially or fully enable the content, any file or files external to the actual content which may enable the content, any application that may enable the content, etc.

The authorized representative module or modules may be transferred along with the digital content file or files and may be directly attached to the content or reside remote from the user's system depending upon the particular application. In one embodiment, the authorized representative module is attached to the content file or files with each transferred content file generating its own authentication code or codes that are interlocked to the specific content file or files. When the content file is accessed or opened, the authorized representative module attempts to authenticate the content by comparing the current system identification or registration information with the previously generated authentication code or codes that include information representative of the system identification. If the current system identification and the previously generated authentication code or codes at least partially match, access may be provided to the digital content file or files. If the comparison is unsatisfactory, access to the digital content file or files may be limited or prevented.

The generation of a particular authentication code may be achieved by a suitable system identification algorithm within the authorized representative module or modules that may subsequently be encrypted to prevent user tampering and interlocked or embedded within the specific content file or files, either randomly, interlaced, periodically interlaced, etc. To further inhibit user tampering, the code or program portion of the authorized representative module or modules that generates the authentication code or codes may optionally be locked, disabled, or deleted as represented by block 130 of FIG. 1. This additional step may optionally be performed after a predetermined number of transfers or installs as represented by block 132. These operations provide further assurance that the attached authorized representative module or modules will be unable to generate and install additional authentication codes to provide unauthorized access to the digital content file or files. As such, if the content file or files are illegally transferred to an unauthorized system, the protected content will remain at least partially disabled due to the incomplete comparison of system identification parameters and the inability to generate additional authentication codes.

Similarly, additional security or protection may also be provided by altering the authentication codes for each piece or file containing protected digital content. Although each authentication code is at least partially associated with the user registration information, each code may be altered relative to subsequently generated codes. This may be accomplished by incrementing each authentication code, by attaching a publisher code, incorporating a file type code, time code, date code, or the like. In addition, for those embodiments using encryption, the encryption algorithms and/or decryption keys may be modified from user system to user system to further deter unauthorized use. For example, a random number generator may be provided to modify each user's authorized administrator encryption algorithm and associated decryption key. As such, even if the encryption is cracked by an unauthorized user, decryption will not be possible in any other unauthorized user system. Other modifiers may include hardware component values, network addresses, and various other registration information as described above.

As represented by block 140 of FIG. 1, an authorized user wishing to install one or more content files on a different machine or device may contact a remote authorized representative entity who may selectively supply and install a new authorized representative module or modules, or generate and download one or more new authentication codes for the authorized user's new device or devices. The remote authorized representative may be constructed and programmed to provide for the ability to override, overwrite, or modify any content file or files or resident authorized representative module or modules, for example.

The ability to reinstall, recover, debug, install in a new system, update, and the like, is applicable to all embodiments of the present invention whether general or specific and may be applied equally to all stand-alone and network implementations. Similarly, it may be necessary and desirable for the user to update one or more authentication codes to provide for changes in the industry, changes in technology, addition of new authorized devices, dynamic authorized representative changes, etc. This function may also be accomplished by manually or automatically contacting a remote authorized representative and updating the authentication file or files as represented by block 140. This feature applies to all embodiments for authentication modules of the present invention including without limitation remote authorized representatives, authorized representative modules which authenticate individual files or groups of files, authorized representative modules which are attached to each content file, etc. Similarly, repeated authentication may also be desired and required by the publisher of the digital content which may also require periodic updating of authentication files or authentication modules in addition to or in place of local authentication.

During any repeated authentication or other contact with an authorized representative, various information may be selectively transferred to the user or user device, i.e. marketing information, update or upgrades, previews of new music files, promotional offers, etc. This transfer may occur independently of authentication, i.e. authenticating once a year but transferring marketing information quarterly. Depending upon the particular application and implementation, it may also be desirable to obtain various information from the user or user's machine during these periods of contact between the user or user's machine and an authorized representative, whether local/user-resident or remote.

For any of the embodiments of the present invention, any one or more of the authorized representative modules may also have communication capabilities to allow for the transfer of information to and/or from the user or users device to an authorized representative entity. Such connectivity between the authorized representative entity and the user and/or the user's device serves a variety of functions. These functions may include the identification of unauthorized users, downloading or generation of suitable warnings to unauthorized users, and/or transferring application upgrades or updates, fixes or patches, marketing information, and the like, as described in greater detail below. This enhanced user-publisher interface provides for a complete connectivity platform between the user and publisher. The authorized representative or administrator may perform various compliance functions, such as collecting registration information, generating an authentication code based at least in part on the registration information, and authenticating the user as represented by block 150 of FIG. 1. Various events may be used to trigger, activate, or initiate one or more of the compliance steps or functions. For example, the compliance functions generally represented by authentication block 150 may be triggered as part of a transfer of protected content, during installation of protected content, or upon a first or some predetermined number of uses to provide a trial, sample, or rental period, for example. In general, compliance functions will include an authentication process that compares current registration information with previously received registration information that is preferably encoded in the authorization or authentication code to determine whether the attempted access or use of the content is authorized. If the attempted use is determined to be unauthorized, compliance actions will generally include limiting or preventing access to unauthorized software/content and/or any other actions to assure compliance with licensing terms as described in greater detail below. Upon authorization, access may be provided to the content for a first predetermined authorization period, interval, or number of uses, which may be limited to a single use or access, before requiring another authorization or authentication as represented by block 160. The predetermined period or interval may vary based on the particular authorized user, device, type of device, cost or value of the software, the number of estimated unauthorized copies, etc. For example, it is anticipated that more expensive content would provide a shorter period of authorization to provide a higher level of security. The higher revenue generated by such content would offset any increased administrative expense of password or authentication code administration. However, depending upon the particular embodiment of authentication utilized, subsequent authorizations or authentications may be performed locally or remotely by an authorized administrator module with little or no additional administrative costs as explained in greater detail herein.

The authorized period of use may be measured in a variety of modes including random, scheduled, based on time of execution or use, calendar time, or number of accesses, for example. The authentication or comparison of authentication codes may occur prior to allowing access or operating the content, during use or access of the content, etc. Repeated authorizations or authentications may be accomplished automatically and transparently to the end-user by electronically contacting the authorized representative and exchanging current registration information for comparison to the previously obtained registration information encoded within the authorization code. The authorized representative may compare the current registration information with previously received registration information to determine if at least a portion of information matches for that particular digital content and associated hardware device. This comparison may be used to determine whether the end-user is an authorized user or an unauthorized user.

The authorized representative or administrator functions may be performed in any combination by the manufacturer or developer of the software, by a third party representative, or by a local or remote software module, or any combination thereof, for example.

As illustrated and described with reference to the various drawings, the present invention provides for the optional use of more than one authorized representative entity to perform various license compliance functions. Authorized representative entities, including but not limited to authorized representative modules, may be utilized independently or in conjunction with one another. Any file or files containing software/digital content may contain one or more types of authorized representative modules. One or more device-resident authentication modules may control all or part of the authentication process individually or in combination with other resident authentication modules with a remote authorized representative entity acting as a further authentication or as backup for the authentication process. As such, the authentication process may include multiple levels of authentication.

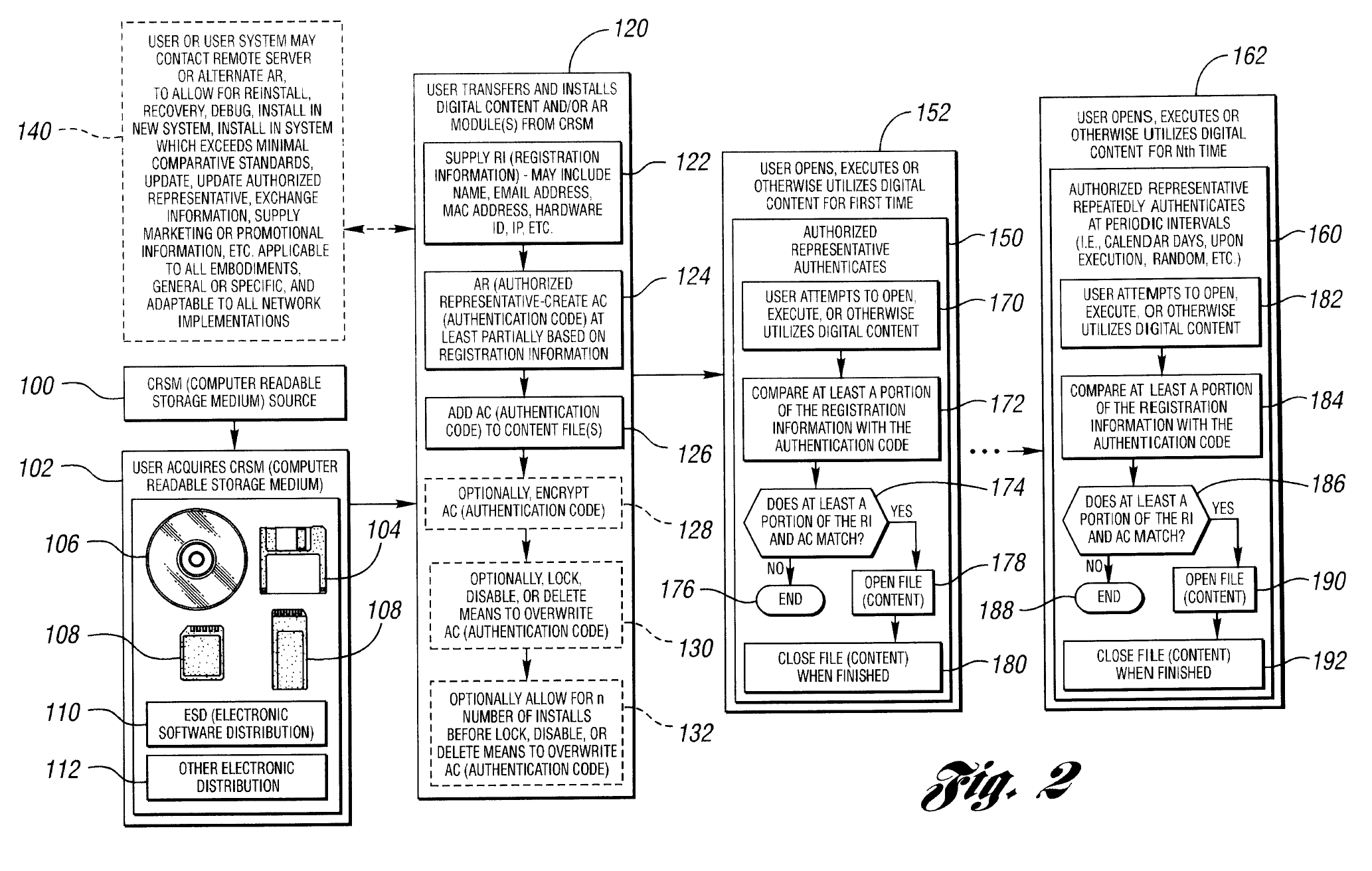

FIG. 2 is a block diagram illustrating various representative compliance functions performed by an authorized representative during a general authentication process according to one embodiment of the present invention. The blocks of FIG. 2 having the same reference numbers as those of FIG. 1 generally perform similar, although not necessarily identical functions as described with reference to FIG. 1 and are not described again in detail here. Exemplary activating or triggering actions are generally represented by block 152. As indicated, when a user subsequently transfers, opens, executes, or otherwise attempts to utilize protected digital content for the first time after the initial transfer and installation represented by block 120, the authorized representative attempts to authenticate the user as represented by block 150. The user attempts may be intercepted as represented by block 170 to generate an identification code based on current registration information and to compare the registration information with the authentication code interlocked to the digital content as represented by block 172. Block 174 then determines whether at least a portion of the registration information matches the interlocked authentication code. If an insufficient amount of the registration information matches the authentication code the authentication process ends as represented by block 176. However, various additional compliance functions may be performed depending upon the particular application and implementation as described in greater detail below.

If a satisfactory comparison of the current registration information and authentication code is performed at block 174, access to the protected software/digital content is provided as represented by block 178. The content file or files are then closed when the current access has been completed as represented by block 180.

The authorized representative may perform repeated authentication at periodic intervals as represented by block 160. The repeated authentication may be activated or triggered by various events as represented by block 162. For example, repeated authentication may be required each time the user attempts to open, execute, or otherwise utilize protected digital content. The attempts to open, execute or otherwise utilize the protected content are intercepted, as represented by block 182, to perform a comparison of at least a portion of the current registration information with the authentication code interlocked to the protected content, as represented by block 184. If at least a portion of the registration information matches the interlocked authentication code as represented by block 186, access to the protected content may be provided as indicated by block 190 until the file or content is closed as represented by block 192. An unsatisfactory match or comparison represented by block 186 may end the authentication process as represented by block 188. However, various additional compliance functions or actions may also be performed to further inhibit unauthorized use or transfer of protected content as described in greater detail below.

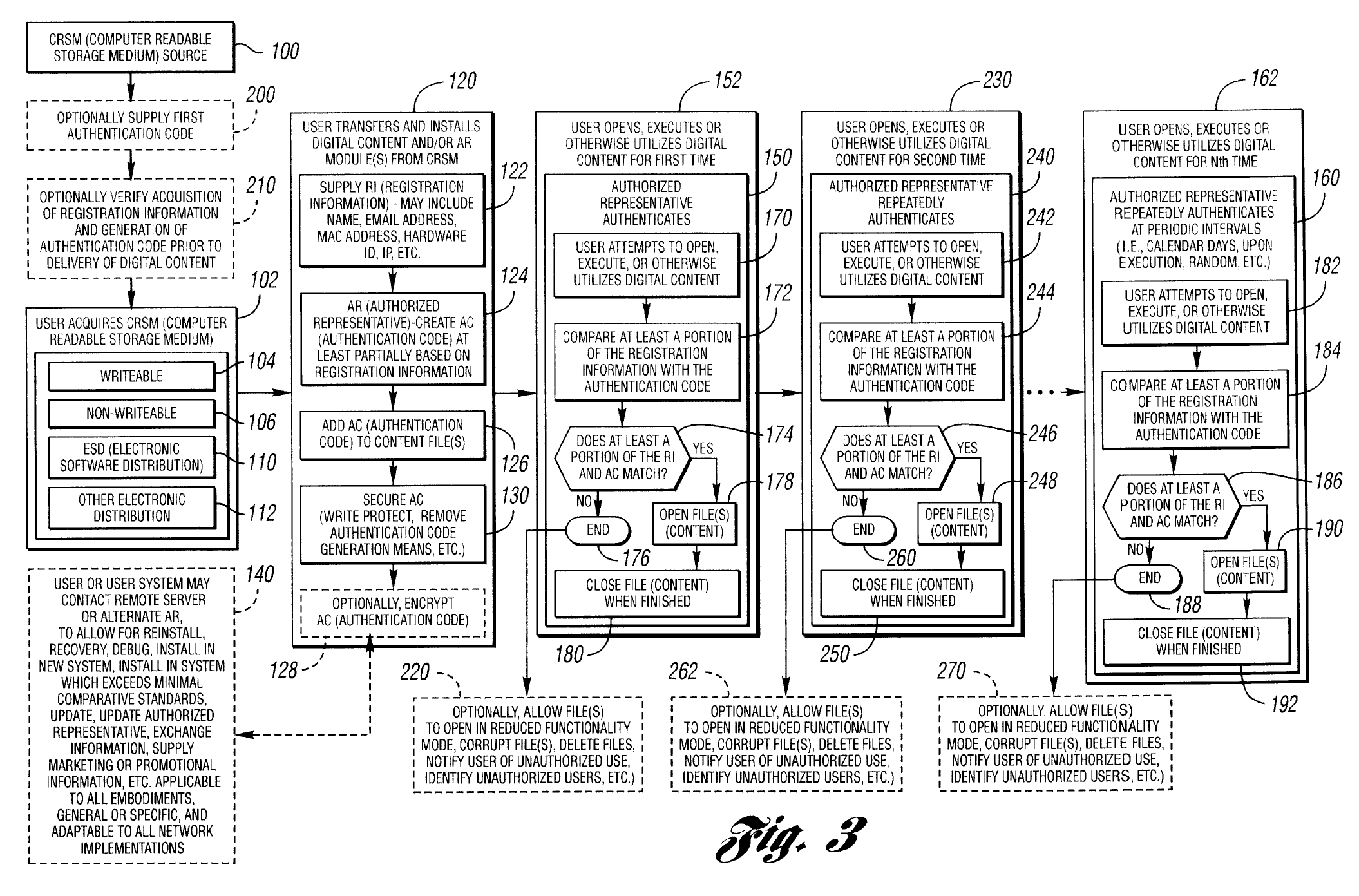

FIG. 3 is a block diagram illustrating an alternative embodiment of a general authentication process including representative authentication or compliance functions that may be performed by an authorized representative. As with the description of various figures illustrating the invention, blocks or functions identified with identical reference numerals throughout the figures perform generally similar, although not necessarily identical, functions in the various embodiments and are generally not described in detail again since those of ordinary skill in the art will appreciate that any of the described and/or illustrated functions may be used alone or in combination to provide the various features and advantages of the present invention.

In the embodiment of FIG. 3, the computer readable storage medium source 100 may optionally be supplied with a first authentication code as represented by block 200. In addition, registration information may be acquired and verified to generate an appropriate authentication code or codes prior to delivery of the protected digital content file or files as represented by block 210. As an example, source 100 may be supplied with a first authentication code 200 based on acquisition and verification of registration information 210 by a remotely located authorized representative entity, such as an authorized representative module located on a remote server, for example. During the ordering or initiation of digital content transfer, the user provides, or the system acquires, registration information, as depicted in block 122, to generate an appropriate authentication code to interlock with the digital content file or files. The transferred digital information acquired by the user as represented by block 102 is then transferred or installed to a user system or device as represented by block 120. Additional registration information may be supplied as represented by block 122 and incorporated into the previously generated authentication code or file, or one or more additional authentication codes or files may be generated and added to the content file or files as represented by blocks 124 and 126. According to the present invention, after an authorized representative module generates authentication codes for one or more content files, the authorization code or codes may be secured as represented by block 130. This may include locking the codes to prevent overwriting, tampering, or deletion of the codes, for example. Accordingly, once locked, the content file or files may only be fully operable on the associated authorized hardware device, or group of devices, or network of devices as appropriate. If the associated content file or files are illegally transferred to an unauthorized machine or device, the content file or files will remain at least partially disabled due to the system identifiers being different and the resulting inability to generate and install new or additional authentication codes.

To provide additional protection, the authentication code or codes may optionally be encrypted as represented by block 128. Authorized users wishing to install the content file or files on a different machine that has not been previously authorized may contact a remote authorized representative entity that may selectively determine that the user is authorized and transfer appropriate authentication codes for the authorized user's new device as represented by block 140.

Various events or actions may trigger a subsequent authentication as represented by block 152, such as attempting to use or transfer one or more protected files. The triggering event or request may be intercepted as represented by block 170 to compare the current device information with the authentication code or password information interlocked with the protected content as represented by block 172. A comparison at block 174 determines whether the user/device is authorized and, if authorized, allows access to the content as represented by block 178 until the content file or files are closed, or another intervening event occurs, as represented by block 180. Other intervening events may include expiration of a current authorization interval, for example. Additional protection may also be derived by periodically or randomly authenticating the content while the content is open. Conversely, the authorized representative may periodically or randomly authenticate the content while the content is not in use. These periodic or random authentications may be instituted individually or globally and may serve to further impede “crackers”and “hackers” from illegally obtaining protected content and are applicable to all embodiments.

If at anytime it is determined that the content file or files are being transferred to an unauthorized system or reside on an unauthorized system, the authorized representative, whether remote, resident on the user's system, or attached to the content file or files either independently or collectively, may take further action to deter unauthorized use as represented generally by block 220. Such further action may include notification of the user of the attempted unauthorized use or action, notifying the user of the need and means to obtain a valid license, notifying a remote authorized representative entity of the attempted unauthorized use or action, or generation of a disable code, for example. Use of a disable code or any similar means may permanently disable the file (either partially or fully), allow the file or files to operate with reduced functionality, corrupt the file or files, delete the file or files, etc. Generation of the disable code or similar actions may originate at the remote authorized representative or any type of resident authorized representative module, program, chip, processor integral, device, or code. Use of the disable code may be temporary or permanent predicated upon the desire or determination of the protected software developer, publisher, or source.

At the discretion of the authorized representative entity, the user may selectively be allowed to rectify the attempted unauthorized use condition by providing authentication and verification information to an authorized representative entity or requiring the user to obtain a valid license, either user system resident or remote. Once the unauthorized condition or action has been identified and overcome, removed, or otherwise remediated, the content file or files may be selectively restored to their fully operable condition and authorized for subsequent use or access for a corresponding authorization interval, which may be limited to a single use, before authentication is again required. Typical conditions that may trigger such an unauthorized use condition by an otherwise authorized user may include a change of some or all of the registration information, installation of new devices, etc.

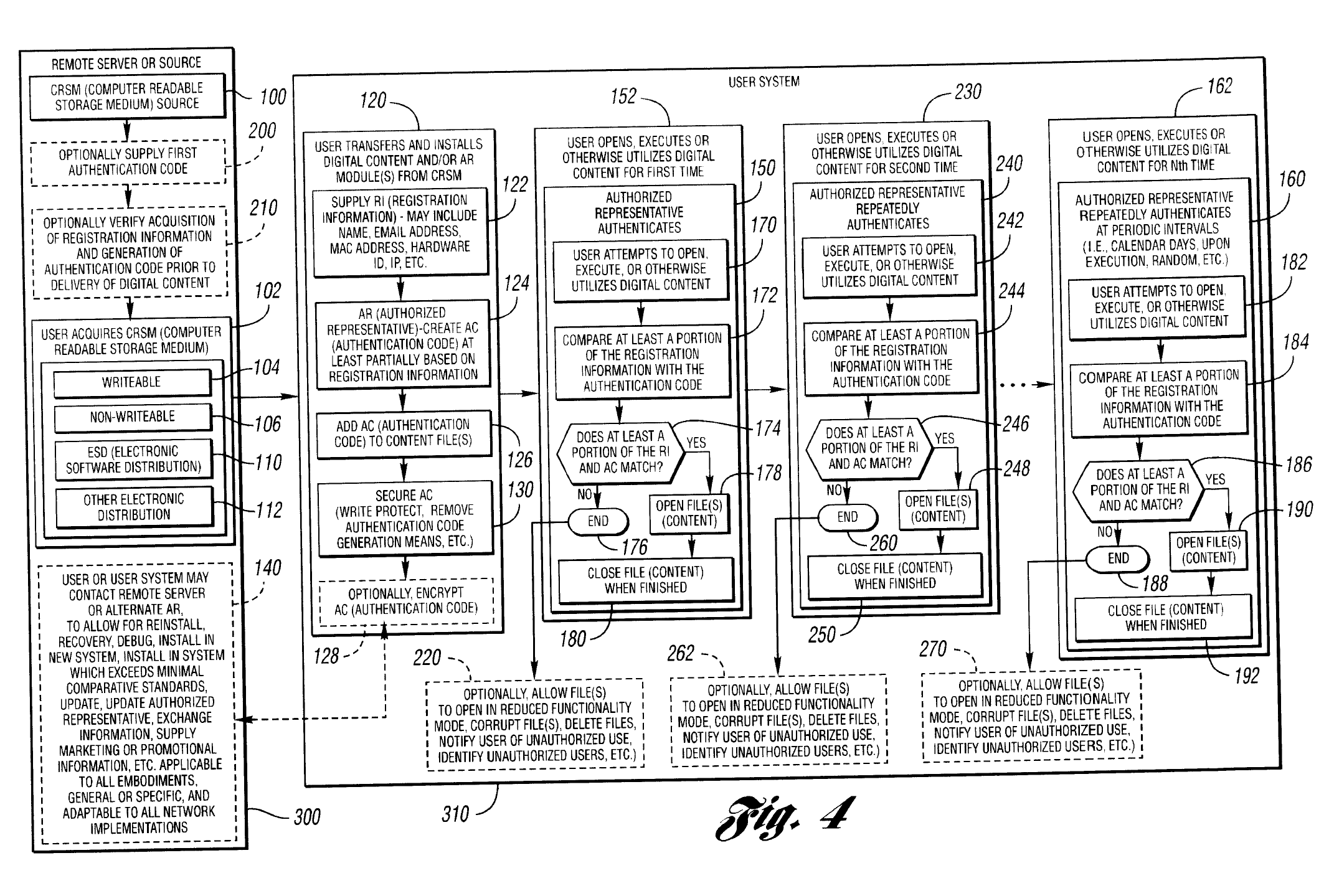

FIG. 4 is a block diagram illustrating one embodiment of the present invention having various authorized administrator functions performed by a remote server or source with other authentication functions performed by one or more user system resident authorized representative modules. Remote server or source 300 contains the software/digital content source 100 on a computer readable storage medium. Those skilled in the art will recognize that a separate remote server may be utilized in this respect. A first authentication code may be optionally supplied by the remote server or source as represented by block 200. Similarly, the remote server or source 300 may optionally verify acquisition of registration information and generate an appropriate authentication code prior to delivery or distribution of the protected content as represented by block 210. For example, when a user connects to a remote server or source 300 to order protected content, the user may manually provide registration information that is subsequently used to generate an authentication code as represented by block 210. Alternatively, remote server or source 300 may automatically collect or acquire hardware specific registration information and/or user registration information, preferably with the consent and/or notification of the user. If registration information is not obtained prior to distribution of the protected content at block 210, the transfer process may be halted until verification occurs, alternatively, it may subsequently be obtained during transfer and/or installation of the protected content as represented by block 122. Alternatively, initial registration information may be collected prior to content distribution as represented by block 210 with additional registration information collected during transfer and/or installation as represented by block 122 as necessary.

Remote server or source 300 then allows the user to acquire the protected content as represented by block 102 via physical media 104, 106 or electronically via electronic software distribution 110 or other electronic distribution 112, for example.

As also illustrated in FIG. 4 and applicable to all embodiments of the present invention, in the event a user acquires a new machine or device, has modified a previously authorized machine or device so that it does not provide a sufficient comparative match to previous registration information, desires to install the content on an additional machine or device, or encounters technical difficulties, the user may manually or electronically contact remote server or source 300 to provide a means for authorizing the requested activity as generally represented by block 140. As described in greater detail below, information may be transmitted or communicated using a public or private local area network, public or private wide area network, by dial-up modem, cable modem, wireless network, or satellite network, for example. Remote server or source 300 may then provide subsequent authorization or authentication to allow for reinstallation, recovery, debugging, installation in a new system, installation in a secondary system such as a laptop, installation in a system in which the minimum comparative standards are not met, and the like.

As also illustrated in FIG. 4, various authorized representative functions may be performed on a user system or device represented generally by block 310. Functions that include gathering of registration information and generation of an appropriate authentication code may be performed as part of the transfer and/or installation of protected content as represented by block 120. Authorization or authentication is then performed by a user system resident authorized administrator represented by block 152 with subsequent authentications represented by blocks 162 and 230.

Use of a single, user resident authorized administrator may be preferable to facilitate protection of varying types of protected content. Such use may be separated as desired into a number of user resident authorized administrators with the single or multiple user resident authorized administrators capable of processing more than one piece or file of protected content. For example, a single user resident authorized administrator may be implemented by an integrated circuit chip installed by the user or OEM in the computer or device, or by software or program code within an operating system or application program installed or transferred to a primary device, such as a computer. Alternatively, multiple administrators may be utilized with one or more authorized administrators installed or otherwise resident on any device used to access the protected content, i.e. any device which includes a processor and memory. The user system resident authorized representative functions represented generally by block 310 are preferably capable of monitoring pre-existing content and/or content that may be transferred to or received by, utilized with, or transferred from the user's system to verify that the activity is authorized. One or more user system resident authorized administrator functions may be supplied by the device manufacturer or installed at a later date. Depending upon the particular application, various user system resident authorized representative functions or compliance functions may be incorporated into the hardware or firmware of a computing device used to access the protected content.

Once present on the user system or network, the authorized representative entity (module or modules) may act to selectively protect any or all digital content received by, transferred from, or otherwise accessed by the system. Such content may be protected on an individual basis, on a group basis, according to the type of file or content, or any other basis desired by the administrator or publisher or as hereinafter described as desired by the user. This protection may extend from the operating system files through applications, music content, video content, gaming, graphics, etc.

As also represented by block 310, after the authorized administrator or representative is transferred to a local user system or network, the authorized administrator may determine additional user registration information as represented by block 124 that may include name, address, email, IP address, MAC address, hardware identification, serial numbers, etc. The additional information is then used to generate an authentication code that is associated with, attached to, interlocked with, injected, or embedded with the protected content as represented by block 126. As previously described, once the authentication code is linked or associated with the protected content, any subsequent access to the protected content requires that at least a portion of the corresponding registration information match the device being used to access the content. As represented by blocks 220, 262, and 270, various compliance measures or actions may be triggered or activated if the registration information does not satisfy the threshold comparison with the embedded authentication code. Access to the protected content may be completely denied. Alternatively, the content may selectively operate at some reduced level of functionality, be allowed to operate for limited time, etc.

Compliance functions, whether implemented by a user system resident authorized representative as represented generally by block 310 and more specifically by blocks 220, 262, and 270, or implemented alone or in combination by a remote authorized representative entity, may also include functions to identify unauthorized users, devices, and/or uses. If protected content is utilized or attempted to be utilized by an unauthorized user or device, the authorized representative or other identification means may collect information on the unauthorized user or device and transfer such information to a local or remote authorized representative as represented by block 300, for example. Alternatively, information may be collected and transferred to an appropriate enforcement entity. Depending upon the particular application, the unauthorized user may be notified, or the information may be collected and sent transparently without alerting the user. Similarly, various combinations or levels of warnings may be provided before collecting and/or sending information relative to the unauthorized use and the unauthorized user and/or device. For example, if protected content is transferred to an unauthorized user or device, the authorized representative may detect the unauthorized use and collect identification information relative to the unauthorized use. Identification information may include user name, organization name, e-mail address, IP address, processor identification, and the like. The information may be subsequently transferred to a remote authorized representative entity or enforcement authority to investigate and/or determine appropriate enforcement actions. Such actions may include storing unauthorized use information, notifying the unauthorized user of the specifics related to the detected unauthorized use, notifying the user of the need and means to obtain a valid license, notifying proper authorities of such illegal use, instituting civil actions, and the like. If protected content is transferred to an unauthorized user or system, the authorized representative may refuse to allow the content to be transferred and concurrently inform the user of its actions. Similarly, the authorized representative may act as a safeguard for other content which has been watermarked or otherwise protected by another party. When watermarking or other third party protection is present, the authorized representative may either refuse to allow the content to be transferred, allow the content to be transferred in a reduced functionality mode, disable printing functions, disable transfer functions, etc. An example of this functionality would occur if a user were to attempt to illegally utilize various computer functionality with currency, artwork, etc. This additional protection and cooperation with other protection schemes is adaptable to all embodiments of the preset invention.

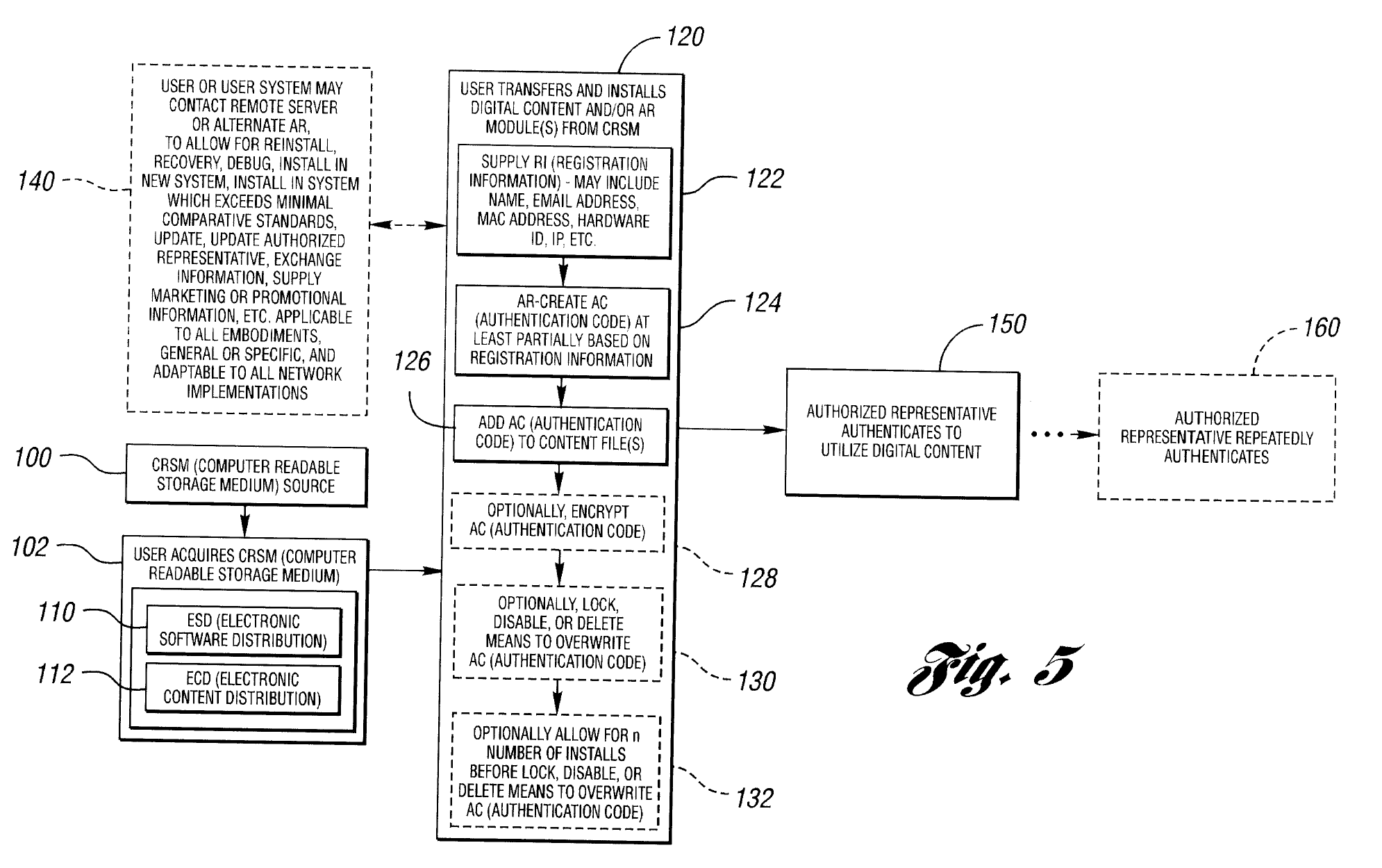

Referring now to FIG. 5, a block diagram illustrating a general authentication process particularly suited for use with electronically distributed software/digital content is shown. Computer readable storage medium source 100 includes one or more types of protected content. A user acquires at least a portion of the protected content from computer readable storage medium source 100 as represented by block 102 using electronic software distribution (ESD) 110 and/or other electronic distribution 112. During the transfer and/or installation of the protected digital content, generally represented by block 120, registration information is acquired by an authorized representative entity as represented by block 122. As previously described, registration information may be collected from the user and/or directly from the user's system or device and preferably includes at least some hardware or device specific information regardless of the manner in which the registration information is collected. For electronically distributed content, registration information preferably includes one or more codes or flags to identify the manner in which the protected content was received. For example, registration information may include some or all of the user's IP address.

After acquiring registration information, the authorized administrator or representative generates a corresponding authentication code at least partially based on the registration information as represented by block 124. In the example above, the authentication code would be at least partially based on the user's IP address. The authentication code is then encoded as a lock code for the digital content file or files as represented by block 126. Generally, the authentication code would be encrypted to prevent user tampering as represented by block 128, although this step is optional. Once locked, the authentication code cannot be changed or altered by the user. To provide additional protection, any locally resident authorized representative functions used to generate an authentication code may be optionally locked, disabled, or deleted as represented by block 130. However, depending upon the particular application, a number of installations or transfers to alternative devices with appropriate generation of authentication codes keyed to those devices (including computer readable storage media) may be allowed before locking, disabling, or otherwise inhibiting operation of the authentication code generation as represented by block 132.

After the authentication code has been associated with the content file or files, the authorized representative authenticates the user using the authentication code before allowing complete access to the protected content as represented by block 150. The authorized representative may repeatedly authenticate the user by comparing current registration information with the registration information encoded in the authentication code on a periodic basis as represented by block 160. Repeated authentication may be based on a number of calendar days, a number of executions or file accesses, or randomly required, for example.

For the example described above to illustrate the embodiment of FIG. 5, any subsequent attempt to transfer the protected content electronically, using a wired or wireless network for example, will also transfer the authentication code having the registration information that includes the IP address of the authorized system or device. If the IP address of the unauthorized device does not match the IP address for the authorized device embedded within the authentication code, the protected content will not be operable, or will be reduced to limited functionality on the unauthorized device. Of course, other identifiers may also be included in the registration information to enhance security. For example, the authentication code may be based on one or more hardware identifiers, processor information, static or dynamic IP addresses, etc. At least a portion of this information must match the originally authorized machine or device for the digital content file to subsequently be operable. Likewise, if the digital content file or files are subsequently transferred to a secondary device, such as a computer readable storage medium, which may include a memory stick, CDR, DVD, or floppy disk, for example, the same or similar authentication process will take place to limit or prohibit the unauthorized use. Because the module or other means to generate an appropriate authentication code has been previously locked, disabled or deleted, the transferred digital content will maintain the originally generated authentication code. Under these conditions, upon transfer or installation from the computer readable storage media or other secondary device on the new (unauthorized) user's machine, the static or dynamic IP address for the source would not be available, and the static or dynamic IP address for the destination would not match the originally authorized IP address. Accordingly, comparison of the registration information which includes the IP address of the originally authorized user's device and/or the source will limit or prohibit the use of the protected content on the unauthorized device. As such, the authentication process has locked the protected digital content file or files to the authorized user's machine or device.

As generally represented in FIG. 5, the authorized representative may exist in any location, or in multiple locations to perform various actions or steps of the authentication process. However, it may be advantageous to specifically locate the authorized representative or administrator at particular locations depending upon the type of computer readable software medium and level of protection desired. Multiple locations may also be included to address the needs of the various scenarios described and illustrated.

Preferably, software transferred directly or indirectly to a writable medium will be administered by a local or user system resident authorized administrator to preclude subsequent illegal transfer or use by unauthorized users or devices. A remotely located authorized representative entity may also be provided to further bolster protection, address other mediums which may be utilized, and to facilitate transitions to new or modified machines or devices as generally represented by block 140. For example, to provide backward compatibility, a remote authorized representative may provide appropriate authentication information or codes for unrecognized devices that do not have the ability to automatically determine hardware specific identifiers.

Use of a user system or network resident authorized administrator increases protection levels and addresses user privacy concerns. These privacy concerns cannot be overstated. Use of a resident authorized administrator generally eliminates the need for any user registration information that may include the user name, address, IP address, e-mail address, hardware identifiers, and the like, to be transferred to any remote authority or entity. All authentications may be controlled internally within the user's machine. The use of a remotely located authorized administrator and exchange of user information may be limited to reloading of software, installation in a new device, modification of a user machine that disables subsequent use of protected content, etc. While some users may raise privacy concerns, administrative and authentication functions may also be processed by a remote authorized administrator either individually or in conjunction with a resident authorized administrator if desired. The best implementation for a particular application may be determined by publisher or distributor functionality and desired protection methods and levels.

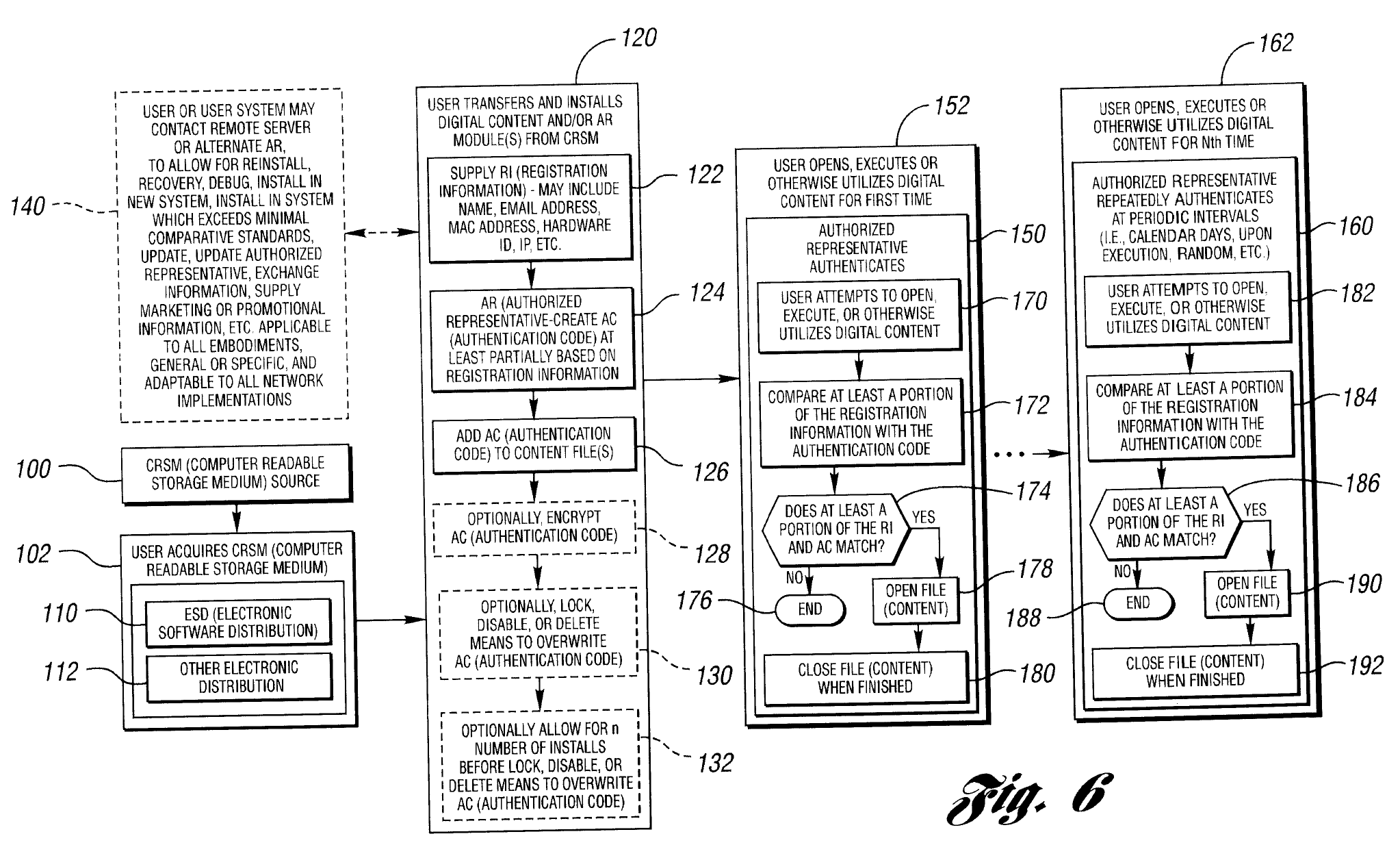

A block diagram providing a more detailed representation of an authentication process particularly suited for use with electronically distributed content is shown in FIG. 6. As generally represented by block 102, a user acquirers protected content from a computer readable storage medium source 100 using electronic software distribution 110 and/or other electronic distribution 112. The protected content may be directly or indirectly transferred by the user and installed on a primary device as represented by block 120. During transfer and/or installation of the protected content prior to any predetermined number of uses, registration information is collected as represented by block 122. The registration information is used by the authorized representative to create an associated authentication code as represented by block 124. While the authorized representative may exist in any number of forms consistent with user needs, user privacy, publisher demands, and level of protection desired, etc., in this embodiment, the authorized administrator preferably performs various functions via a user system resident module or modules. These functions may include gathering registration information as represented by block 122, creation of an authentication code as represented by block 124, linking the authentication code to protected content files as represented by block 126, and various other functions or actions represented by block's 128-132, 152, and 162.

The resident authorized representative module or modules may optionally encrypt the authentication code as represented by block 128, in addition to one or more of the protected content files or portions thereof. After generation of an appropriate authentication code and association of the authentication code with the protected content, the means to generate additional authentication codes or otherwise alter the authentication code may optionally be locked, disabled, or deleted as represented by block 130. Depending upon the particular application, a predetermined number of transfers or installations may be allowed before locking, disabling, or deleting the means to overwrite the authentication code as represented by block 132. Alternatively, depending upon the particular application, a predetermined number of devices may be authorized with corresponding authentication codes associated with the protected content during the initial transfer/installation. This implementation would allow transfer and use of the protected content on these pre-authorized devices while removing the authentication code generator to prevent user tampering or hacking.

Use of a resident authorized administrator or representative increases protection levels and addresses user privacy concerns by limiting the transfer of information to modules resident on the user's machine or within a trusted user network. As such, use of a resident authorized administrator module or modules generally eliminates the need for any user registration information to be transferred to any remote authority or entity. However, various registration information may be transferred to a remotely located authorized representative entity in the event of suspected unauthorized use.

In combination with, or in place of the user resident authorized representative, a remote authorized representative may provide various troubleshooting functions and manual and/or automatic authentication for authorized users as generally represented by block 140. Once contacted, the remote authorized representative entity may search for previous registration of the software using registration information automatically obtained from the user system or device and/or manually obtained from the user. If it is determined that the software has not been previously registered, the remote authorized representative may transmit the necessary information to make the protected content operational on the user device or network. This information may include one or more authorization or authentication codes and/or program modules with instructions to generate corresponding authentication codes based on manually or automatically obtained user/device registration information. If the remote authorized representative entity determines that the protected content has been previously registered and the previous registration information does not match the current registration information provided by the user and/or the user system or network, the authorized representative may notify the user of the previous registration of the same protected content and thereafter take appropriate action. Such action may include denying the necessary operational password or authentication code, providing a code to enable limited access, providing a code to enable access for a limited period of time, or altering the protected content to disable future unauthorized use, for example.

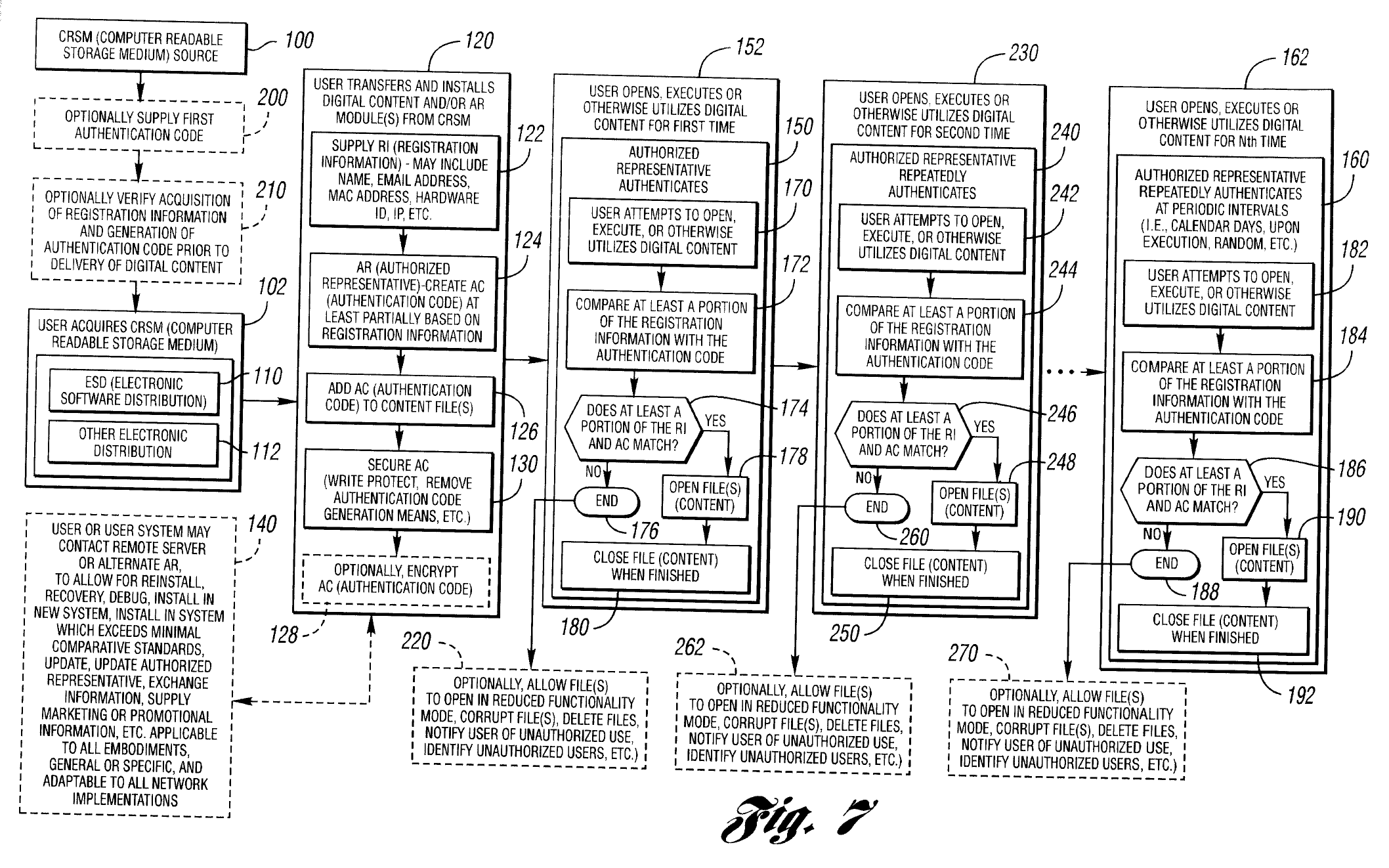

Referring now to FIG. 7, a block diagram illustrating an authentication process for electronically distributed content according to one embodiment of the present invention is shown. The software manufacturer or developer (source) 100 produces software that requires initial and/or periodic password/authentication code updates to become or to remain operational. The protected software may be associated with individual end-users, with a particular regional or geographic group or other group of users, or users associated with a particular organization or site, for example, using one or more corresponding authentication codes. Providing authorization or authentication codes for groups rather than for each individual significantly reduces the number of passwords required and any corresponding administrative overhead that may be required, including electronic storage and transmission requirements, for example. Depending upon the particular implementation, one or more authentication codes may be electronically stored on computer readable storage medium source 100 for future transmission to the user. Authentication code information may include the actual authentication code or codes but preferably includes information used to generate subsequent authentication codes based on the individual copy or group of copies of the protected content and the associated registration information. For example, password information may be contained within an authorized representative module that is subsequently transferred to the user device for use in generating one or more authentication codes based on corresponding registration information. In addition, the authorized representative module may be used to authenticate the user and/or device to allow access to the protected content.

As represented by block 200, a first authentication code may optionally be supplied with the computer readable storage medium source 100. As described above, the first authentication code may be an actual code used to enable transfer, installation, or use of the protected content, or may be embedded within an authorized representative module in the form of code or instructions used to generate an authentication code based on the user registration information. Registration information acquired during the ordering/downloading process, or other acquisition means may be used to generate one or more authentication codes prior to delivery of the protected digital content as represented by block 210.

The user acquires the software using a wireless, wired, or satellite network, which may include a public and/or private local or wide area network such as the Internet, for example, as represented by block 102. The software may include one or more authorized representative modules and means for generating an authentication code as described above. Once the software including the protected content and any associated authorized representative modules is acquired by the user at step 102, the user partially or fully installs the software in his computing device or local network as represented by block 120. During or following installation of the software, the user may be prompted to provide additional registration information as represented by block 122. This additional registration information may be used to generate the first or subsequent authentication codes or operational password(s) which may be an alphanumeric string which is encoded or encrypted, or a binary (machine readable) code, for example, which are then added to or associated with the protected content as represented by blocks 124 and 126.

For applications using a remotely located authorized representative entity, the user may be prompted to select automatic or manual registration during the process of transferring and/or installing the protected digital content from a computer readable storage medium as represented by block 120. Alternatively, the authorized representative may require manual registration to verify the accuracy of at least some of the registration information that may be used to authorize subsequent access to the protected content. If the user provides inaccurate information, passwords or authentication codes may not be supplied to enable access to the protected content. For applications requiring repeated authentication or contact with a remotely located authorized representative entity, the user may subsequently elect to modify the communication mode from manual to automatic or vice versa. If automatic registration is selected, the software automatically contacts the authorized representative via a wireless, satellite, modem, network, or other connection to obtain any additional operational passwords, download product updates or upgrades, exchange registration information, download one or more authorized representative modules, and the like. For user resident authorized representative implementations, the automatic communication may occur within the user's system, device, or network. Where manual registration is selected (or required), the user may contact the authorized representative source via telephone, mail, e-mail, Internet, or the like to obtain any necessary authentication code or authorized representative modules to enable access to the protected content. Submission of registration information and authentication code entry may be accomplished manually in any embodiments of the present invention.

After transfer and installation of the protected digital content as represented by block 120, the authorized representative entity attempts to authenticate the user when the user opens, executes, or otherwise attempts to utilize the digital content for the first time as represented by block 152. If the user is authenticated by the local and/or remote authorized representative, access is provided to the protected content for a single use or other authorization interval. Otherwise, various compliance actions may be initiated. If at any time it is determined that the protected content file or files are being transferred to an unauthorized system or reside on an unauthorized system, the authorized representative entity whether remote, resident on the user's system or network, or attached to the content file or files either independently or collectively, may take further action to reduce unauthorized use as represented generally by blocks 220, 262, and 270. These compliance actions may include notifying the user of the unauthorized use or action, notifying a remote authorized representative entity of the unauthorized use, storage and/or transfer of registration information associated with the unauthorized use and/or system, generation of a disable code to prevent future access to the protected content, etc. Use of a disable code or any similar means may permanently disable the protected content (partially or fully), allow the file or files to operate in a reduced functionality mode, corrupt the file or files, disable the file or files, delete the file or files, etc. Generation of the disable code or similar means may originate at a remote authorized representative or any type of resident authorized representative module or modules. Use of a disable code may be temporary or permanent predicated upon the desire or determination of the publisher or source of the protected content.

At the discretion of the authorized representative or authorized representative module, the authorized representative entity may selectively allow the user or user system to rectify the attempted unauthorized use as represented generally by block 140. The user or user system/device may be required to supply additional registration information to verify that the use is authorized within the associated licensing terms of the protected content. Once the unauthorized use condition has been rectified, overcome, or otherwise removed, the protected content file may be selectively authorized and restored to a fully operable condition. Examples of conditions which may be detected as unauthorized use may include changes to the authorized user hardware or registration information, installation in a new system, etc.

Once the use of, or access to the protected content has been authenticated, the authentication code may provide subsequent access to the protected content for a particular authorization interval that may include an operation period or time period. For example, once authenticated, protected digital content may be authorized for use for a predetermined number of minutes, hours, days, etc. (time period) or may be authorized for use for five accesses/executions (operation/use period). Alternatively, access to the protected content may be limited to a single use. Once the authorization interval expires, the user or device must again be authenticated as generally represented by blocks 162 and 230. The authentication process for subsequent access to the protected content proceeds in a similar fashion with the user's system or device contacting an authorized representative that determines whether the use is authorized based on a comparison of any previously received registration information as encoded in the authentication code and the current registration information associated with the user's system or device attempting to access the protected content, for example. The authentication process may take place transparently to the user, may notify the user, and/or may require some user input depending upon the particular application and implementation.

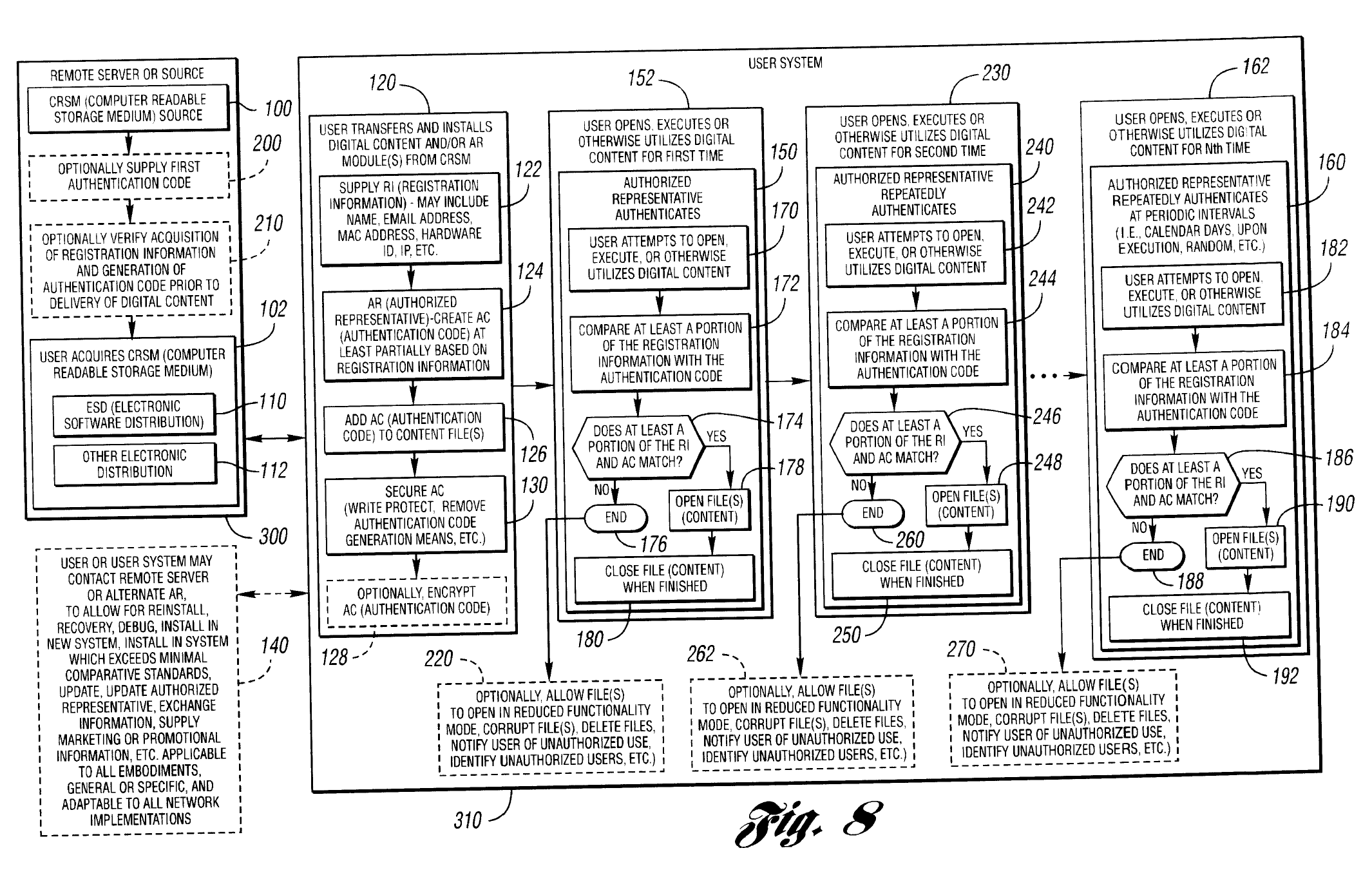

Referring now to FIG. 8, a block diagram illustrating an authentication process particularly suited for use with electronically distributed protected content according to one embodiment of the present invention is shown. As illustrated, the embodiment of FIG. 8 uses a remote server or source 300 to supply the computer readable storage medium source 100 in addition to optionally supplying a first authentication code 200 and optionally verifying acquisition of registration information and generation of one or more authentication codes prior to delivery of digital content as represented by block 210. As such, remote server or source 300 may optionally act as an authorized representative entity in performing one or more compliance functions, such as supplying the first authentication code and/or obtaining registration information to generate an authentication code as represented by blocks 200 and 210. Remote server or source 300 may be accessed by the user via a local area network (LAN), via a wide area network (WAN), and/or via a wireless or satellite network, for example.

The user acquires the protected content as represented by block 102 via electronic software distribution or other electronic distribution as represented by blocks 110 and 112, respectively. The protected content acquired by the user may also include one or more authorized representative modules, or instructions to subsequently obtain one or more authorized representative modules, to implement a self-activating user-resident authorized representative entity to perform various authentication functions without requiring transfer of registration information outside of the user's system or trusted network such that the system is also self-authenticating. The protected content along with one or more authorized representative modules is then transferred and installed on or in a primary user device as represented by block 120. Depending on the particular application and implementation, the initial transfer of protected content to a user device may simply transfer an identifier, password, code, or instructions to subsequently obtain an authorized representative from a computer readable storage medium or over a local or wide area network. The instructions or other device may be triggered upon first use of the protected content, for example.

The user resident authorized representative or administrator module or modules, whether installed along with protected content or previously present on the user's system or device, may collect additional registration information to create one or more corresponding authentication codes as represented by blocks 122 and 124, respectively. The authentication code or codes are locked or associated to the protected content and may optionally be encrypted as represented by blocks 126 and 128. After generating one or more authentication codes corresponding to authorized user devices, the corresponding generation means may be removed or otherwise disabled as represented by block 130.

A user resident authorized representative, whether implemented by software, hardware, or a combination thereof may be used to monitor protected content residing on, received by, transferred from, or utilized with the user's system. When a user attempts to open, execute, transfer, or otherwise utilize protected digital content for the first time as represented by block 152, the local authorized representative attempts to authenticate the user as represented by block 150. As described above, authentication may use an embedded or otherwise associated authentication code for the protected content to determine if at least a portion of the registration information is consistent with the originally authorized user or device as represented by blocks 170, 172, and 174. If the attempted use or transfer is authorized, access to the protected content may be provided for a corresponding authorization interval, preferably a single use, as represented by blocks 178 and 180. The attempted unauthorized use may trigger various compliance actions as generally represented by block 220. Subsequent authentications may be required upon expiration of the current authorization interval and performed as generally represented by blocks 162 and 230.

Various embodiments of the present invention, including the embodiment illustrated in FIG. 8, should be effective to reduce or eliminate unauthorized use of various media including music, movies, pictures, and graphics delivered as digital content, for example. These embodiments should reduce or eliminate various types of unauthorized use ranging from direct piracy to central (server based), distributed (peer-to-peer, also referred to as person-to-person or p2p), or combination file sharing programs and networks as in the Napster, Blubster, Grokster, Kazaa, Gnutella, and Morpheus models, among many others that continue to be developed. The user system resident authorized administrator, whether integrated within the protected content access device or subsequently installed as an application, operating system, or other resident module or device, monitors protected content stored, accessed, or transferred to/from the device to ascertain if protection is required. For example, files of a particular type or extension such as WAV files, MP3 files, application files, JPEG files, MPEG files, or any other authorized representative designated file types may be specified as requiring authentication. Of course, this does not preclude protecting all content within the system or device. If the protected content developer or publisher deems protection appropriate, the content may be created as a particular type of file or otherwise include flags or indicators to activate content protection. For example, a publisher creates MP3 files for a certain selection of music. As the content enters the user's system, the resident authorized administrator module, chip, or device creates and links an authentication code to the content. Subsequently, when the content is opened or otherwise accessed it will only be operable if the authorized administrator determines that a comparison of the authentication code at least partially matches registration information of the originally authorized user system. If the code is missing, tampered with, or otherwise altered, the content will remain inoperable. If the content, including the authentication code, is transferred to an unauthorized system or device, a comparison of the authentication code will not produce a sufficient match with hardware-specific registration information associated with the unauthorized user system and the content will remain inoperable.

In this way, a music publisher may upload hundreds or thousands of individual files to an authorized user without concern of illegal file sharing. If a user attempts to subsequently transfer these files to any unauthorized user or network, the files will be rendered useless or inaccessible to the recipient. Of course, the file types mentioned above are used by example only. Similar protection may be afforded to all types of digital content including application programs, operating systems, video, gaming, etc., and all modes of distribution such as CDs, DVDs, electronic distribution, and the like.

Publisher protection may also extend to the actual system user. When a user creates digital content, he may be considered the publisher and may also desire the protections available utilizing the authorized representative. For example, the user may specify that a particular piece of content be linked, associated, or otherwise locked to his or her system, network, or device and may instruct the authorized representative to attach an authentication code corresponding thereto. As such, the content may only be used on the user's system.

For conventional file security, only a simple password is used. This form of protection is easily circumvented or cracked. In contrast, use of the authorized administrator to lock the content to the user machine, network, or device according to the present invention will greatly enhance security. Individual users may specify individual pieces or files of content for protection such as JPEG's, MPEG's, text documents, etc. or may specify that all content created on the user system, network, or device be protected. Alternatively, the user may specify protection for various types or groups of content such as e-mail, graphics, music, etc. Of course, this protection may be in addition to conventional forms of content security.

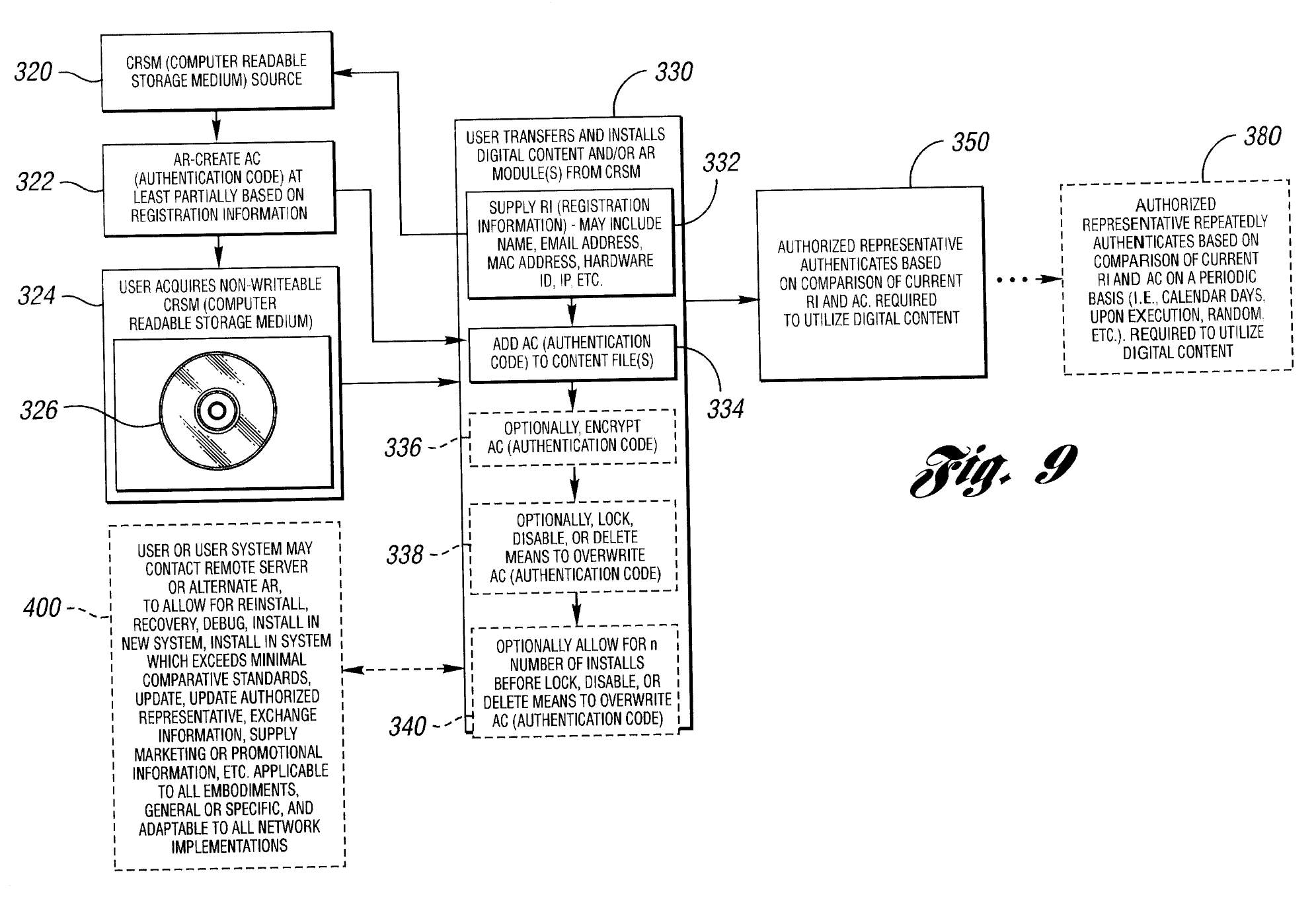

FIG. 9 is a block diagram illustrating a representative embodiment for an authentication process particularly suited for non-writable computer readable storage media according to the present invention. Content designated by the developer or publisher is placed on a computer readable storage medium source 320. An authorized representative creates an authentication code at least partially based on registration information required from a user, user network, and/or user device as represented by block 322. It is preferable that any protected digital content supplied in a non-writable format be administered by a remote authorized administrator/representative to preclude illegal transfer or use by unauthorized users or devices. While a resident authorized administrator may be included within the user system to further bolster protection and address other media that may be utilized, the absence of a remote authorized administrator authenticating and creating the authentication code or codes for non-writable media would allow the the media with the software to be usable in any machine such that it may be illegally transferred or otherwise copied.

Various authorized representative functions may be performed during the initial ordering or transferring of the protected content to a non-writable computer readable storage medium to generate an appropriate authentication code for subsequent installation of the protected content on one or more authorized devices. The user then acquires the non-writable computer readable storage medium as represented by block 324. The computer readable storage media may be a CDR or DVD as generally represented by reference numeral 326, for example. The user then transfers and/or installs the protected digital content from non-writable computer readable storage media 326 to a user system or device as represented by block 330. The transfer or installation process may require the user to supply registration information as represented by block 332. As described above, the registration information may be supplied during the initial ordering or other acquisition of the non-writable computer readable storage medium such that the authorized representative may create an authorization code associated with the protected content and storage on the non-writable media 326 prior to acquisition or installation by the user. Alternatively, or in combination, registration information obtained as represented by block 332 may also be associated with the protected digital content transferred to the user device or network to protect the content from subsequent unauthorized transfer or use. In this case, the generated authentication code would be added to the content file or files as represented by block 334. The authentication code may be optionally encrypted as represented by block 336 with the means to generate or overwrite the authentication code optionally locked, disabled, or deleted as represented by block 338. Alternatively, a predetermined number of installations or transfers may be allowed before disabling or otherwise inhibiting the means to generate and/or overwrite authentication codes is as represented by block 340.

When the user attempts to access, transfer, or otherwise use the protected digital content, the user request may be intercepted to provide authentication by the authorized representative as represented by block 350. The authorized representative may use any procedure, process, or device to determine whether the attempted transfer or use is authorized within the licensing terms of the protected content. If the attempted use is within the terms of the associated protected content license, the authorized representative may allow access to the content for a single use, or other authorization interval depending upon the particular application. As represented by block 380, the authorized representative may repeatedly authenticate the user based on comparison of current registration information and the authentication code or codes associated with the protected content on a periodic basis. The periodic basis may be based on calendar days, number of uses, a random, etc. Similarly, the repeated authentication represented by block 380 may take place at the expiration of an authorization interval, or based on a schedule determined by the authorized representative.

Similar to previously described authentication processes, the representative authentication process for use with non-writable computer readable storage media may allow the user or user system to contact a remote authorized representative to provide various functions as represented by block 400. These functions may include reinstallation of protected content on a previously authorized device or network, recovery of authentication information to enable access to protected content, and various other recovery, troubleshooting, or debugging functions. In addition, the authorized representative may exchange various types of information with the user and/or user's device that may include repeated authorization and authentication, network metering and monitoring, dynamic authorized representative process changes, quality assurance functions, error and usage information, marketing information, product updates, upgrades, and the like.

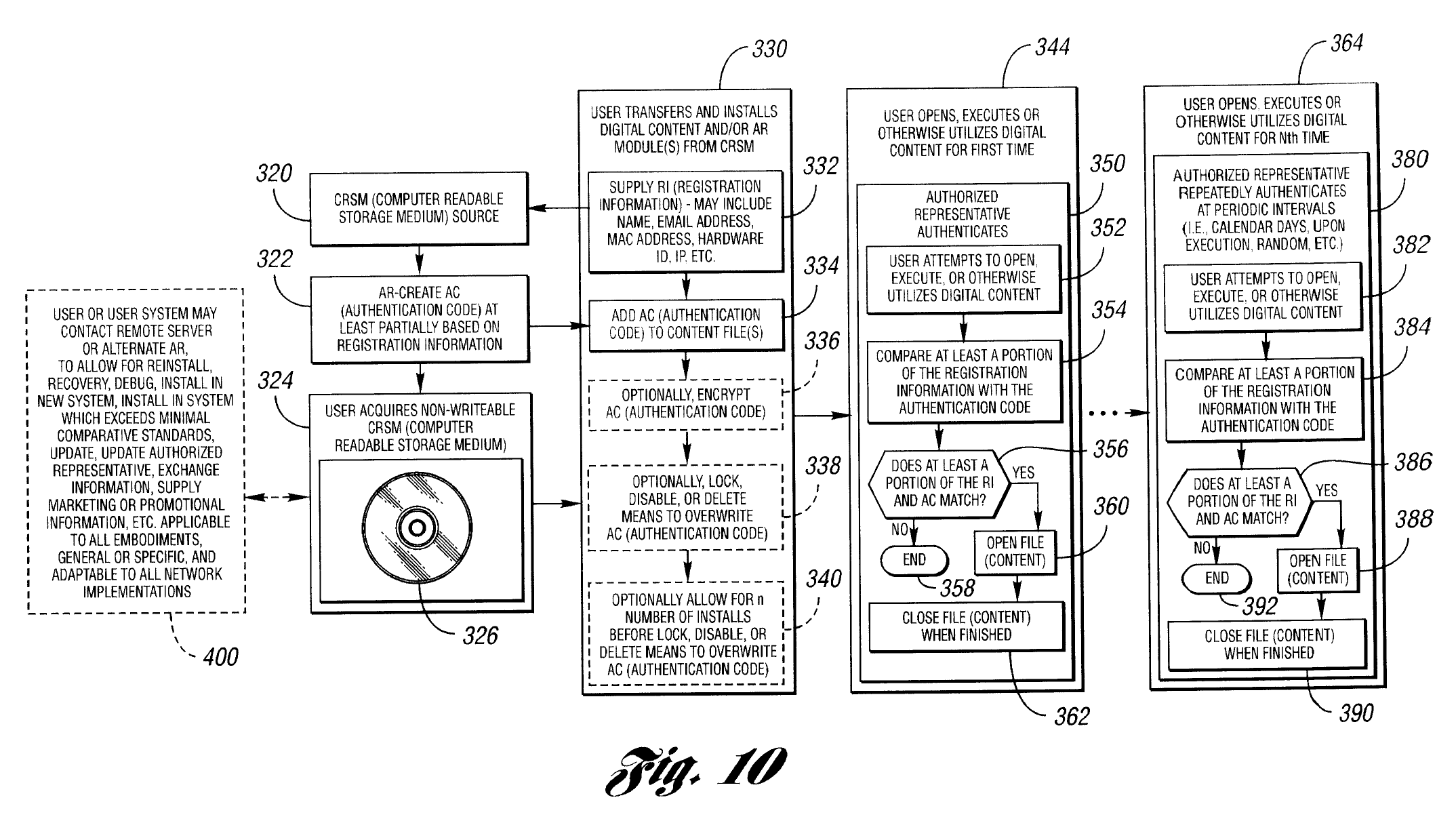

FIG. 10 provides a more detailed representation of an authentication process particularly suited for use with non-writable computer readable storage media according to one embodiment of the present invention. The computer readable storage medium source 320 includes protected digital content for transfer to a user, the any non-writable computer readable storage medium generally represented by reference numeral 326. Depending upon the particular implementation, the protected content developer, publisher, or source may require registration information associated with the user and/or authorized user devices prior to distribution of the protected content. Where registration information is available, the authorized representative may create one or more authentication codes at least partially based on the registration information as represented by block 322. The authentication code or codes are then lots, linked, embedded, or otherwise associated with the protected content and stored on non-writable computer readable storage medium 326 prior to acquisition by the user as represented by block 324.

The user transfers the protected content, preferably including one or more associated authentication codes based on previously supplied user registration information, to an authorized user system or device as represented by block 330. Various user actions or times may trigger authentication as generally represented by block 344. For example, the user may attempt to open, execute, or otherwise utilize the digital content for the first time after installation on the authorized device. The authorized representative, preferably remotely located, attempts to authenticate the user as represented by block 350. This may be performed by intercepting the user attempts to access for utilize the digital content as represented by block 352 and using the embedded or otherwise associated authentication code to determine whether the attempted action is authorized and to provide access for authorized actions as generally represented by blocks 354-362. As described above, authentication may be performed using the embedded authentication code by comparing hardware-specific registration information of the current user device with the authentication code associated with the protected content. Various forms of authentication may be used to determine whether the attempted use, access, or transfer is authorized and may have the same effect as comparing registration information with the authentication code without an actual comparison of information, per se. For example, the current registration information may be used to generate a current authentication code that may act as a decryption key, for example, to provide access to protected content previously encrypted using a key associated with the originally authorized user or device.

Repeated authentication may be desired or required and triggered by subsequent user action as represented generally by block 364. Alternatively, repeated authentication may be triggered by expiration of an authorization interval based on calendar days, time of use, number of executions or transfers, random, etc.

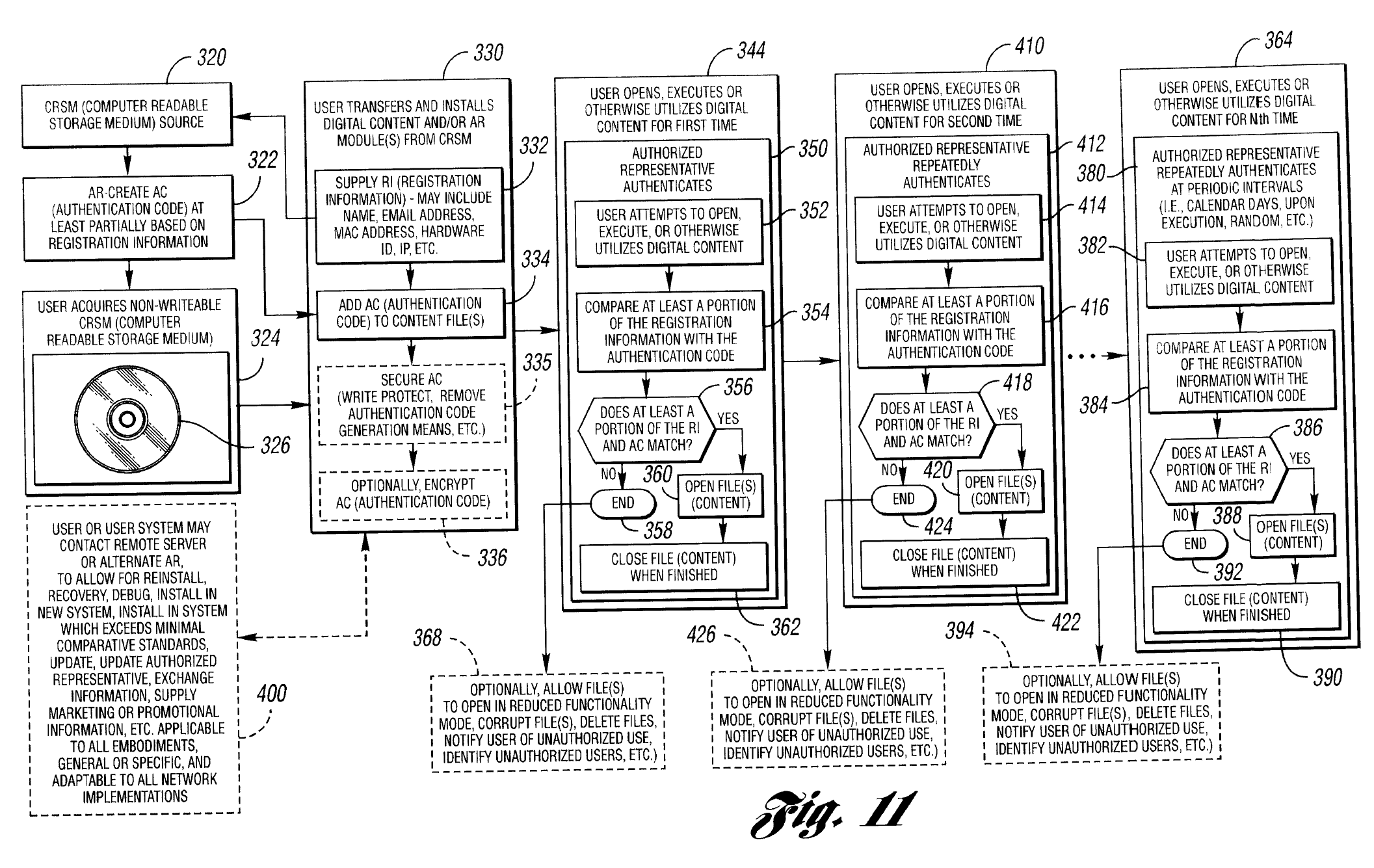

A block diagram illustrating an alternative embodiment for an authentication process particularly suited for use with non-writable computer readable storage media according to the present invention is shown in FIG. 11. A source of digital content desired to be protected from unauthorized use is generally represented by block 320. The source may perform various authorized representative functions including creation of an authentication code at least partially based on registration information as represented by block 322. It should be noted that the registration information may be associated with a particular user or user's device and/or may be used to authorize protected content for use on various types of devices or systems. For example, the digital content may be protected by generating an authentication code or codes for use with devices manufactured by a specific manufacturer, or a specific model of device, or a specific type of device. To further illustrate, a digital content distributor may generate authentication codes that allow the digital content to be used on devices manufactured by company XYZ. The user would be required to specify the manufacturer of his authorized device when ordering or acquiring the protected content. The authentication code would prevent the protected content from being used on, or otherwise utilized by any devices other than those manufactured by company XYZ.

As another example, registration information specific to a particular type of device may be encoded into a corresponding authentication code as represented by block 322. In this example, a content distributor or source may include registration information specific to digital audio players. The corresponding authentication codes would prevent the protected content from being used by any other device, such as a computer or CD player, for example. Again, the user would be required to designate the type of authorized device for which the protected content was being acquired during ordering or other acquisition of the content.

Once the user acquires the protected content on a non-writable computer readable storage medium as represented by block 324, the user transfers the protected digital content to a user system, device, or network as represented by block 330. Additional registration information may be required as generally indicated by block 332 and may be obtained manually or automatically. Registration information preferably includes at least some hardware specific information. Additional authentication codes may be added to protect the digital content file or files transferred from the non-writable computer readable storage medium 326 to the user system, device, or network as represented by block 334. The module or any other device or chip used to generate the authentication code may be subsequently secured as represented by block 335 and the authentication code may be optionally encrypted as represented by block 336.

When the user attempts to open, execute or otherwise use the digital content for the first time as represented by block 344, the authorized representative, preferably remotely located, attempts to authenticate the user as represented by block 350. The user attempts to access the protected content may be intercepted as represented by block 352 to determine whether the attempted use is authorized is generally represented by blocks 354 and 356 with access provided for authorized uses as represented by blocks 360 and 362. If the authorized administrator detects a potential unauthorized use as represented by block 358, various actions may be performed by the authorized representative as represented by block 368. The authorized representative may optionally allow the protected content to be opened with reduced functionality, or may provide full functionality for a predetermined period of time to allow the user to correct the conditions leading to the detection of an unauthorized use as generally represented by block 400. Alternatively, or in combination, the authorized representative may disable, delete, or otherwise inhibit or prevent access to the protected content as indicated by block 368. In addition, the user may be notified of the detected unauthorized use while various information is collected, with or without user knowledge or consent, and stored or transferred to an appropriate entity for tracking and/or enforcement.

A subsequent attempt to open, execute, or otherwise utilize protected digital content may trigger another authentication as generally represented by block 410. As such, the authorized representative may repeatedly authenticate the user as represented by block 412 by intercepting any user attempts to open, execute, transfer, or otherwise utilize the digital content as represented by block 414. Depending upon the particular application, the authorized administrator functions performed for second and subsequent attempts to utilize the protected content may be performed by a resident authorized administrator. The authentication may include an actual or functional comparison of registration information associated with the user or device attempting to access the digital content with the previously generated authentication code as represented by block 416. If at least a portion of the registration information matches the embedded authentication code as represented by block 418, access may be provided to the protected content as indicated by block 420 for a single use as represented by block 422, or for some other authorization interval. If the authorized representative cannot authenticate the user as represented by block 424, various other actions may be performed as represented by block 426.

A similar process may be performed upon subsequent attempts to utilize protected digital content as represented generally by block 364. The authorized representative may repeatedly authenticate the user at periodic intervals and/or upon expiration of an authorization interval as represented by block 380. As such, subsequent attempts by the user to access the protected digital content are intercepted as represented by block 382. Hardware specific registration information may be used to determine whether the user or device is authorized as represented by block 384. Access is provided for authorized users/devices as represented by blocks 386, 388, and 390. Unauthorized access is hindered or prevented as represented by blocks 392 and 394.

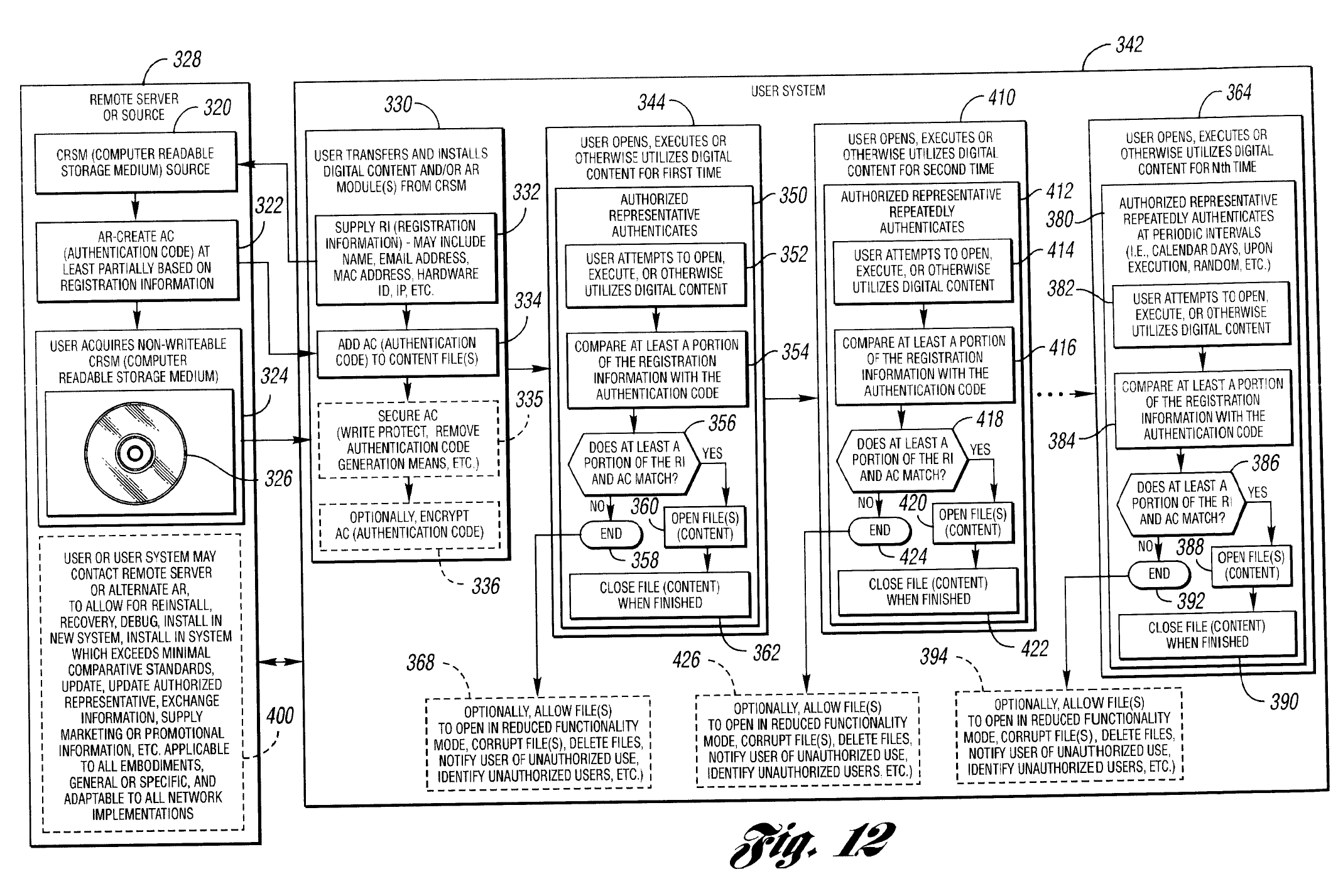

Referring now to FIG. 12, a block diagram illustrating one embodiment of an authentication process particularly suited for use with a non-writable computer readable storage medium is shown. As generally indicated in FIG. 12, various authorized representative functions may be performed by a remote server or source 328 with other authorized representative functions performed by a user system, network, or device as represented by block 342. Remote server or source 328 may provide computer readable storage media 320 having digital content designated for subsequent protection using an authentication process according to the present invention. The authorized representative may create one or more authentication codes based on generic or specific registration information as represented by block 322 and attach the authentication code or codes to the protected digital content. The user acquires the protected digital content on a non-writable computer readable storage medium 326 as generally represented by block 324. As such, remote server or source 328 may gather registration information from the user or a user device during ordering and generate an appropriate authentication code. Alternatively, or in combination, one or more authentication codes may be based on generic registration information corresponding to device manufacturers, types, models, etc.

User system, network, or device 342 may subsequently be used to perform various additional authentication processes with a resident authorized representative module or device. In general, the user transfers or otherwise accesses the protected content using system 342 as generally represented by block 330. Various user actions may trigger a first authentication as represented by block 344, a second authentication as represented by block 410, and/or subsequent authentications that may be based on an authorization interval, rental period, trial use, try-before-you-buy, or other periodic interval as represented by block 364. Each of the authentication processes generally proceeds in a manner as previously described. If the authentication process detects what is perceived to be an unauthorized access or use, various compliance functions may be performed as generally represented by blocks 368, 426, and 394.

As one can see from the embodiment of FIG. 12, it is preferable that software supplied for a non-writable computer readable storage medium to have at least some authorized administrator functions performed by a remote authorized representative entity, generally represented by remote server or source 328. The use of a remote authorized representative entity may preclude illegal transfer or other unauthorized use by unauthorized users and/or devices. Without any authentication functions performed by a remote authorized representative, such as creating an authentication code based on generic or specific registration information, the software would be usable by any machine or device having access to the non-writable computer readable storage medium and may be illegally transferred or copied from the non-writable computer readable storage medium 326. However, even applications developed primarily for use with non-writable computer readable storage media preferably employ a resident authorized representative within the user system or network to provide additional protection against unauthorized use and subsequent transfer to other media or devices.

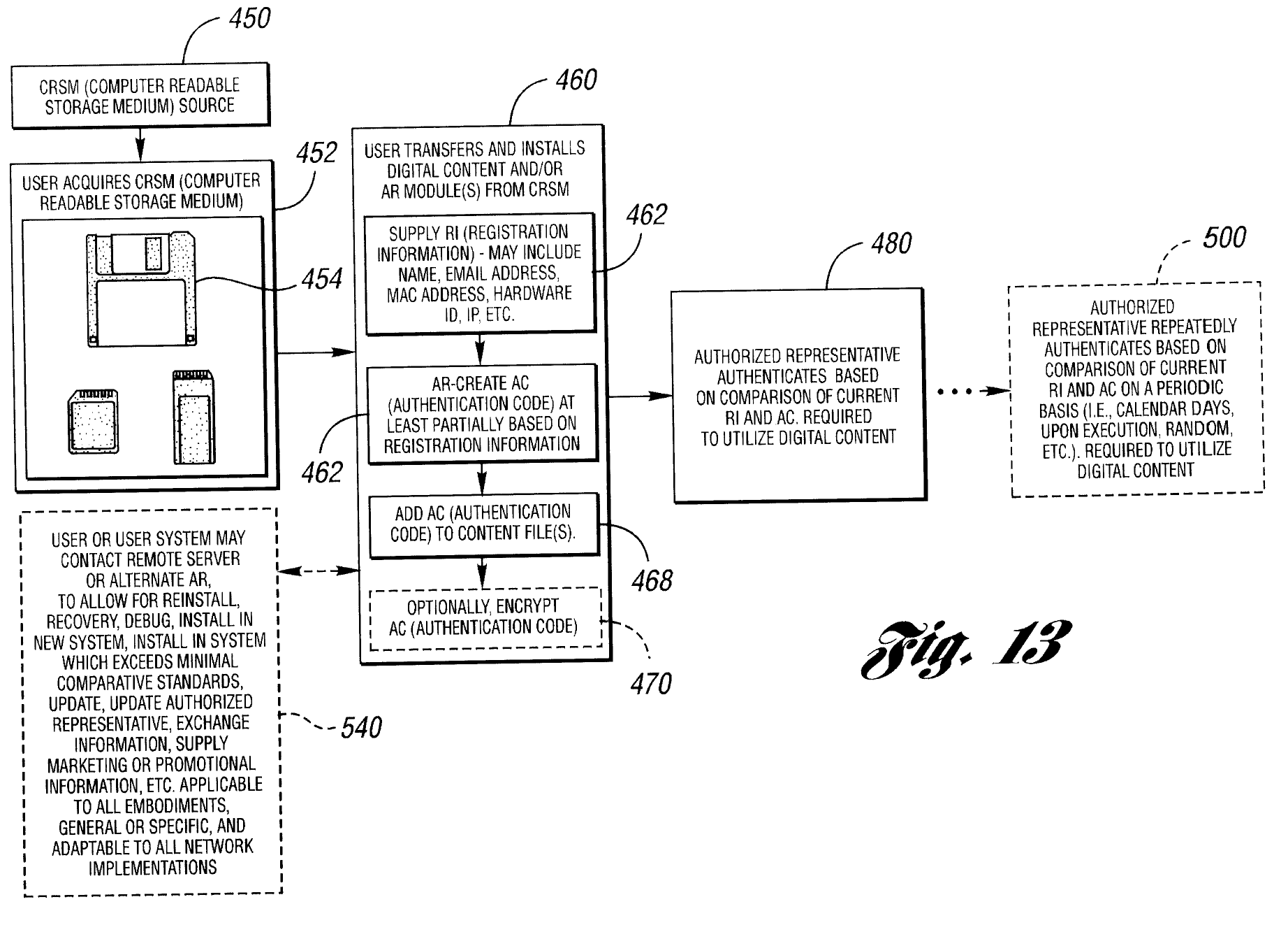

A block diagram illustrating one embodiment of an authentication process particularly suited for use with writable computer readable storage media and secondary devices according to the present invention is shown in FIG. 13. A computer readable storage medium source 450 distributes digital content designated for protection on a writable computer readable storage medium 454 as represented by block 452. Upon the first use or access of the protected software stored on the writable computer readable storage medium as represented by block 460, registration information is collected or acquired from the user and preferably includes hardware specific information as represented by block 462. An authorized representative entity then creates or generates an authentication code at least partially based on registration information collected from the user, user's system, or user's device as represented by block 464. The authentication code is then added to the protected content file or files as represented by block 468 and may optionally be encrypted as represented by block 470. For applications that require the software to be transferred and installed on the users system or device, the authentication code would typically be stored along with the protected content on the user's system or device. As an added feature, the authentication code may also be transferred to the writable computer readable storage medium 454 to prevent it from subsequent transfer to and/or use on unauthorized systems or devices. Similarly, those of ordinary skill in the art will recognize that in embodiments having content designated for protection that is distributed via writable computer readable storage media, the user may not necessarily be required to transfer and/or install the digital content on the user's system or device to access or otherwise utilize the content. As such, the present invention preferably modifies the content on the writable computer readable storage medium using one or more authentication codes corresponding to the user's system or device upon first access or utilization of the content to prevent the content from being transferred to multiple unauthorized systems or devices.

As also shown in FIG. 13, a user system resident authorized representative and/or remotely located authorized representative attempts to authenticate the user based on current registration information and one or more authentication codes prior to allowing access to the protected content as represented by block 480. The authentication process may optionally include repeated authentication by a local and/or remote authorized representative as generally represented by block 500. Repeated authentication may be based on an authorization interval, a rental period, or some other interval or period determined by the authorized representative.

Similar to previously described embodiments, the embodiment of FIG. 13 may optionally provide the user or user system a means to contact a remote server or other remote authorized representative to provide for authorization or authentication of content that is otherwise prevented by the local or remote authorized representative entity. For example, embodiments using one or more authorized representative modules (whether local or remote) may provide customer service representatives or other backup functionality generally represented by block 540 to allow for reinstallation, recovery, installation in a new system, or various other functions as appropriate.

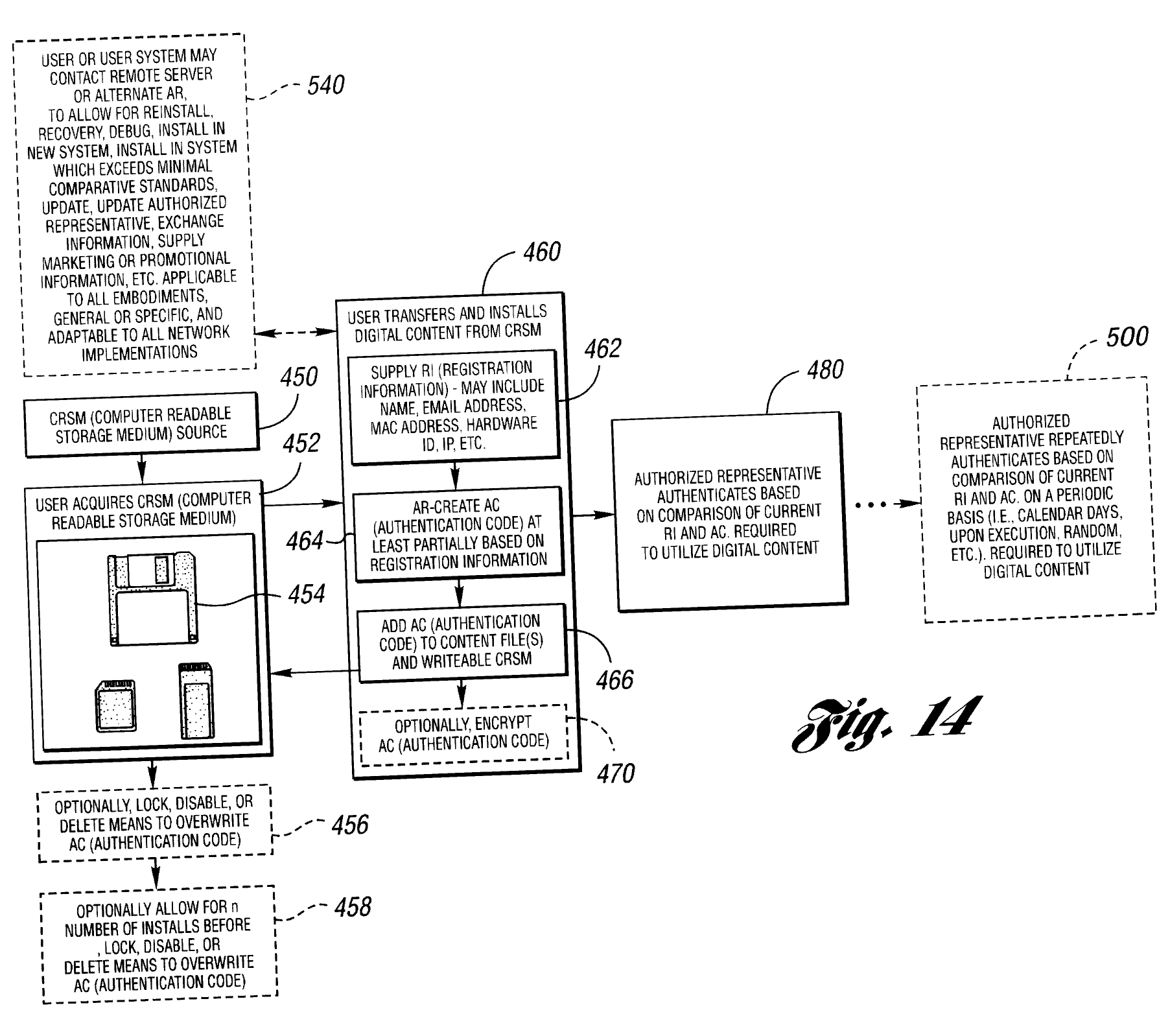

A block diagram illustrating an alternative embodiment for an authentication process particularly suited for writable computer readable storage media according to the present invention is shown in FIG. 14. Computer readable storage medium source 450 provides content designated for protection to a user on a writable storage medium 454 as represented by block 452. Any attempts to utilize the content, which may include transferring and/or installing the content as represented by block 460, requires manually or automatically obtained registration information as represented by block 462. An authorized representative entity creates a corresponding authorization code based at least partially on the registration information as represented by block 464. The authentication code is added to the content files on the user system and transferred to the writable computer readable storage media as represented by block 466. The authentication code may optionally be encrypted on the user system and/or the writable computer readable storage medium as represented by block 470. After the authentication code has been transferred to computer readable storage medium 454, the means to overwrite the authentication code or otherwise generate new authentication codes may optionally be locked, disabled, deleted, etc. as represented by block 456. Alternatively, a number of transfers or installations may be accommodated before disabling or deleting the means to overwrite the authentication code as represented by block 458.

The authorized representative attempts to authenticate the user based on current registration information as represented by block 480. If the user or device is determined to be authorized, access to the digital content is allowed. The authorized representative, whether user resident or remotely located or both, may repeatedly authenticate the user based on current registration information on a periodic basis or upon the expiration of a corresponding authorization interval as represented by block 500. A remote server or other authorized representative may also be provided to facilitate reinstallation, recovery, installation in a new system, and the like as represented by block 540.

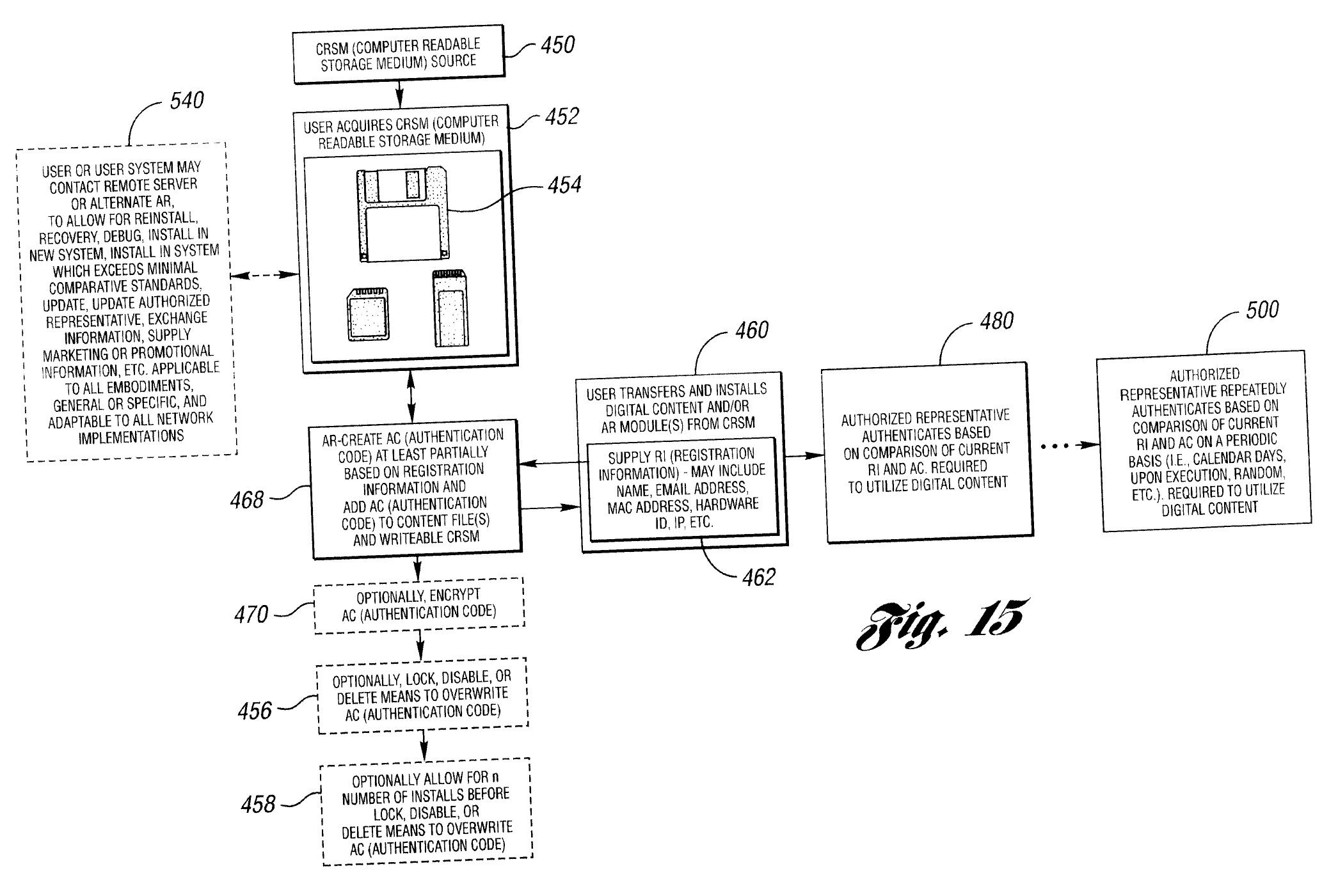

An alternative embodiment for an authentication process particularly suited for use with writable computer readable storage media according to the present invention is shown in the block diagram of FIG. 15. The computer readable storage medium source 450 distributes or otherwise supplies content designated for protection to the user as represented by block 452 on a writable computer readable storage medium 454. An authorized representative creates an authentication code at least partially based on registration information and adds the authentication code to the content file or files designated for protection on the writable computer readable storage medium as represented by block 460. The authentication code or codes may be based on user-specific registration information associated with a particular user, system, network, or device. Alternatively, registration information associated with a particular manufacturer, model, type of device, or the like may be used to generate associated authentication codes. User-specific registration information may be provided by the user or collected from the user's system during ordering or any other acquisition process, which includes electronic distribution or downloading of software to a writable computer readable storage medium of the user, for example. The authentication code or codes may optionally be encrypted as represented by block 470 before locking, deleting or otherwise disabling the authentication code generation means as represented by block 456. Alternatively, or in combination, a predetermined number of installations or transfers from writable computer readable storage medium 454 may be allowed before locking, deleting, or otherwise disabling the authentication code generation as represented by block 458.

The user transfers and installs protected digital content from the computer readable storage medium as represented by block 460 and may supply additional registration information as represented by block 462. The authorized representative attempts to authenticate the user based on general and/or user-specific registration information to allow access to the protected content as represented by block 480. If the user or device is determined to be authorized, access is provided to the protected content. If the user or device is determined to be unauthorized, various compliance actions may be initiated as previously described. Alternatively, or in combination, if the user is determined to be unauthorized, the user or user's system may contact a remote server or other authorized representative as indicated by block 540. The authorized representative may repeatedly authenticate the user based on current registration information and one or more authentication codes upon the expiration of an authorization interval and/or on a periodic basis determined by the authorized representative as represented by block 500.

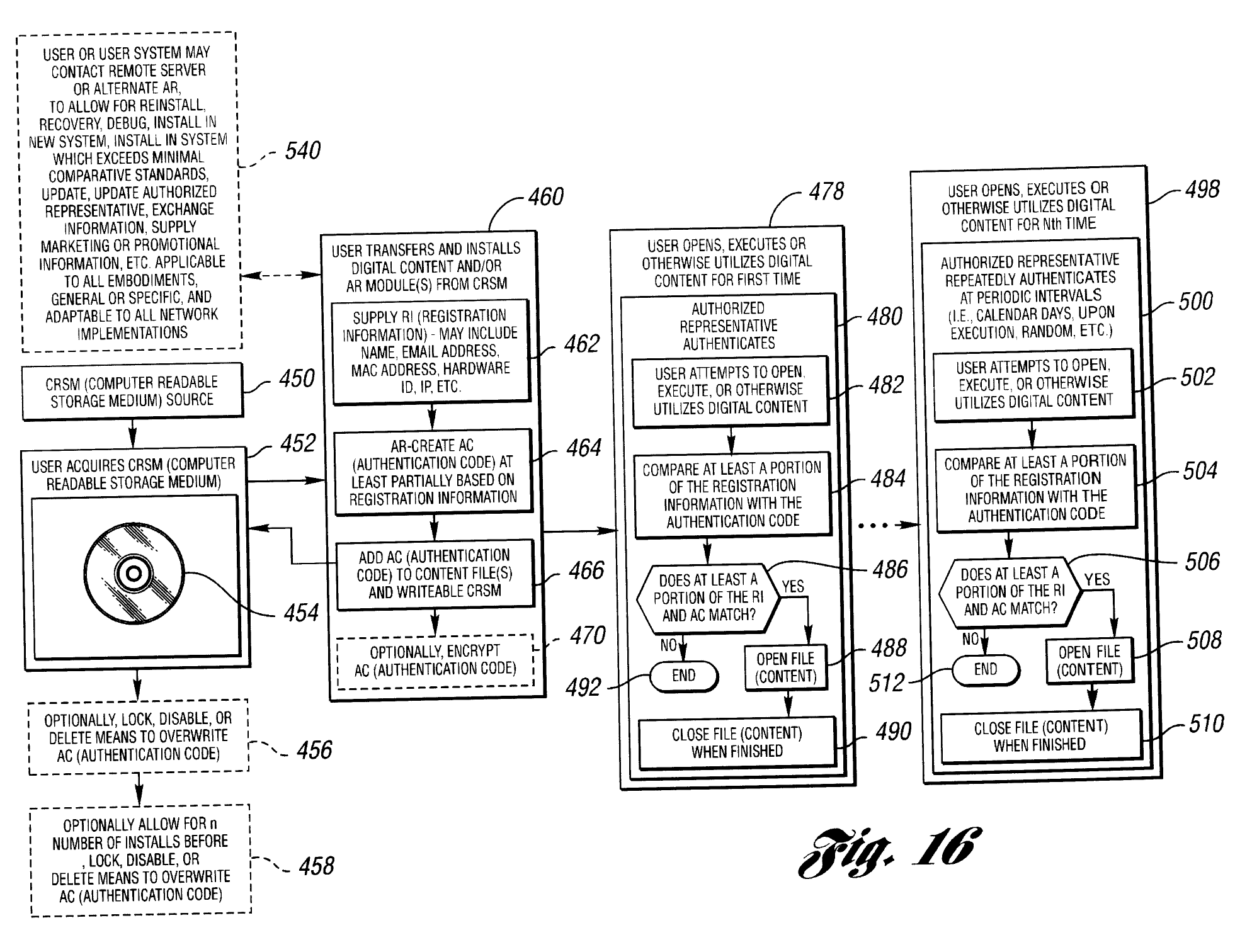

A block diagram illustrating an authentication process particularly suited for use with writable computer readable storage media according to one embodiment of the present invention is illustrated in FIG. 16. A developer, publisher, or other source of content designated for authorization provides the content on a writable computer readable storage medium 454 as represented by blocks 450 and 452. The user transfers and installs the digital content, or otherwise accesses the digital content from the writable computer readable storage medium as represented by block 460. Registration information supplied or collected from the user is used by the authorized representative to create a corresponding authentication code or codes that are added to the content file or files on the writable computer readable storage medium as represented by block's 462,464, and 466. One or more authentication codes may optionally be encrypted as represented by block 470. After adding the authentication code, the means to overwrite the authentication code or codes may optionally be locked, deleted, or otherwise disabled as represented by block 456. Alternatively, a number of transfers or accesses may be allowed prior to locking, deleting, or otherwise disabling the means to overwrite the authentication code or codes as represented by block 458.

Various user actions may trigger an authentication as generally represented by block 478. For example, when the user attempts to open, execute or otherwise utilize the digital content for the first time, a user system resident or remotely located authorized representative entity attempts to authenticate the user or device as represented by block 480 by intercepting the user's attempted access as represented by block 482. The registration information is used to determine whether the user or device is authorized as represented by blocks 484 and 486. If the use or device is determined to be authorized, access to the protected digital content may be provided as represented by block 488 for a predetermined authorization interval and/or until the file is closed as represented by block 490. Access to the protected content may be inhibited or prevented if the use is determined to be unauthorized as represented by block 492.

Additional authentication may be required when the user opens, executes, or otherwise utilizes the protected software as represented by block 498. An authorized representative may repeatedly authenticate the user upon expiration of an authorization interval and/or periodic intervals determined by the authorized representative as represented by block 500. The subsequent authentications may intercept various user attempts to utilize the protected software as represented by block 502. Current registration information may then be examined to determine whether the use is authorized as represented by block 504 and block 506. If the use is determined to be authorized, the protected content may be opened as represented by block 508 and used or otherwise accessed for a single use as represented by block 510. Otherwise, if the user or device is determined to be unauthorized, access or other use of the protected content is inhibited or prevented as represented by block 512.

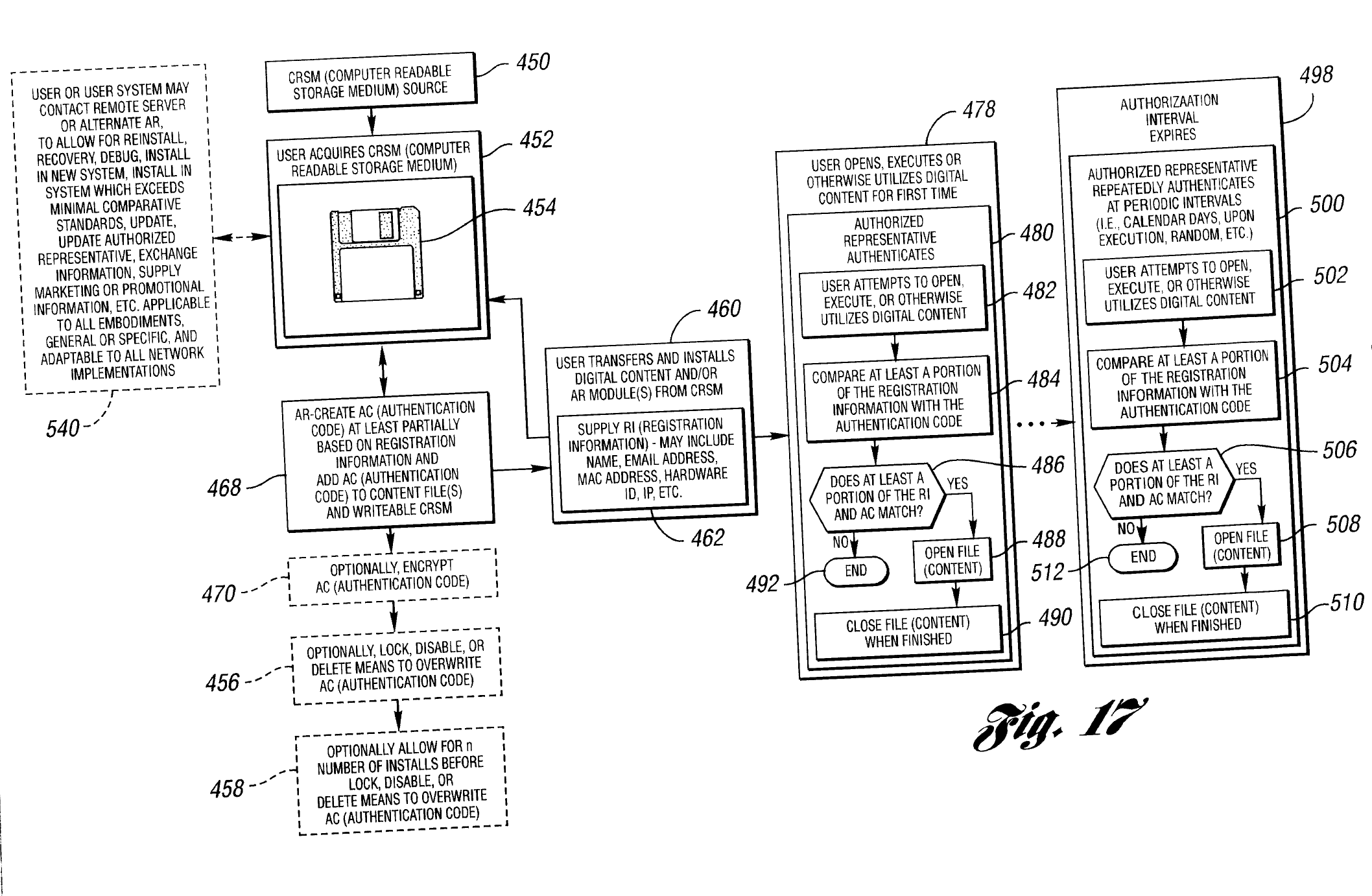

Another embodiment of an authentication process particularly suited for use with writable computer readable storage media according to the present invention is illustrated by the block diagram of FIG. 17. Computer readable storage medium source 450 provides content designated for protection to the user on a writable computer readable storage medium 454 as represented by block 452. An authorized representative creates an authentication code based on user device specific information or general device information and adds the authentication code(s) to the writable computer readable storage medium as represented by block 468. Once an authentication code has been associated with the protected content, the authentication code will then be transferred along with the protected content if the user transfers the protected content to another computer or a secondary device, which may include computer readable storage media, a digital audio player, or the like. Additional security may be provided by making any local or user system resident authorized administrator, or other means to generate or overwrite authentication codes hidden to the user, tamper-resistant, and/or encrypting all or a portion of the information exchanged, for example, as represented by block 470 prior to optionally locking, deleting, or otherwise disabling any means to overwrite the authentication code or codes as represented by block 456. Alternatively, a predetermined number of transfers or installations may be allowed before locking, deleting, or otherwise disabling the means to overwrite the authentication code as represented by block 458.

Additional user-specific registration information may be required when the user transfers, installs, or otherwise accesses the protected software stored on the writable computer readable storage medium 454 with the user system or device as represented by blocks 460 and 462. The authentication may then be required when the user opens, executes, or otherwise utilizes the protected software for the first time as represented by block 478. Likewise, additional authentications may be required when an authorization interval, rental period, or other interval expires as represented by block 498.

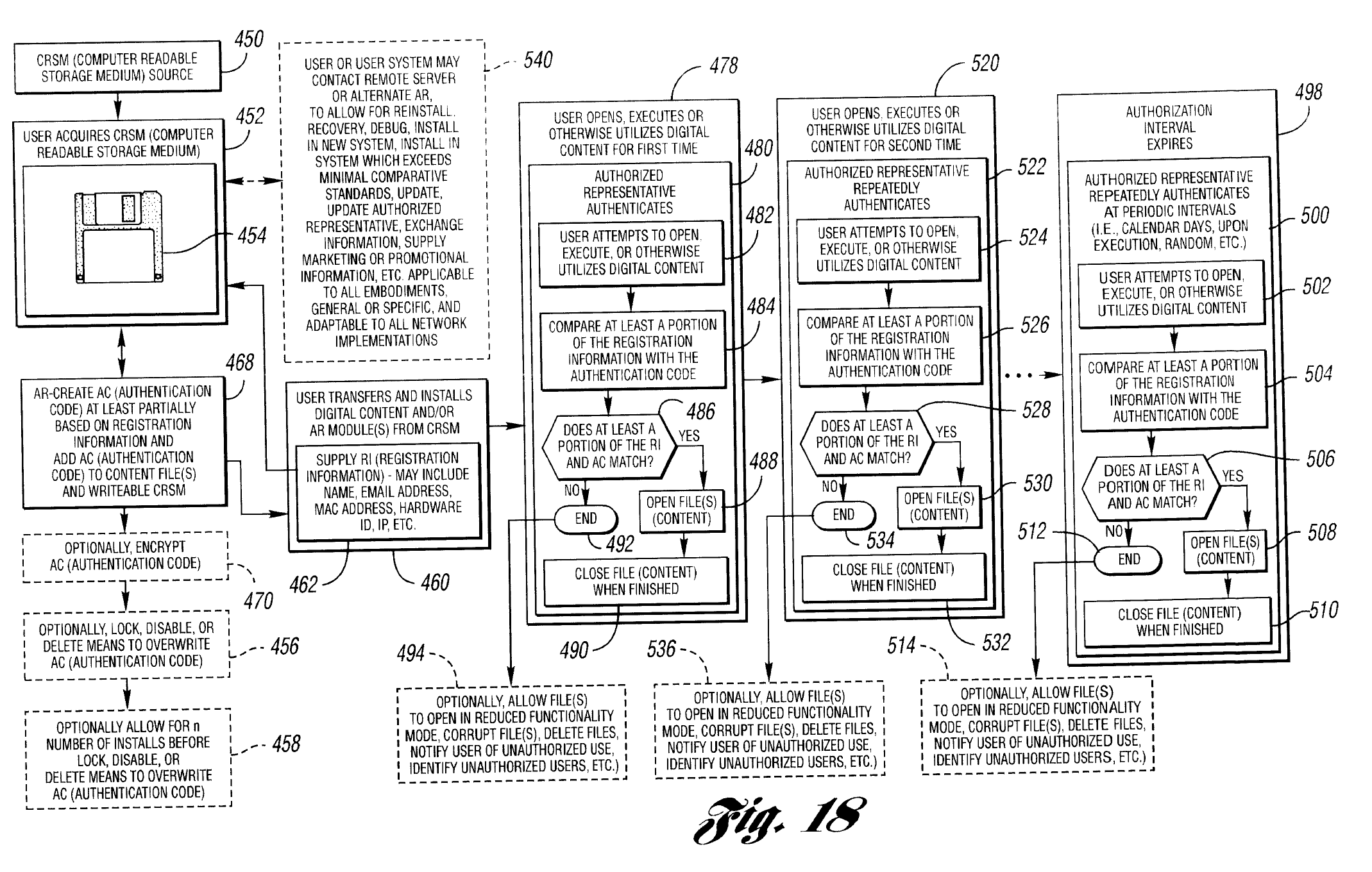

FIG. 18 is a block diagram illustrating another embodiment of an authentication process particularly suited for use with writable computer readable storage media according to the present invention. In this embodiment, an authorized representative authenticates the user or user device based on various attempted uses of the protected content as represented by blocks 478 and 480. If the attempted use is determined to be authorized, access to the protected content is provided as represented by blocks 482 490. If the attempted use is determined to be unauthorized, various compliance actions may be performed as represented by block 494. The compliance actions may be performed by one or more authorized representative entities whether remotely located, resident on the user's, device, or network, or attached to the protected content file and may include any actions to deter unauthorized use. The representative compliance actions may include notifying the user of the unauthorized use or action, notifying a remote authorized representative of the unauthorized use, and/or generation of a disable code. Use of a disable code or any similar means may permanently disable the file or files (partially or fully), allow the file or files to operate in a reduced functionality mode, corrupt the file or files, disable the file or files, delete the file or files, etc. Generation of a disable code or similar means may originate at a remotely located authorized representative entity or any other type of resident authorized representative module or device. Use of a disabled code may be temporary or permanent depending upon the desire or determination of the developer, publisher, or source of protected content. At the discretion of the content developer and/or authorized representative entity, the user may be allowed to rectify the attempted unauthorized use conditions by providing authentication verification information to an authorized representative entity (local or remote) as generally represented by block 540. Once the unauthorized use condition has been corrected or removed, the protected content file or files may be selectively authorized and restored to their fully operable condition. Conditions that may be detected as an unauthorized use include changes to the registration information, installation in a new device, etc.

Compliance functions represented by block 494 may also include various modules or devices used to identify and/or track unauthorized users, devices, systems, and/or networks. The authorized representative entity may collect information relative to an attempted unauthorized use and store and/or transfer the information to a remote authorized representative entity or other appropriate enforcement representative. For example, if the content is transferred to an unauthorized user or device, the authorized representative may detect the unauthorized use and collect identification information relative to such unauthorized use. Identification information may include user name, organization name, e-mail address, IP address, processor identification, etc. The information may then be transferred to a remote authorized representative or enforcement authority either with or without the user's consent and/or knowledge.

As also illustrated in FIG. 18, additional or alternate authentications may be required when the user opens, executes, or otherwise attempts to utilize the protected software a second time as generally represented by block 520. The authorized representative repeatedly authenticates the user by intercepting user attempts to determine whether the user is authorized and providing complete access for authorized users as represented by blocks 522 532. If the authorized representative detects and unauthorized use as represented by block 534, various compliance actions may be initiated as represented by block 536.

The authorized representative may repeatedly authenticate the user upon subsequent attempts to access the protected digital content and/or upon expiration of an associated authorization interval as represented by block 498. The authentication proceeds in a similar fashion as previously described with access to the protected content provided for authorized users for a single use as represented by block 510, or for some other authorization interval. Various compliance actions may be initiated as represented by block 514 to hinder, inhibit, or prevent unauthorized use detected by the authorized representative.

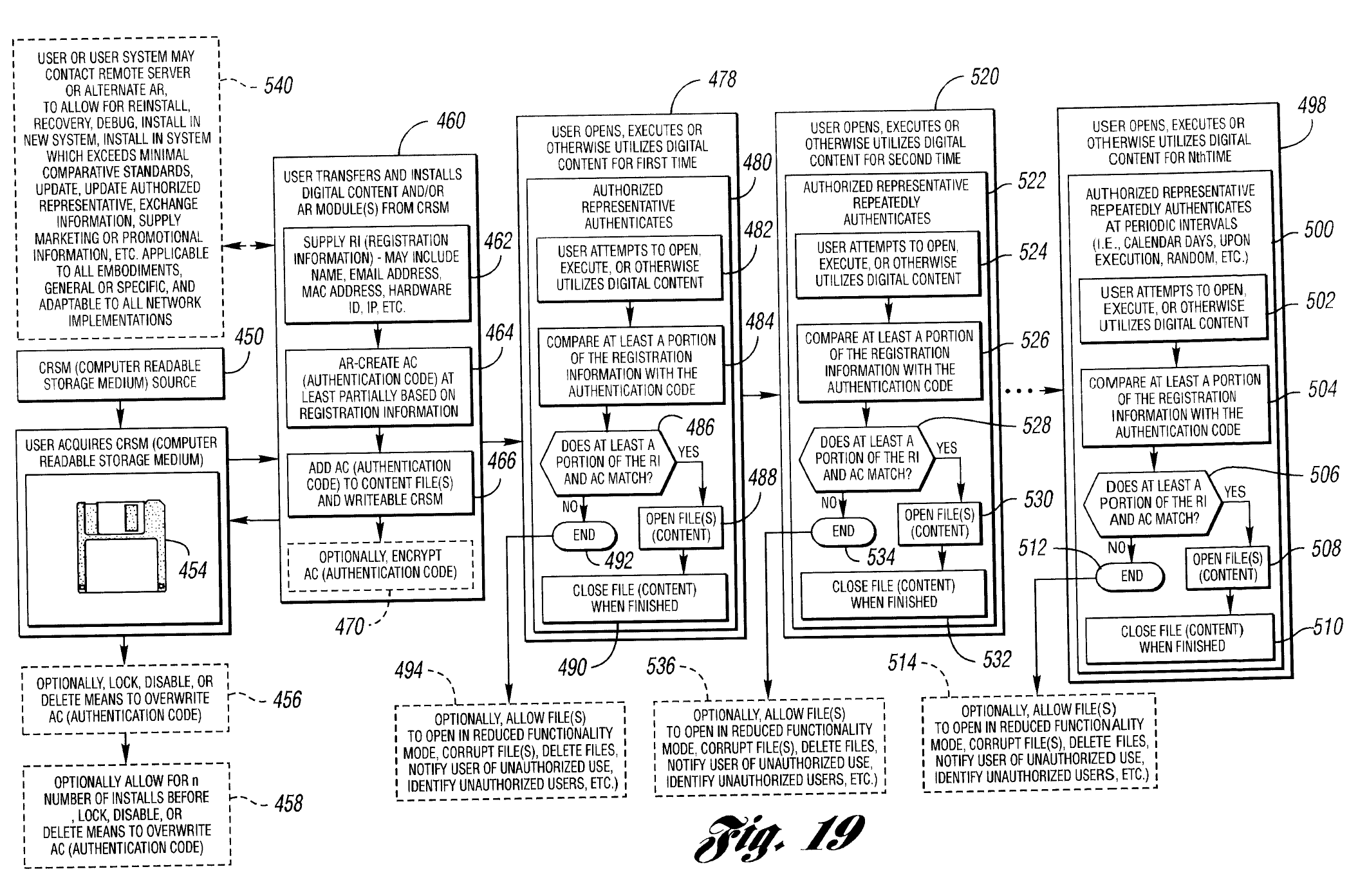

A block diagram illustrating an authentication process particularly suited for use with writable computer readable storage media according to one embodiment of the present invention is shown in FIG. 19. The source designates content for protection and provides the content on a writable computer readable storage medium 454 as represented by blocks 450 and 452. One or more authentication codes may be added to the content files on the writable computer readable storage media 454 based on user specific or general registration information associated with a group of devices, network, or the like, as represented by block 466. The means to overwrite the authentication code or generate new authentication codes may actually be locked, deleted, or otherwise disabled as represented by block 456 after storing the authentication code or codes on computer readable storage medium 454. Alternatively, a number of content accesses, transfers, or installs may be allowed before locking, deleting, or otherwise disabling the means to overwrite the authentication code or codes as represented by block 458. The user transfers, installs, or otherwise accesses the digital content from computer readable storage medium 454 as represented by block 460 using a network, system, or device. Additional registration information may be collected and preferably includes user-specific hardware identifiers as represented by block 462. The authorized representative then creates corresponding authentication codes at least partially based on registration information as represented by block 464 and adds the authentication code or codes to the content file or files on the user system, network, or device as represented by block 466. The authentication codes based on user-specific registration information may also be added to the computer readable storage medium 454. The authentication codes on the user system, network, or device, as well as those on the computer readable storage medium 454, may optionally be encrypted as represented by block 470. These actions protect the content whether transferred electronically or transferred physically by distribution of writeable media to unauthorized parties.

The authorized representative attempts to authenticate the user when the user opens, executes, or otherwise utilizes the digital content for the first time as represented by blocks 478 and 480. The authentication process generally proceeds as previously described with access provided to the protected content for authorized users until the protected content is closed as represented by block 490, or for some other authorization interval. The unauthorized use is hindered, prevented, or otherwise inhibited using one or more compliance actions as represented by block 494.

Repeated authentication may be provided by a local or remote authorized representative based on attempted use of the protected content for the second time as generally represented by block 520. If unauthorized use is detected, various compliance actions represented by block 556 may be implemented. A local and/or remote authorized representative may also repeatedly authenticate the user at periodic intervals determined by the authorized representative, and/or upon expiration of an authorization interval, and/or when the user opens, executes, or otherwise utilizes the digital content as generally represented by block 498. The local and/or remote authorized representative may implement various compliance functions represented by block 514 if an unauthorized use is detected.

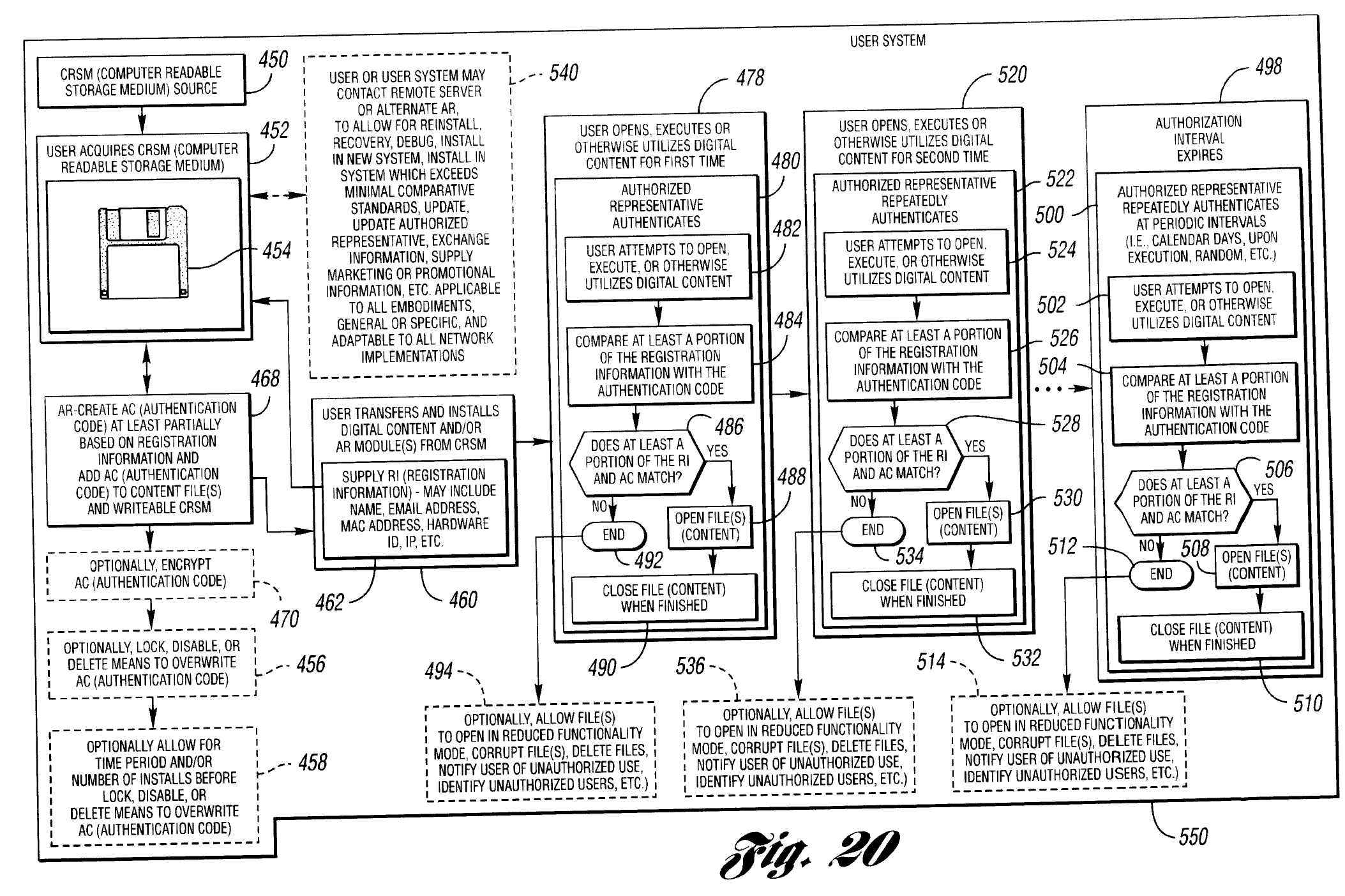

FIG. 20 is a block diagram illustrating one embodiment of an authentication process particularly suited for use with writable computer readable storage media according to the present invention. As illustrated, this embodiment may provide the majority of the authorized representative functions on the user system, network, or device as represented by block 550. A computer readable storage medium source 450 contains content designated for protection. The computer readable storage medium source 450 may include any writable or non-writable (read-only) computer readable storage media attached to, integrated with, or otherwise accessible by the user system, network, or device 550. The software flagged for protection is acquired by the user on a writable computer readable storage medium as represented by block 452. For example, this step may include transfer of protected content from a hard drive or CDR represented by block 450 to a memory card or floppy disk represented by block 452. A user resident authorized representative then creates an authentication code at least partially based on registration information and adds the authentication code to the content file or files on the writable computer readable storage medium as represented by block 468. One or more of the authentication codes associated with the protected software may optionally be encrypted as represented by block 470. Any means to overwrite or otherwise generate an authentication code may then be optionally locked, disabled, or otherwise inhibited as represented by block 456 to prevent user tampering or generation of authentication codes for unauthorized devices. Alternatively, a time interval and/or number of installations or transfers may be allowed before locking, disabling, or deleting the means to overwrite the authentication code as represented by block 458. For example, the user may be provided a seven-day period to transfer content from a writable computer readable storage medium to one or more authorized devices after which time the module to generate additional authentication codes becomes disabled. As another example, the user may be allowed to transfer, install, or otherwise copy the protected content to a predetermined number of devices, a predetermined number of types of devices, or other group of devices before disabling the module or device that generates authentication codes.

The user may subsequently transfer, install, or otherwise access the digital content from the writable computer readable storage medium as represented by block 460 with additional registration information required based on the destination device within the user system or network 550 is registration information may be used to generate additional authentication codes that may be added to the computer readable storage medium and/or other media or devices within user system 550.

A designated user resident authorized representative attempts to authenticate the user when the user opens, executes, or otherwise utilizes the digital content on a particular device for the first time as represented by block 478. Similarly, the user system resident authorized representative may repeatedly authenticate the user when the user attempts to open, executes, or otherwise utilizes the protected digital content for a second time as represented by block 520. As previously described, the user resident authorized representative is preferably located within user system 550 so that it is capable of monitoring content designated for protection that may be received by, utilized with, or transferred from any device or devices within user system or network 550. As described in greater detail below, the user resident authorized representative may be implemented in hardware and/or software supplied by the original equipment manufacturer (OEM), installed by the user, and/or transferred to the system along with protected content. Once installed, the user resident authorized representative may act to selectively protect any or all content subsequently received by user system 550. Such content may be protected on an individual (file-by-file) basis, group basis, type basis, or any other basis desired by the administrator or publisher or as desired by the user for user-created content. This protection may extend from the operating system through application programs and various types of content including music, video, gaming, graphics, etc.

While use of a single, user resident authorized representative may be preferable to facilitate protection of various types of content, the authorized representative functions may of course be segregated and distributed into a number of user resident and/or remote authorized representative entities depending upon the particular application and implementation. The single or multiple user resident authorized representatives may be capable of processing more than one piece or type of content and may be utilized by any primary or secondary computing device, i.e. any device which includes a processor and a memory.

While deterring piracy among experienced “hackers”or those with a high level of technical expertise may be more difficult and require additional safeguards, embodiments of the present invention, such as the embodiment of FIG. 20, incorporate various features that can be used alone or in combination to reduce or eliminate piracy even among the most determined abusers. One strategy used for advanced piracy may be to pirate a content file or file in its original form, prior to encoding the authentication code(s) with the native or user system resident authorized representative module(s) so that subsequent transfers to unauthorized devices would continue to generate authentication codes and appear to be authorized to the authorized representative entity. This is the typical piracy scenario encountered or anticipated within “Warez”sites that are commonplace on the Internet. Other piracy scenarios are similar in nature.

Various anti-Warez embodiments are included within the scope of the invention to combat these and other types of piracy. Embodiments may include a time locked authorized representative module(s) or other authentication code generating means as represented by block 458 of FIG. 20, for example. This time locking feature would only allow for copying of protected digital content file(s) within a predetermined time frame, with the time preferably ascertained by a trusted clock that can not be reset or otherwise tampered with by the user. Various trusted time stamps are available on the Internet or could be provided by another public or private local or wide area network or remote server, for example. As such, if a content file was pirated in its original form, prior to encoding the authentication code(s) with the native authorized representative module(s), copying to the user's machine would have to take place within a given “window”. If the window was set at a seven day period, i.e., May 9, 2003 through May 16, 2003, the copying would have to take place within this “window”. Attempts to copy the digital content file(s) outside of this window would fail. The user may be instructed upon copy failure to contact the authorized representative for a remedy. Based on verification of the user's status as either authorized or unauthorized, the authorized representative entity may take appropriate action(s). For authorized users these actions may include transferring a new content file(s) or authorized representative module(s) with an updated current “window” or taking other selective actions. If the user is deemed unauthorized, the authorized representative would preferably not transfer a new content file(s) or authorized representative module(s) with this updated current “window”. Further, the authorized representative may locate and identify the suspected unauthorized party and take appropriate action. Such actions may range from simply warning the illegal user of the legal implications of piracy, to identifying the unauthorized user and notifying appropriate parties in an effort to institute civil or criminal actions, for example.

Various other “locked” features may also be effective in these scenarios in combination with or in place of a time window or interval. Additional “locking” features may include locking content to a single or range of static or dynamic IP addresses, geographic location, registration information, serial number, etc.

Alternatively, or in combination, repeated authentication as generally represented by blocks 498 and 520 of FIG. 20 is also an effective tactic in combating this and other forms of piracy. For example, if the content file(s) were pirated in its original form, prior to encoding the authentication code(s) with either type of native authorized representative module, they could be illegally transferred to unauthorized machines which would allow for illegal authentication within the new machines. Requiring a subsequent authentication, particularly from a remote authorized representative, assures that only one or a select number of activations takes place. Such repeated authentications may take place at the time of transfer, or may be required at a future date or within a predetermined time frame. Additional periodic authentications may also be required for continued use of the digital content file(s). Alternatively, the sequence may be reversed wherein the initial authentication is from the remote authorized representative and subsequent authentications take place at the native or user system resident authorized representative entity (software and/or hardware module(s) or device(s)).

Although no feature is likely to be completely effective in preventing piracy with experienced “hackers”for any long period of time, various features of the present invention used alone, or particularly in combination, should dramatically reduce the unauthorized use of protected content even by determined abusers with a high level of technical expertise in piracy scenarios.

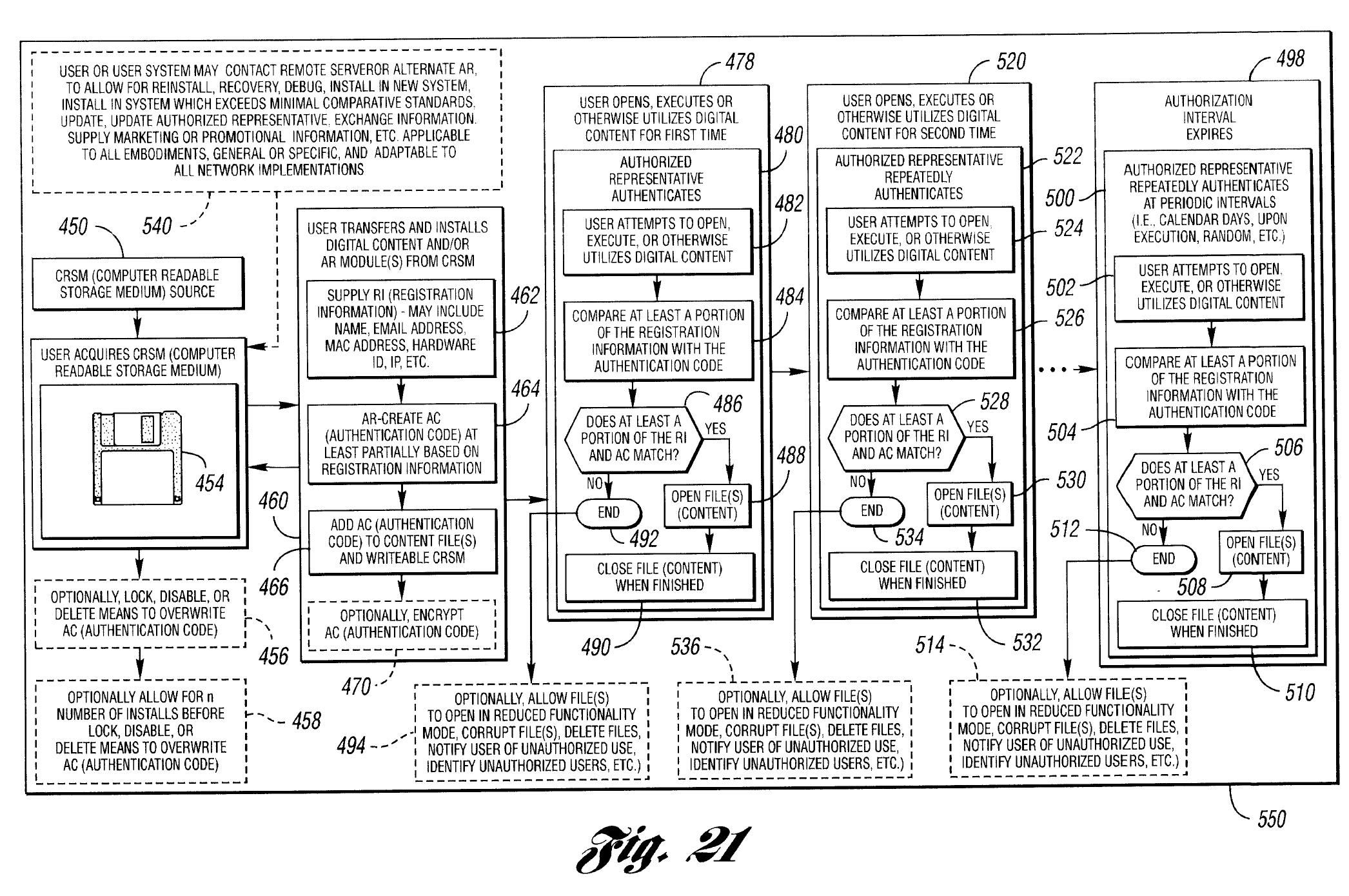

Referring now to FIG. 21, a block diagram illustrating another embodiment of an authentication process for use with writable computer readable storage media according to the present invention is shown. The embodiment of FIG. 21 includes many steps or functions similar or identical to the like numbered steps or functions of FIG. 20 that are not described in detail here. As with the embodiment of FIG. 20, the embodiment of FIG. 21 performs many or all functions of the authorized representative on the user system, network, or device 550. After acquiring content designated for protection on a writable computer readable storage medium, which may optionally contain one or more authentication codes, as represented by blocks 450 458, the user transfers, installs, or otherwise copies the digital content from the writable computer readable storage medium to a user system, device, or network as represented by block 460. Registration information may be supplied by the user or gathered automatically and preferably includes various hardware specific identifiers as represented by block 462. During the self-authentication process, the resident authorized representative then creates one or more authentication codes and associates them with the digital content as indicated at block 464. The authentication code or codes are preferably at least partially based on registration information collected in step 462 and/or registration information previously collected from or supplied by the user during ordering, downloading, etc. The authentication code or codes may then be added to the content file or files on the user system 550 as well as the writable computer readable storage medium as represented by block 466. Any or all the authentication codes may be optionally encrypted as represented by block 470.

The user system resident authorized representative attempts to authenticate the user the first time the user attempts to open, execute, or otherwise utilize the protected digital content on a user device as represented by block 478. Similarly, the same or a different authorized representative entity repeatedly authenticates the user when the user opens, executes, or otherwise utilizes the digital content for the second time as represented by block 520. Any of the authorized representative entities may authorize use for a designated authorization interval, which is preferably a single use. Additional or repeated authentications may then be required upon the expiration of the authorization interval as represented by block 498. In addition, one or more authorized representative entities may repeatedly authenticate users at periodic intervals that may be based on calendar days, execution time, random, etc.

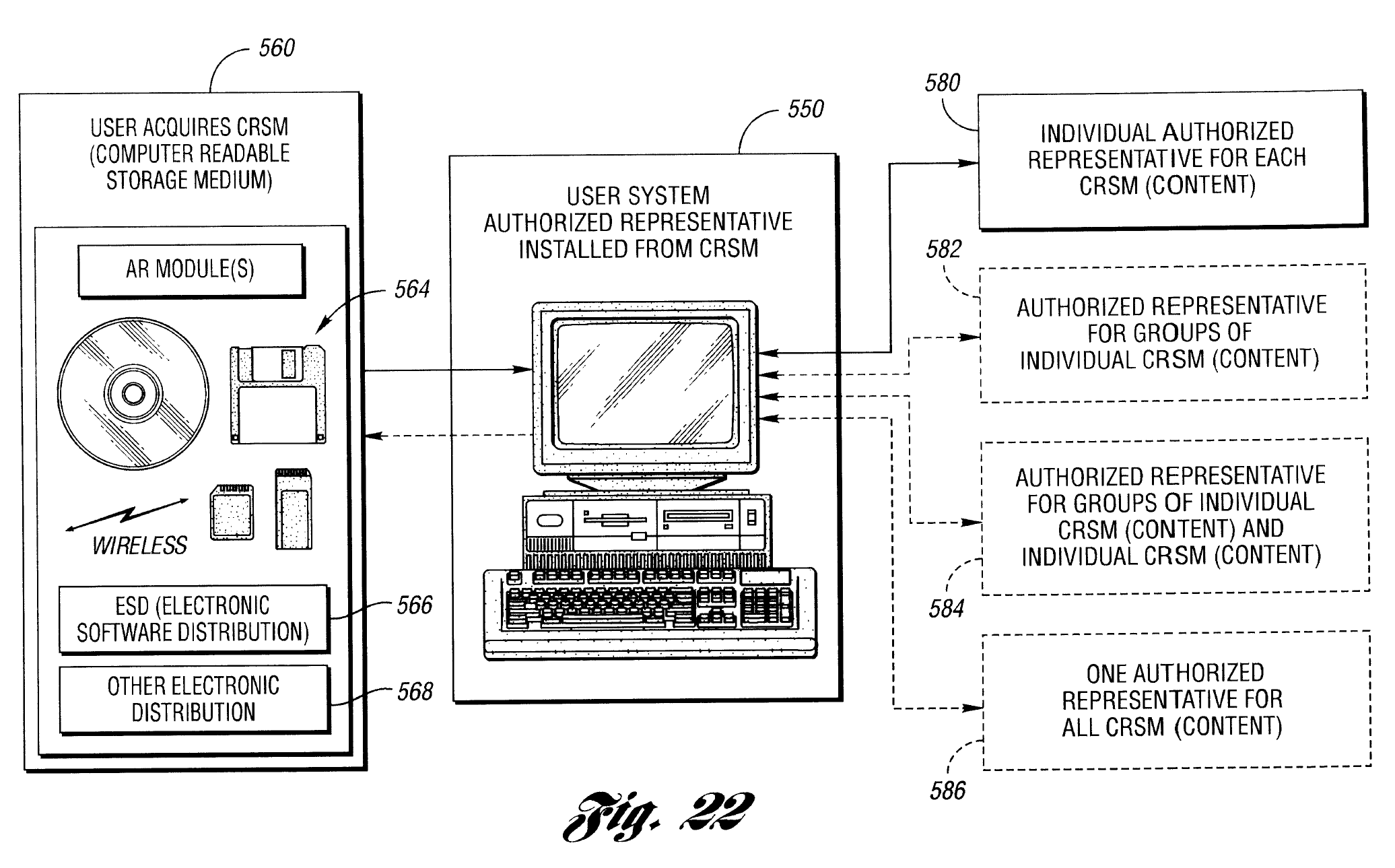

FIGS. 22-29 provide block diagrams illustrating exemplary locations and types of authorized representative entities that may be used with any of the embodiments of the present invention. The authorized representative or administrator may exist in any form consistent with user needs, user privacy, publisher demands, level of protection desired, etc. The authorized representative entities may be implemented by control logic or code in one or more programs, modules, applets, drivers, etc., either remotely located or resident on a user system, network, or device. The code or control logic for one or more authorized representative functions may reside in a dedicated authentication integrated circuit chip or chip set within the user system and/or secondary device and may be programmable, i.e. executed by a microprocessor, and/or hardcoded within a dedicated chip or chip set that is preferably permanently affixed to the main processor board or motherboard of the device or system. Alternatively, the authorized administrator or representative entity may be located within any of the system components adaptable to such processing. For example, the authorized representative functions may be integrated into the main system microprocessor, a co-processor, or other supporting chip or chip set. Of course, it is also possible for the authorized representative to reside in memory within any compatible component of the user system or device.

The authorized representative functions, whether programmable or hardcoded, may be developed or implemented using any available programming language or technique including basic, Visual Basic, C, C+, C++, Java, assembly language, mark-up language, etc. Similarly, hardcoded implementations may be developed using FPGAs (field programmable gate arrays) prior to widespread implementation using ASICs (application specific integrated circuits), for example. Such techniques may also be employed in one or more external devices in communication with, or attached to the user system, network, or device, such as dongles or hardware keys generally residing in a computer system parallel port, for example.

The block diagram of FIG. 22 illustrates one embodiment of the present invention with a self-activating and self-authenticating user system resident authorized representative installed from a computer readable storage medium. In this embodiment, one or more authorized representative modules may be directly or indirectly acquired by a user as represented by block 560. The authorized representative modules, drivers, programs, etc. may be acquired via computer readable storage media 564 directly from a distributor and/or via electronic software distribution 566 or other electronic distribution 568. The authorized representative module or modules may be transferred to the user system, network, or device 550 along with one or more files designated for protection, or may be transferred independently in a separate step. Likewise, the transfer and/or installation of one or more authorized representative modules may be performed transparently to the user or may be installed in a conventional manner with user prompts to allow the user to specify the location and manner of installation, for example. The transferred authorized representative module or modules may contain executable code or instructions to perform the various self-authentication and compliance functions as described herein using a general purpose or dedicated processor within user system, network, or device 550. Alternatively, or in combination, the authorized representative module or modules may contain data or codes to activate or otherwise enable a dedicated processor or integrated circuit chip to perform various authorized administrator functions. User system, network, or device 550 may exchange various information, which may include registration information for example, with the authorized representative module distributor and/or computer readable storage medium 560 during the acquisition of the authorized representative modules or subsequently during transfer/installation on user system 550.

Depending upon the particular application, the authorized representative module or modules may be implemented as an individual authorized representative for each file of protected content as represented by block 580. For example, each time user system, network, or device 550 acquires protected content, a corresponding individual authorized representative would be installed to protect that content. The individual authorized representative module may be a separate module or modules associated with the protected content, or may be integrated or otherwise embedded with the protected content or one or more application programs used to access the protected content, for example. Alternatively, or in combination, an authorized representative may be provided for designated groups of individual content files as represented by block 582. For example, each type of protected content (such as music, video, application programs, clip art or graphics, etc.) may include an associated authorized representative contained in one or more modules, drivers, programs, etc. and installed on user system or network 550 prior to, concurrently with, or subsequent to the protected content. As another example, authorized representative 582 may perform various authentication functions for a group of individual protected content installed from a common computer readable storage medium or downloaded during a single session regardless of the particular types of protected content files.

The authorized representative may also be implemented for groups of individual content in addition to one or more authorized representatives for individual content as represented by block 584. Alternatively, a single authorized representative for all protected content may be utilized as represented by block 586.

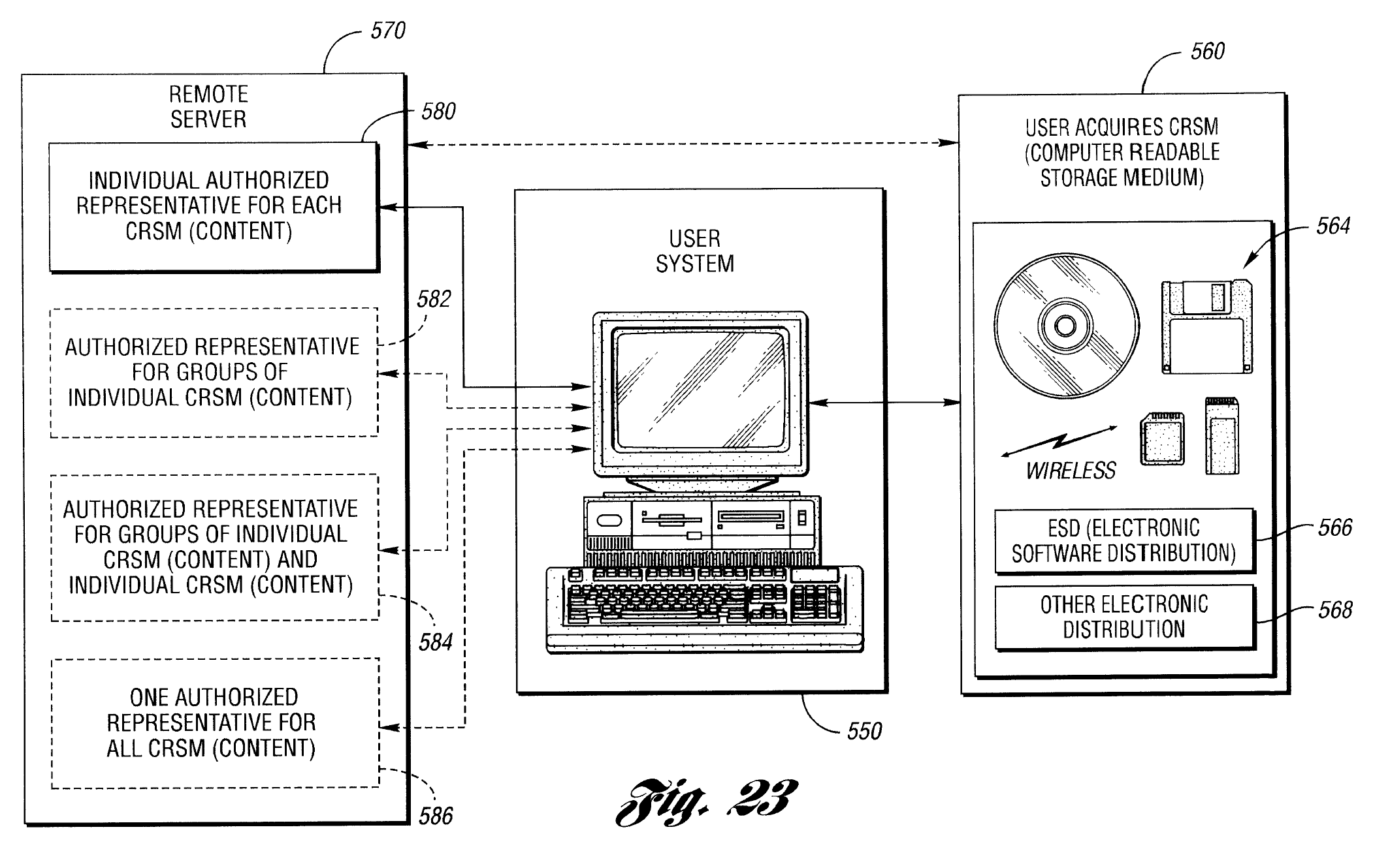

FIG. 23 illustrates another exemplary implementation for an authorized representative to be used in authentication according to the various embodiments of the present invention. User system, network, or device 550 may communicate with a remote server 570 containing one or more authorized representatives as represented by blocks 580, 582, 584, and 586. A user acquired computer readable storage medium 560 may exchange various information with one or more authorized representatives on remote server 570. Similarly, one or more authorized representative modules may be transferred to computer readable storage media 564 acquired by the user as represented by block 560. Transfer of the authorized representative module or modules may occur prior to distribution of the computer readable storage media 564, or during distribution via electronic software distribution 566 or other electronic distribution 568, for example. During transfer, installation, or other access to protected content on computer readable storage media 564, user system 550 may be used to perform various authorized representative functions directly or indirectly through contact with remote server 570 and associated authorized representatives.

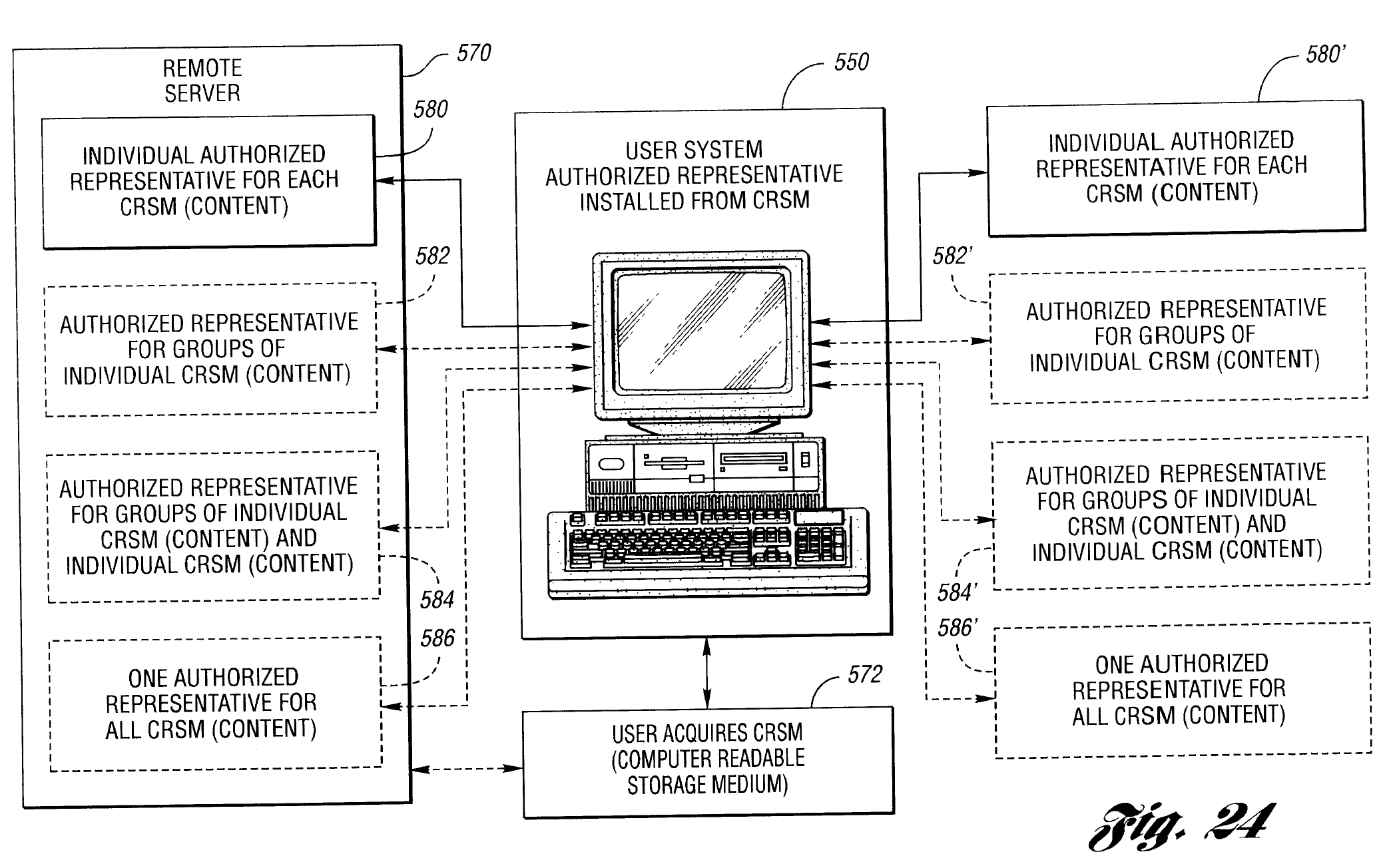

A block diagram illustrating additional implementations for authorized representative functions performed during authentication according to the present invention is shown in FIG. 24. In this embodiment, one or more types of authorized representative entities represented by blocks 580′, 582′, 584′, and 586′ are preferably resident on or within user system, network, or device 550, which may be a computer, for example. The authorized representative entity or entities may be installed to a computer readable storage medium on or within user system 550 from remote server 570, for example, or installed from another computer readable storage medium as represented by block 572. Alternatively, or in combination, various authorized representative functions may be performed by one or more types of authorized representative entities represented by blocks 580, 582, 584, and 586 via contact with a remote server 570 prior to, subsequent to, or concurrently with authentication to provide access to protected content. A remotely located authorized representative, such as individual authorized representative 580, may provide functions associated with verification of an authorized user or device during reloading of protected software, installation in a new machine, modification of a device that alters hardware specific registration information, etc. Although perhaps not preferable from a privacy standpoint, administrative and authentication functions may also be processed by remote server 570 alone or in combination with a resident authorized administrator on system 550. Determination of the best implementation for a particular application may be predicated on publisher functionality parameters and the desired protection method and level, for example. Remote server 570, whether attended by customer service representatives or completely automated, may be provided to allow a transitioning to various authentication processes according to the present invention. Similarly, content designated for protection may be provided with authentication code linking to take effect at some future date or may be provided with multiple types of protected content to allow for use of the content on older devices, etc. as described in greater detail below.

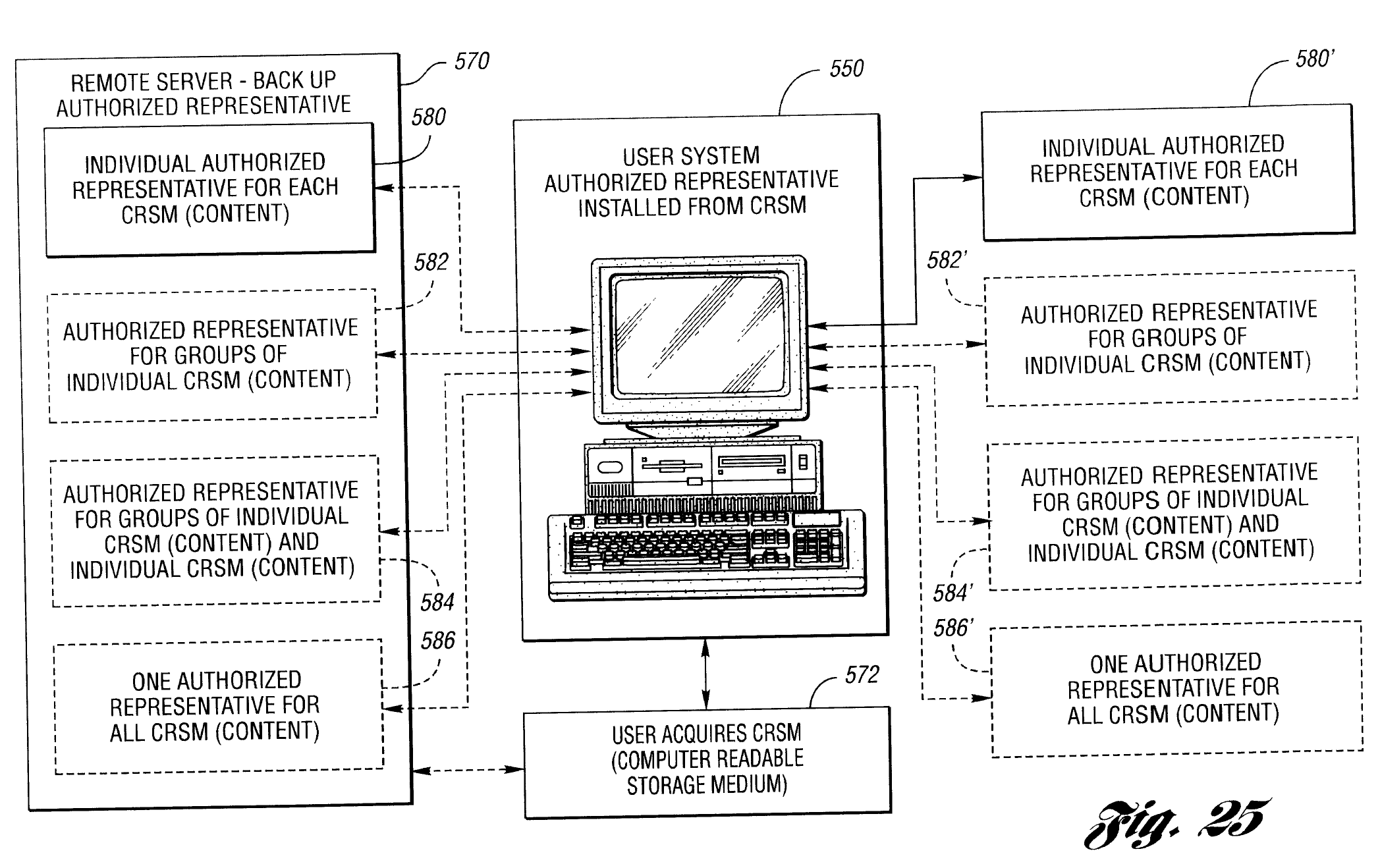

FIG. 25 is a block diagram illustrating other possible implementations for authorized representatives in an authentication process according to the present invention. User system 550 includes an authorized representative installed from a computer readable storage medium, such as may be acquired by a user with protected content as represented by block 572, for example. The user system resident authorized representative may include an individual authorized representative for each computer readable storage medium as represented by block 580′. Alternatively, or in combination, the authorized representative may provide authentication functions for groups of content as represented by blocks 582′ and 584′. A single user resident authorized representative for all protected content or content designated for protection may also be provided as represented by block 586′. A remote server 570 may be accessed by user system 550 using public or private local or wide area networks, satellite, dial-up, or the like, to provide various backup authorized representative functions as previously described.

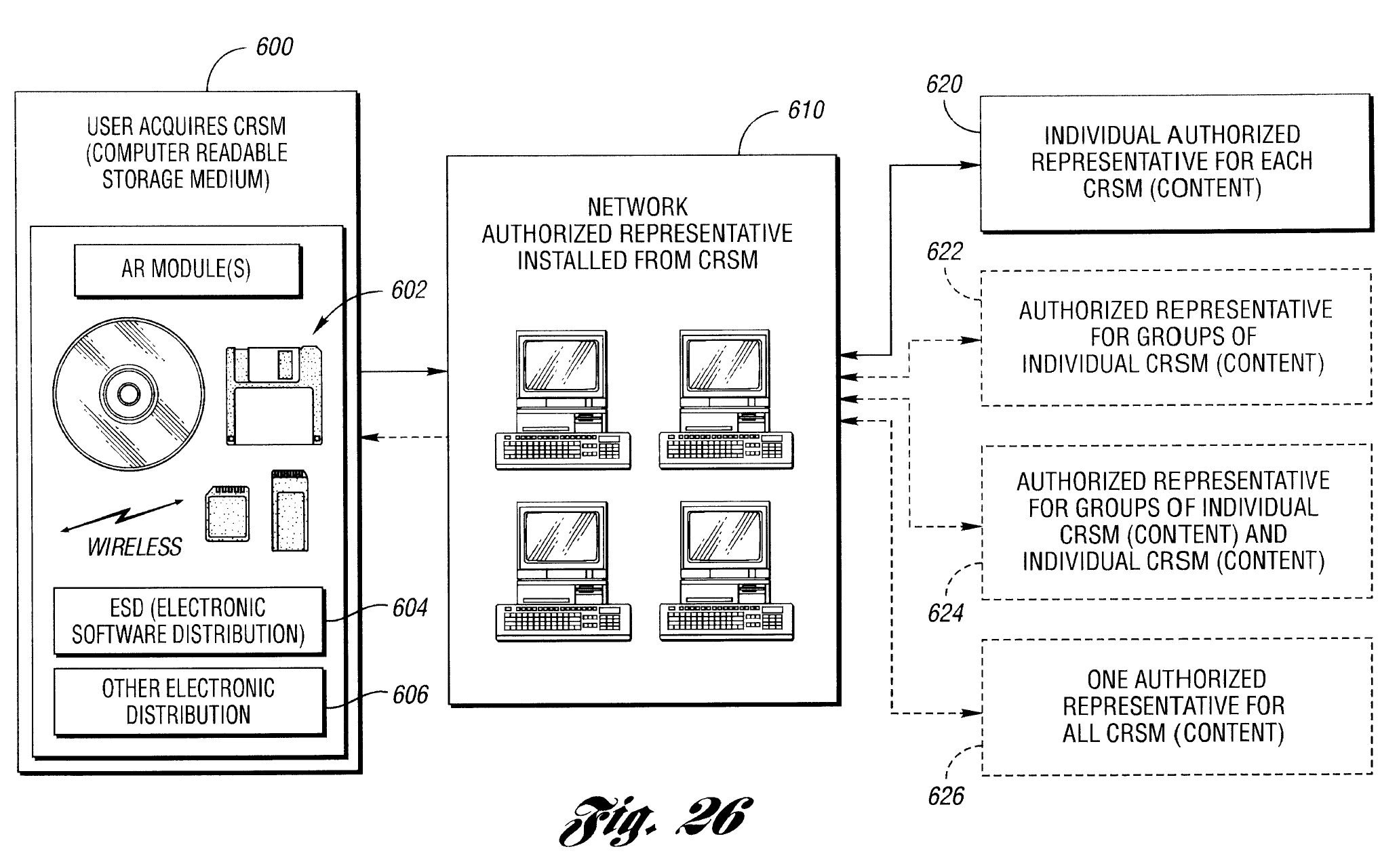

FIG. 26 illustrates a network implementation for an authorized representative used in an authentication process according to the present invention. A user may acquire computer readable storage media having content designated for protection and/or authorized representative information as represented by block 600. The authorized representative entity may be transferred to computer readable storage media 602 using electronic software distribution 604 and/or other electronic distribution 606, for example. The authorized representative entity is then transferred to a user network 610. The authorized representative entity may be provided as an individual authorized representative for each content file 620, or optionally as an authorized representative for various groups of individual content 622. Similarly, the authorized representative entity installed on user network 610 may act as the authorized representative for groups of individual content as well as each individual file containing content designated for protection as represented by block 624. Alternatively, a single resident authorized representative may be provided to perform the authorized representative functions for all protected content as represented by block 626.

The authorized representative entity installed on user network 610 may reside on an individual machine or device accessible by other machines or devices in the network, or may be installed on multiple or all systems or devices within the network. The particular location or locations of the authorized representative entity within network 610 may depend upon the network architecture or topology or the type of protected content, for example. Network 610 may use any of a number of technologies to provide communication between devices, including wired and wireless connections, and a client-server, master-slave, and/or peer-to-peer architecture, for example. Likewise, the network 610 may change as devices are added to, or removed from the network. As an example, the authorized representative entity may reside only on primary devices, such as computers, but may be accessible to various secondary devices, such as PDAs, digital audio players, and portable computer readable storage media in temporary or permanent communication with the primary device or devices. As a further example, the authorized representative entity may reside on a computer within network 610 that is used to authenticate or authorize transfer of protected content from the computer to a digital audio player (that may or may not contain its own authorized representative module or device). Once the transfer has been authenticated, the digital audio player could be disconnected from network 610 and repeatedly access the protected content without additional authentication. Alternatively, the digital audio player may be required to access the authorized representative entity on computer network 610 each time protected content is used or accessed, i.e. each time protected music is played.

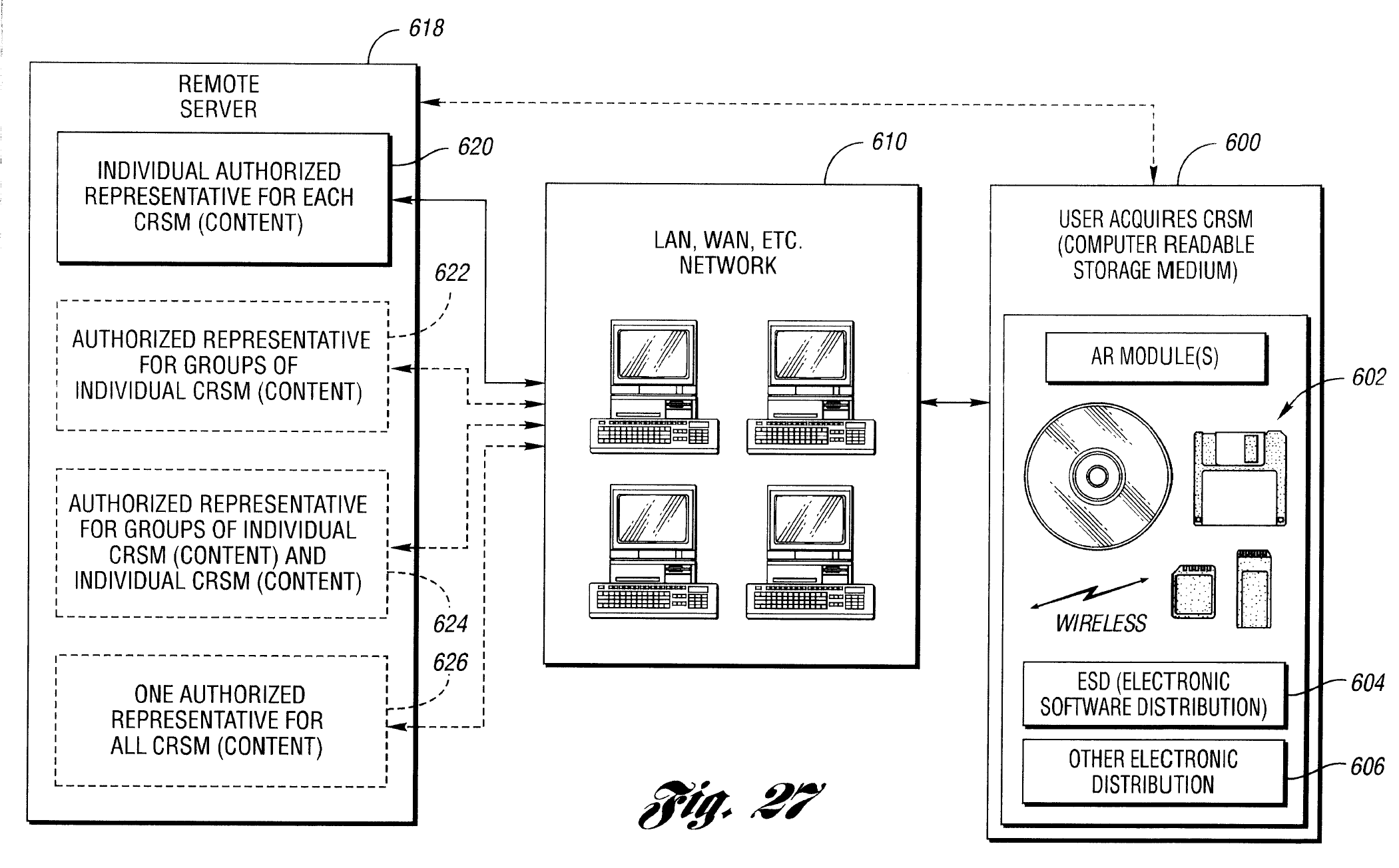

FIG. 27 is a block diagram illustrating another network implementation of an authorized representative entity for use in an authentication process according to the present invention. Network 610′ represents a local area network (LAN), wide area network (WAN), etc. that may be used to access an authorized representative located on the remote server 618 to authenticate protected content acquired or accessed by a user as represented by block 600. The authorized representative entity may be implemented as an individual authorized representative for each file of protected content as represented by block 620. Alternatively, or in combination, an authorized representative entity may be supplied for groups of individual content as represented by blocks 622 and 624, or a single authorized representative for all protected content may be provided as represented by block 626.

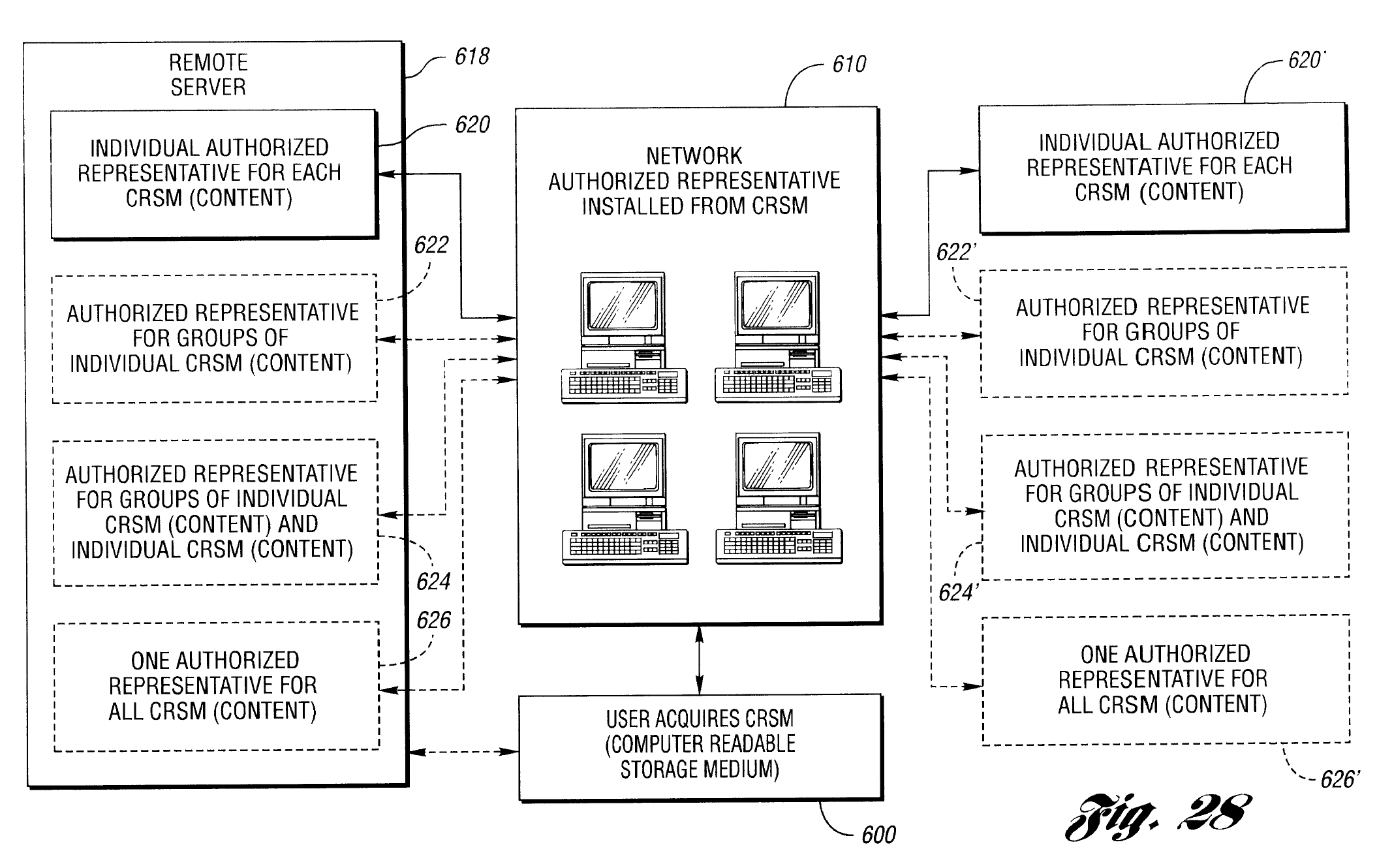

A block diagram illustrating another network implementation for an authorized representative entity for use in an authentication process according to the present invention is shown in FIG. 28. An authorized representative entity may be installed on network 610 from a computer readable storage medium acquired by a user as represented by block 600, for example, or may be acquired by user 600 from a remote server or website 618, for example. The network authorized representative may be in the form of an individual authorized representative for each protected file as represented by block 620′, and/or for groups of individual content as represented by blocks 622′ and 624′, or a single authorized representative may be provided to authenticate all protected content as represented by block 626′. In addition to the resident authorized representative entity, a remotely located authorized representative may be provided on remote server 618 in one or more forms as represented by blocks 620, 622, 624, and 626.

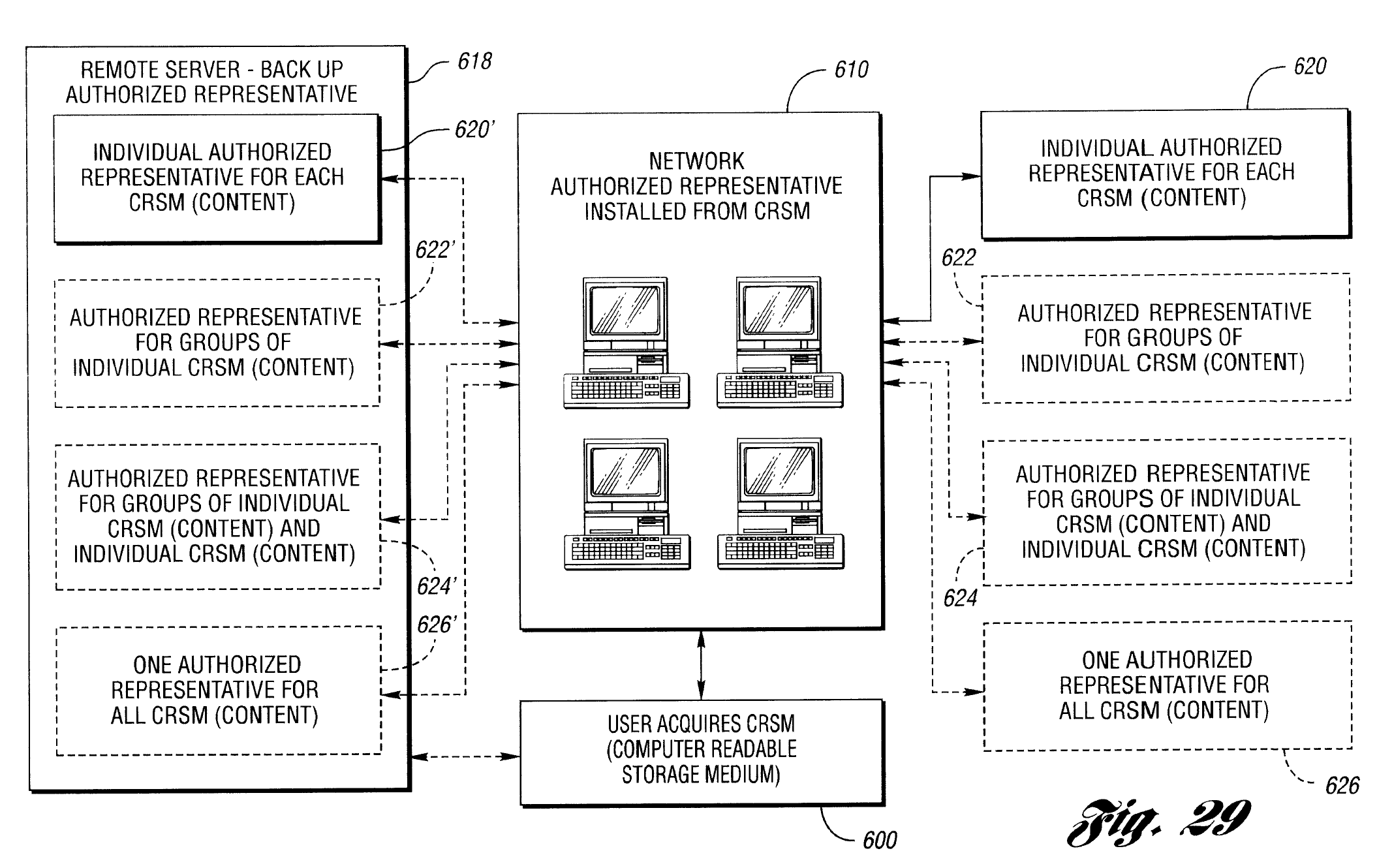

Another exemplary implementation for an authorized representative entity resident on a local network for use in an authentication process according to the present invention is shown in FIG. 29. Network 610 preferably includes an authorized representative entity in one or more of the forms represented by blocks 620, 622, 624, and 626. The resident authorized representative entity may be transferred and/or installed from a computer readable storage medium acquired by a user as represented by block 600. The authorized representative entity may be installed either transparently without user knowledge or intervention, with user knowledge, with user consent, etc. Similarly, the authorized representative may be installed as part of an application program or in conjunction with an application program that may access or use protected content. The authorized representative entity, whether implemented in hardware, software, or a combination of both hardware and software may be structured to operate under the supervision of applications used to access protected content, such as Microsoft's MediaPlayer and Real Network's RealPlayer by installing the module or device within or in conjunction with such applications. All authentication processes or any portion of the processes may be utilized in this manner if desired. Additionally, separate file types and/or file extensions may be utilized to facilitate use of any of the processes described herein.

Network 610 may also be in communication with a remote server 618 that provides various types of backup authorized representatives 620′, 622′, 624′, and 626′. The backup authorized representatives may be used to provide customer service, network metering and monitoring, or other troubleshooting functions and may be completely automated or may use service representatives depending upon the particular application.

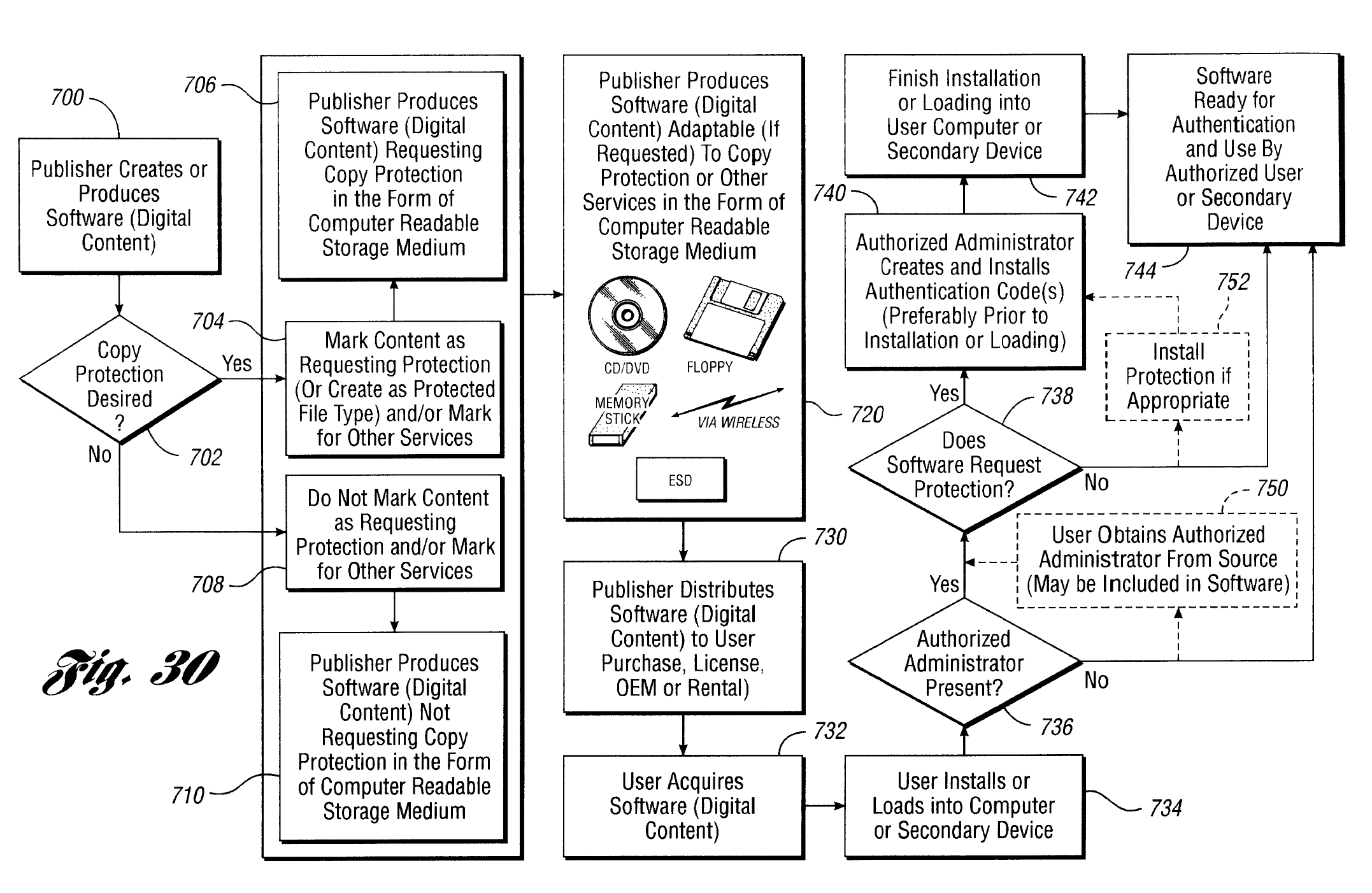

Referring now to FIG. 30, a block diagram illustrating use of an authorized representative as a clearinghouse for all software according to one embodiment of the present invention is shown. A publisher or developer creates or produces software as generally represented by block 700. The publisher may indicate whether copy protection is desired for the digital content as represented by block 702. If protection is requested, the digital content may be correspondingly coded or marked as represented by block 704. The content may be designated for protection by an embedded code, flag, module, or the like or may be created as a protected file type. Multiple codes, flags, modules, may also be included to provide redundant indicators. These redundant indicators may assist in hampering efforts to decompile, alter and recompile protected software. A protected file type may be indicated by an appropriate file name or extension, such as filename.MP3z4, filename.exez4, or filenamez4.exe, etc. the digital content designated for copy protection may then be produced in the form of one or more types of computer readable storage media as represented by block 706. Publisher 700 may also produce content for which copy protection is not desired or required as represented by block 708. The unprotected content may be produced in the form of various types of computer readable storage media as represented by block 710.

A publisher may also produce software adaptable (if requested) to copy protection in the form of computer readable storage media as represented by block 720. The publisher then distributes the software, which may include digital content designated for copy protection and/or digital content not designated for copy protection, to a user via purchase, license, rental, or embedded or installed on a system or device distributed by an equipment manufacturer (OEM) as represented by block 730. The user acquires the digital content as represented by block 732 and transfers, installs, or otherwise loads the digital content into a primary or secondary device as represented by block 734. Any secondary device that contains a processor and memory, or any other means of identification may be used to implement any of the authentication processes of the present invention. A secondary device may, of course, be considered the primary (or sole) device depending upon the particular use or application of the device. As in FIG. 30, most embodiments of the present invention illustrate a computer as the primary device and various portable devices including PDAs, cellular telephones, digital audio players, satellite radio, etc. as secondary devices although any of the devices may be used as a primary or secondary device depending upon the particular arrangement. In general, primary devices are those that first receive digital content from a publisher or distributor.

If an authorized representative or administrator is available as represented by block 736, and the software is designated for copy protection as represented by block 730, the authorized representative generates an appropriate authentication code or codes and locks them to the protected content, preferably prior to or concurrent with installation or loading of the protected content on the user system or device, as represented by block 740. The user may then be required to complete installation or loading of the content into a primary or secondary device as represented by block 742. This may include providing registration information or otherwise activating or authorizing the protected content, for example. The transferred software is then ready for authentication and use by the authorized user on authorized primary and/or secondary devices as represented by block 744.

If an authorized administrator is not available as determined by block 736, an authorized administrator may be obtained from the source of the protected content or another third-party as represented by block 750. The authorized administrator or representative may be included with the protected content or may be obtained separately. The process then proceeds to determine whether the particular content is designated for protection as represented by block 738.

For content that is not designated for copy protection as determined by block 738, unrestricted access may be provided without generation of an authentication code or codes. Alternatively, a master authentication code or other generic code may be installed to allow access and use of the unprotected content as generally represented by block 752.

In practice, the embodiment for an authentication process/authorized administrator illustrated in FIG. 30 may serve the needs of all publishers with no undue burden to either the publisher or user while alleviating any privacy concerns by using a resident authorized representative to perform authentication. For example, publisher A publishes music software (digital content including music and/or application programs to access, organize, and/or transfer music) and thus marks or designates the software for copy protection. Such marking may be in the form of instructions within the content, by creating a specific file type, etc. Publisher B publishes a graphics software application which includes clip art and marks all content for protection. Publisher C publishes shareware software and does not desire protection and thus does not mark the software. Publisher D publishes games and marks selected portions for protection and other portions remain unmarked. During transfer to the user system, the authorized administrator recognizes that the software from Publishers A and B, and selected content of publisher D require protection and therefore obtains appropriate registration information and generates corresponding authentication code(s) for all incoming content which has been marked for protection. Authentication code(s) are then linked or embedded into the content. All embodiments may also utilize redundant authentication codes to further enhance protection. Content not marked for protection, although preferably monitored by the authorized administrator, flows normally into the system. To ease the burden on publishers, publishers may simply utilize a new file extension or type for content which they deem appropriate for protection as described above, i.e., MP3z4, exez4, MPEGz4, JPEGz4, dllz4, etc. As such, the authorized administrator will authenticate all files or content within these groups or types of files. As in all embodiments, the authentication code(s) may be encrypted for additional protection.

Preferably, the authorized administrator is mandatory and if it is removed or tampered with the system may be partially of fully disabled or rendered incapable of utilizing digital content which has been marked for authentication.

Once the authentication code(s) are attached to content designated for protection, the content can only be utilized by authorized systems or devices. If the content is transferred or copied to an unauthorized system or device, the authentication code(s) are also transferred to hinder or prevent access by an unauthorized device as described herein. In either case the content is rendered at least partially disabled in the unauthorized system or device. Alternatively, instructions may be included in systems or devices that prevent content with authentication code(s) attached from being copied into memory within the system or device. The authentication code(s) may be attached, embedded, encrypted, etc. in any appropriate manner, preferably in such a way as to deter tampering. Older systems or devices which do not include, or are incapable of implementing a resident authorized administrator, may allow the content to be enabled if so desired by the publisher, thus easing the transition to the authentication processes of the present invention. Of course, these older systems may still utilize a remote authorized administrator(s) or be updated with an installed resident authorized administrator(s) depending upon the particular device.

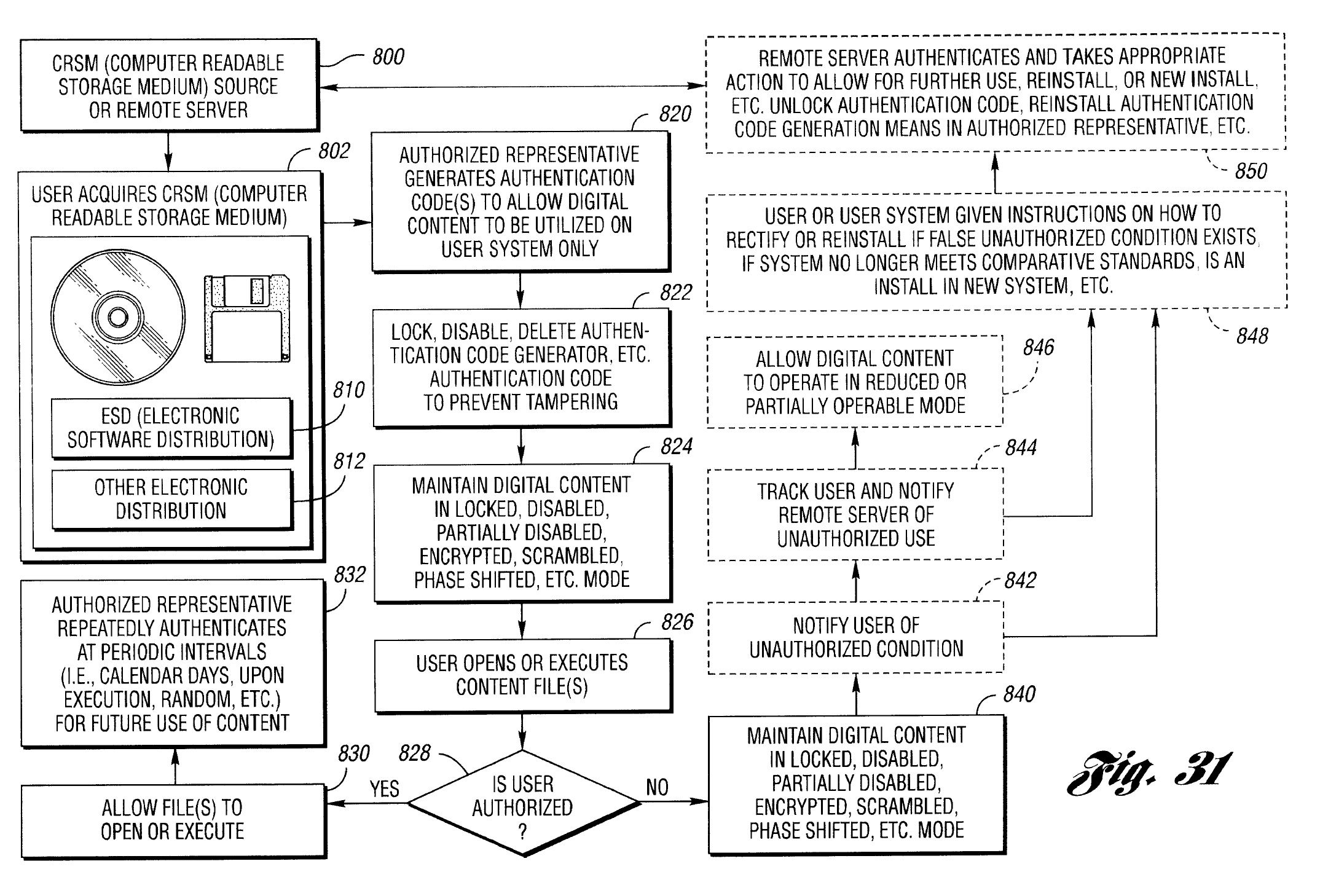

The embodiment illustrated in FIG. 31 may produce the most preferable means of protection for content developers, device manufacturers, and users alike as it may be instituted at a negligible cost to system or device manufacturers and publishers with little or no future administrative costs. Likewise, the embodiment of FIG. 31 presents no undue burden to the user and protects the user from any unwanted invasion of privacy. The ability of users to also utilize the protection means available via an authorized administrator when acting in the capacity of content creators or publishers should also assist in user acceptance. As represented in block 850, a remote server may be optionally provided to assist the user in troubleshooting, further use, installation or reinstallation, unlocking of authentication code(s), reinstallation of authentication code generation means, etc. Transitioning means may be provided for transfer from one machine to another as would be the case if a user acquires a new system or legally sells the software to another user. “Unhooking”and “hooking” from one machine to another may by accomplished by the user indicating that the software is to be transferred. Once the transfer sequence is activated, the authorized representative will start a shutdown timer that will permanently disable the software on the first system within a given timeframe, i.e. ten days. The software is then free to be transferred to the new authorized system where the original authorization code is replaced by the new authorization code generated by the new system. Preferably this process is limited to a given number of transfers and may include additional safeguards to assure license compliance. Such “unhooking”and “hooking” to a new system may be accomplished within the authorized user system or in conjunction with a remote server and is adaptable to all embodiments of the present invention.

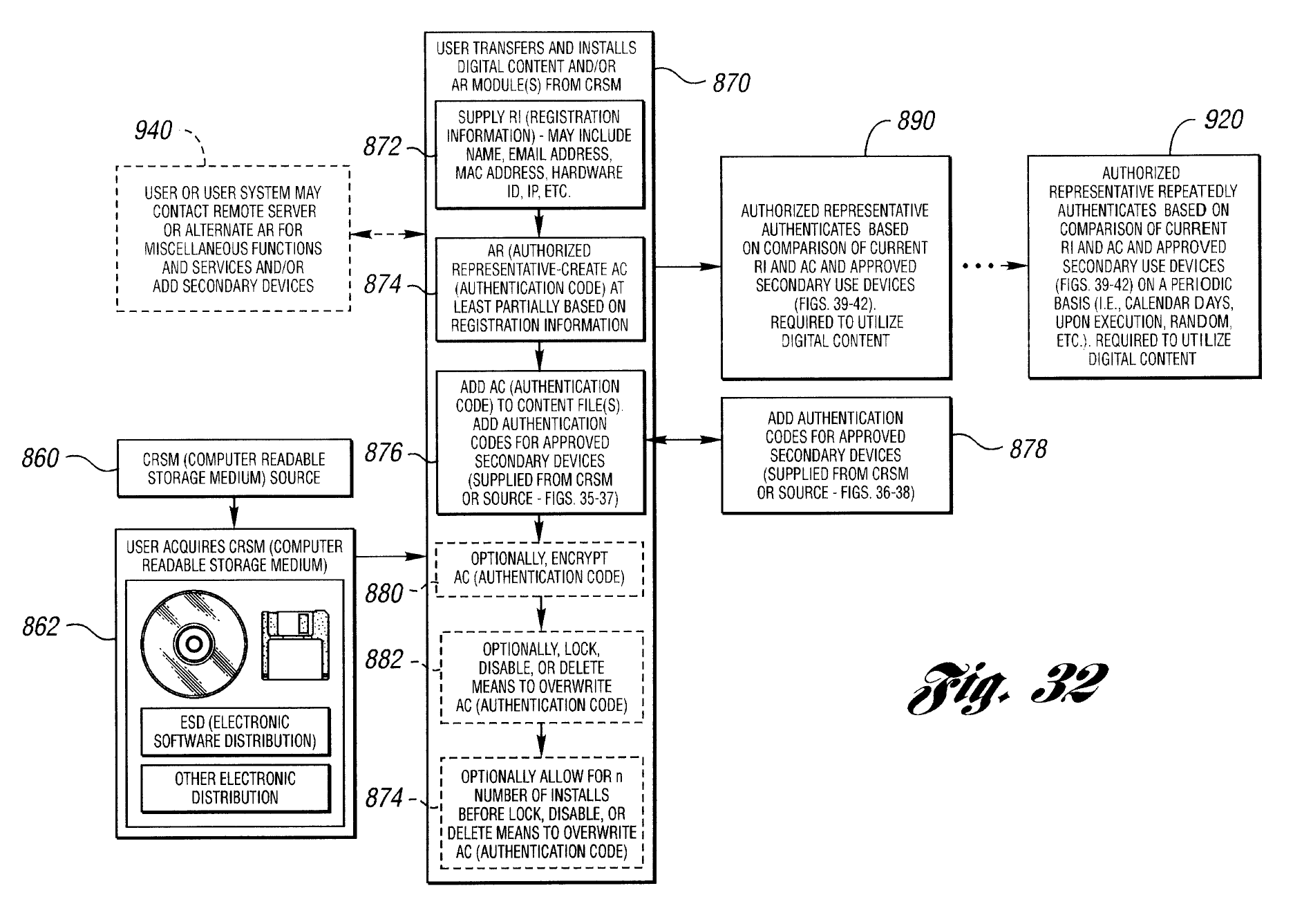

A block diagram illustrating a general authentication process particularly suited for use with secondary devices according to one embodiment of the present invention is shown in FIG. 32. A computer readable storage medium source 860 includes one or more types of content already protected or designated for protection and acquired by a user as represented by block 862. The content may be acquired by a physical computer readable storage medium or acquired via electronic software distribution and subsequently transferred to a computer readable storage medium, for example. The user transfers, installs, and/or otherwise accesses the digital content from the computer readable storage medium as represented by block 870. Registration information may be gathered from the user and/or the receiving device and preferably includes hardware-specific information as represented by block 872. The hardware-specific information may be automatically obtained from the system or device, and/or may be supplied by the user. For example, when digital content is transferred to a primary device, such as a computer, hardware-specific registration information may be automatically obtained from the primary device. In addition, the user may be prompted to enter registration information associated with one or more secondary devices. Secondary device registration information may include the device manufacturer, model, serial number, or other identifying information, for example. Depending upon the particular application, the user may be allowed to manually pre-authorize a limited number of secondary devices.

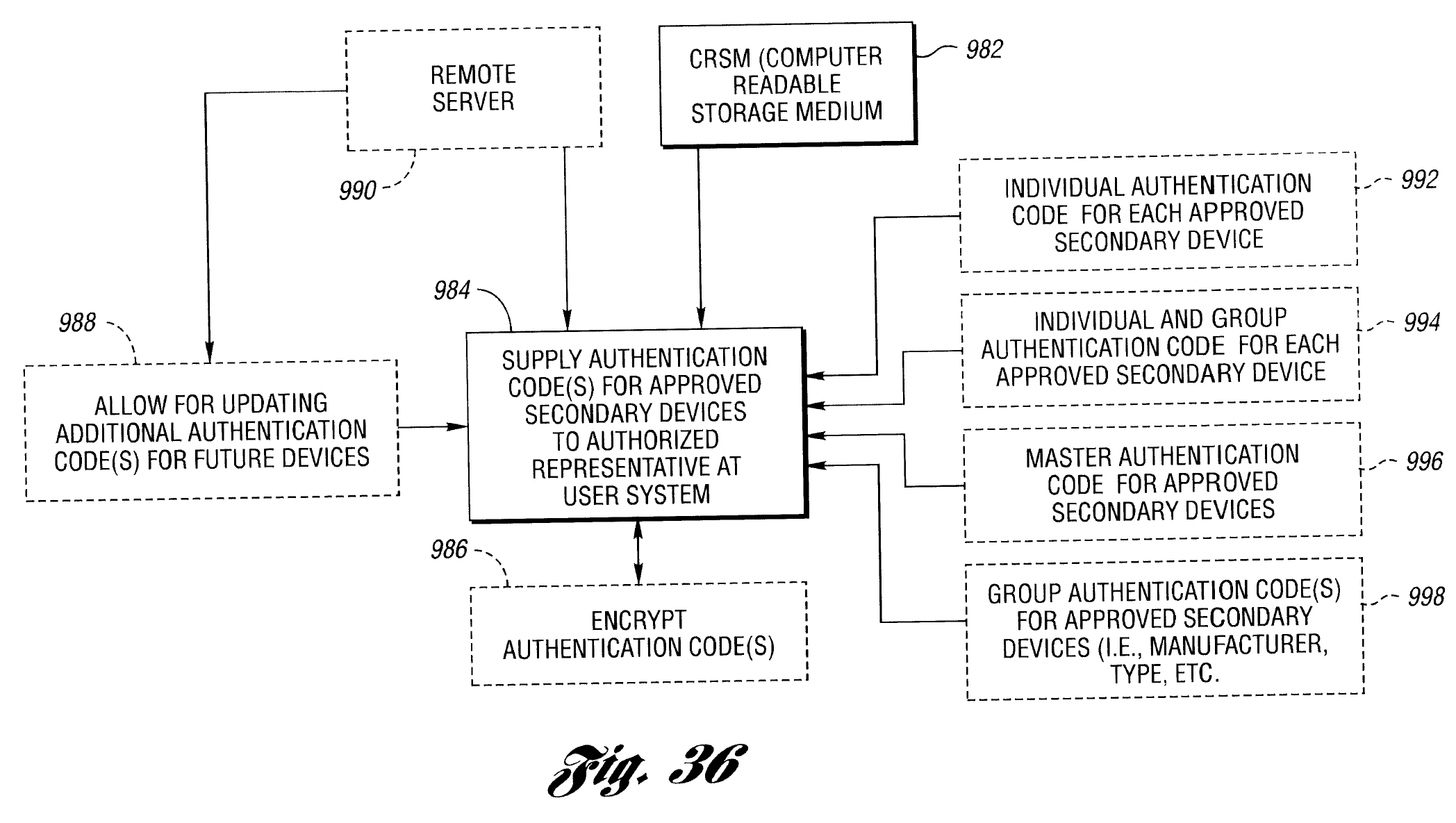

The authorized representative creates one or more authentication codes at least partially based on registration information as represented by block 874. The authentication code or codes are added to the content file or files as represented by block 876. The authentication code or codes for approved secondary devices may be added as illustrated and described in greater detail with reference to FIGS. 36 38, along with the authentication code or codes for the primary device or devices. Block 876 may also include generation of additional content files of a particular type with embedded or otherwise linked authentication codes for approved secondary devices. For example, content transferred to a primary device with a generic filename such as “song.mp3” and including a designation to provide copy protection for one or more types of secondary devices may be used to generate corresponding file types for approved secondary devices including embedded or linked authentication codes, such as song.mpx that includes embedded or linked authentication codes for use on a specific digital audio player (or all players made by SONY, or all Atrac players made by SONY, for example), song.cdx for use in a specific or generic CD player or computer, song.drm for use in a cell phone, etc. The authentication codes for approved devices may be transferred to the computer readable storage medium as represented by block 878 and described in greater detail with reference to FIGS. 36 38.

Any one or more of the authentication codes may optionally be encrypted as represented by block 880. In addition, the means, module, driver, etc. used to generate or overwrite an authentication code may optionally be locked, deleted, or otherwise disabled as represented by block 882. Optionally, a number of transfers, installations, etc. may be allowed before locking, deleting, or otherwise disabling the authentication code generation module as represented by block 884.

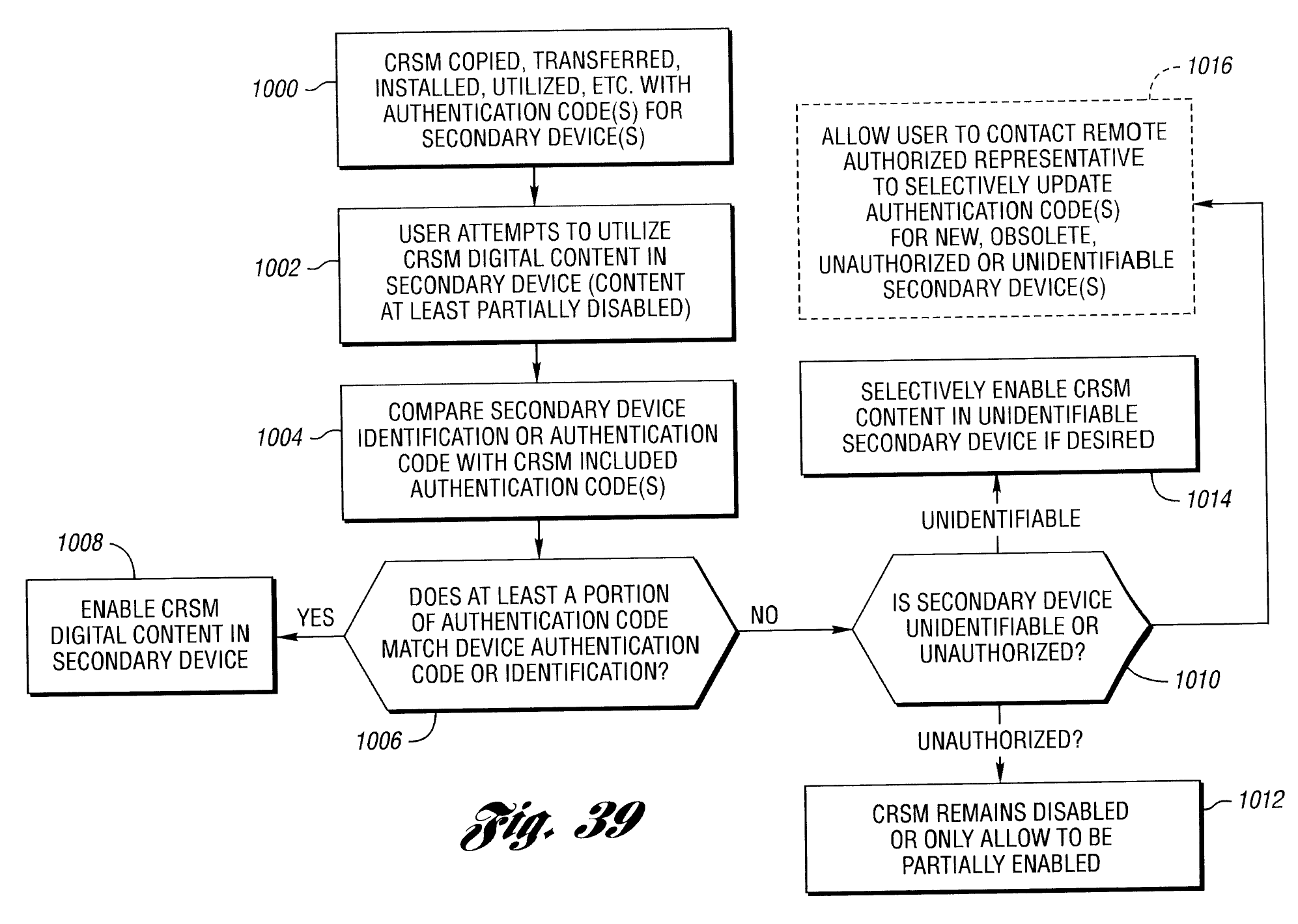

An authorized representative authenticates the user based on the authentication code or codes to provide access to the protected content as represented by block 890 and described in greater detail with reference to FIGS. 39-42. The authorized representative entity may be located on a primary device and/or one or more secondary devices depending upon the particular capabilities of the secondary devices. Depending upon the particular application, the secondary devices may require authentication for each use of the protected content as generally represented by blocks 890 and 920. Alternatively, or in combination, authentication of secondary devices may take place upon transfer of protected content from a primary device such that subsequent use on the secondary device does not require independent authentication. For example, transfer of a protected music file from a computer to a digital audio player would require authentication of the digital audio player by the computer in order to transfer the protected content. After the authorized administrator determines that the digital audio player is authorized, the protected content would be transferred to the digital audio player and could be used without additional authentication by the player itself.

The authorized representative may repeatedly authenticate the user and/or secondary devices on a periodic basis as generally represented by block 920. The authentication interval may be determined by the authorized representative, or may be initiated by expiration of an authorization interval based on time, uses, etc. As with previously described embodiments, the user or system may contact a remote server as represented by block 940 to allow for reinstallation, recovery, troubleshooting, installation in a new system, or authorization of a device that has changed its registration information. In addition, the authorized representative may exchange information with the user and/or device to add secondary use devices, update the resident authorized representative, etc.

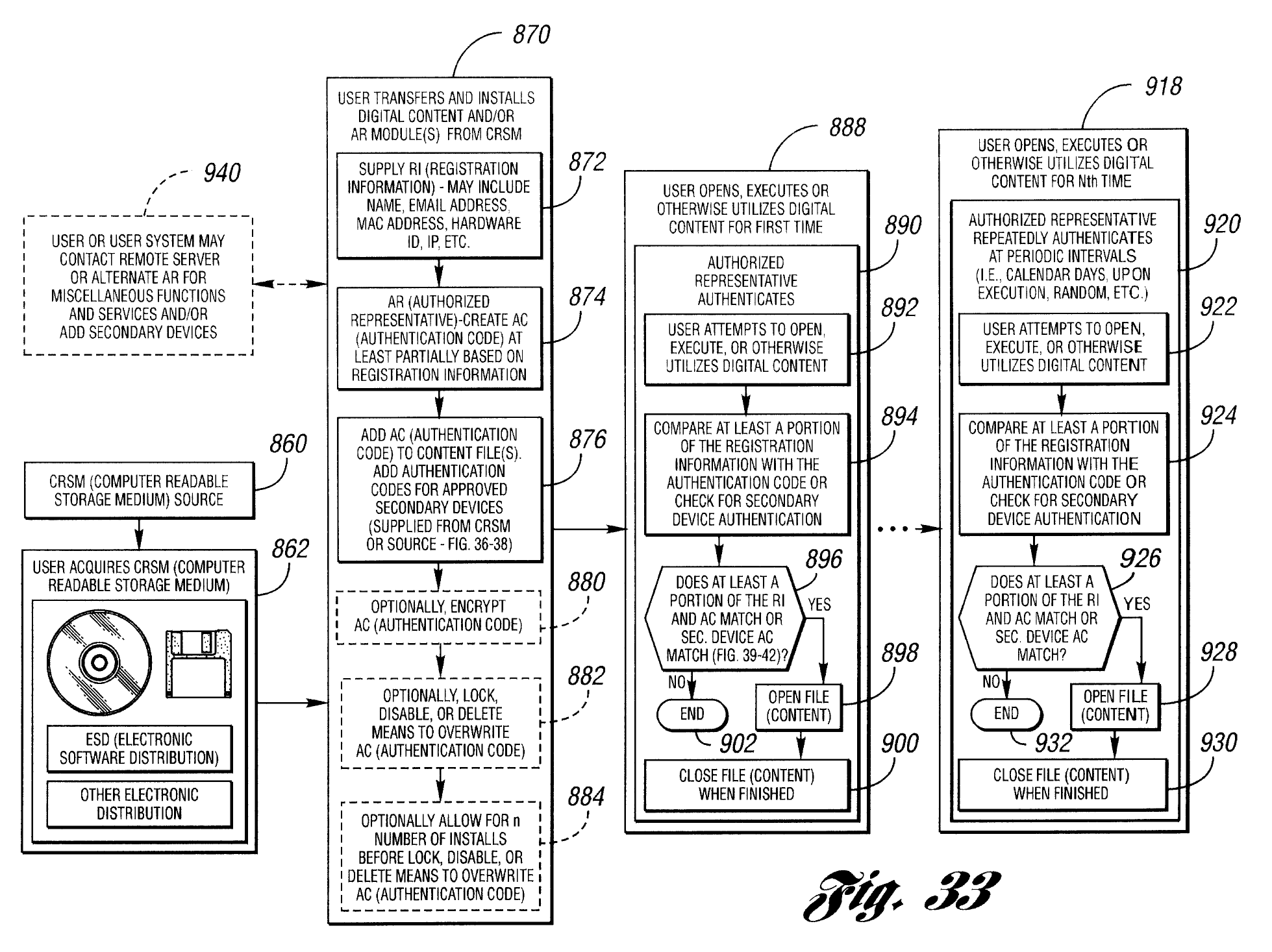

FIG. 33 illustrates an alternative embodiment for a general authentication process particularly suited for use with secondary devices according to the present invention. The user acquires protected content, or content designated for protection, from a source as represented by blocks 860 and 862. The digital content is then transferred or otherwise installed to a primary and/or secondary devices represented by block 870. The authorized representative then attempts to authenticate the user when the user opens, executes, or otherwise attempts to utilize the digital content for the first time as represented by blocks 888 and 890. The user attempts to open, execute, or otherwise utilize the digital content may be intercepted by the authorized administrator as indicated at block 892. The determination is made based on the authentication code or codes whether the user is authorized as represented by blocks 894 and 896. If the user is determined to be authorized, the access or other utilization of the content is allowed as represented by block 894 for a particular authorization interval, such as a single use, as represented by block 900. Otherwise, access or utilization of the protected content is prevented or inhibited as represented by block 902.

Subsequent access or other use of the protected content may trigger repeated authentication as generally represented by block 918. Alternatively, or in combination, subsequent authentications may be triggered by the authorized representative at periodic or random intervals, whether or not based on user actions, as represented by block 920. The repeated authentication process proceeds in a similar fashion as previously described and as represented in blocks 922, 924, 926, 928, and 930 to provide access to the protected content for authorized users, and as represented by block 932 to prevent or hinder access for unauthorized users.

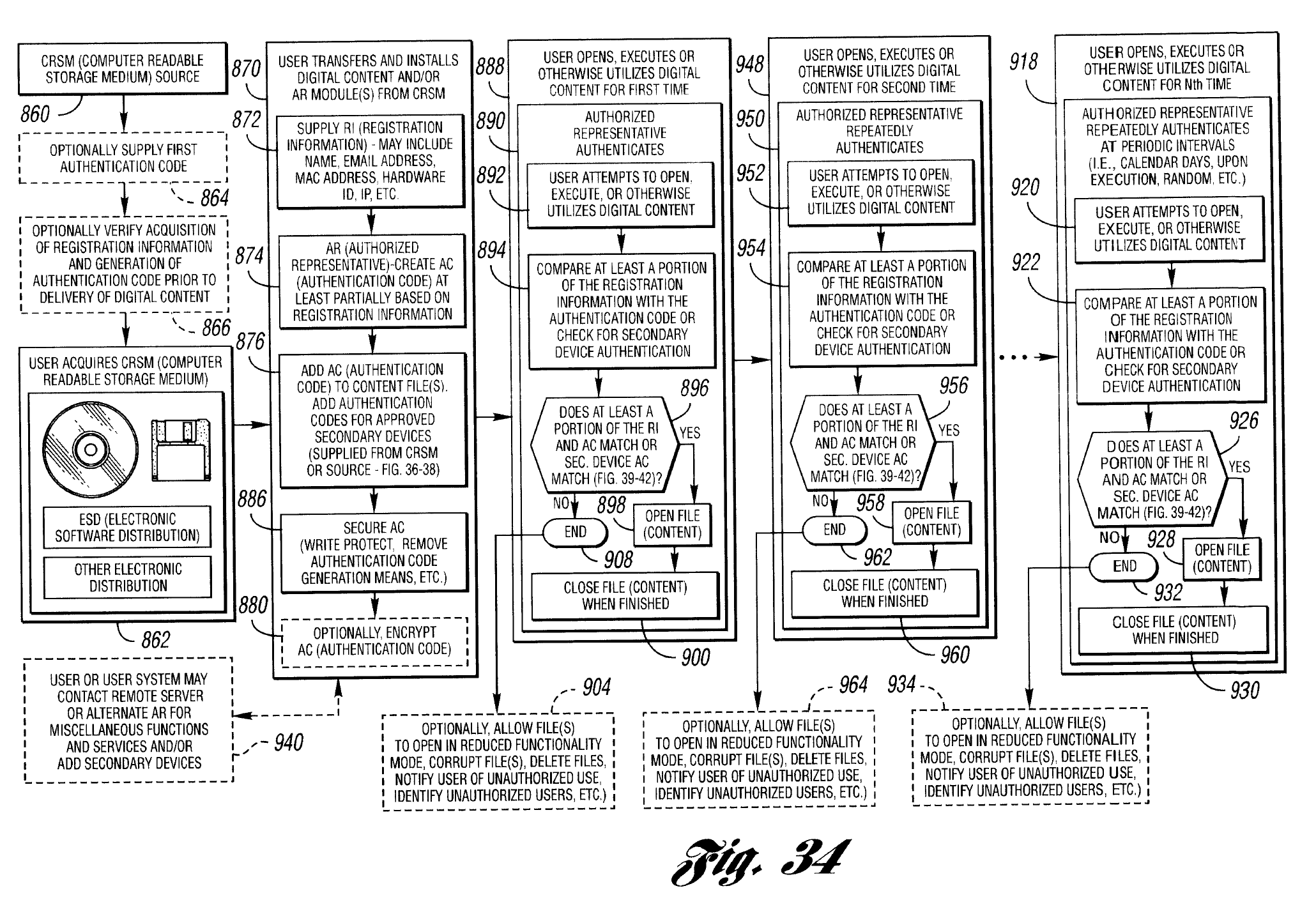

Referring now to FIG. 34, a block diagram illustrating another alternative embodiment for an authentication process with secondary use devices according to the present invention is shown. In this embodiment, the digital content source represented by block 860 may optionally supply a first password or authentication code along with the digital content as represented by block 864. As described with reference to previous embodiments, the first authentication code may be used to authorize a group of devices, may authorize any device for a first authorization interval, or may authorize a specific device or specific devices based on registration information manually or automatically obtained from a user as represented by block 866, for example. The user acquires content designated for protection via a computer readable storage medium, electronic software distribution, or other electronic distribution as represented by block 862.

Upon transfer, installation, or other access to the software as represented by block 870, additional registration information may be required as represented by block 872. The authorized representative then creates one or more original or additional authentication codes, or may modify existing authentication codes based at least in part on the registration information as represented by block 874. For example, the first authentication code may be supplied by the original content developer as represented by block 864 to authorize content for use with a particular manufacturer's devices. The first authentication code may be modified to incorporate user-specific registration information as represented by block 874. Alternatively, one or more additional authentication codes may be generated to uniquely identify a particular user's authorized device or devices as represented by block 874, for example. The added or modified authentication code or codes are linked, embedded, or otherwise associated with the content file or files as represented by block 876, and may include one or more authentication codes for approved secondary devices as illustrated and described in greater detail with reference to FIGS. 36-38.

After generation of appropriate authentication codes, and adding, linking, or otherwise associating the authentication codes with the protected content, the authentication code or codes may be secured as represented by block 886. This may include write protecting, removing, or otherwise disabling the authentication code or the module, program or other information used to generate additional authentication codes, for example. One or more of the authentication codes may also optionally be encrypted as represented by block 880.

When the user opens, executes, or otherwise utilizes the digital content for the first time as represented by block 888, an authorized representative attempts to authenticate the user as represented by block 890. The authentication process proceeds as previously described by determining whether the attempted use is authorized and providing access to the protected content if the use is authorized as represented by blocks 892, 894, 896, 898, and 900. If the attempted use cannot be verified as being authorized, various compliance actions may optionally be performed as represented by block 904. Additional actions may include allowing the file to be used in a reduced functionality mode, corrupting the file or files, deleting the files, notifying the user of the unauthorized use, and/or various steps to identify the unauthorized use and/or users, etc.

An additional authentication may be required when the user opens, executes, or otherwise attempts to utilize the digital content for the second time as represented by block 948. The authorized representative may repeatedly authenticate the user as represented by block 950 by intercepting any user attempts to open, executes, or otherwise utilize the protected digital content as represented by block 952. The authorized representative may compare at least a portion of the registration information for the current device with the corresponding information embedded or included within the authentication code associated with the protected content. This may also include gathering appropriate information for a secondary device as represented by block 954. If the attempted use is authorized as determined by block 956, access is provided to the protected content as represented by block 958 until expiration of an authorization interval, such as a single use as represented by block 960. Various compliance actions may be instituted if the attempted use is determined to be unauthorized as represented by blocks 962 and 964.

Additional authentications may also be required to provide repeated authentication as represented by block 918. This repeated authentication may be triggered by expiration of an authorization interval, or may be performed at periodic or random intervals as determined by the authorized representative. Various optional actions may be performed as represented by block 934 if a determination is made that the user, use, or device is unauthorized.

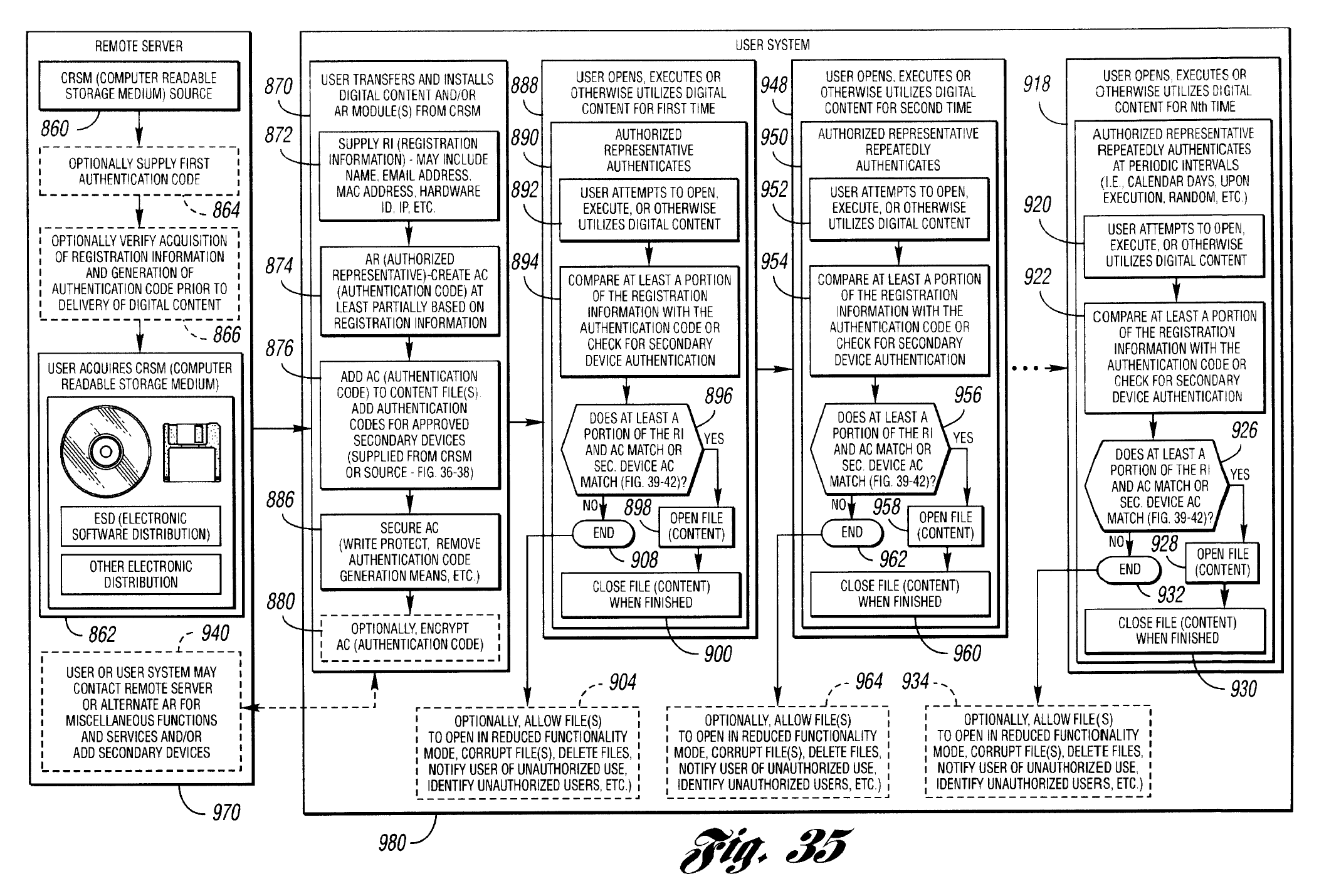

Referring now to FIG. 35, a block diagram illustrating another alternative embodiment of an authentication process having a user system resident and/or remote server resident authorized administrator according to the present invention is shown. Remote server 970 may provide a computer readable storage medium source 860 having content designated for protection. The first authentication code may be supplied with the content designated for protection as represented by block 864. Although less preferable, other activation or authentication code(s) may be required subsequent to installation of the content in this or other embodiments of the present invention. Likewise, registration information may be required prior to delivery of the digital content as represented by block 866. Remote server 970 may then provide the protected content and/or authorized representative entities for installation on a user system via computer readable storage media, or directly to a primary or secondary device by electronic software distribution or other electronic distribution as represented by block 862. Remote server 970 may also provide various recovery functions and the like as generally represented by block 940. Various installation and authentication functions as represented by blocks 870, 888, 948, and 918 are then performed on the user system, network, or device 980 by a resident authorized representative entity as previously described.

FIG. 36 is a block diagram illustrating a process for adding secondary device authentication codes to a computer readable storage medium according to one embodiment of the present invention. A computer readable storage medium 982 may contain one or more authorization or authentication codes for approved secondary devices that are subsequently transferred to the user resident authorized representative as represented by block 984. One or more of the authentication codes may be optionally encrypted as represented by block 986. Likewise, one or more authentication codes may be provided for future devices as represented by block 988. Alternatively, additional authentication codes for future devices may be provided by a remote server 990 and used to update the authentication codes associated with previously authorized content. Similarly, remote server 990 may communicate with the user system, network, or device to supply authentication codes for approved secondary devices as represented by block 984.

Depending upon the particular application, authentication codes for secondary devices may be supplied in the form of an individual authentication code for each approved secondary device as represented by block 992, individual and group authentication codes for each approved secondary device as represented by block 994, as a master authentication code for approved secondary devices as represented by block 996, or as a group authentication code for approved secondary devices by manufacturer, model, type, etc. as represented by block 998.

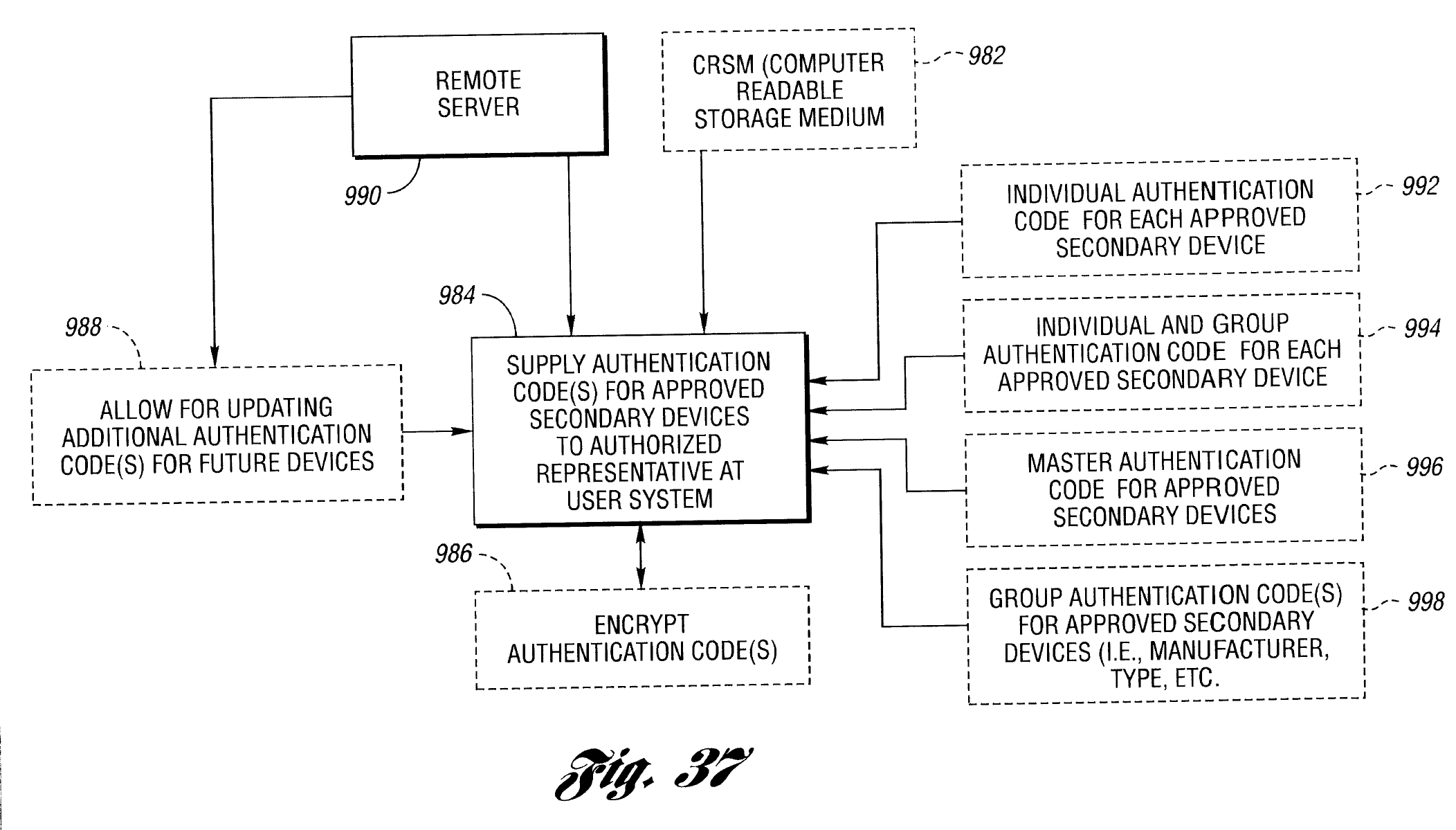

A block diagram illustrating an alternative implementation for adding secondary device authentication codes to a computer readable storage medium according to the present invention is shown in FIG. 37. In this embodiment, authentication codes for secondary approved devices are preferably provided by remote server 990 to an authorized representative within the user system, network, or device as represented by block 984. The authentication code or codes may optionally be supplied by a computer readable storage medium 982 in addition to codes supplied by the remote server, if desired. The authentication code or codes may optionally be supplied in various forms as represented by blocks 992, 994, 996, and 998, as previously described. Remote server 990 may optionally allow for updating of additional authentication codes to authorize future devices for use with previously authorized protected content as represented by block 988.

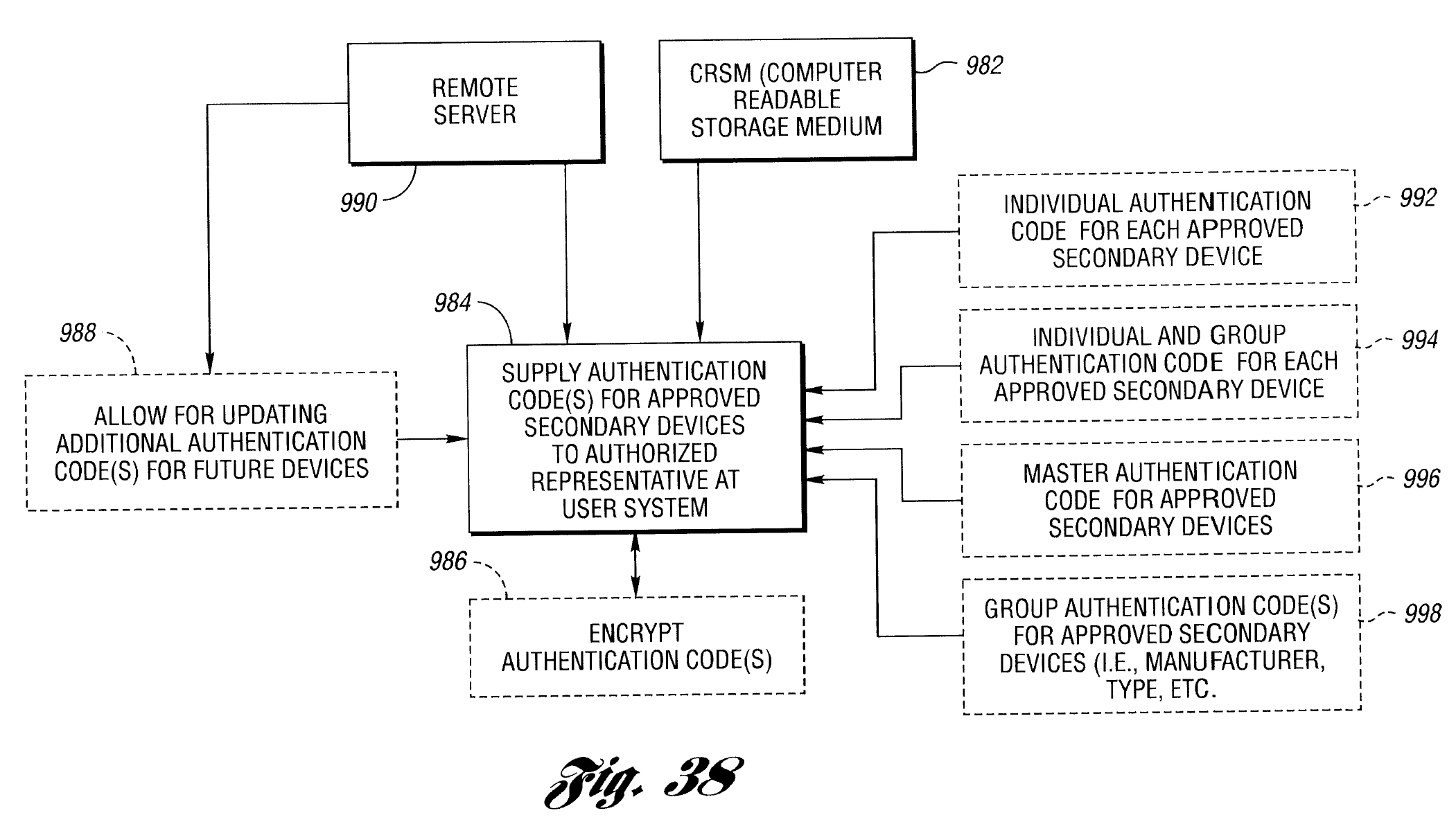

Another embodiment of a process for adding secondary device authentication codes to a computer readable storage medium according to the present invention is illustrated in the block diagram of FIG. 38. In this embodiment, authentication codes for secondary approved devices are provided to the authorized representative at the user system as represented by block 984 from both remote server 990 and computer readable storage medium 982. As with the previously described embodiments, the authentication code or codes may be optionally encrypted as represented by block 986. The authentication codes may be supplied in a variety of forms or types to authorize individual and/or groups of devices as generally represented by blocks 992, 994, 996, and 998.

A block diagram illustrating authentication of a secondary device using an authentication code for the secondary device according to one embodiment of the present invention is shown in FIG. 39. A computer readable storage medium associated with a primary device having content designated for protection with authentication codes associated with authorized secondary devices is provided as represented by block 1000. When the user attempts to utilize the protected digital content in a secondary device, the content may be at least partially disabled until completion of the authentication process as represented by block 1002. Registration information associated with the secondary device is then obtained by the authorized representative to determine whether the protected content is authorized for use with the secondary device based on the secondary device authentication codes included with the computer readable storage medium as represented by block 1004. If the secondary device is authorized to access the protected content as determined by block 1006, the secondary device is allowed to access the digital content as represented by block 1008. Otherwise, block 1010 determines whether the secondary device is unidentifiable or unauthorized. If the secondary device is determined to be unauthorized, the content remains only partially enabled, may be entirely disabled, or various other compliance actions may be performed as represented by block 1012 and previously described with reference to various other embodiments.

If the secondary device cannot be identified, the content may be selectively enabled for use in the secondary device as represented by block 1014. Whether the secondary device is unidentifiable or unauthorized, the user may be allowed to contact a remote authorized representative to update authentication codes provided to the user resident authorized representative, or to otherwise enable or disable the protected content as represented by block 1016.

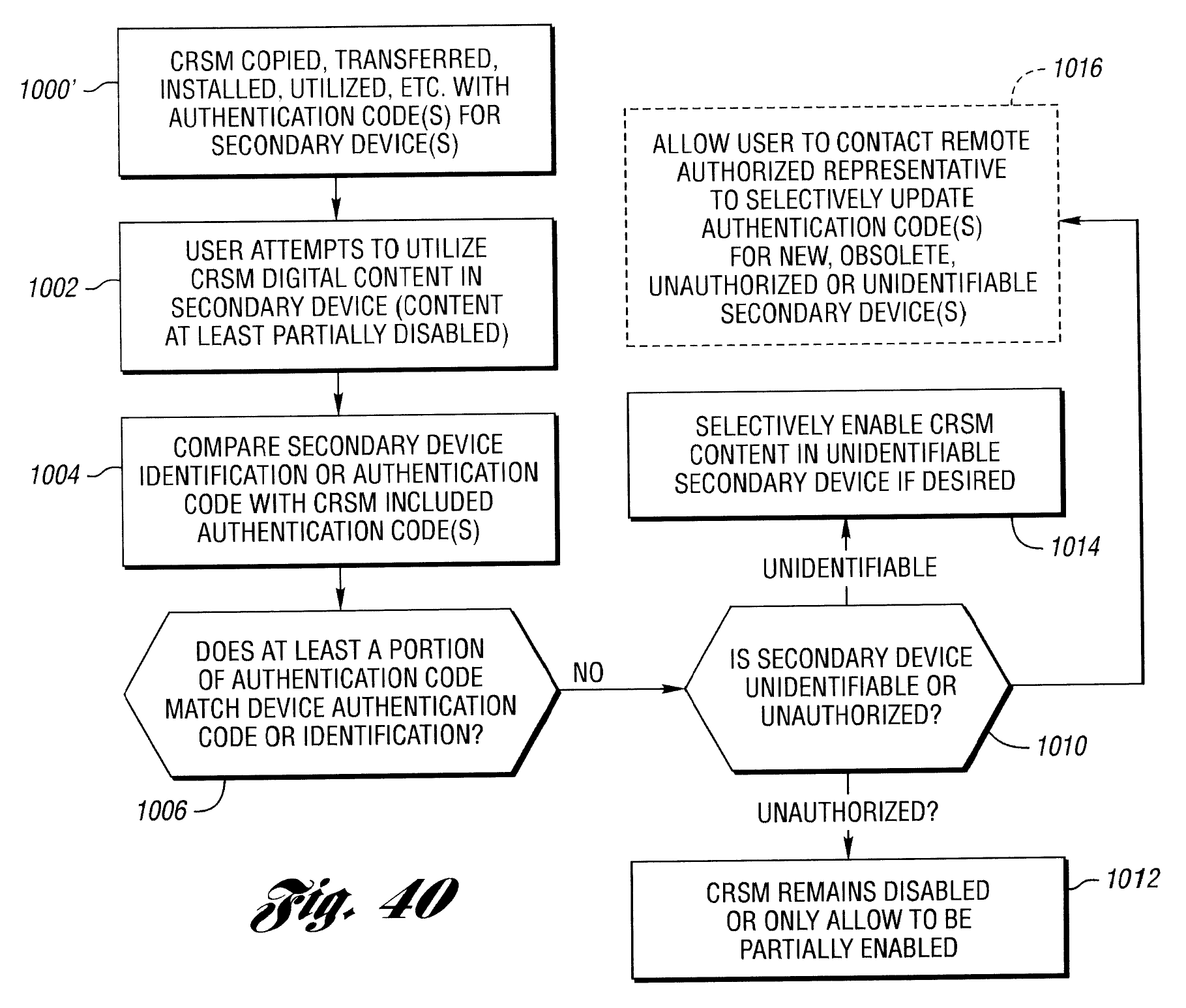

Referring now to FIG. 40, a block diagram illustrating another embodiment for authentication of secondary devices according to the present invention is shown. The embodiment of FIG. 40 would typically be used for music or video content, but may be used for other types of digital content as well. The user acquires a computer readable storage medium having protected digital content without authentication codes for secondary devices as represented by block 1000′. If the user attempts to utilize the protected digital content in a secondary device as represented by block 1002, the content may be at least partially disabled until the authentication process is completed. Identification information associated with the secondary device is obtained and compared to the authentication code or codes for the protected content as represented by block 1004 and 1006. Because the protected content does not include any authentication codes for the secondary devices, the comparison of block 1006 will indicate the device is either unidentifiable or unauthorized. If the device is unauthorized as determined by block 1010, the protected content remains disabled or may be partially enabled as represented by block 1012. If the secondary device cannot be identified, the protected content may be selectively enabled for use with the secondary device as desired as represented by block 1014. The user may optionally be allowed to contact a remote authorized representative entity to selectively update one or more authentication codes associated with the protected content for new, obsolete, unauthorized, or unidentifiable secondary devices as represented by block 1016.

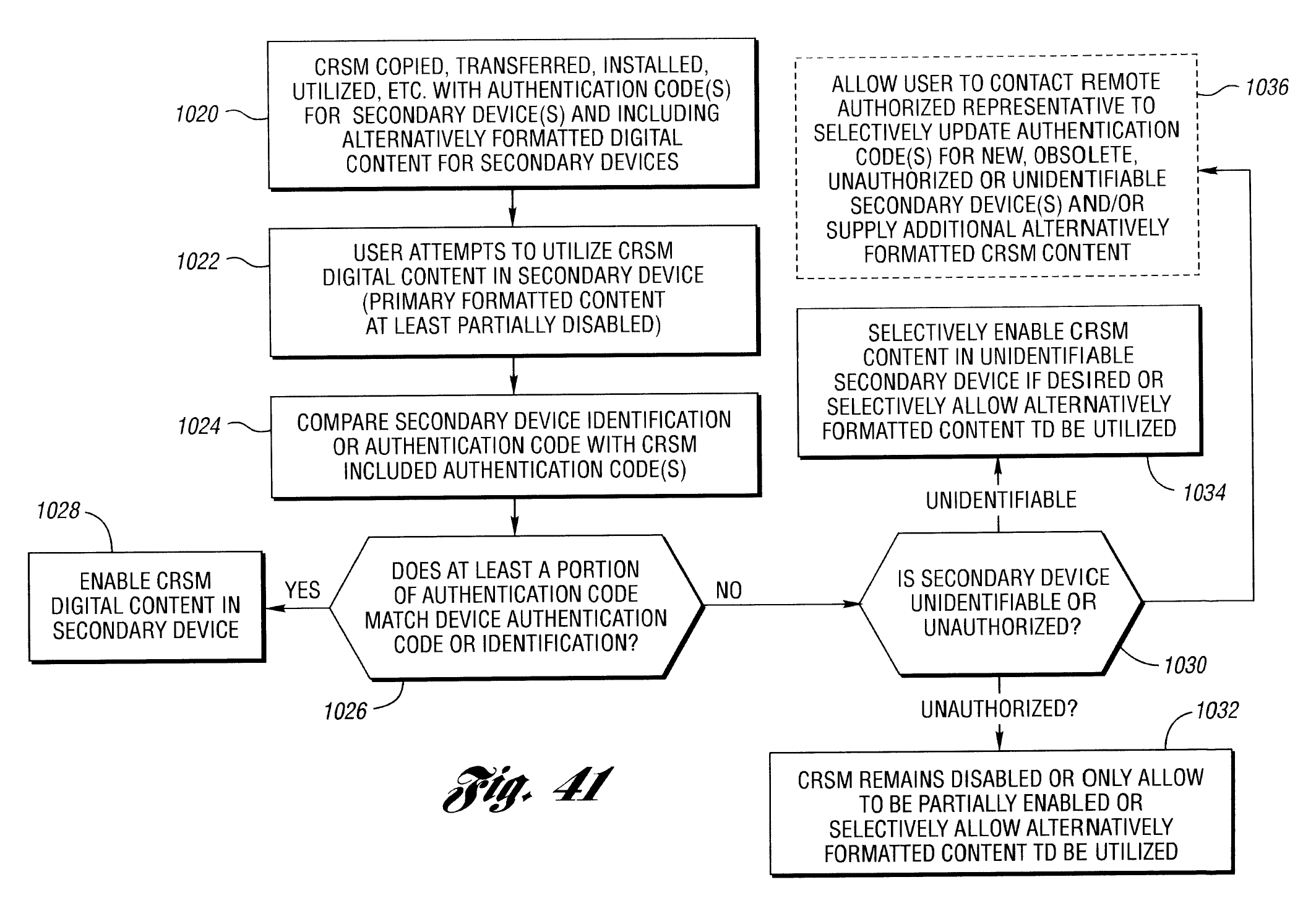

Referring now to FIG. 41, a block diagram illustrating authentication of secondary devices utilizing authentication codes for the secondary devices and alternatively formatted content according to one embodiment of the present invention is shown. The protected content having authentication codes for secondary devices and alternatively formatted content (or instructions/modules for generating alternatively formatted content) is represented generally by block 1020. When the user attempts to utilize the protected content contained within a primary file format in the secondary device, the attempt may be at least partially disabled, delayed, or prevented as represented by block 1022 to complete the authentication process. The authorized representative compares identification information associated with the secondary device to corresponding information within one or more authentication codes associated with the protected content as represented by block 1024. If the secondary device is authorized as indicated by one or more of the authentication codes at block 1026, access to the digital content in the primary format is provided for the secondary device as represented by block 1028.

If the identification information for the secondary device cannot be determined, or does not match authorized device information contained within one or more authentication codes associated with the protected content, block 1030 determines whether the secondary device can not be identified or can be identified but is unauthorized. If the secondary device is unauthorized, the protected content remains disabled or only partially enabled as represented by block 1032. At the discretion of the authorized representative, content developer, or publisher, alternatively formatted content may be provided and allowed to be accessed if the secondary device is determined to be unauthorized as also represented by block 1032. For example, an alternatively formatted content file may contain lower resolution or lower quality content for audio or video content, or may have an application program with fewer features.

If a secondary device cannot be identified by the authorized representative, the content stored in the primary format may selectively be enabled for use in the secondary device if desired as represented by block 1034. Alternatively, a content file having an alternative format may be enabled for use on the secondary device as also represented by block 1034. The alternatively formatted content may be transferred from the computer readable storage medium, or may be generated by an appropriate program, module, or the like. Instructions for generating the alternatively formatted content may be included within the authorized representative entity, or as a separate module or program associated with the protected content, for example.

If the secondary device is unidentifiable or unauthorized as determined by block 1030, the user may be allowed to contact a remote authorized representative to selectively update authentication codes for new, obsolete, unauthorized, or unidentifiable devices and/or to supply one or more alternatively formatted content files as represented by block 1036.

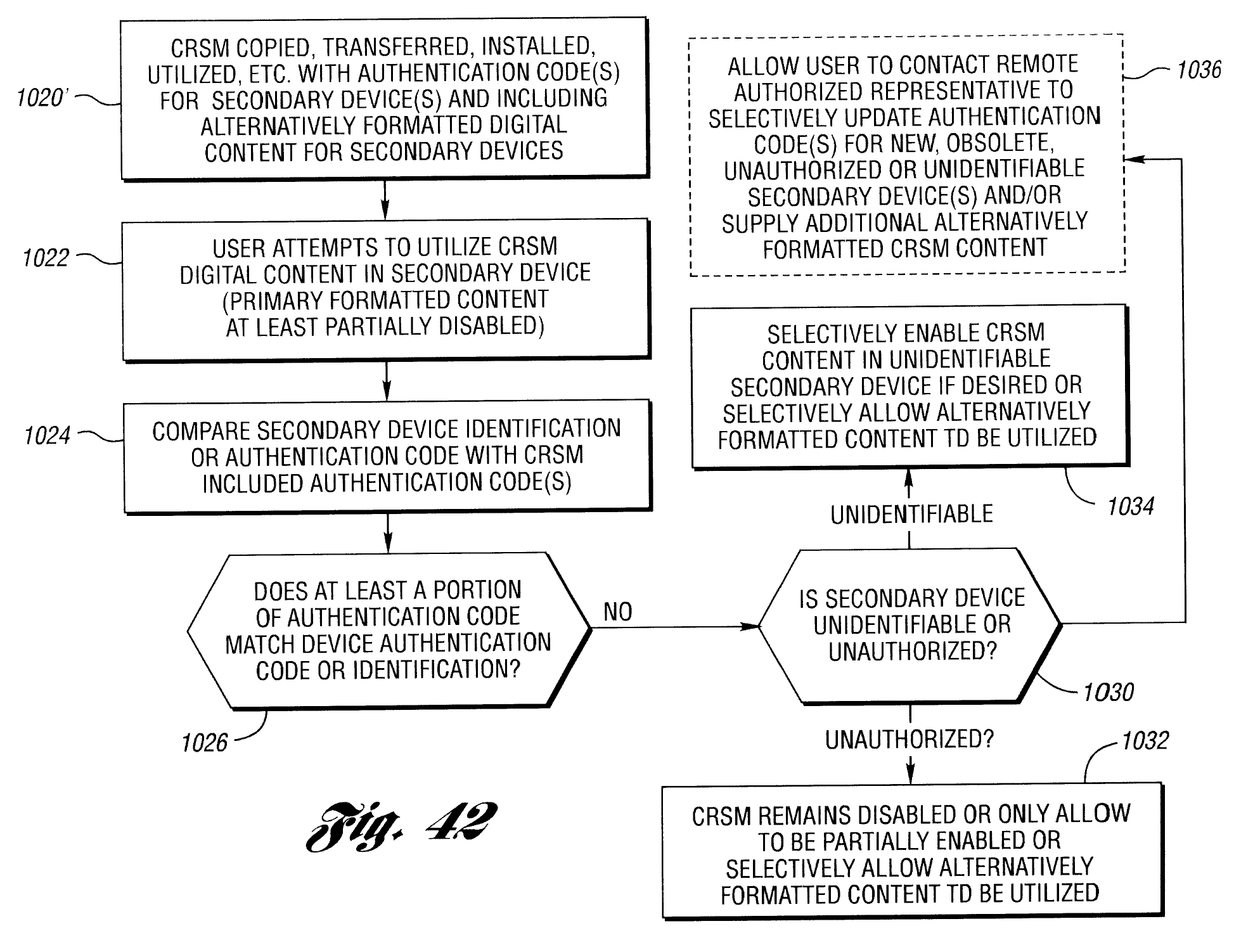

A block diagram illustrating an alternative embodiment for authentication of secondary devices without corresponding authentication codes according to the present invention is shown in FIG. 42. Similar to the embodiments of 39-41, the embodiment illustrated in FIG. 42 is particularly suited for use with music or video content but may be used with various other types of protected software. A computer readable storage medium having content designated for protection includes alternatively formatted content for use with secondary devices, but no authentication codes for the secondary devices, as represented by block 1020′. Alternatively, the computer readable storage medium may include program code or instructions to generate an alternatively formatted content file or files for use with secondary devices. For applications having a program module or other instructions to generate an alternatively formatted digital content file, the instructions may be executed within the context of a remote or user resident authorized representative, or may run independently of the authorized representative depending upon the particular application. For implementations including one or more alternatively formatted content files, the files are preferably locked, encrypted, or otherwise hidden from the user to deter user tampering or unauthorized use of the alternatively formatted files. Alternatively formatted content may be incorporated into a single content file and subsequently extracted when and if needed.

The user attempts to utilize the digital content in a secondary device as represented by block 1022. Use of the content in the primary format on the secondary device may be delayed, prevented, or partially disabled while completing the authentication process as also represented by block 1022. The secondary device identification information is obtained for comparison with authentication codes associated with the protected content on the computer readable storage medium as represented by block 1024. As described above, the protected content does not include any authentication codes for the secondary device so the authorized representative determines that the device is either unidentifiable or unauthorized as represented by block 1026 and block 1030. If the device is unauthorized, the protected content may continue to be partially or fully disabled, or alternatively formatted content may be utilized as represented by block 1032. As previously described, the alternatively formatted content may have lower resolution, fewer features, or otherwise be less desirable than the original content in the primary format. Alternatively, the alternatively formatted content may include additional features particularly suited for use on the secondary device depending upon the particular application and implementation.

If the secondary device cannot be identified by the authorized representative, the protected content in the primary format may be selectively enabled if desired or alternatively formatted content may be utilized as represented by block 1034. Again, the alternatively formatted content may have a different resolution or quality (either lower/worse or higher/better), have different features (more or less), etc. depending upon the particular application. Likewise, multiple types of alternatively formatted content may be provided with different types of content utilized depending on whether the secondary device is determined to be unauthorized or unidentifiable, for example. Alternatively formatted content may also be provided by a remote authorized representative general indicated by block 1036. The remote authorized representative may also provide additional authentication codes to authorize use of content in any one or more of the formats on a new, obsolete, or otherwise unauthorized or unidentifiable secondary device as also represented by block 1036.

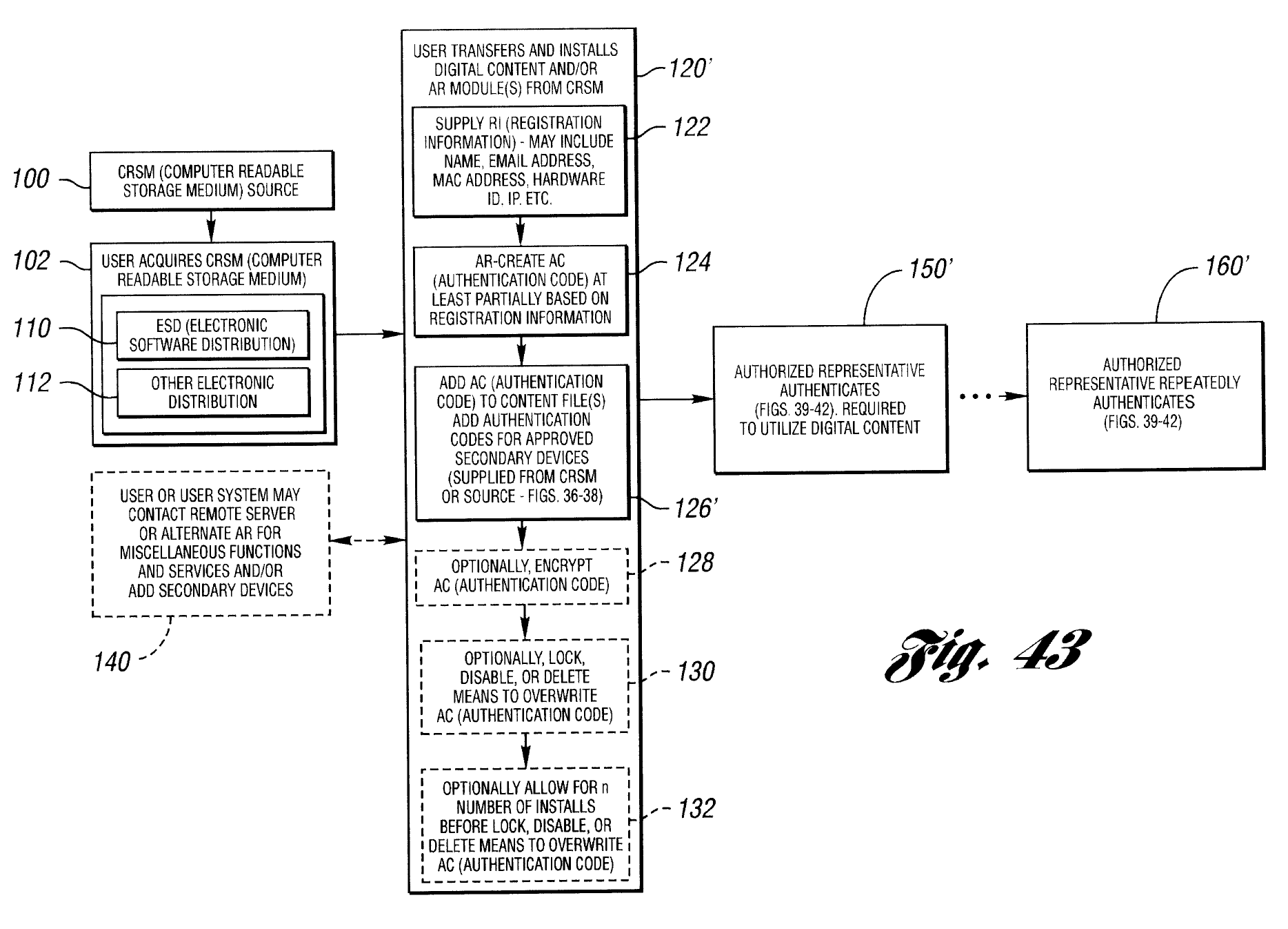

FIGS. 43 60 include block diagrams illustrating applications of general authentication processes previously described and illustrated according to the present invention particularly suited for use with secondary devices. As such, various steps or functions are similar or identical to like numbered functions illustrated and described previously and are not repeated in detail here. However, those of ordinary skill in the art will appreciate that like numbered functions or steps are not necessarily identical to those previously described and may be modified to accommodate secondary devices.

Referring now to FIG. 43, a block diagram illustrating an authentication process for electronically distributed software used on secondary devices according to one embodiment of the present invention is shown. The block diagram of FIG. 43 represents embodiments of a general authentication process for electronically distributed content as illustrated and described with reference to FIG. 5 particularly suited for use with secondary devices. The authentication process for electronically distributed content for secondary devices includes the step of adding authentication codes for the secondary devices as represented by block 126′ and illustrated and described in greater detail with reference to FIGS. 36-38. The authentication codes may be generated for approved secondary devices based on registration information obtained from secondary devices in communication with a primary device, from registration information manually provided by a user, from registration information residing on a primary device associated with one or more secondary devices (such as drivers, registry information, etc.) or directly from a secondary device.

An authorized representative attempts to authenticate the user as represented by block 150′ and described in greater detail with reference to FIGS. 39 42. The authorized representative may use any method or process to determine whether the attempted use, user, or device is authorized. Generally, the authorized representative uses registration information associated with a current device or user and one or more authentication codes previously associated with the protected content to determine whether the attempted use, user, or device is authorized. Repeated authentications may optionally be performed as represented by block 160′ and illustrated and described in greater detail with reference to FIGS. 39-42.

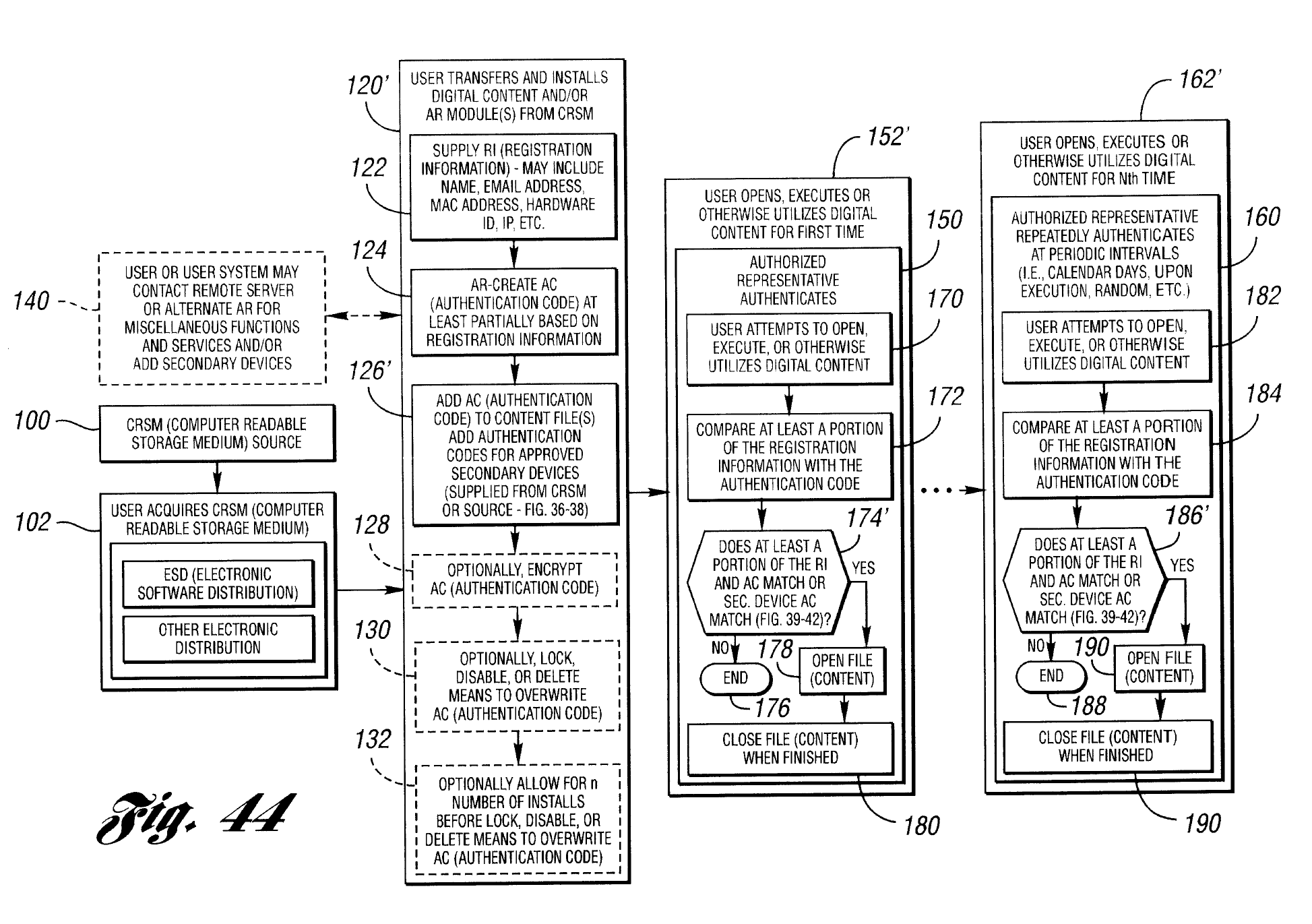

An alternative embodiment for an authentication process particularly suited for use with electronically distributed content and secondary devices is illustrated and described with reference to FIG. 44. The process of FIG. 44 is similar to the general authentication process illustrated and described with reference to FIG. 6, but includes various steps or functions adapted for use with secondary devices. In particular, when the user transfers and installs digital content from a computer readable storage medium as represented by block 120′, additional authentication codes for approved secondary devices may be generated by the authorized representative and/or supplied from the computer readable storage medium source as represented by block 126′. Representative methods for adding authentication codes corresponding to approved secondary devices are illustrated and described with reference to FIGS. 36-38, for example.

The authorized representative also attempts to authenticate the user when the user attempts to perform various triggering actions as represented by block 152′. User actions may be performed on a primary device associated with a secondary device, or on a secondary device. For example, the user may attempt to transfer protected content from a primary device, such as a computer, to a secondary device, such as a digital audio player. Depending upon the particular implementation of the authorized representative entity, authentication may take place on the computer prior to transfer of protected content to the digital audio player. Alternatively, or in combination, authentication represented by block 152′ may take place on the digital audio player. The authentication is preferably based on registration information associated with a secondary device and one or more authentication codes associated with the protected content as generally represented by block 174′. Exemplary embodiments for authentication of the secondary device are illustrated and described in greater detail with reference to FIGS. 39-42. However, any method may be used to determine whether the attempted use, user, or device is authorized.

The authorized representative may require repeated authentications as generally represented by block 162′. Repeated authentications may be triggered by user actions and/or based upon expiration of an authorization interval and/or at periodic intervals determined by the authorized representative. Repeated authorization or authentication proceeds in a similar fashion as previously described and may occur on a primary device and/or secondary device as generally represented by block 186′.

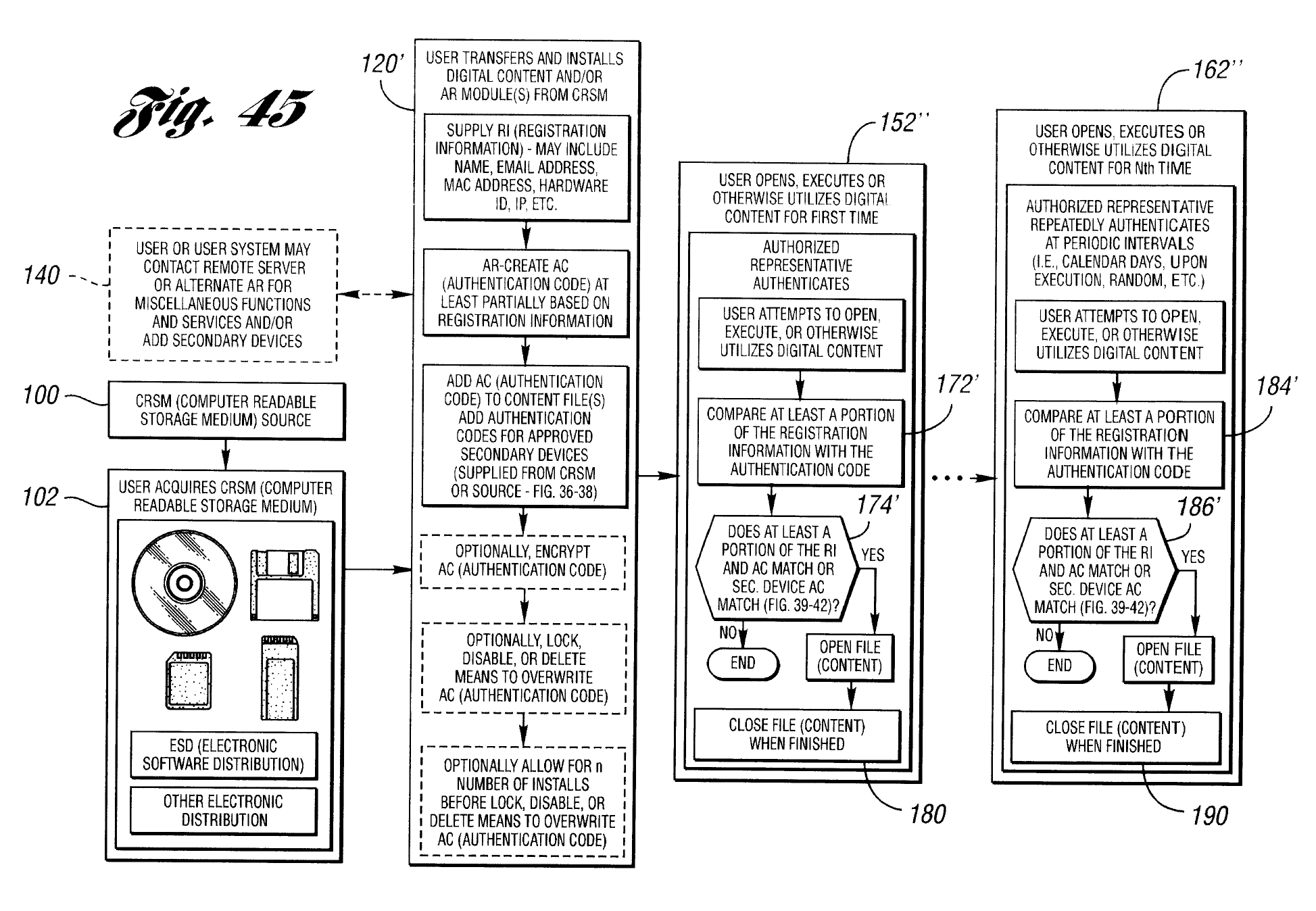

FIG. 45 is a block diagram illustrating another embodiment for an authentication process particularly suited for electronically distributed software and secondary devices according to the present invention. Similar to the previously described embodiments, one or more authentication codes may be added to content designated for protection during transfer and installation of the content from a computer readable storage medium as represented by block 120′. The authentication codes may be stored on the computer readable storage medium and/or a primary device, such as a computer, and/or a secondary device such as a PDA, for example. Block 152″ represents the authentication process performed by an authorized representative when the user opens, executes, or otherwise attempts to utilize the digital content either on the primary device or secondary device for the first time. The authorized representative may determine whether the attempted use on a secondary device is authorized by comparing at least a portion of the registration information associated with the secondary device to the authentication code or codes associated with the protected content as represented by block 172′. If at least a portion of the registration information matches corresponding registration information encoded within the authentication code or codes as represented by block 174′, access or other use of the protected content may be provided as illustrated and described with reference to FIGS. 39-42, for example.

For digital content that requires repeated authorization as determined by the content developer, distributor, or publisher, block 162″ represents various functions performed by the authorized representative based on user actions and/or an authorization interval. In particular, block 162″ may include comparison of at least a portion of registration information associated with a particular secondary device with corresponding authorized devices as indicated by one or more authentication codes associated with the protected content as represented by block 184′ and block 186′. Access to or use of the protected content is then provided for authorized users while being inhibited or prevented for unauthorized users as previously described.

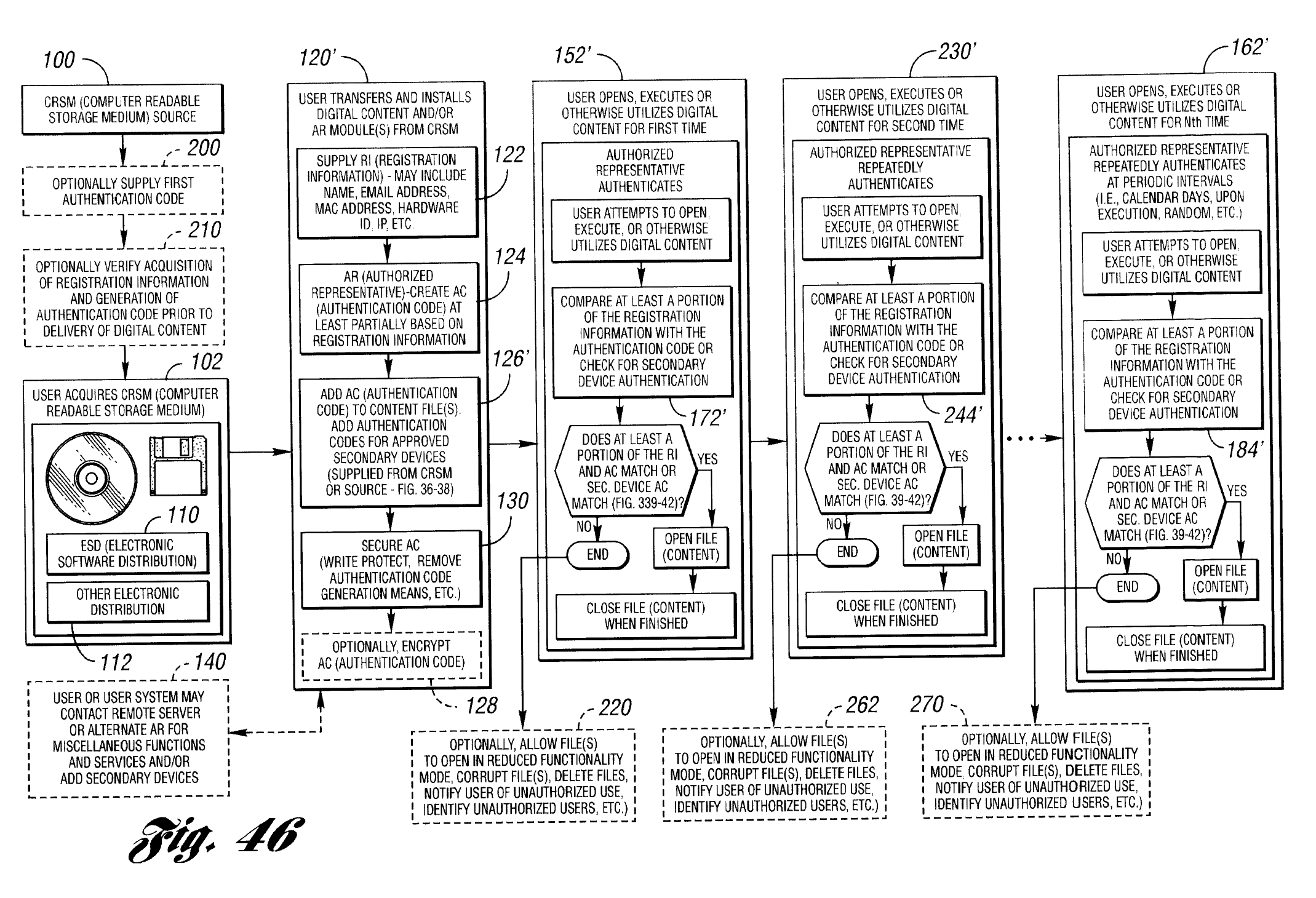

Another embodiment for an authentication process according to the present invention particularly suited for use with secondary devices is illustrated in the block diagram of FIG. 46. The process of FIG. 46 illustrates one application of the general authentication process illustrated and described with reference to FIG. 7. The process may include adding authentication codes for approved secondary devices when the user transfers, installs, or otherwise accesses digital content designated for protection from a computer readable storage medium as represented by blocks 120′ and 126′. The authentication process includes authentication by an authorized representative when the user attempts to utilize the content for the first time as represented by block 152′, for the second time as represented by block 230′, and for the nth time as represented by block 162′. The authentications may include determining whether the use on a primary and/or associated secondary device is authorized as represented by blocks 172′, 244′, and 184′, respectively.

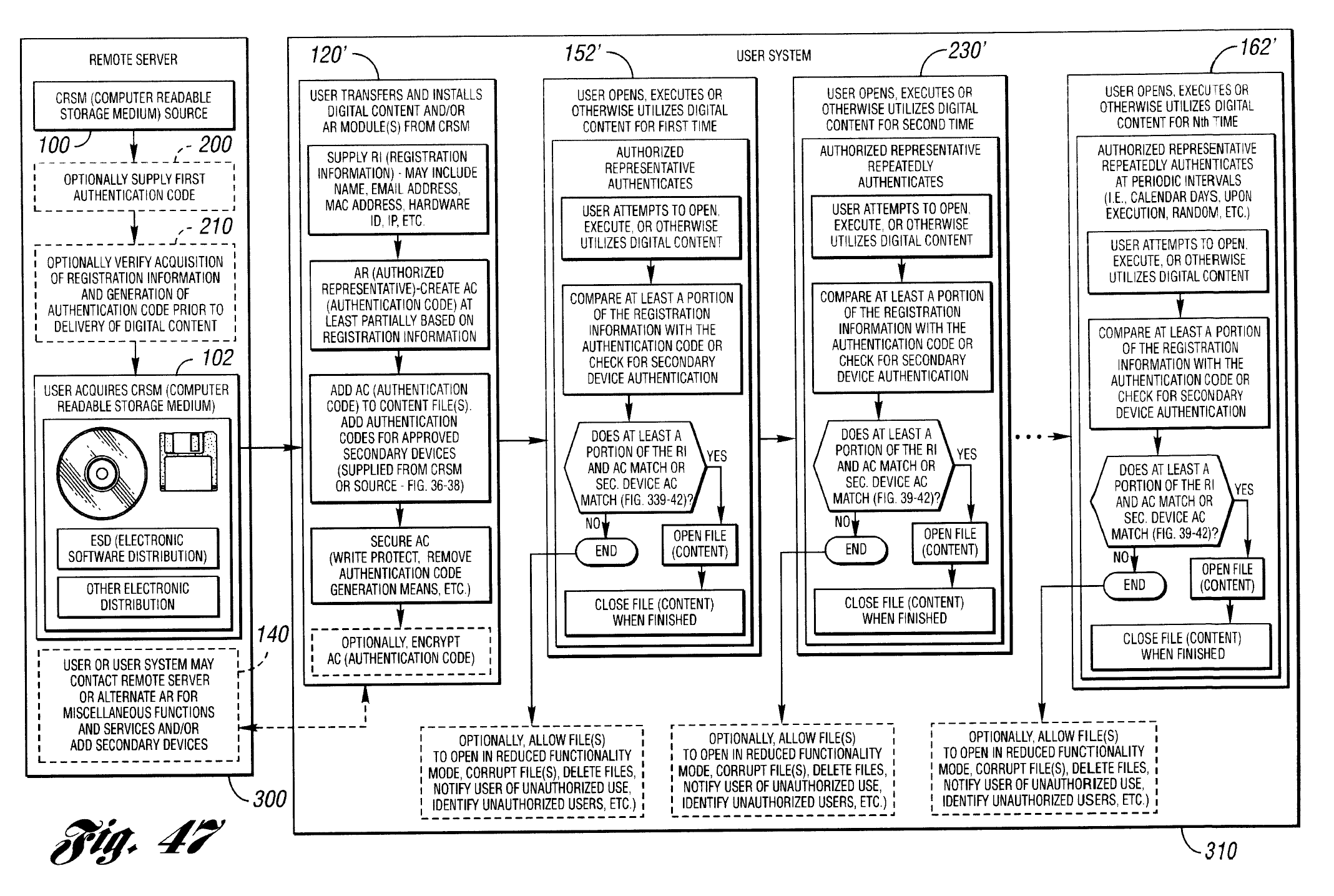

FIG. 47 is a block diagram illustrating one embodiment for an authentication process particularly suited for use with electronically distributed content for secondary devices according to the present invention. The authentication process of FIG. 47 includes various modifications of the general authentication process illustrated and described with reference to FIG. 8. Various authorized representative functions are performed on a remote server 300 with other functions performed on user system, device, or network 310. Installation or other transfer of content designated for protection to a primary or secondary device may include one or more authentication codes for secondary devices as represented by block 120′. The user system resident authorized representative authenticates the use, user, and/or device, which may include one or more secondary devices, as generally represented by blocks 152′, 230′, and 162′ to allow or prevent access to the content designated for protection.

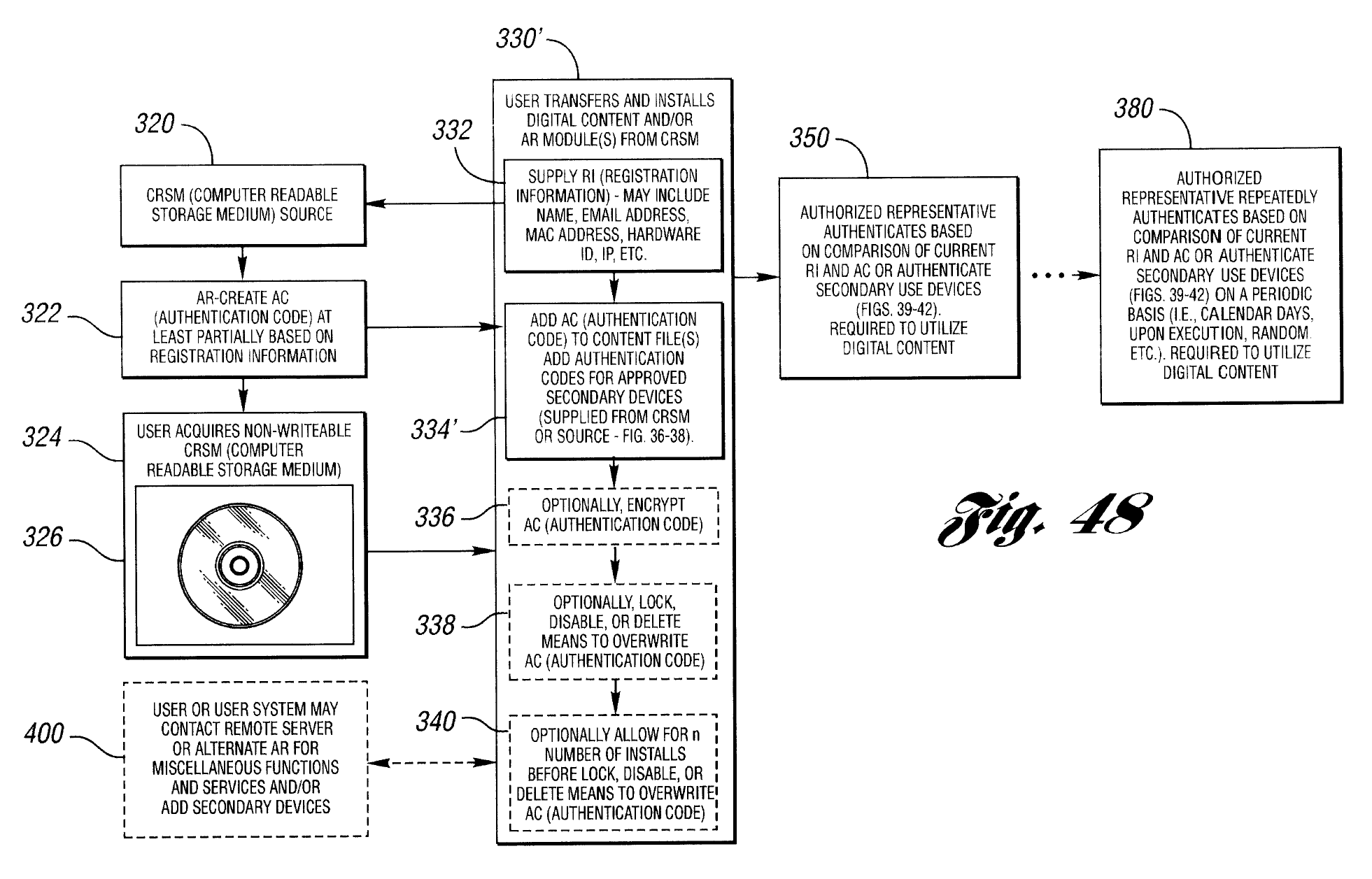

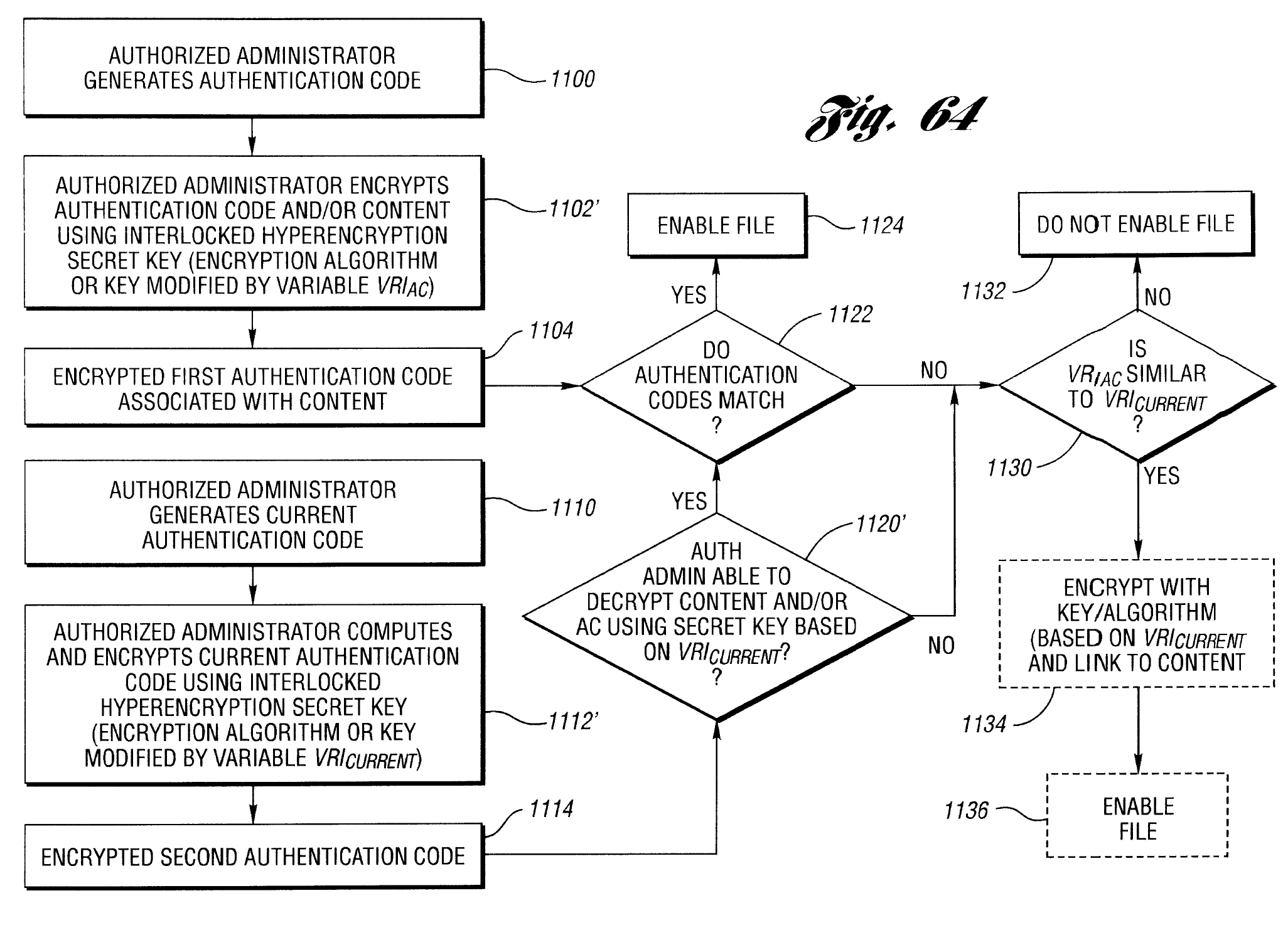

A block diagram illustrating an authentication process for use with content transferred from non-writable computer readable storage media for use with secondary devices according to the present invention is shown in FIG. 48. The authentication process of FIG. 48 includes various functions particularly suited for use with secondary devices, but otherwise is similar to the general authentication process described and illustrated with reference to FIG. 9. For example, when the user transfers, installs, or otherwise attempts to utilize digital content previously designated for protection as represented by block 330′, one or more authentication codes may be generated and added to the protected content to authorize use for one or more secondary devices as represented by block 334 and described in greater detail with reference to FIGS. 36-38. As with any of the previously described embodiments, authentication code and/or associated content may be encrypted to prevent user tampering with exemplary encryption/decryption processes illustrated and described with reference to FIGS. 64-68. The authorized representative authenticates the user based on current registration information and corresponding registration information contained within the authentication code or codes as represented by block 350′ with exemplary embodiments for authenticating use of content designated for protection on secondary devices described in greater detail with reference to FIGS. 39-42. Repeated authentication may optionally be required as represented by block 380′.

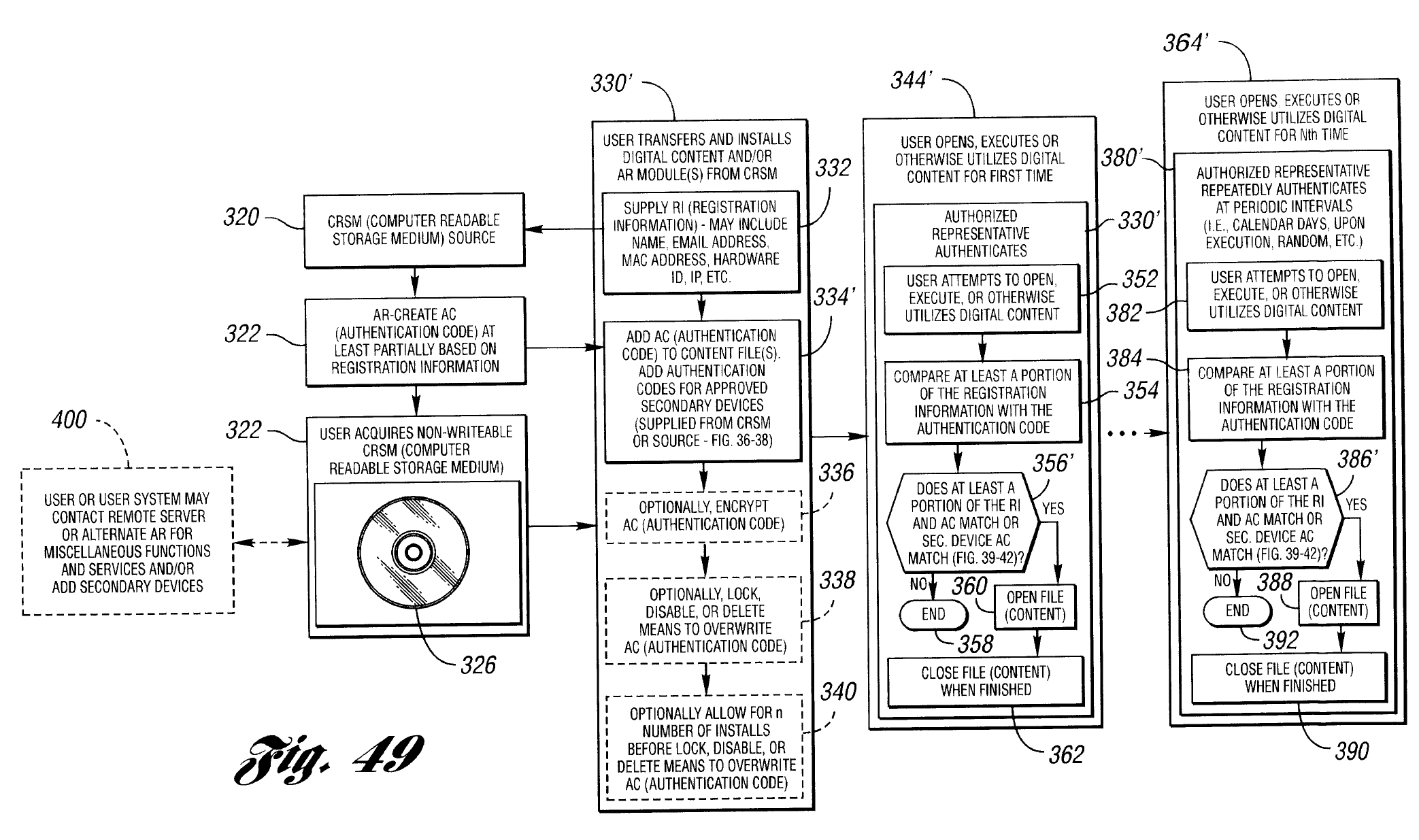

An authentication process for use with content transferred from non-writable computer readable storage media for use with secondary devices according to one embodiment of the present invention is shown in the block diagram of FIG. 49. The authentication process of FIG. 49 is adapted from the general authentication process illustrated and described with reference to FIG. 10. In particular, when the user transfers, installs, or otherwise uses content designated for protection as represented by block 330′, one or more authentication codes for approved secondary devices may be added as represented by block 334′, or one or more encrypted content files may be generated corresponding to each approved secondary device, for example. Depending upon the particular application, the authentication codes for approved secondary devices may be stored on a primary device and/or a secondary device and may be associated with the original format of the protected content or alternatively formatted content as previously described.

The authorized representative authenticates the user as represented by block 330′ when the user attempts to open, execute, or otherwise utilize the content designated for protection as represented by block 344′. The authentication may include a determination of whether registration information associated with a secondary device matches at least a portion of the corresponding information encoded within the authorization or authentication codes as represented by block 356′ and described in greater detail with reference to FIGS. 39 42. The authorized representative(s) may be located on a primary device, a secondary device, and/or remotely located depending upon the particular application. Repeated authorizations may be required based on user actions as generally represented by block 364′ and/or based on expiration of an authorization interval or other authentication interval as determined by the authorized representative as represented by block 380′. Determining whether the attempted use is authorized for a corresponding secondary device may proceed as described with reference to FIGS. 39-42 and generally represented by block 386′.

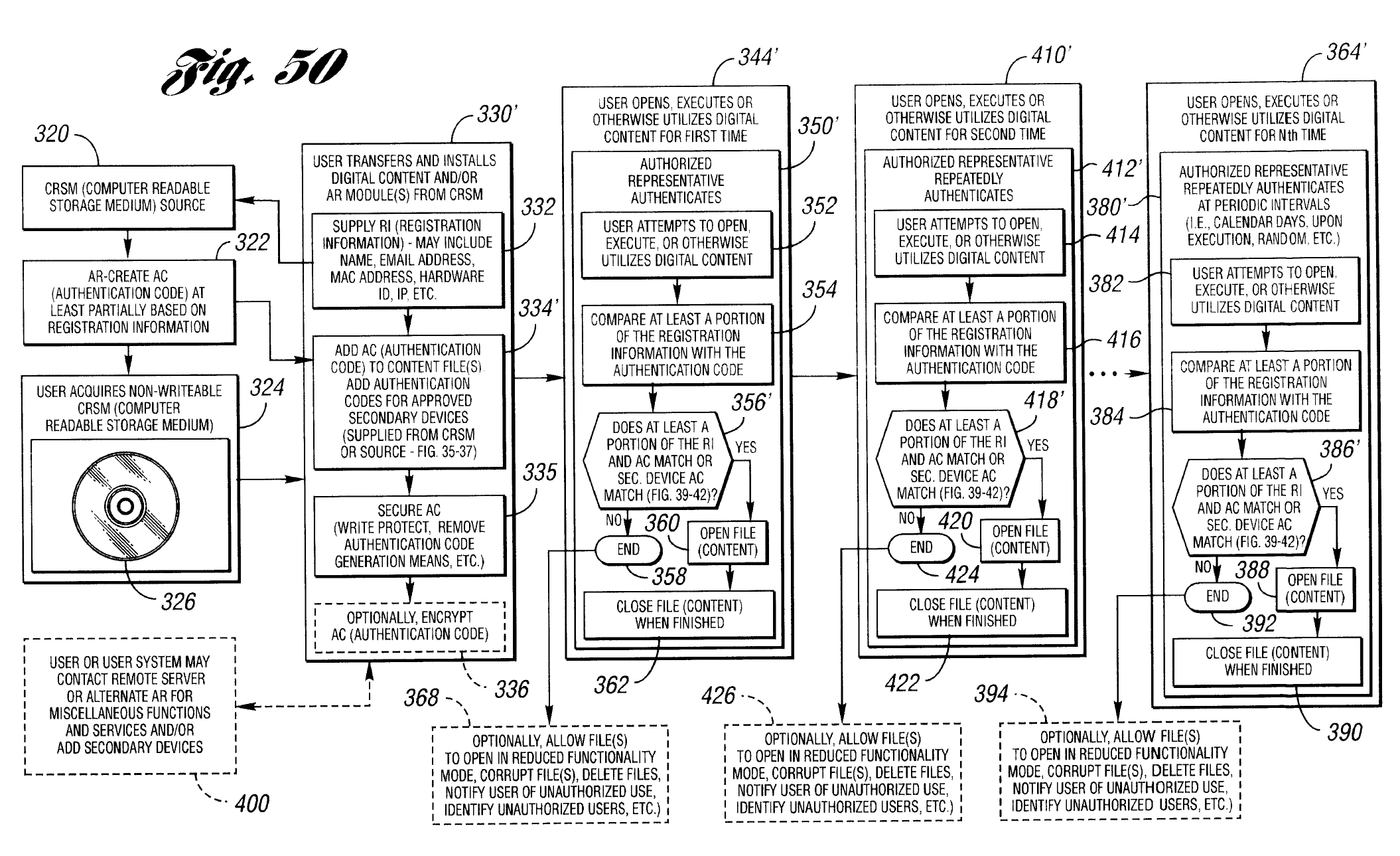

Referring now to FIG. 50, a block diagram illustrating another embodiment of an authentication process for use with non-writable computer readable storage media and secondary use devices according to the present invention is shown. The embodiment of FIG. 50 is similar to the general authentication process illustrated and described with reference to FIG. 11 with representative modifications made to illustrate the process as used with secondary devices. In particular, additional registration information may be obtained from the user or automatically from the primary and/or secondary device to generate corresponding authentication codes, encryption keys, or encryption algorithms for approved secondary devices as represented by block 330′ and block 334′. The authentication by an authorized representative entity may be performed when the user attempts to open, execute, or otherwise utilize the digital content on a primary and/or secondary device as represented by blocks 344′ and 350′. The authorized representative may repeatedly authenticate the user when the user opens, executes, or otherwise utilizes content designated for protection the second time as represented by blocks 410′ and 412′. Subsequent authentications may also be performed as generally represented by block 364′ based on user actions and/or at periodic intervals as represented by block 380′.

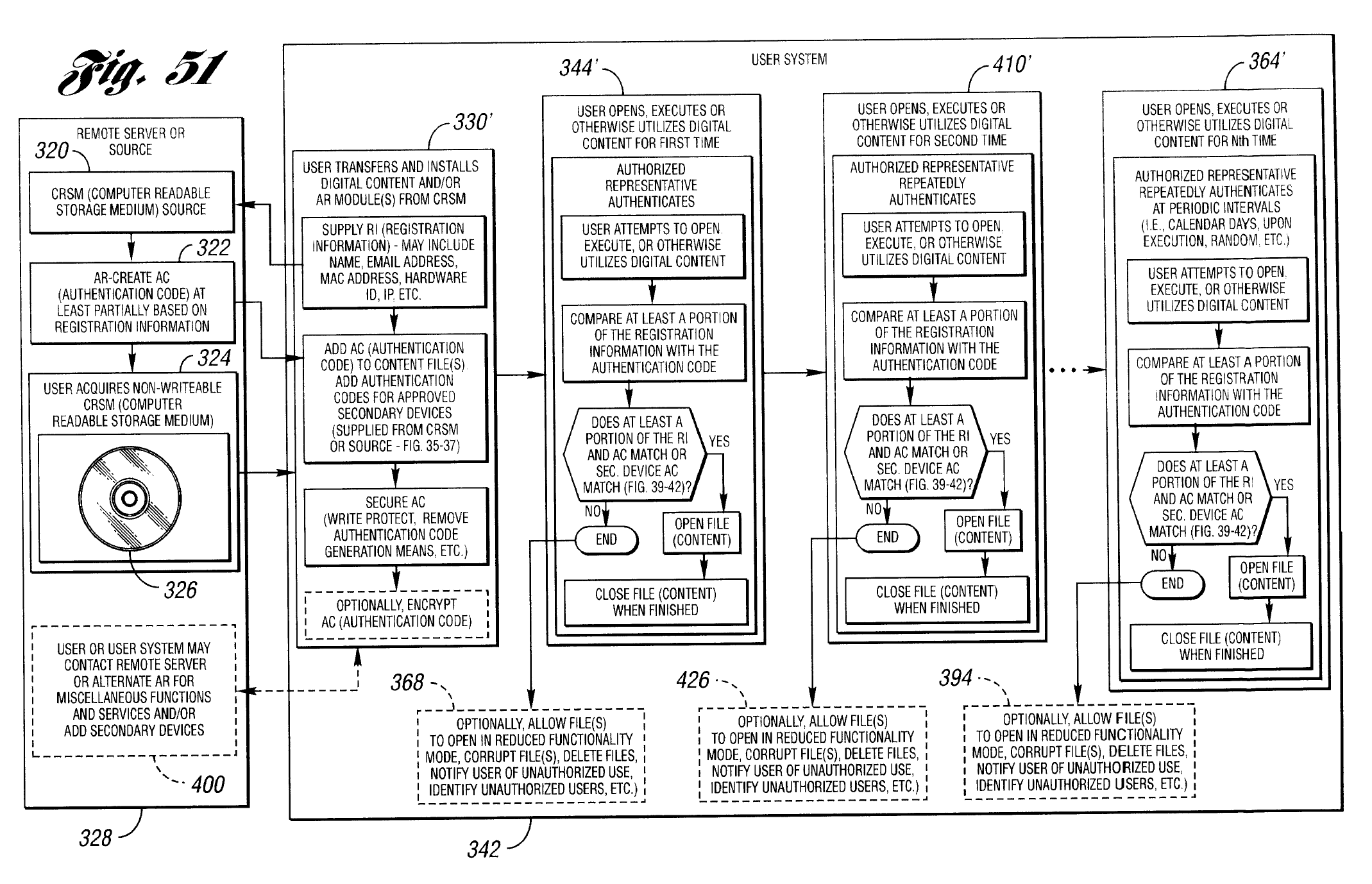

Another embodiment of an authentication process for use with content designated for protection stored on non-writable computer readable storage media for use with secondary devices is illustrated in the block diagram of FIG. 51. The process of FIG. 51 is similar to the general authentication process illustrated and described with reference to FIG. 12 with various functions or steps described with reference to secondary devices. As shown in FIG. 51, a remote server or source 28 may perform some authorized representative functions. However, user system, network, or device 342 preferably performs the majority of authorized representative functions upon transfer of the content designated for protection from the non-writable computer readable storage media as represented by block 330′, including authentication when the user accesses the protected content for the first time as represented by block 344′, the second time as represented by block 410′, and for the nth time as represented by block 364′.

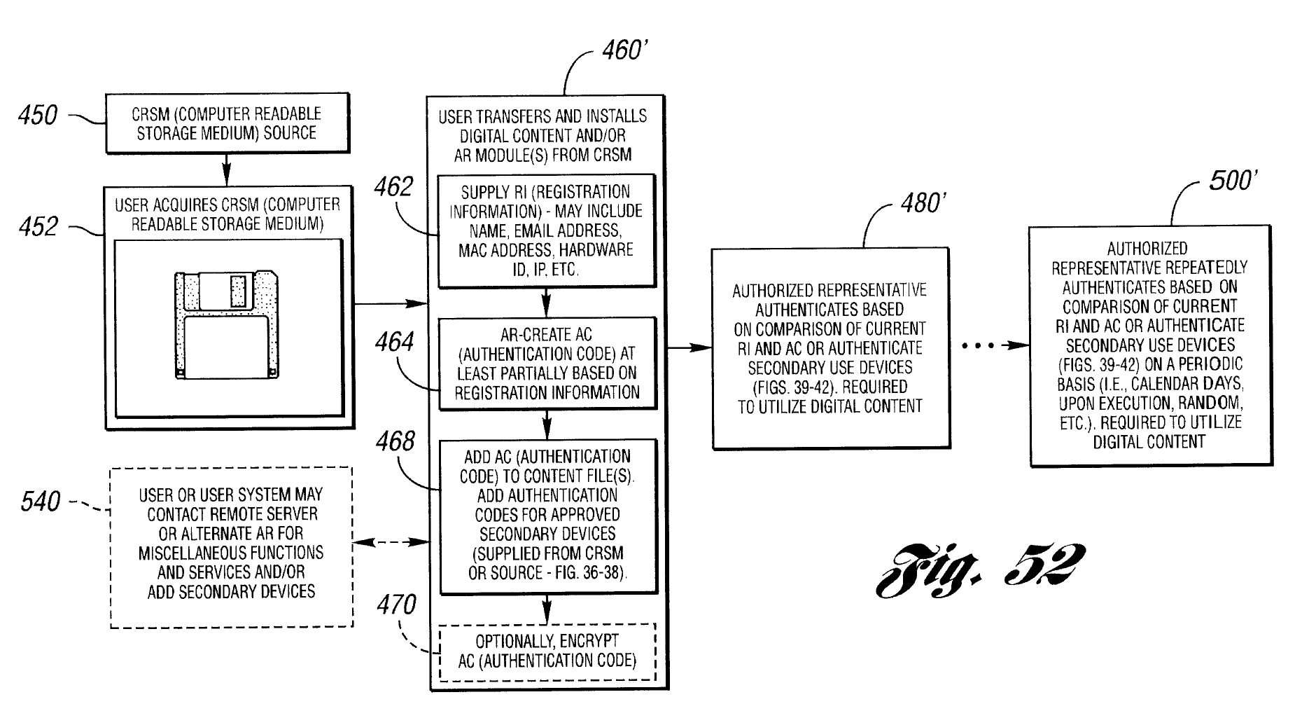

FIG. 52 illustrates an authentication process for writable computer readable storage media and secondary devices according to one embodiment of the present invention. The authentication process of FIG. 52 illustrates one implementation of the general authentication process illustrated and described with reference to FIG. 13 including specific steps to authenticate a secondary device. In particular, when the user transfers, installs, or otherwise accesses digital content designated for protection from the computer readable storage medium, one or more authentication codes may be created for approved secondary devices as represented by blocks 460′ and 468′. Examples illustrating the generation of authentication codes for secondary devices are described with reference to FIGS. 36-38.

The authorized representative authenticates the user based on identification information associated with the secondary device and one or more authentication codes associated with the content designated for protection as represented by block 480′. Exemplary embodiments of authentication of secondary devices are illustrated and described with reference to FIGS. 39-42. The authorized representative may require repeated authentication of the user based on comparison of current registration information and authentication codes associated with secondary use devices as represented by block 500′.

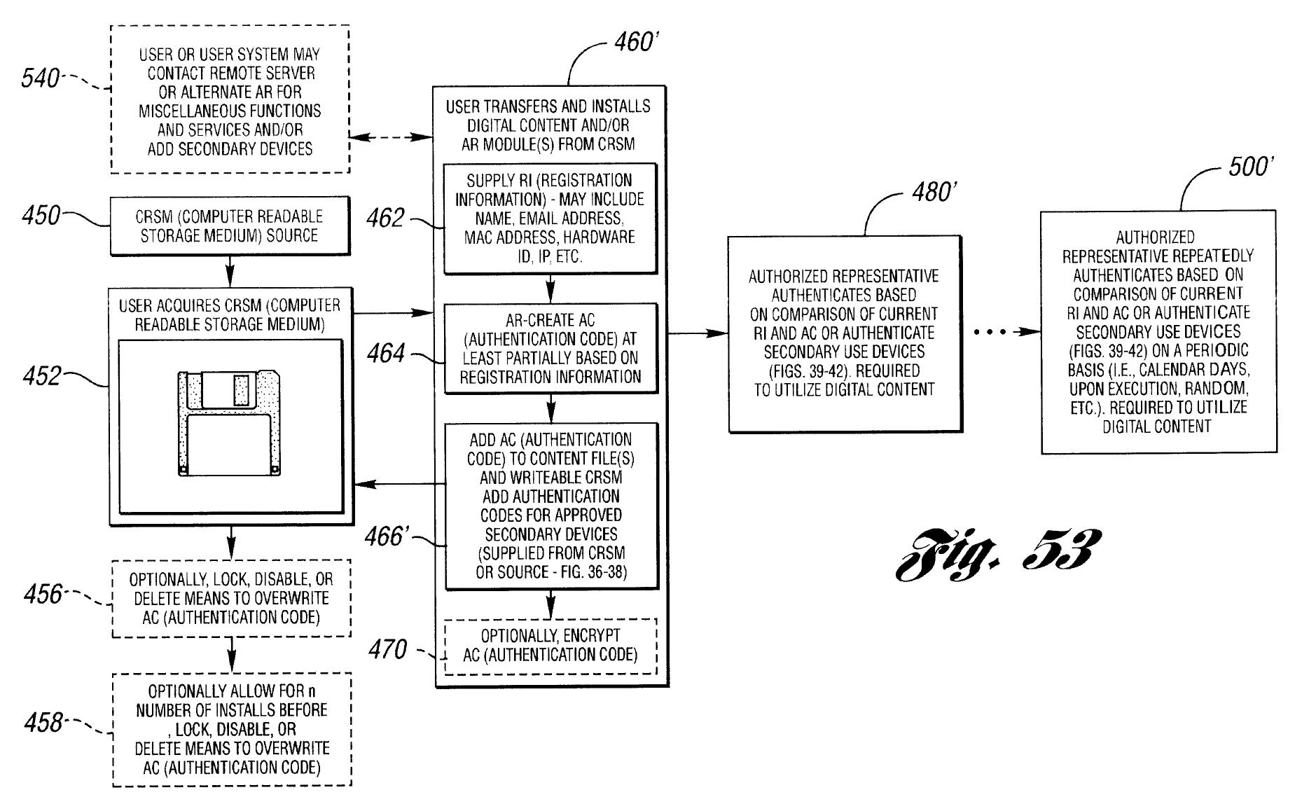

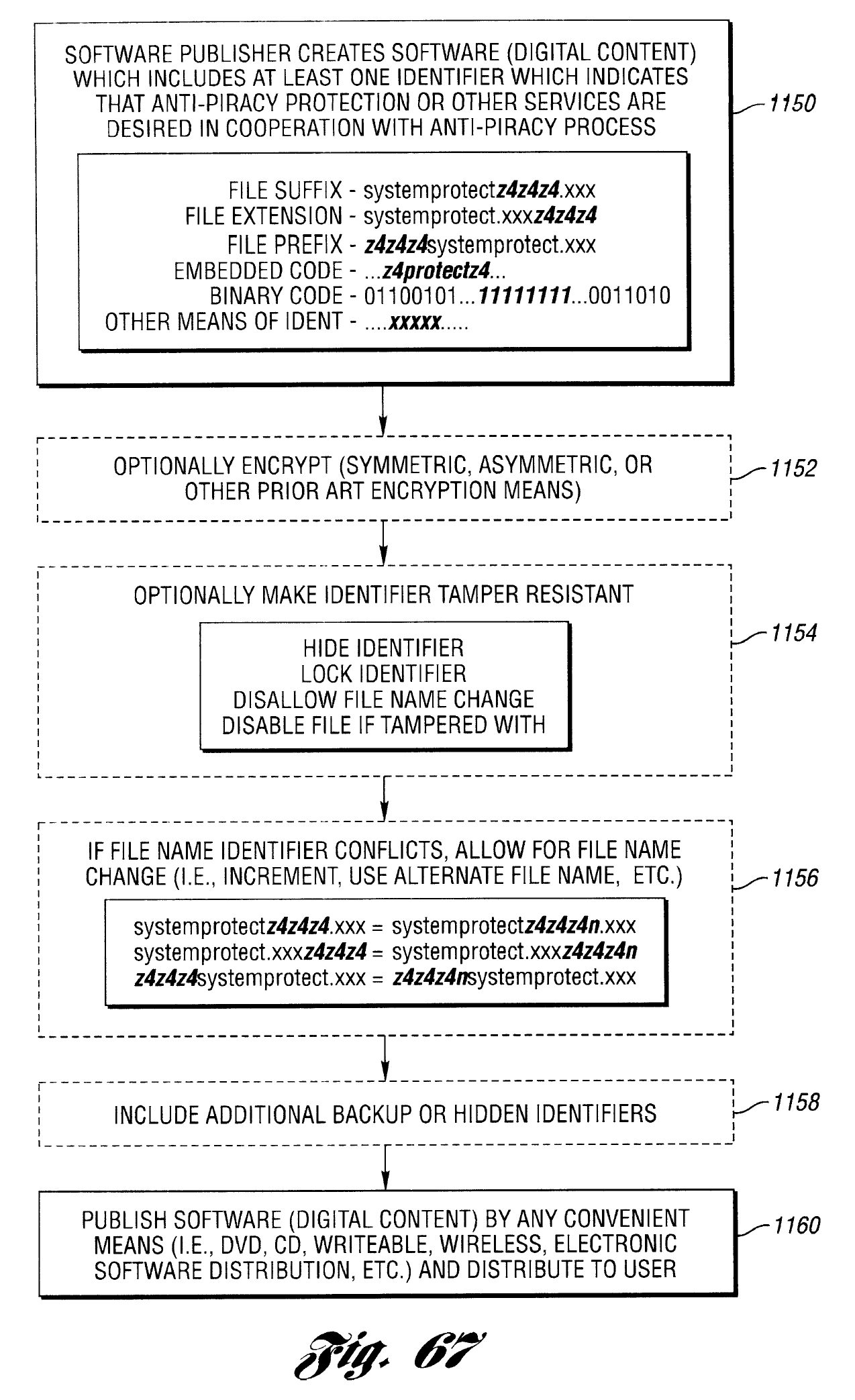

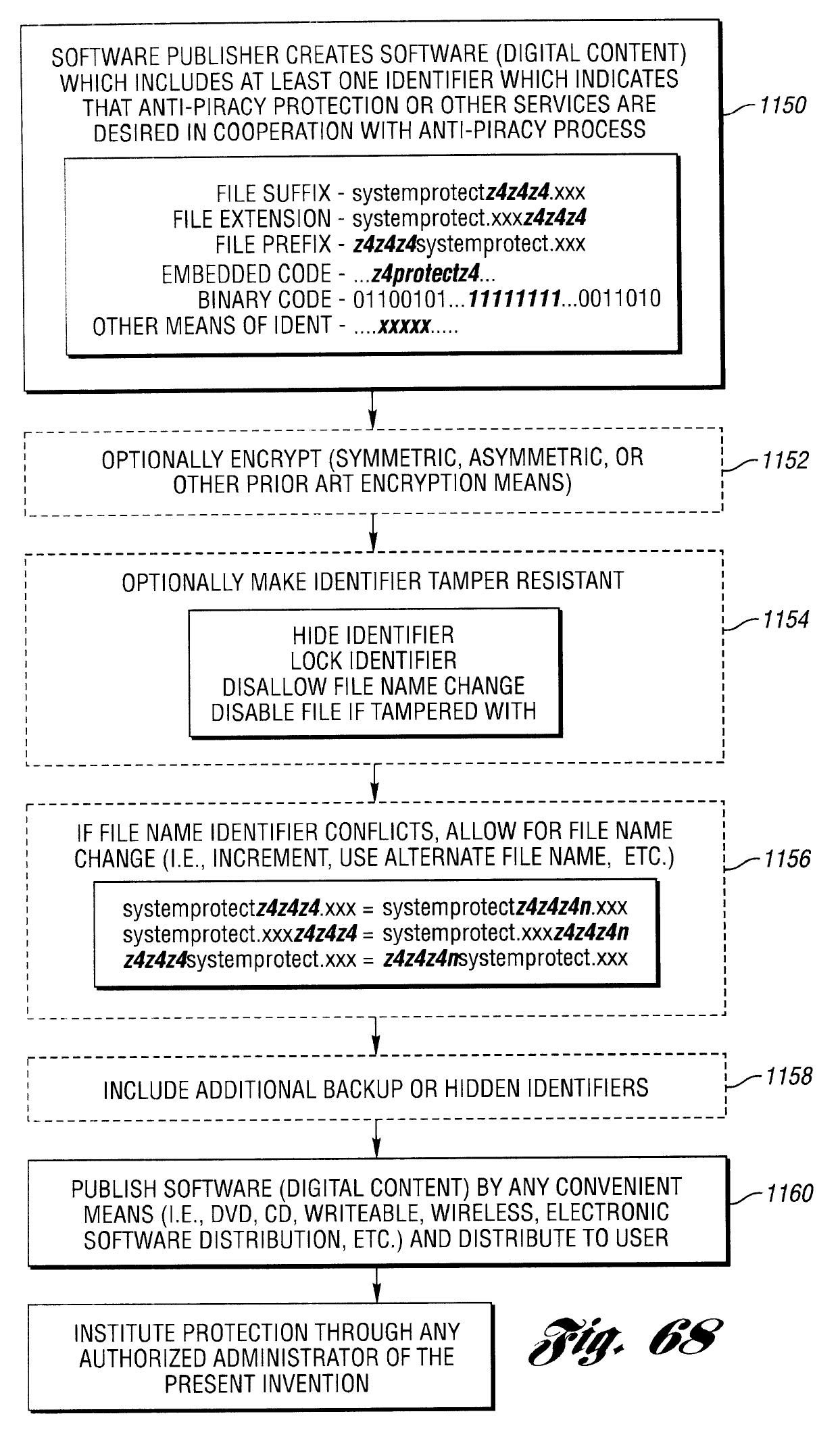

Referring now to FIG. 53, a block diagram illustrating an authentication process for writable computer readable storage media and secondary devices according to one embodiment of the present invention is shown. The authentication process illustrated in FIG. 53 provides an example for applications of the general authentication process illustrated and described with reference to FIG. 14 to authenticate protected content for use on various secondary devices. The process proceeds in a similar fashion as previously described with reference to FIG. 14. However, when the user transfers and installs digital content from the writable computer readable storage medium as represented by block 460′, the authorized representative entity may generate authentication codes to authorize the content designated for protection for use with one or more secondary devices as represented by block 466′. The authentication codes may be added to the computer readable storage medium acquired by the user as represented by block 452, may be stored on computer readable storage media associated with a primary device such as a computer, or stored within one or more secondary devices depending upon the particular application. The authentication code or codes may be generated and attached or otherwise associated with software designated for protection using any one of the embodiments illustrated and described with reference to FIGS. 36-38, for example. Software may be designated for protection as illustrated and described with reference to FIGS. 67 and 68, for example.

The authorized representative authenticates the user based on identification of a secondary device and authentication codes associated with the software designated for protection as represented by block 480′. The authentication process may proceed as illustrated and described in the representative embodiments of FIGS. 39-42, or any other process to determine whether the secondary device is authorized to use or access the protected software. Repeated authentication may be optionally required, as generally indicated by block 500′, upon subsequent use or access to the protected content with a secondary device, upon expiration of an authorization interval, and/or periodically as determined by a local or remote authorized representative.

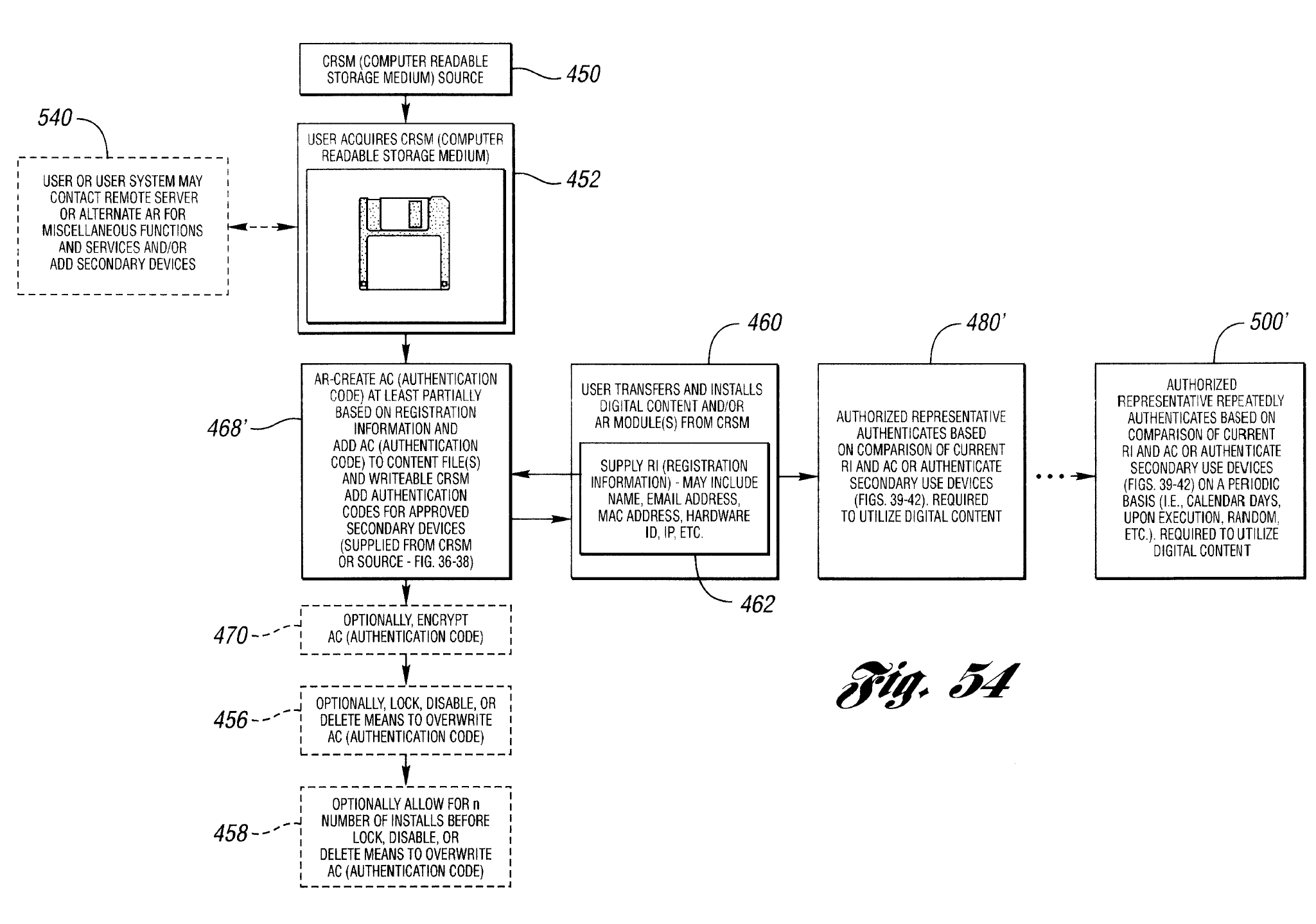

The block diagram of FIG. 54 illustrates a representative embodiment for an authentication process particularly suited for use with writable computer readable storage media and secondary devices according to the present invention. The embodiment illustrated in FIG. 54 represents a specific implementation of the general authentication process illustrated and described with reference to FIG. 15 for authentication of secondary devices. After acquiring content designated for protection on a writable computer readable storage medium as represented by blocks 460 and 452, the authorized representative creates one or more authentication codes based on registration information associated with the primary and/or secondary devices as represented by block 468′. The authentication code or codes may optionally be encrypted as represented by block 470 with the module or other means used to generate authentication codes locked, deleted, or otherwise disabled as represented by block 456, which may optionally be performed after a predetermined number of installations or authorizations as represented by block 458. As previously described, authentication codes generated by the authorized representative may include a generic code to authorize a particular device or group of devices or may be generated using user-specific registration information, or both. Registration information may be collected when content designated for protection is transferred to a primary and/or secondary device as represented by blocks 460 and 462. The authorized representative then attempts to authenticate the user based on current registration information or other hardware identifiers and the authentication code or codes associated with the protected software as represented by block 480′. Representative embodiments for authenticating secondary devices are described in greater detail with reference to FIGS. 39-42. Repeated authentications may also be required as represented by block 500′.

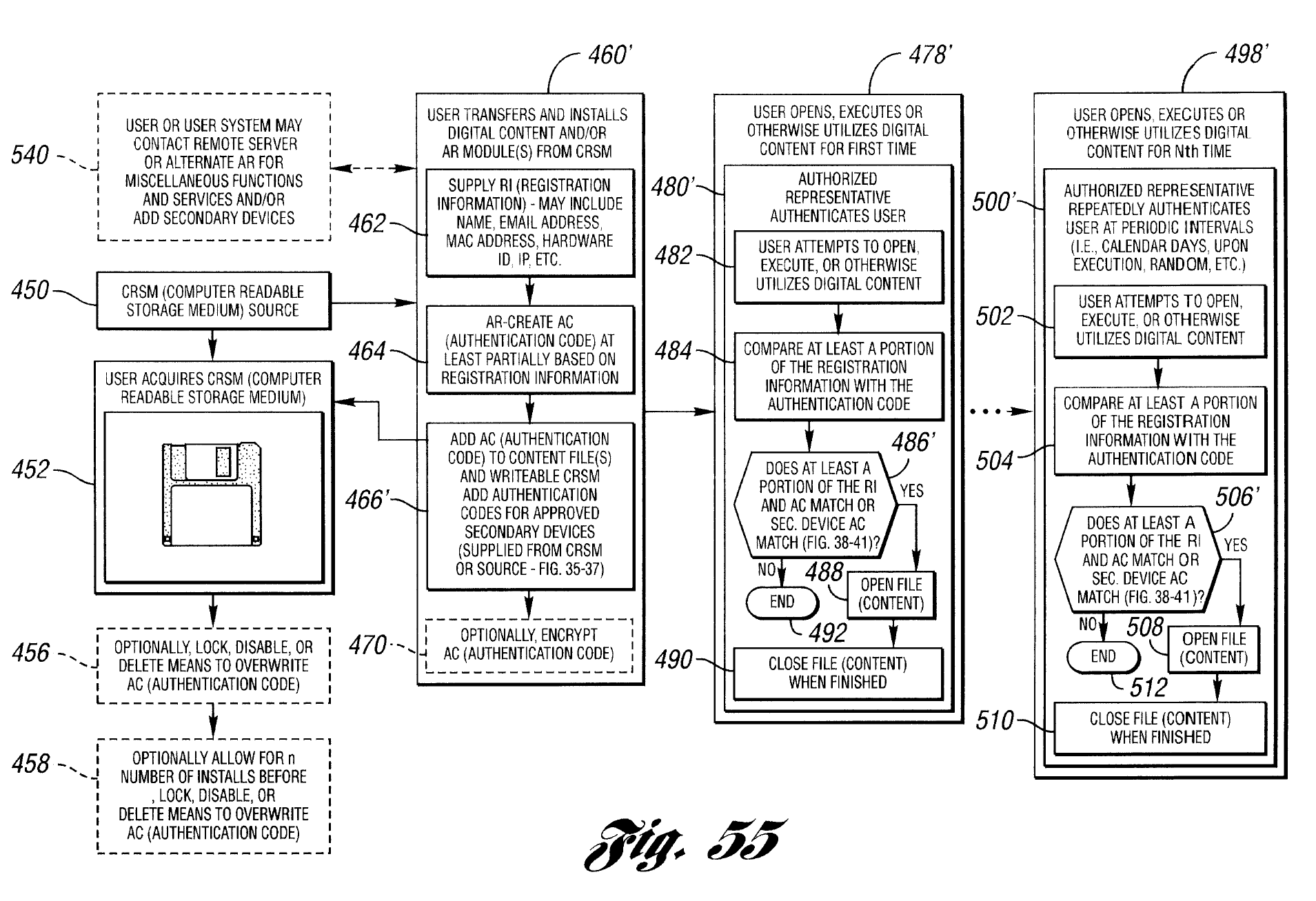

Referring now to FIG. 55, a block diagram illustrating an authentication process particularly suited for use with writable computer readable storage media and secondary devices according to the present invention is shown. The embodiment of FIG. 55 illustrates representative embodiments of the general authentication process illustrated and described with reference to FIG. 16 for use in authenticating or authorizing secondary devices. The process proceeds in a similar manner as described with reference to FIGS. 16, but includes the addition of an authentication code or codes upon transfer, installation, or other access from the computer readable storage medium as represented by blocks 460′ and 466′. Similarly, the authentication process determines whether the secondary device is authorized as represented by blocks 478′ and 498′ using corresponding authorized representatives represented by blocks 480′ and 500′ to compare identification information or other registration information associated with the secondary device to the corresponding authentication code or codes as represented by blocks 486′ and 506′.

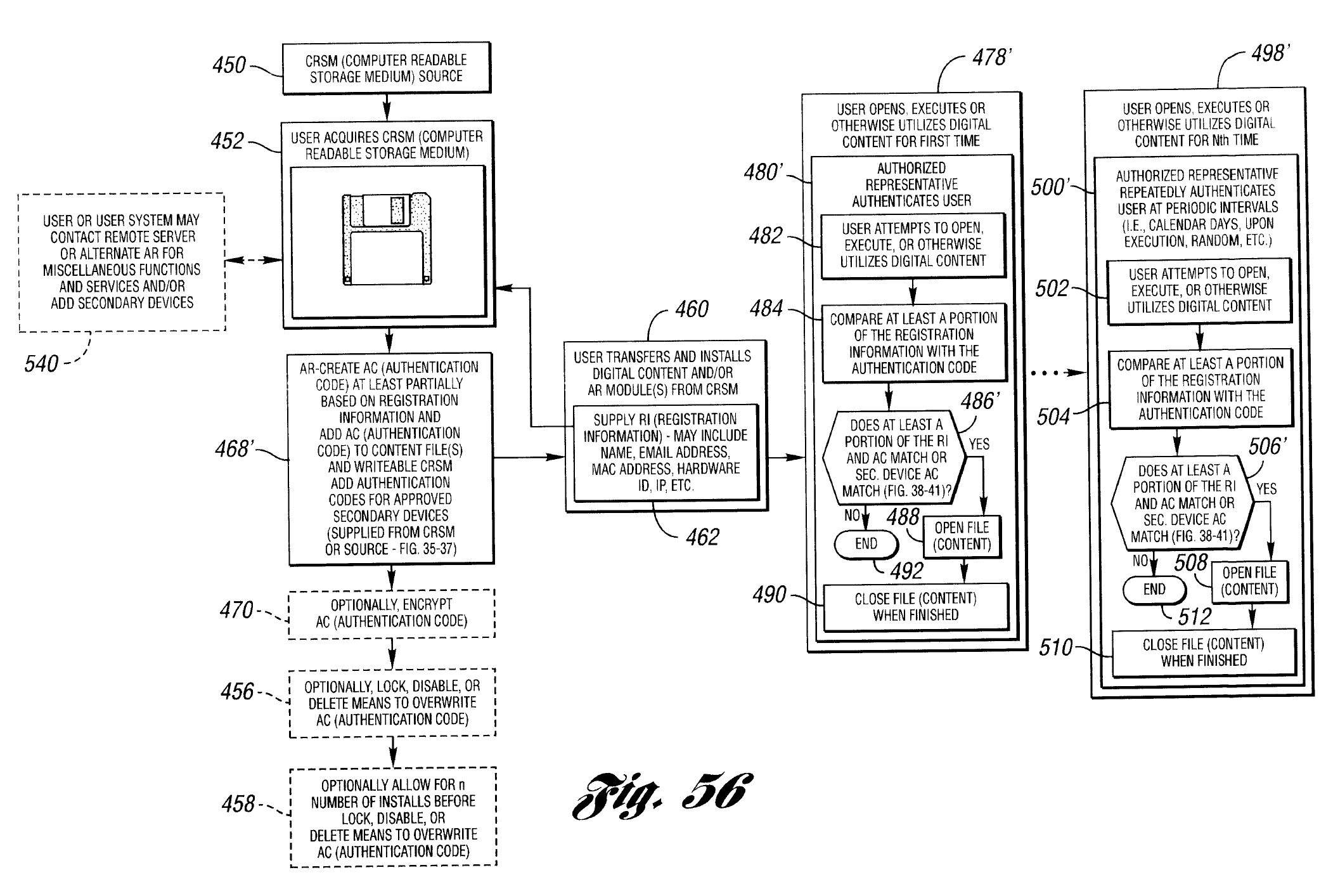

FIG. 56 is a block diagram illustrating another embodiment for an authentication process particularly suited for use with writable computer readable storage media and other secondary devices according to the present invention. The embodiment illustrated in FIG. 56 is one application for the general authentication process illustrated and described with reference to FIG. 17. The process proceeds in a similar fashion as previously described with the authorized representative creating passwords (authorization or authentication codes) for approved secondary devices as represented by block 468′. The secondary device authorization codes may be transferred to the writable computer readable storage medium and may be generated by a local authorized representative, supplied with the computer readable storage medium or source, or obtained from a remotely located authorized representative as illustrated and described in greater detail with reference to FIGS. 36-38. The authentication process includes authentication by an authorized representative entity as represented by blocks 480′ and 500′ when the user attempts to utilize the protected content for the first time and for the nth time as represented by blocks 478′ and 498′, respectively.

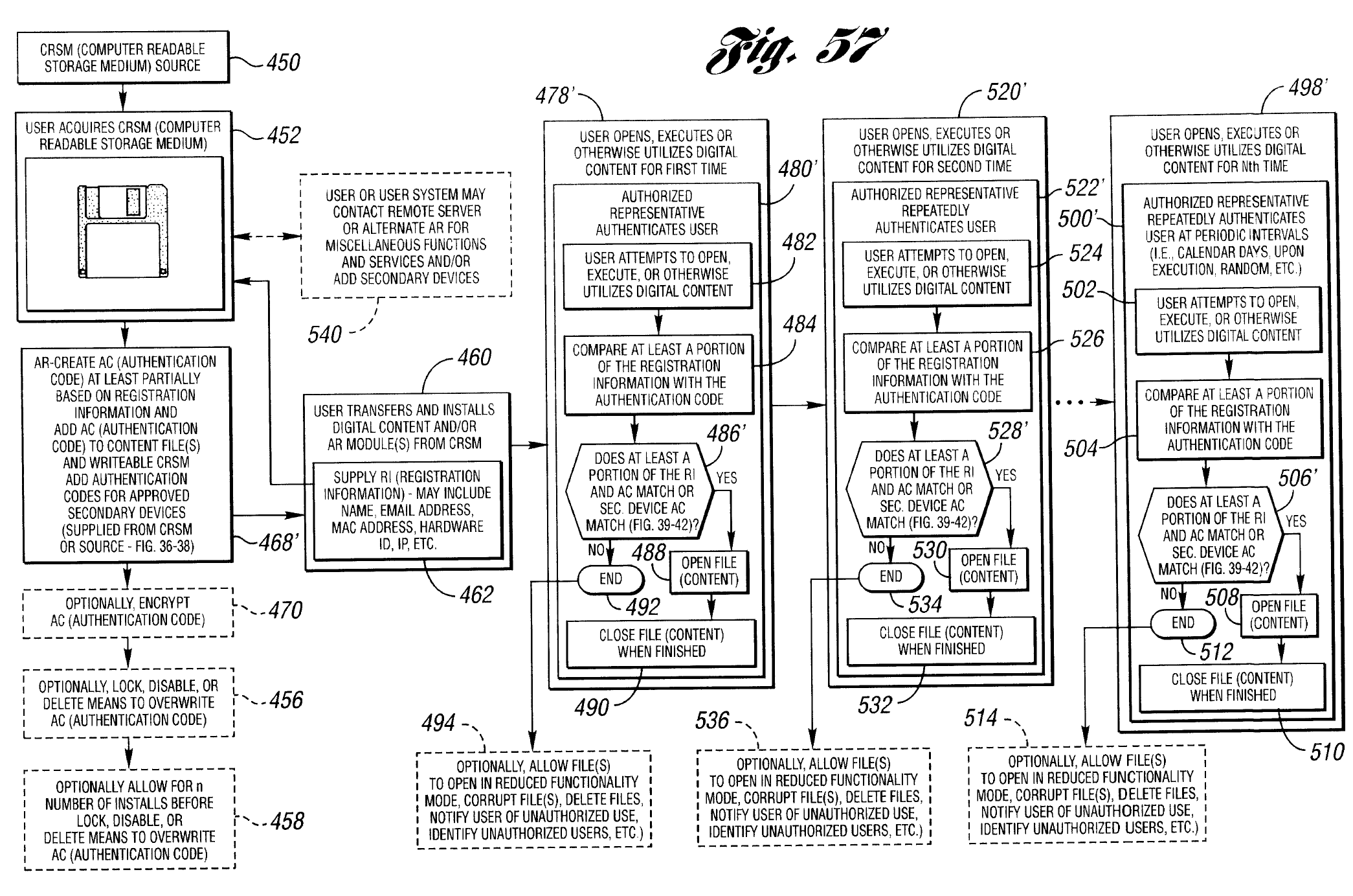

FIG. 57 is a block diagram illustrating one embodiment for an authentication process particularly suited for use with writable computer readable storage media and secondary devices according to the present invention. The embodiment of FIG. 57 illustrates one implementation of the general authentication process illustrated and described with reference to FIG. 18 for use with secondary devices. In addition to the steps described with reference to FIG. 18, the embodiment of FIG. 57 includes the generation of authentication codes for approved secondary devices as represented by block 468′. The authentication codes may be based on registration information obtained from the user, from a primary device, and/or from secondary devices. The authentication code or codes may be supplied along with the computer readable storage medium or may subsequently be generated by authorized representative entity. Authentication then proceeds based on registration information associated with the secondary device and the authentication code or codes associated with content designated for protection as generally represented by blocks 478′, 520′, and 498′. The authentication process may include an authorized representative determining whether the secondary device is authorized by comparing identification information associated with the secondary device to corresponding information encoded within one or more authentication codes as represented by blocks 480′, 486′, 522′, 528′, 500′, and 506′.

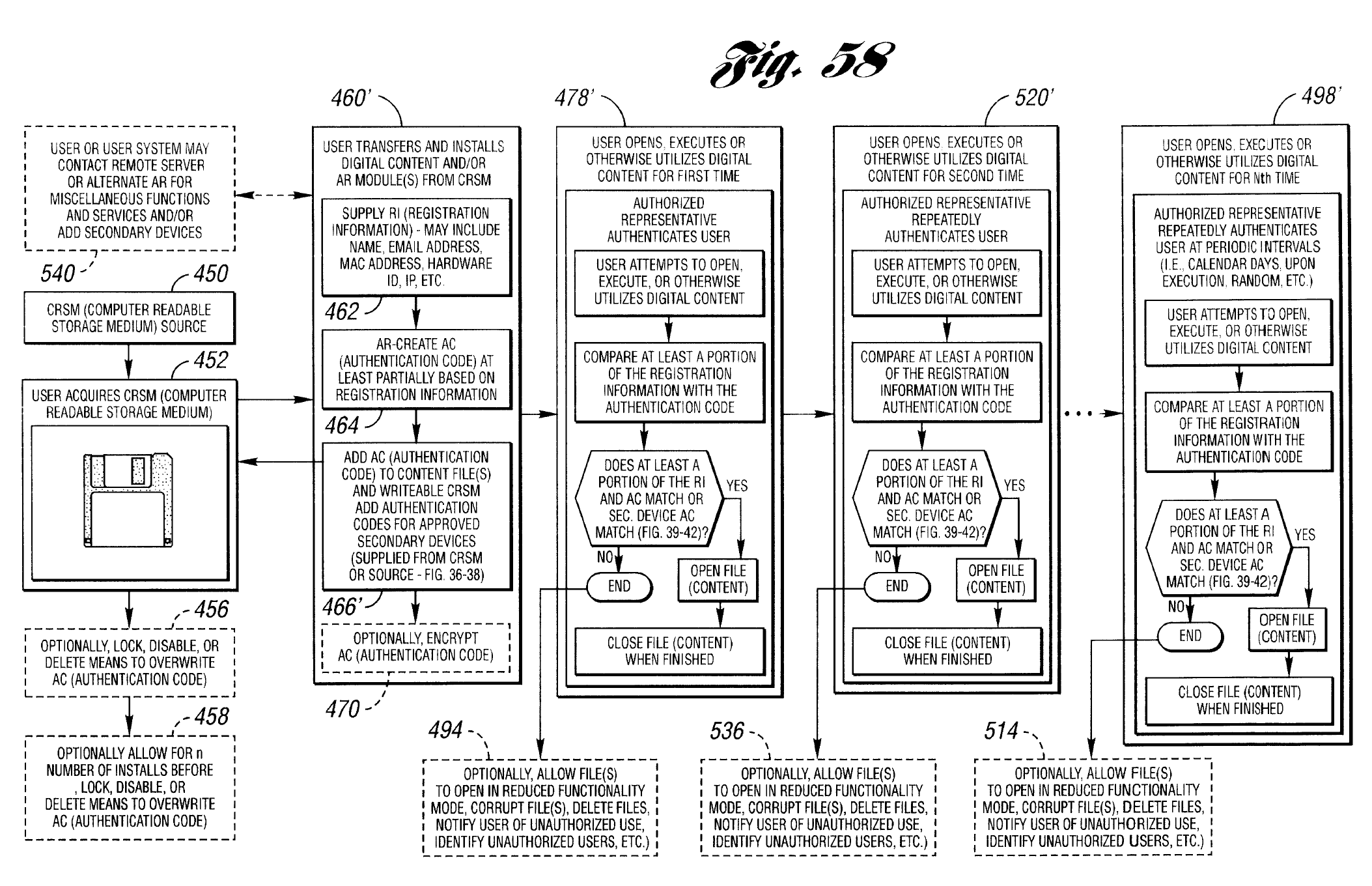

The block diagram of FIG. 58 illustrates one embodiment of an authentication process particularly suited for use with writable computer readable storage media with secondary devices according to the present invention. The embodiment of FIG. 58 illustrates a particular application for the general authentication process illustrated and described with reference to FIG. 19 with various steps described with reference to secondary use devices. For example, when the user transfers and installs digital content from the computer readable storage medium as represented by block 460′ the authorized representative may create one or more authentication codes for approved secondary devices based on registration information automatically obtained from the secondary devices and/or supplied by a user as represented by block 466′. Representative embodiments for generating authentication codes associated with secondary devices are illustrated and described with reference to FIGS. 36-38.

The authorized representative authenticates the user when the user opens, executes, or otherwise utilizes digital content designated for protection for the first time on a primary and/or secondary device as represented by block 478′. Authentication may include a comparison of registration information associated with a secondary device to corresponding authentication codes as illustrated and described in greater detail in FIGS. 39-42. The authorized representative may repeatedly authenticate the user when the user opens, executes, or otherwise utilizes digital content designated for protection for the second time as generally represented by block 520′. Similarly, the authorized representatives may repeatedly authenticate the user at periodic intervals and/or when the user opens, executes, or otherwise utilizes digital content designated for protection for the nth time as represented by block 498′.

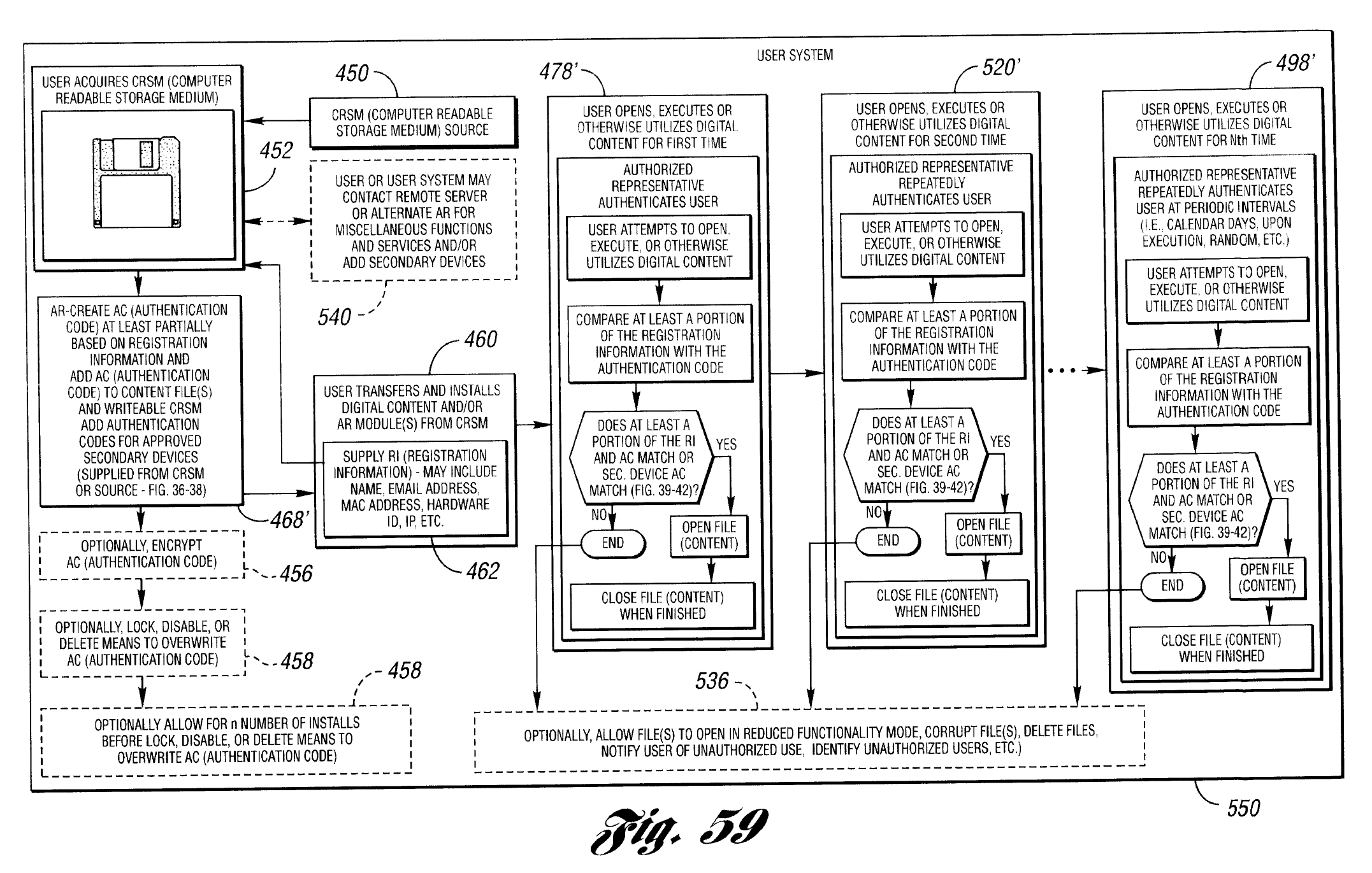

An authentication process particularly suited for use with writable computer readable storage media and secondary devices according to one embodiment of the present invention is illustrated in the block diagram of FIG. 59. The embodiment of FIG. 59 illustrates a specific application of the general authentication process illustrated and described with reference to FIG. 20. As illustrated, the authorized representative functions are performed on user system 550. In particular, the user acquires content designated for protection on a writable computer readable storage medium 452. The authorized representative then creates an authentication code at least partially based on registration information and adds the authentication code to the corresponding content designated for protection and the computer readable storage medium as represented by block 468′. In addition, the authorized representative may add authentication codes for approved secondary devices. The authentication codes may be generated based on registration information as represented by block 460. Alternatively, authentication codes for approved secondary devices may be supplied from computer readable storage medium 452. As previously described, authentication codes may also be obtained from a remote authorized representative depending upon the particular application. Representative embodiments for generating authentication codes associated with secondary devices are described and illustrated in greater detail with reference to FIGS. 36-38.

One or more of the authentication codes may be optionally encrypted individually or in combination with protected content as represented by block 470. In addition, the means to overwrite or otherwise generate new authentication codes may be optionally locked, deleted, or otherwise disabled as represented by block 456 after optionally allowing for a predetermined number of installations as represented by block 458. The user then transfers and installs content designated for protection on a primary and/or secondary device as represented by block 460. Additional registration information may be collected or supplied to generate one or more authentication codes as previously described.

The user resident authorized representative authenticates the user, system, or device when the user attempts to open, executes, or otherwise utilize content designated for protection for the first time as represented by block 478′. Depending upon the application, repeated authentications may be required as represented by blocks 498 and 520.

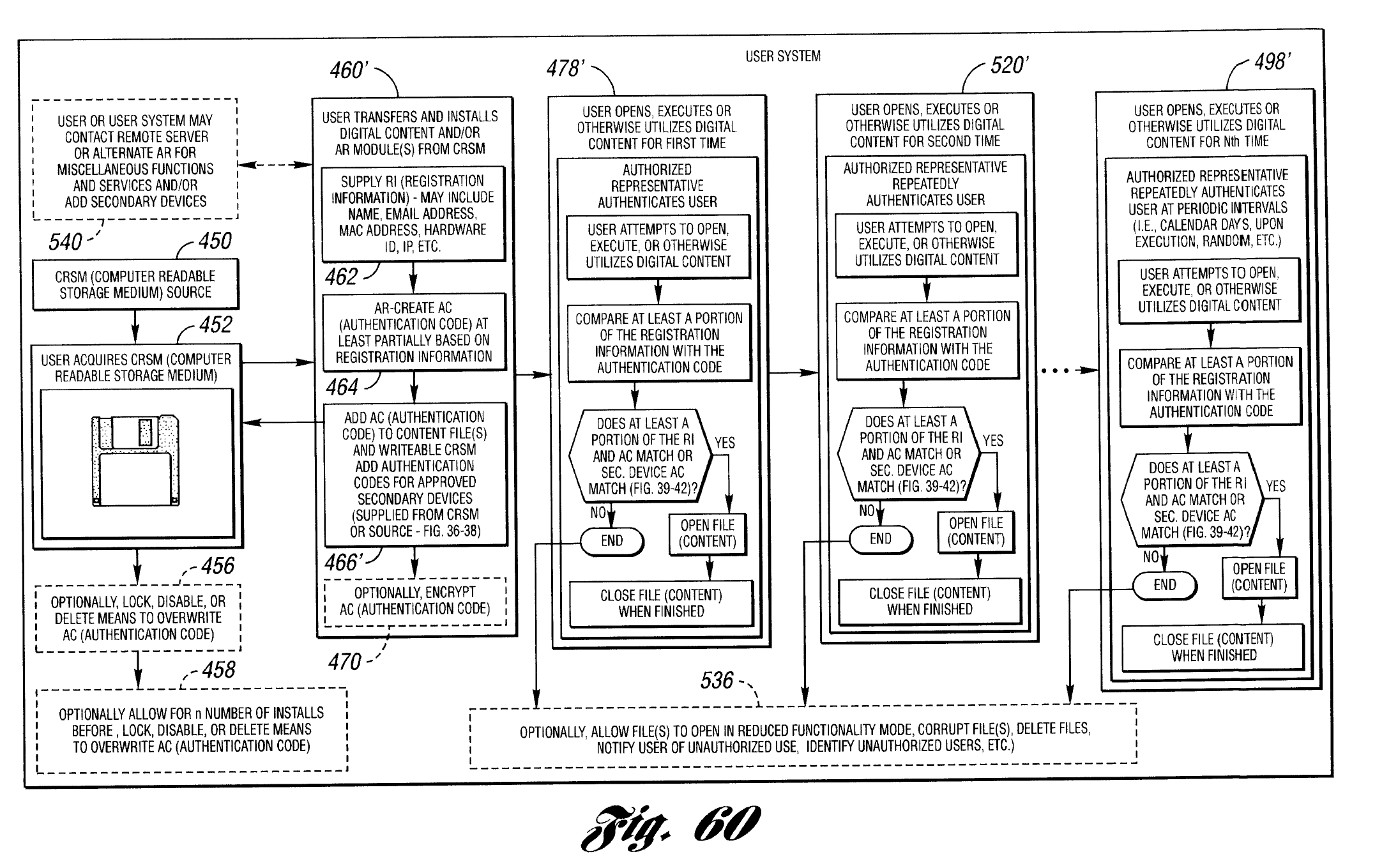

Referring now to FIG. 60, a block diagram illustrating one embodiment for an authentication process particularly suited for use with writable computer readable storage media and secondary devices according to the present invention is shown. The embodiment of FIG. 60 illustrates a representative implementation for the general authentication process illustrated and described with reference to FIG. 21 for use with one or more secondary devices. In particular, authentication codes for approved secondary devices may be generated by the authorized representative upon transfer and installations of the digital content from the computer readable storage medium to the primary and/or secondary device as represented by blocks 460′ and 466′. The user system resident authorized representative entity authenticates the user when the user attempts to open, execute, or otherwise utilize software designated for protection as represented by block 478′. The authentication process may include comparison of registration information associated with a secondary device and authentication codes associated with the content residing on a primary device and/or the secondary device to determine whether the secondary device is authorized. Repeated authentications may be required as generally represented by block 498′ and by block 520′.

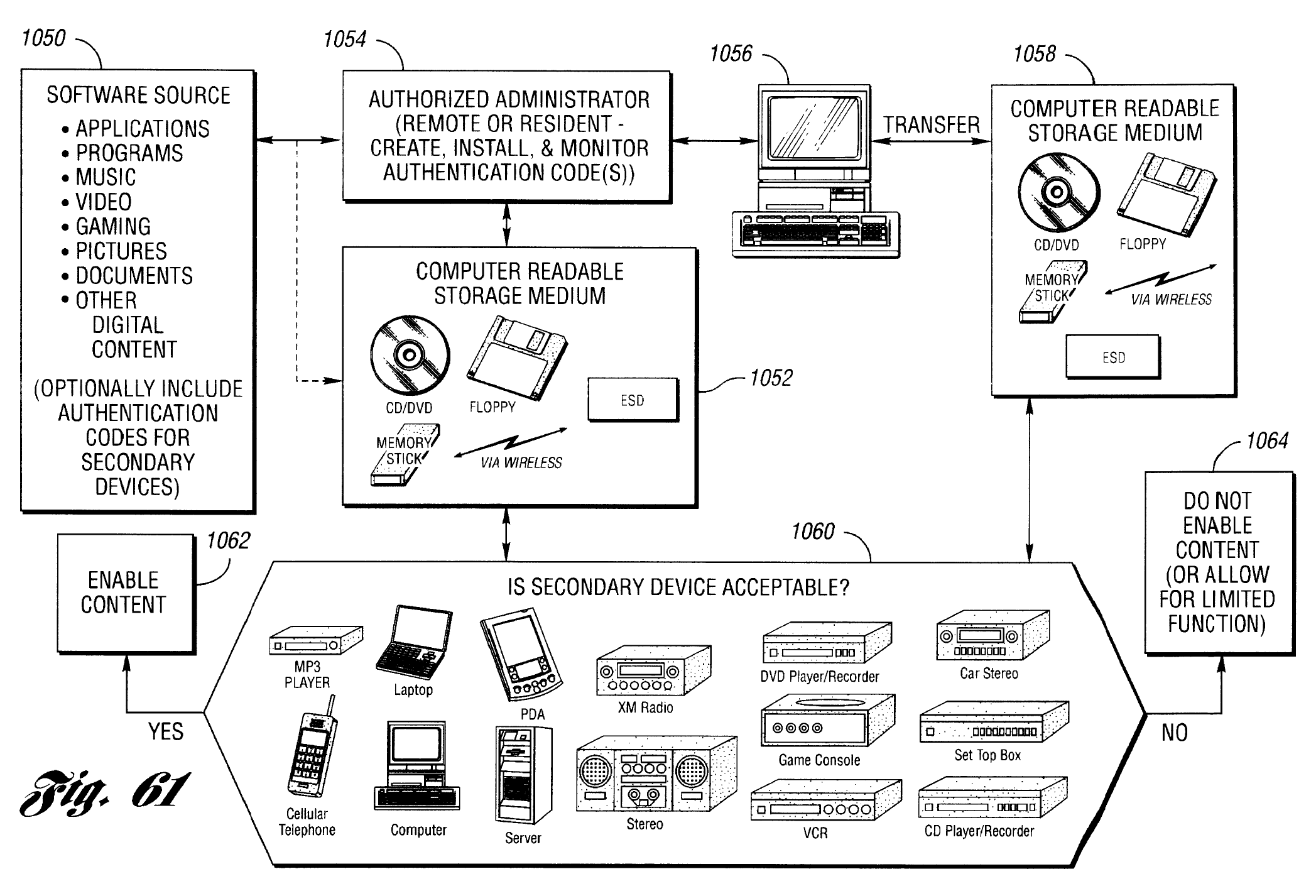

FIG. 61 is a block diagram illustrating representative applications of the present invention that include various secondary devices. The software source or publisher 1050 provides software that may include application programs or operating system programs, applets, scripts, music, video, movies, games, pictures, graphics, clipart, documents, or any other digital content to be acquired by users by purchase, license, rental, or otherwise. Software source 1050 may optionally include one or more authentication codes for approved secondary devices. Included authentication codes may be generic for particular models, manufacturers, etc. or may be user specific based on registration information supplied by the user prior to or concurrently with the ordering or other acquisition process. The authentication codes may be supplied to an authorized administrator 1054 associated with the user system 1056 that may be remotely located or resident on the user system, network, or device. The authentication code or codes may be modified or additional codes may be created by the authorized administrator upon transfer of the content designated for protection to system 1056. Software source 1050 may distribute software using various types of computer readable storage media or directly via wireless, satellite or other networks using electronic software distribution or download as represented by block 1052. The computer readable storage media may include CDs/DVDs, floppy disks, solid-state memory devices, etc.

Content designated for protection may be transferred directly from computer readable storage medium 1052 to one or more secondary devices 1060. As previously described, any secondary device containing a processor and memory or any other usable means of identification may be incorporated into the authentication processes of the present invention. Of course, depending upon the particular application, any of the secondary devices may in fact be considered a primary device. Most embodiments of the present invention have been described using a computer as the primary device with other portable devices as the secondary device. However, any of these secondary devices may in fact be the primary or only device. Exemplary secondary devices may include an MP3 or other digital audio player, a laptop computer, a PDA, satellite (XM) radio, DVD player and/or recorder, car stereo, cellular telephone, computer, server, stereo, game console, set-top box, VCR, CD player, for example, as represented by block 1060. The authorized administrator determines whether the secondary device is acceptable and then enables access to the content for acceptable devices as represented by block 1062. If the secondary device is not acceptable, the authorized administrator may prevent access to the content or provide limited access as represented by block 1064. As previously described, the authorized administrator may reside on a primary system 1056 and/or within one or more secondary devices 1060. For secondary devices that are incapable of performing authorized administrator functions to monitor authentication codes for content designated for protection, authorized administrator functions may be performed on a primary device such as computer 1056. For example, an authorized administrator on primary device 1056 may prevent content from being transferred to a secondary device 1060 unless the secondary device is determined to be authorized or acceptable. Similarly, various alternative file types may be provided for secondary devices that cannot be identified or are incapable of implementing authorized administrator functions as previously described.

Rather than transferring content designated for protection directly from source 1054 to one or more secondary devices 1060 via distribution means 1052, computer, network, or other primary device 1056 may transfer content designated for protection via distribution means 1058 to one or more secondary devices 1060. As illustrated in FIG. 61, distribution means 1052 and 1058 include direct distribution via wireless technology. Any of the embodiments of the present invention may be utilized on any type of wireless device. As an example, music content transmitted via satellite to an XM radio may include an authorized representative and authentication code generation means. Alternatively, the wireless source corresponding to the satellite network provider in this example may perform authentication and authorization functions and only transmit the content once the authentication code has been embedded or otherwise attached to the content. When the transmission is received by a corresponding receiver or transceiver, the authorized representative, which may reside within the wireless device, determines registration information such as hardware identification and generates an appropriate authentication code that may be embedded to or attached to the content as previously described. If the file is subsequently transferred to another device, it will include the authentication code associated with the original wireless device and/or of the authorized user thereby restricting use in any subsequent unauthorized device. The content may be deleted, rendered inoperable, or allowed to operate in a reduced functionality mode in an unauthorized device as previously described. Satellite radio is used by example only. All processes are adaptable to any wireless device including cellular telephones, PDAs, laptop computers, etc.

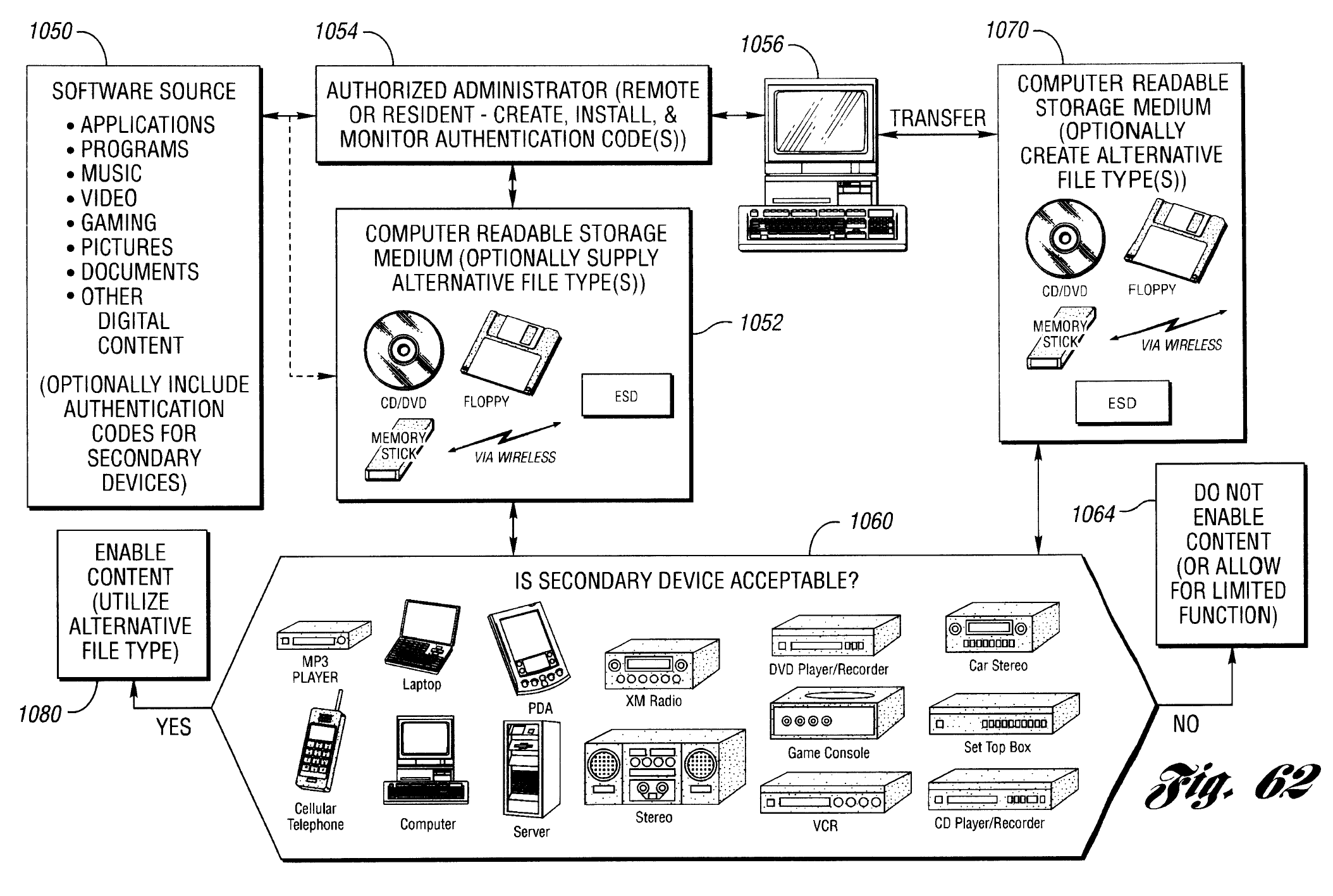

Referring now to FIG. 62, a block diagram illustrating use of an authentication process having alternative file types for use with secondary devices according to one embodiment of the present invention is shown. Software source 1050 develops, creates, and/or distributes one or more types of software that may optionally include authentication codes for secondary devices. Software source 1050 may include one or more alternative file formats for the software designated for protection. Alternatively, or in combination, software source 1050 may include corresponding identifiers, instructions, modules, or the like to subsequently generate one or more alternative file formats for corresponding devices. Software source 1050 may provide content designated for protection to an authorized administrator that may be remotely located or resident on the user computer, network, or device 1056. Software source 1050 may also optionally provide content designated for protection directly to the user via distribution channel 1052.

The authorized administrator determines whether the secondary device is authorized or otherwise acceptable to access the protected software as represented by block 1060. If the secondary device is authorized or otherwise acceptable, access to the protected software is provided as represented by block 1080. The protected software may be provided in an alternative file type for a particular secondary device as previously described. If the secondary device is determined to be unauthorized or otherwise unacceptable, access to the protected software is prevented or allowed with limited functionality as represented by block 1064.

Primary device 1056 may also be used to transfer protected software to one or more secondary devices 1060 via distribution channel 1070. The primary device 1056 may optionally create alternative file types for corresponding authorized secondary devices. Alternatively, primary device 1056 may obtain an appropriate alternative file type from authorized administrator 1054 for subsequent transfer to one or more secondary devices 1060 via a computer readable storage medium or wireless network, for example.

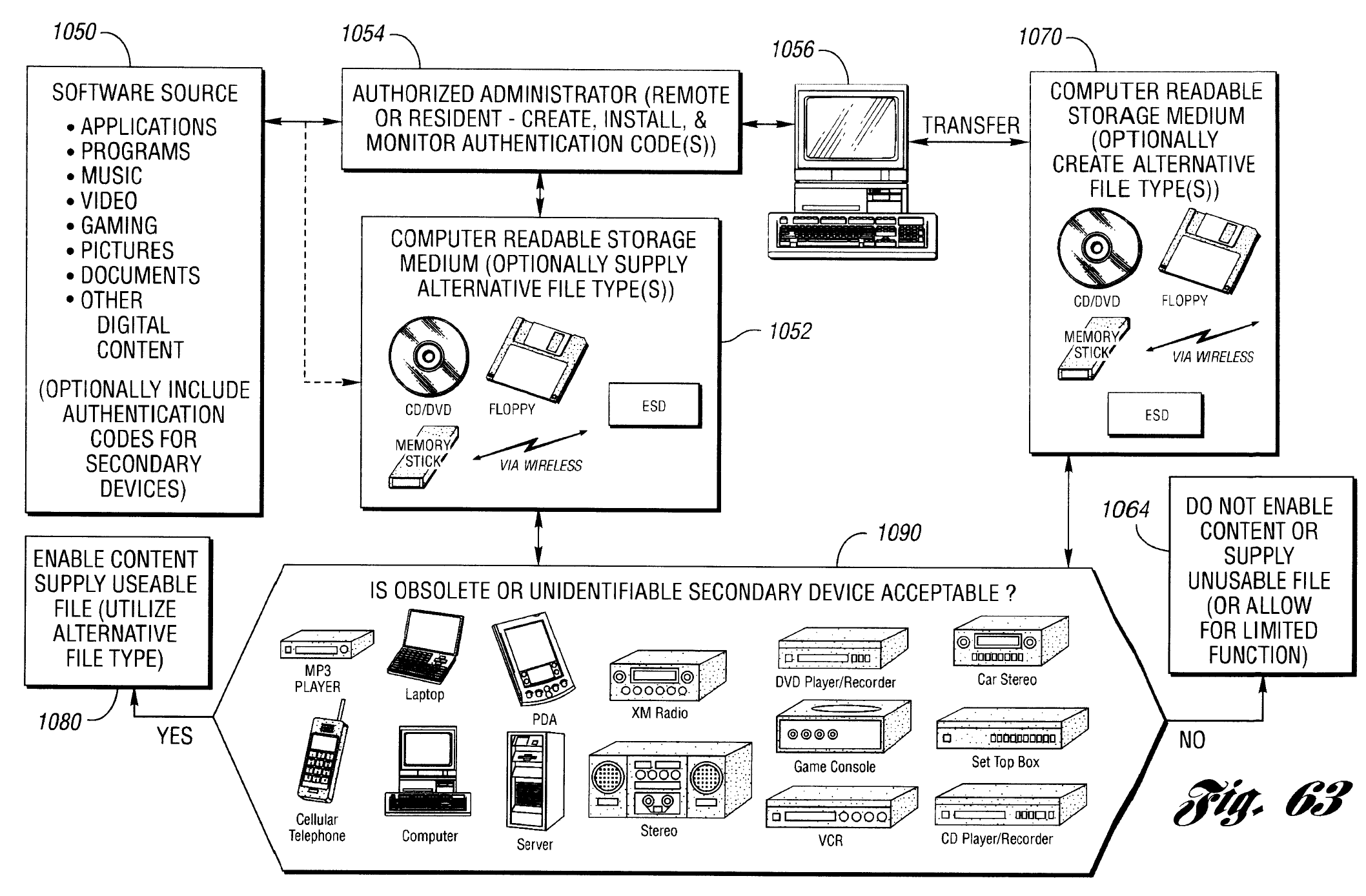

FIG. 63 is a block diagram illustrating representative uses of authentication processes of the present invention with secondary devices that are obsolete or unidentifiable. Software source 1050 distributes software designated for protection that may optionally include one or more authentication codes for approved secondary devices. Software may be distributed via an authorized administrator 1054 that creates, installs, and monitors authentication codes and may reside on a remote server or locally on a primary device 1056, such as a computer, network, or other device. Alternatively, or in combination, software source 1050 may distribute software designated for protection directly to one or more obsolete or unidentifiable secondary devices 1090 via distribution channel 1052.

Authorized administrator 1054 determines whether one or more secondary devices 1090 are authorized or otherwise acceptable before providing access to the protected software as represented by block 1080. Depending upon the particular application, access may be provided to the protected software utilizing an alternative file type. If the authorized administrator 1054 determines that the unidentifiable or obsolete secondary device is not acceptable, access to the protected software is prevented or otherwise hindered as represented by block 1064. As also illustrated in FIG. 63, primary device 1056 may transfer content designated for protection via distribution channel 1070 to one or more obsolete or unidentifiable secondary devices 1090.

FIG. 64 is a block diagram illustrating a representative authentication process using encryption according to one embodiment of the present invention. As described with reference to previous embodiments of the present invention, encryption may be utilized in any of the authentication processes to encrypt one or more authentication codes, content designated for protection, or both. When encryption is utilized, the encryption/decryption algorithms and/or keys may be modified from system to system to further deter unauthorized use. For example, a random number generator may be included to modify each user's authorized administrator encryption algorithm and associated keys. As such, even if the encryption is cracked by an unauthorized user, decryption will not be possible on another unauthorized system. Various registration information or hardware identifiers may be utilized to modify the encryption and decryption algorithms and/or keys.

The authorized administrator may periodically (i.e. randomly based, time based, number of executions based, calendar based, or based on a failure to decrypt, failure of comparative match, etc.) dynamically update/change the authentication code or codes to reflect changes in user registration information, which may include changes to hardware, software, system settings, and the like. This strategy may be used to provide a more accurate or identical match to user registration information so that minimum comparative standards may be elevated to further ensure compliance. However, the authorized administrator or representative may require a minimum comparative match between registration information encoded within an authentication code associated with protected content and current registration information before allowing a new authentication code to be determined and associated with the protected content to accommodate changes to the user system. This ensures that only incremental changes to the registration information will result in an updated authentication code while preventing large-scale changes that would be indicative of an unauthorized system.

As illustrated in FIG. 64, the authorized administrator generates an authentication code based on registration information associated with an authorized user as represented by block 1100. The authorized administrator then encrypts the authentication code and/or the content designated for protection using an “interlocked hyperencryption” secret key. The encryption algorithm and/or key may be modified by a variable (VRI_{AC}) based on registration information as represented by block 1102. The encrypted authentication code is then embedded, linked, or otherwise associated with the content designated for protection as represented by block 1104.

During a subsequent authentication process the authorized administrator generates a current authentication code based on registration information associated with the current user, user device, system, etc. as represented by block 1110. The current authentication code may be encrypted using an “interlocked hyperencryption”secret key with the encryption algorithm and/or key modified by a variable (VRI_{CURRENT}) based on registration information as represented by block 1112 to produce an encrypted second authentication code represented by block 1114. The authorized representative may also attempt to decrypt the protected content and/or the authentication code or codes associated with the protected content using the secret key based on the encryption algorithm or key variable (VRI_{CURRENT}) as represented by block 1120. If the protected content and/or associated authentication code or codes can be decrypted, the second authentication code may be compared to the first authentication code as represented by block 1122. If the authentication codes match, access to the file is enabled as represented by block 1124.

If the authorized administrator is unable to decrypt the protected file and/or associated authentication code or codes, or the first and second authentication codes do not match, the registration information encoded in the first authentication code corresponding to the originally authorized system and the registration information associated with the current system as represented by the variables VRI_{AC} and VRI_{CURRENT}, respectively, may be compared as represented by block 1130. The comparison of the registration information or corresponding variables may be used to identify the number of components or type of components that have changed relative to the originally authorized system and the current system. If the registration information associated with the originally authorized system and the registration information associated with the current system is not sufficiently similar as represented by block 1130, access to the content is prevented or hindered as represented by block 1132. If the registration information associated with the content is similar to the current registration information as represented by block 1130 a new authentication code may be determined and encrypted, using the encryption key and/or algorithm as modified by the current registration information and then associated or linked to the protected content as represented by block 1134. Access to the protected content is then enabled as represented by block 1136.

As illustrated in FIG. 64, this embodiment of the invention allows the use of encryption while tolerating a predetermined level of modification to the registration information associated with an authorized system. For example, if the user receives content designated for protection using an authorized device but subsequently changes one or more components within the authorized device, such as a hard drive, motherboard, processor, etc., the embodiment of FIG. 64 allows the protected content to be accessed by the updated system. The authentication code or codes associated with the content are also updated to reflect the changes to the registration information. However, if the content designated for protection is transferred to an unauthorized system, it is unlikely that registration information of the unauthorized system will meet the minimum comparative match to allow the authentication code associated with the content to be updated. As such, access to the protected content on the unauthorized system will be prevented or otherwise restricted. If an authorized user modifies an authorized device to the extent that the modified device fails to meet the minimum comparative match, the user would have to contact a remote authorized representative to verify registration information and receive a new authentication code at the discretion of the authorized representative to enable access to the protected file or files.

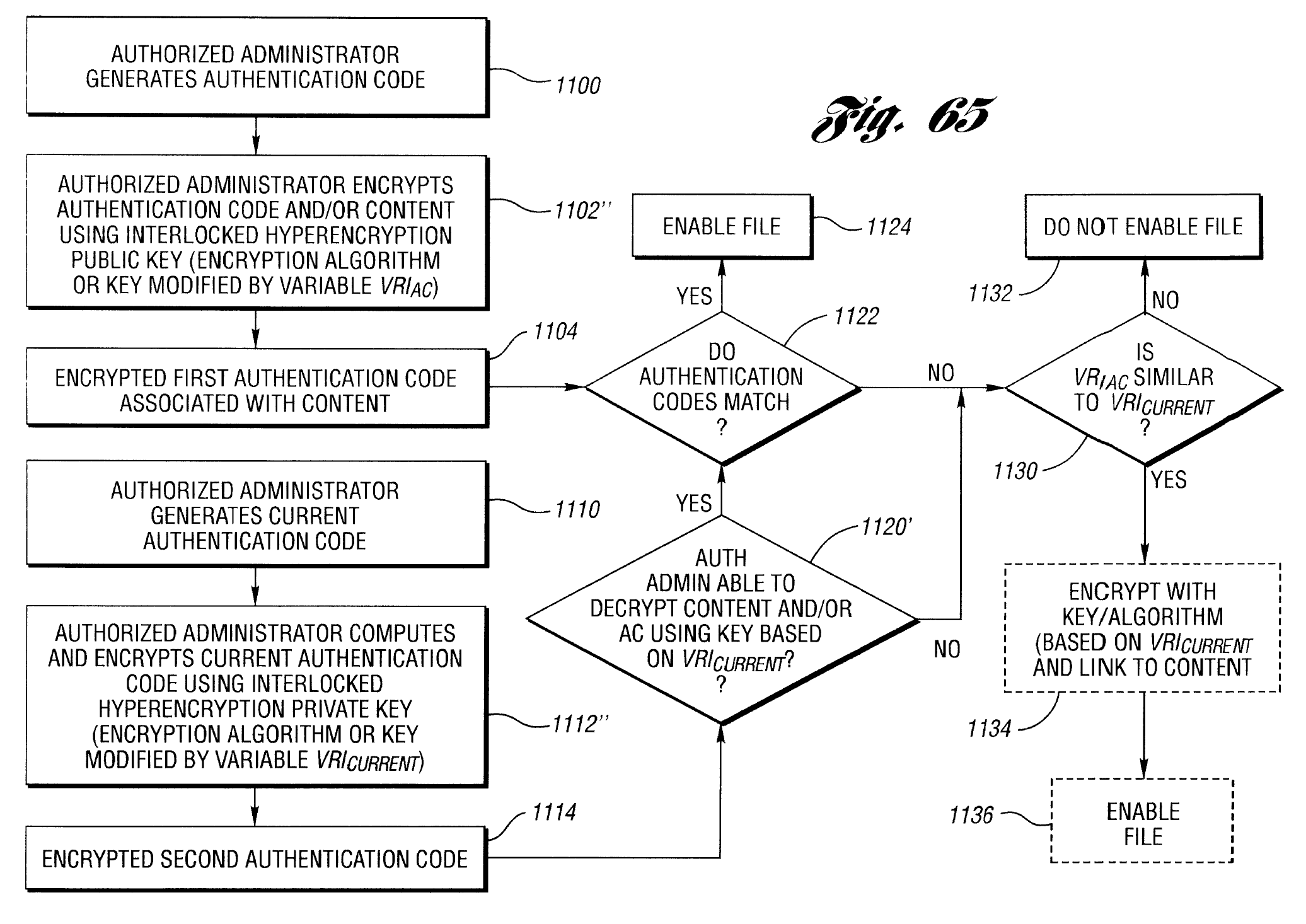

FIG. 65 is a block diagram illustrating use of asymmetric encryption for an authentication process according to one embodiment of the present invention. Content may be designated for protection using any of a number of codes, file names, file types, etc. as illustrated and described in greater detail with reference to FIG. 67. During the initial use or installation of the software designated for protection on a user system, network, or device, a password or authorization code will be required by the software to function properly. The user or program attempting to access the software must establish contact with the authorized representative, which is preferably located on the user system or network, to obtain the appropriate authorization code or password. The password or authorization code administrator obtains registration information and provides one or more appropriate passwords or authentication codes for the software as represented by block 1100. Communication of registration information and the authorization code(S) may be accomplished either manually or automatically depending upon the particular application and configuration and/or type of software. The password administrator or authorized representative preferably stores collected registration information to be used for various purposes according to the present invention to reduce unauthorized use of the software. The registration information may be encoded, encrypted, or otherwise hidden to prevent tampering.

The authorized administrator may encrypt the authentication code or codes and/or the software designated for protection using “interlocked hyperencryption” with a private key, for example. The encryption algorithm or key may be modified for each system based on registration information that may be contained in a corresponding variable, such as VRI_{AC} for example, as represented by block 1102′. The encrypted authentication code is associated or otherwise embedded with the content designated for protection as represented by block 1104.

When the user subsequently attempts to transfer, install, or otherwise access the protected content, the authorized administrator generates a second authentication code based on current registration information as represented by block 1110. The authorized administrator may then compute and encrypt the current authorization or authentication code using “interlocked hyperencryption” with a public key. The encryption algorithm or key may be modified by a variable representing the current registration information for the system as represented by block 1112′ to produce a second encrypted authentication code represented by block 1114. The current registration information may also be used by the authorized administrator to attempt to decrypt the protected content and/or authentication code associated with the protected content as represented by block 1120′. The first and second authentication codes may be compared as encrypted or decrypted codes as represented by block 1122. If the authentication codes match, the protected content file is enabled as represented by block 1124. If the authorized administrator is not able to decrypt the authorization or authentication code associated with the protected content, or the first and second authentication codes do not match, the authorized administrator determines whether the original registration information is similar to the current registration information as represented by block 1130.

If the current registration information is similar to the registration information associated with the protected content as contained in the corresponding authentication code, the authorized administrator may update the authentication code as represented by block 1134. The updated authentication code may be encrypted using a corresponding key and algorithm based on the current registration information and associated with the content designated for protection for subsequent authentication. Access to the protected content is then provided as represented by block 1136.

If the current registration information is significantly different from the registration information associated with the protected content as determined by block 1130, access to the protected content may be prevented or various other compliance actions may be initiated as represented by block 1132 and described in greater detail above.

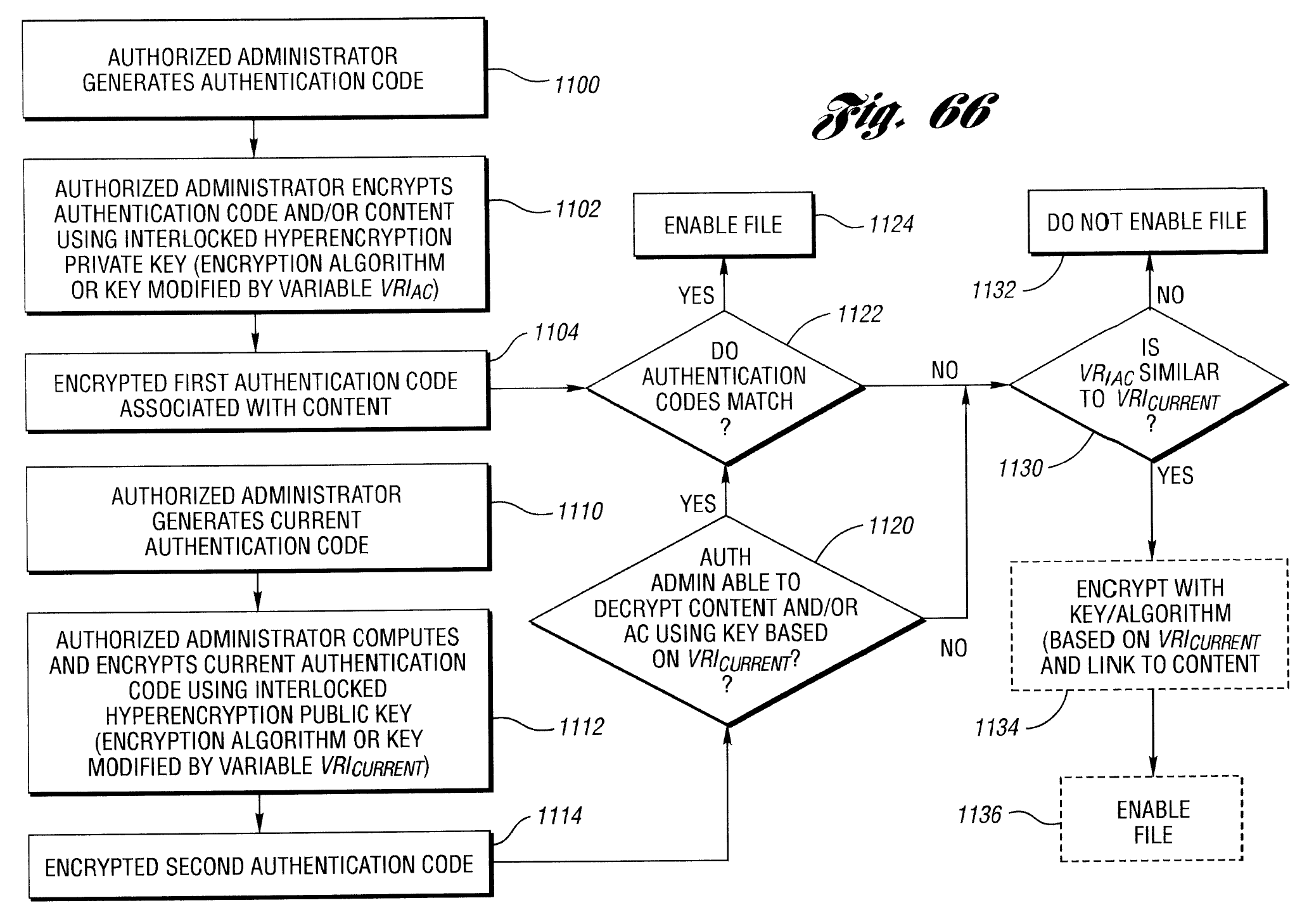

FIG. 66 is a block diagram representing another embodiment of an authentication process using asymmetric encryption according to the present invention. The embodiment of FIG. 66 is similar to the asymmetric encryption described with reference to FIG. 65. In the embodiment of FIG. 66, the authorized administrator encrypts the authentication code and/or content designated for protection using interlocked hyper encryption with a public key as represented by block 1102″. The encryption algorithm or public key may be modified based on registration information if desired.

When the content designated for protection is subsequently accessed, the authorized administrator computes and encrypts an authentication code using a private key based on current registration information as represented by block 1112″. The process then proceeds in a similar fashion to enable access to the file for authorized users as represented by blocks 1124 and 1136. Likewise, the authorized administrator attempts to determine whether incremental changes to the system as reflected in the registration information have occurred, or whether the protected content has been transferred to an unauthorized system. The authorized administrator updates the authentication code or codes associated with the protected content if it is determined that the modified system is authorized while preventing access to the content if it is determined that the system is unauthorized.

FIG. 67 is a block diagram illustrating a system and method for protecting software from unauthorized use according to one embodiment of the present invention. Manufacturers, developers, or publishers create software that may include application programs or other digital content which may be stored as data on computer readable media. Computer readable media may include any medium capable of storing instructions and/or data which is directly or indirectly readable by a computer or any device with a microprocessor. The software preferably includes at least one identifier indicating that anti-piracy measures or copy protection is desired as represented by block 1150. The identifier may be in the form of a serial number, password, or other alphanumeric or binary string, for example. The identifier is preferably transparent to any systems that do not include an authorized representative or other module or device to implement copy protection so that the software may be used without restrictions on those systems or devices. This would provide a backward compatibility feature. However, the identifier would be detected by an authorized representative associated with any systems or devices employing copy protection to trigger an authentication process according to the present invention as previously described and illustrated. Other services may also be signified by these or additional identifiers. Such services may include instructions for periodically contacting a remote server or remote authorized representative for the exchange of information including repeated authorization and authentication, dynamic authorized representative process changes, updates/upgrades, patches, marketing or promotional purposes, quality assurance purposes, network monitoring and metering, error and usage information, etc. These services may be in conjunction with or independent from the protection processes described.

As generally represented by block 1150, the copy protection identifier may be any unique code or character string included somewhere within the file or associated with the content designated for protection. The identifier may be included in a unique file prefix, file suffix, file extension, embedded within the content, as a binary code, or any other convenient method to designate protection. For each of the examples illustrated in block 1150, the unique code or string may be contained anywhere within the protected content, including the name, whether visible, hidden, or encrypted. For example, if integrated into the file name, the code may appear as a prefix, suffix, or interspersed their between. If implemented as a file extension, the unique identifier may be placed before a standard extension, after a standard extension, or anywhere in between, etc. Redundant identifiers may also be included to further deter illegal use.

The software identifier may optionally be encrypted using symmetric, asymmetric, or other encryption strategies as represented by block 1152. Alternatively, or in combination, various optional strategies may be employed to make the identifier tamper-resistant as represented by block 1154. The identifier may be hidden from view of the user, may be locked or interlocked with the associated content, or the file may be rendered inoperable if the identifier is changed or tampered with, for example. As also represented by block 1154, the file name made be locked or otherwise prevented from being changed or tampered with. Various other strategies may also be used to assure the integrity of the content and identifier as well known by those of ordinary skill in the art.

Depending upon the particular application and implementation, file name changes may be accommodated to allow for file name conflicts as represented by block 1156. For example, in the case of a pre-existing file name that conflicts with an incoming file name, the incoming file name may be changed automatically or manually by adding a numerical or alphabetic character to the incoming file, or adding any other designation while still maintaining the integrity of the file identifier. Preferably the file may also contain more than one identifier as represented by block 1158. Additional identifiers may be provided for backup or as hidden identifiers to further hinder tampering with the protected content. All identifiers may be required to be present to provide access to the file with any missing identifiers indicating that the file has been tampered with or otherwise corrupted and used to trigger various compliance actions, for example.

The software developer or publisher then distributes the content designated for protection using any convenient distribution channel as represented by block 1160. The content designated for protection may be distributed on computer readable storage media including DVDs, CDs, and memory cards, or electronically, for example. As such, the software publisher may designate software to activate, trigger, or otherwise utilize an available authorization or authentication process to reduce unauthorized use according to the present invention.

FIG. 68 is a block diagram illustrating an authentication process according to one embodiment of the present invention. A software publisher creates software that includes at least one identifier to trigger an authentication process on a user's system, network, or device as represented by block 1150. The identifier may optionally be encrypted as represented by block 1152 or otherwise made tamper-resistant as represented by block 1154. If the identifier is included within the protected content file name, various strategies may be used to provide conflict resolution of file names as represented by block 1156. Preferably, more than one identifier is included with the content designated for protection as represented by block 1158. The software publisher then distributes the digital content with one or more identifiers to users via any convenient means including computer readable storage media and/or electronically as represented by block 1160. Any of the anti-piracy strategies in the various embodiments of the present invention are then triggered when a local or remote authorized administrator or representative detects the identifier(s) associated with the content to reduce or prevent unauthorized use of the content as represented by block 1170.

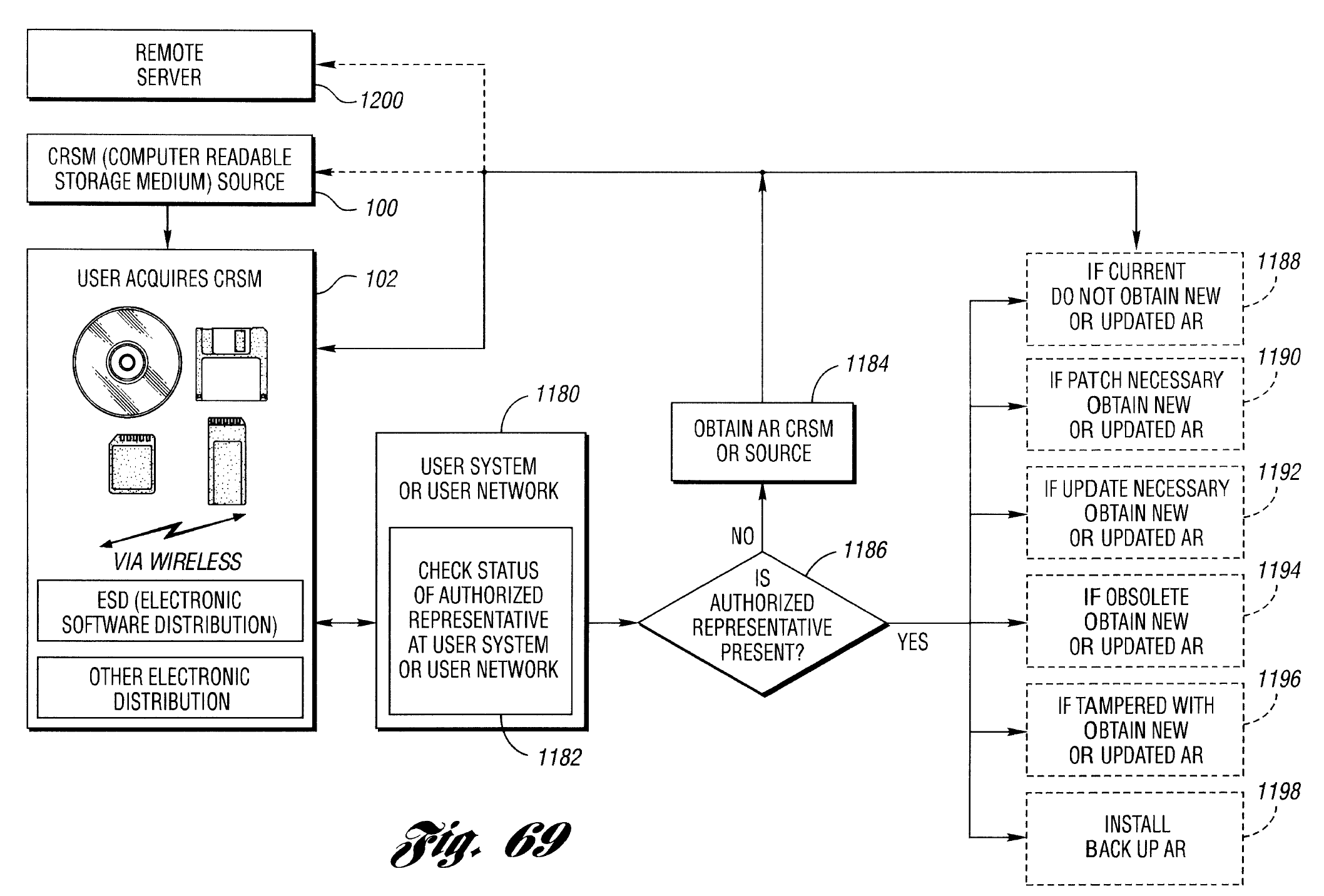

FIG. 69 is a block diagram illustrating a process for determining current authorized representative status and applicable update procedures according to one embodiment of the present invention. A computer readable storage medium source 100 is acquired by user as represented by block 102. The user may acquire the computer readable storage medium via a wireless network, via electronic software distribution, or via any other electronic distribution method and transfer the content to a local computer readable storage medium. Likewise, the digital content may be transferred to a computer readable storage medium prior to acquisition of the computer readable storage medium by the user. The user system or network 1180 is analyzed to determine the status or presence of an authorized representative as generally represented by block 1182. If an authorized representative program, module, chip, card, processor, etc. is not detected as determined by block 1186, an authorized representative may be obtained as represented by block 1184 from a local or remote source.

If an authorized representative is detected as represented by block 1186, various additional steps may be performed to determine the status of the authorized representative as represented by block 1188-1198. In particular, if the authorized representative is determined to be up-to-date or current as represented by block 1188, no additional action is required. However, if a patch or service pack for the authorized representative is required or available, it may be automatically or manually obtained from a local or remote source as represented by block 1190. Similarly, if the authorized representative requires updating of some or all of the functionality, an update may be obtained as represented by block 1192. If the authorized representative is obsolete or outdated, a new or updated authorized representative may be obtained as represented by block 1194. If the authorized representative has been tampered with, modified, corrupted, or changed in any way, a new or updated authorized representative may be acquired manually or automatically as represented by block 1196. In addition or in combination, A back-up authorized representative may be installed as represented by block 1198.

As illustrated in FIG. 69, any of the authentication functions and rules for any applicable embodiment previously described may be dynamically changed by a local or remotely located authorized representative. As one example, the algorithm used to generate authentication codes may be periodically modified by contacting a local or remote server. The user system would then update the authorized representative module or modules and all applicable associated content. This would always keep the “crackers” and “hackers” one step behind the current authentication algorithms used within any given system. This feature of the present invention is one of the many features that improve over the prior art, which is static in this regard.

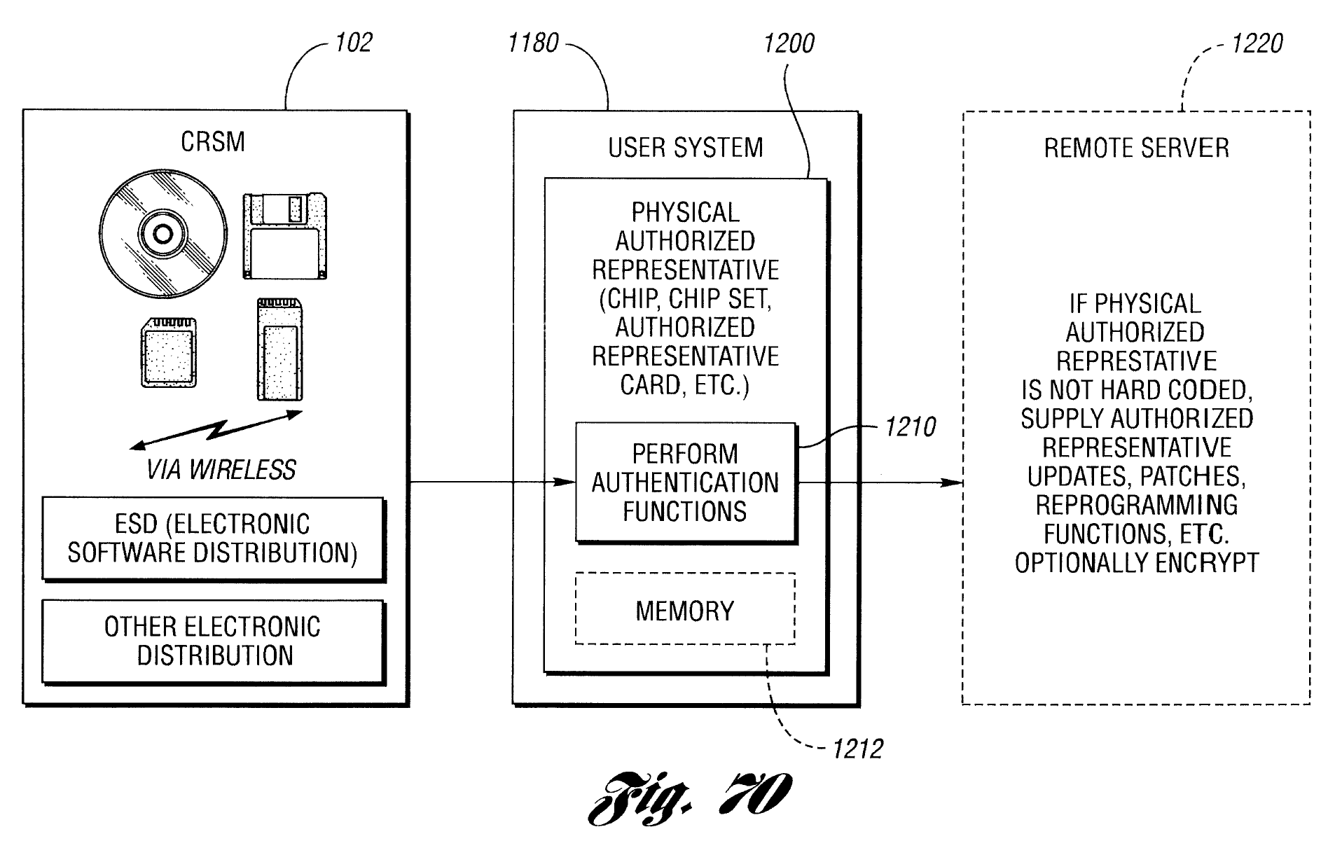

FIG. 70 is a block diagram illustrating operation of an authorized representative implemented in a hardware device according to one embodiment of the present invention. Protected software present on a computer readable storage medium 102 is acquired by a user for use on a user system or network 1180. User system or network 1180 includes a physical authorized representative 1200 that may be implemented by a hardware device including a computer chip, chip set, card, processor integral, etc. Physical authorized representative 1200 performs various authentication functions as previously described and generally represented by block 1210. Physical authorized representative 1200 may optionally include memory 1212 that may be used to update, revise, or replace various authorized representative algorithms, functions, keys, and the like.

Physical authorized representative 1200 may be permanently installed in user system 1180. For example, an authorized representative chip or chip set may be included on a system motherboard to prevent user tampering or removal. Preferably, hardware device 1200 includes firmware or other non volatile memory to facilitate dynamically changing one or more functions or algorithms of the authorized representative as described above. Hardware device 1200 may also be implemented in a device that is selectively connected to user system 1180 using a wired or wireless connection. For example, an authorized representative device may be installed as a card in a computer. Similarly, an authorized representative device may be connected via a serial port, parallel port, USB port, etc. The hardware device 1200 may also be accessible via a wireless or wired network. For example, an authorized representative device 1200 may be connected to a user system or computer accessible via a wireless network by a secondary device such as a digital audio player.

As also illustrated in FIG. 70, a remote server 1220 may optionally be provided to supply an authorized representative if the hardware device is not present or is inoperable. Similarly, remote server 1220 may provide authorized representative updates, patches, reprogramming functions, etc. for hardware device 1200. Various information may be optionally encrypted to prevent user tampering as previously described.

Thus, the present invention provides a system and method for reducing or preventing unauthorized use of protected software including various types of digital content. The systems and methods of the present invention may be used transparently to the user and with little or no user information being transferred outside of a trusted system or network. The present invention also provides a convenient and low cost system and method for software publishers to designate software for protection while providing backward compatibility for older devices. Although it is unlikely that any anti-piracy strategy will be completely effective for any length of time, the present invention provides a solution to many of the problems associated with prior art strategies and should significantly reduce the unauthorized used of all types of software.

While the best mode for carrying out the invention has been described in detail, those familiar with the art to which this invention relates will recognize various alternative designs and embodiments for practicing the invention as defined by the following claims.

1. A method for securing software to reduce unauthorized use, the method comprising:
providing at least one authorized representative entity installed on or in the user device;
obtaining registration information corresponding to at least one user device;
generating an authentication code at least partially based on the registration information;
associating the authentication code with the software;
determining whether a current user device is authorized at least partially based on the authentication code associated with the software and registration information associated with the current user device; and
controlling access to the software based on whether the current user device is authorized.

2. The method of claim 1 wherein the software is self activating and self authenticating in conjunction with the authorized representative located on or in the user device.

3. The method of claim 1 wherein the software comprises data representing content selected from the group consisting of music, video, an application program, an operating system component, a game, a movie, graphics, watermarked works, a magazine, and a book.

4. The method of claim 1 wherein the step of obtaining registration information is performed by the at least one authorized representative entity installed on or in the user device.

5. The method of claim 1 wherein the step of generating an authentication code is performed by the at least one authorized representative entity installed on or in the user device.

6. The method of claim 1 wherein the step of obtaining registration information is performed by a remotely located authorized representative entity.

7. The method of claim 1 wherein the step of generating an authentication code is performed by a remotely located authorized representative entity.

8. The method of claim 1 wherein the steps of obtaining, generating, associating, determining, and controlling are performed by a resident authorized representative entity installed on at least one user device.

9. The method of claim 8 wherein registration information associated with the current user device remains within a trusted network associated with the user device.

10. The method of claim 8 wherein registration information associated with the current user device is not communicated to any third party.

11. The method of claim 1 wherein the steps of obtaining registration information, generating an authentication code, and associating the authentication code are performed prior to transferring the software to the current user device.

12. The method of claim 1 wherein the steps of obtaining registration information, generating an authentication code, and associating the authentication code are performed concurrent with transferring the software to the current user device.

13. The method of claim 1 wherein the steps of obtaining registration information, generating an authentication code, and associating the authentication code are performed following transferring the software to the current user device.

14. The method of claim 11 wherein the steps of obtaining, generating, and associating are performed by a remote authorized representative entity.

15. The method of claim 1 wherein the authorized representative entity comprises a hardware device.

16. The method of claim 15 wherein the hardware device is a computer chip.

17. The method of claim 15 wherein the hardware device is integral with a CPU.

18. The method of claim 15 wherein the hardware device is a PC card.

19. The method of claim 15 wherein the hardware device is a microprocessor.

20. The method of claim 1 wherein the steps of determining whether a current user device is authorized and controlling access to the software are performed by the authorized representative entity installed on or in a user device.

21. The method of claim 1 wherein the authorized representative entity comprises software.

22. The method of claim 21 wherein the software is electronically distributed.

23. The method of claim 21 wherein the software is transferred to a user device from a computer readable storage medium.

24. The method of claim 1 further comprising electronically distributing the software to a user.

25. The method of claim 1 wherein at least one authentication code is distributed with the software.

26. The method of claim 1 wherein the authentication code corresponds to a group of user devices.

27. The method of claim 26 wherein the authentication code corresponds to a manufacturer of a user device.

28. The method of claim 26 wherein the authentication code corresponds to a model of a user device.

29. The method of claim 1 wherein the authentication code corresponds to a unique user device.

30. The method of claim 1 wherein the steps of determining whether a current user device is authorized and controlling access to the software are performed by a remotely located authorized representative entity.

31. The method of claim 1 wherein the step of controlling access to the software comprises preventing transfer of at least a portion of the software to the current user device.

32. The method of claim 1 wherein the step of controlling access to the software comprises preventing the current user device from utilizing the software.

33. The method of claim 1 wherein the steps of determining and controlling are at least partially performed by an authorized representative installed on a secondary user device.

34. The method of claim 1 wherein the steps of obtaining, generating, and associating are at least partially performed by a primary user device and the steps of determining and controlling are performed by a secondary user device.

35. The method of claim 1 further comprising encrypting the authentication code.

36. The method of claim 1 further comprising encrypting the registration information.

37. The method of claim 1 further comprising associating an identifier with the software to trigger authentication by an authorized representative entity.

38. The method of claim 1 further comprising:
securing any means for generating the authentication code after generating the authentication code associated with the software.

39. The method of claim 1 wherein the steps of obtaining registration information, generating an authentication code, and associating the authentication code are at least partially performed by an authorized represenatative entity installed on or in a user device, the method further comprising:
modifying the authorized representative entity to disable subsequent generation of authentication codes associated with the software.

40. The method of claim 1 wherein the steps of obtaining registration information, generating an authentication code, and associating the authentication code are at least partially performed by a remote authorized representative prior to distribution of the software.

41. A method for securing software to reduce unauthorized use having an authorized representative entity installed on or in a user device, the method comprising:
determining whether the user device is authorized to access the software using the authorized representative entity; and
controlling access to the software based on whether the user device is determined to be authorized.

42. The method of claim 41 wherein the software is self authenticating in conjunction with an authorized representative located on or in the user device.

43. The method of claim 41 further comprising:
determining whether the user device is authorized to access the software using a remotely located authorized representative entity in combination with the authorized representative entity installed on or in the user device.

44. The method of claim 41 wherein the authorized representative entity comprises a computer chip.

45. The method of claim 41 wherein the authorized representative entity is integral with the CPU.

46. The method of claim 41 wherein the authorized representative entity comprises a PC card.

47. The method of claim 41 wherein the authorized representative entity comprises program instructions executed by a microprocessor.

48. The method of claim 47 wherein the program instructions comprise an operating system component.

49. The method of claim 47 wherein the program instructions comprise an application program.

50. The method of claim 47 wherein the program instructions comprise a driver for a secondary device.

51. The method of claim 41 wherein the step of determining whether the user device is authorized comprises:
comparing registration information associated with the user device to registration information associated with the software.

52. The method of claim 51 wherein the registration information associated with the software is embedded within an authentication code.

53. The method of claim 51 wherein the registration information associated with the software is encrypted.

54. The method of claim 51 wherein the registration information includes hardware information.

55. The method of claim 54 wherein the registration information includes hardware information associated with a unique user device.

56. The method of claim 55 wherein the hardware information includes a serial number.

57. The method of claim 54 wherein the registration information includes hardware information associated with a group of user devices.

58. The method of claim 41 wherein the authorized representative entity is installed by a manufacturer of the user device.

59. The method of claim 41 wherein the authorized representative entity is installed from a computer readable storage medium.

60. The method of claim 41 wherein the authorized representative entity is downloaded to the user device.

61. The method of claim 460 wherein the authorized representative entity is transferred to the user device from a network.

62. The method of claim 41 wherein the step of controlling access comprises preventing the software from being transferred to a second user device.

63. The method of claim 41 wherein the step of controlling access comprises preventing the software from being executed by the user device.

64. The method of claim 41 wherein the step of controlling access comprises providing limited access to the software.

65. The method of claim 41 wherein the software comprises data representing content selected from the group consisting of music, video, an application program, an operating system component, a game, a movie, graphics, watermarked works, a magazine, and a book.

66. The method of claim 41 wherein the software comprises instructions for generating at least one authentication code at least partially based on registration information associated with the user device.

67. The method of claim 66 wherein the software comprises instructions for encrypting the authentication code.

68. The method of claim 41 wherein the step of determining whether the user device is authorized comprises:
contacting a remote authorized representative entity if the authorized representative entity installed on or in a user device is unable to determine whether the user device is authorized.

69. The method of claim 41 wherein the step of determining whether the user device is authorized comprises:
contacting a remote authorized representative if the authorized representative entity installed on or in a user device determines that the user device is not authorized.

70. The method of claim 41 wherein the step of determining whether the user device is authorized comprises:
obtaining registration information associated with the user device; and
comparing the registration information associated with the user device with registration information encoded in an authentication code associated with the software.

71. The method of claim 41 further comprising:
detecting an identifier associated with the software to trigger authentication functions performed by the authorized representative entity installed on or in the user device; and
performing the steps of determining whether the user device is authorized and controlling access to the software only if the identifier is detected.

72. The method of claim 41 further comprising:
automatically contacting a remote authorized representative based upon a triggering event to receive information.

73. The method of claim 72 wherein the information is selected from a group consisting of updates, upgrades, patches, marketing information, promotional information, quality assurance information, network monitoring and metering information, and error and usage information.

74. The method of claim 73 wherein the information updates the authorized representative entity installed on or in the user device.

75. The method of claim 73 wherein the information modifies the software.

76. The method of claim 72 wherein the triggering event is based on a user action.

77. The method of claim 72 wherein the automatic contact with the remote authorized representitve is repeated.

78. A method for reducing unauthorized use of software, the method comprising:
associating at least one identifier with the software corresponding to a request for digital rights management;
distributing the software to a user;
detecting the at least one identifier using an authorized representative entity;
associating at least one authentication code with the software;
determining whether a user device is authorized to access the software; and
controlling access to the software based on whether the user device is authorized.

79. The method of claim 78 wherein the software is self activating and self authenticating in conjunction with an authorized representative located on or in the user device.

80. The method of claim 78 further comprising encrypting the at least one authentication code.

81. The method of claim 78 further comprising:
obtaining registration information associated with at least one user device; and
generating the at least one authentication code at least partially based on the registration information.

82. The method of claim 67 further comprising encrypting the registration information.

83. The method of claim 81 wherein the steps of obtaining registration information, generating the at least one authentication code, and associating the at least one authentication code are performed before the step of distributing the software.

84. The method of claim 81 wherein the steps of obtaining registration information, generating the at least one authentication code, and associating the at least one authentication code are performed concurrent with the step of distributing the software.

85. The method of claim 81 wherein the steps of obtaining registration information, generating the at least one authentication code, and associating the at least one authentication code are performed subsequent to the step of distributing the software.

86. The method of claim 81 wherein the steps of obtaining registration information, generating the at least one authentication code, and associating the at least one authentication code are performed by an authorized representative entity installed on or in the user device.

87. The method of claim 81 wherein the step of generating the at least one authentication code is performed by an authorized representative entity installed on or in the user device, the method further comprising:
securing the authentication code to resist user tampering.

88. The method of claim 87 wherein the step of securing comprises preventing the authorized representative entity installed on or in the user device from generating any more authentication codes for the software.

89. The method of claim 87 wherein the step of securing comprises encrypting the authentication code.

90. The method of claim 78 further comprising:
determining whether an operational authorized representative entity is available locally;
installing an authorized representative entity on or in the user device if an operational authorized representative entity is not available locally.

91. The method of claim 90 wherein the step of installing comprises transferring the authorized representative entity to the user device from a remote authorized representative entity.

92. The method of claim 90 wherein the step of installing comprises transferring the authorized representative entity to the user device from a computer readable storage medium.

93. The method of claim 90 wherein the software includes an authorized representative entity and wherein the step of installing comprises transferring the authorized representative entity to the user device from the software.

94. The method of claim 78 further comprising:
determining whether an operational authorized representative entity is installed on or in the user device; and
contacting a remote authorized representative entity if no operational authorized representative entity is installed on or in the user device.

95. The method of claim 94 wherein the remote authorized representative entity performs the steps of determining whether a user device is authorized and controlling access to the software.

96. The method of claim 78 further comprising:
obtaining registration information including hardware specific information associated with a user device, wherein the steps of obtaining registration information and associating at least one authentication code are performed prior to the step of distributing the software to a user.

97. The method of claim 78 further comprising:
obtaining registration information including hardware specific information associated with a user device, wherein the steps of obtaining registration information and associating at least one authentication code are performed concurrent with the step of distributing the software to a user.

98. The method of claim 78 further comprising:
obtaining registration information including hardware specific information associated with a user device, wherein the steps of obtaining registration information and associating at least one authentication code are performed following the step of distributing the software to a user.

99. The method of claim 67 wherein the step of determining whether a user device is authorized is performed by a hardware device.

100. The method of claim 67 wherein the step of controlling access to the software comprises preventing the software from being transferred to the user device if the user device is not authorized.
